(19) United States
(12) Patent Application Publication
(10) Pub. No.: US 2026/0226350 A1
(43) Pub. Date: Aug. 6, 2026

(54) LIQUID-CRYSTALLINE MEDIUM

(71) Applicant: MERCK PATENT GMBH, Darmstadt, DE (US)

(72) Inventors: Akihiro KOJIMA, Tokyo (JP); Chen-Wei JAO, Pudong New Area, Shanghai (CN); Chang-Suk CHOI, Pyeongtaek (KR)

(73) Assignee: MERCK PATENT GMBH, Darmstadt (DE)

(21) Appl. No.: 19/138,552

(22) PCT Filed: Dec. 13, 2023
(86) PCT No.: PCT/EP2023/085550

§ 371 Date: Jun. 12, 2025

(30) Foreign Application Priority Data
Dec. 16, 2022 (CN) 202211621287.0
Apr. 27, 2023 (CN) 202310472881.6

(51) Int. Cl. C09K 19/06; C09K 19/04; C09K 19/12; C09K 19/30

(52) U.S. Cl. CPC C09K 19/068; C09K 19/066; C09K 19/067; C09K 19/12; C09K 19/3003; C09K 19/3028; C09K 19/3048; C09K 19/3059; C09K 19/3068; C09K 19/3087; C09K 2019/0466; C09K 2019/122; C09K 2019/123; C09K 2019/3004; C09K 2019/3006; C09K 2019/3009; C09K 2019/301; C09K 2019/3013; C09K 2019/3021; C09K 2019/3025; C09K 2019/3031; C09K 2019/3036; C09K 2019/304; C09K 2019/3063; C09K 2019/3077

(57) ABSTRACT

Liquid-crystalline (LC) media and liquid-crystal displays (LCDs) containing these media, especially energy-saving displays addressed by an active matrix and in particular LC displays of the TN, PS-TN, STN, TN-TFT, OCB, IPS, PS-IPS, FFS, HB-FFS, XB-FFS, PS-FFS, SA-HB-FFS, SA-XB-FFS, polymer-stabilized SA-HB-FFS, polymer-stabilized SA-XB-FFS, positive VA, or positive PS-VA type, wherein the media have an improved long-term stability at lower temperatures and are highly suitable for use in automotive and outdoor applications.

### CROSS-REFERENCE TO RELATED APPLICATIONS

This is a PCT National Stage application filed under 35 U.S.C. § 371(c), claiming priority benefit under 35 U.S.C. § 365(a) of and to PCT International Application No. PCT/EP2023/085550, filed Dec. 13, 2023, which claims priority benefit under 35 U.S.C. § 365(b) of and to Chinese Patent Application No. 202211621287.0, filed Dec. 16, 2022, and Chinese Patent Application No. 202310472881.6, filed Apr. 27, 2023, the contents of which documents are incorporated herein by reference in their entirety and for all purposes.

### FIELD OF THE INVENTION

The present invention relates to liquid-crystalline (LC) media and to liquid-crystal displays (LCDs) containing these media, especially to energy saving displays addressed by an active matrix and in particular to LC displays of the TN, PS-TN, STN, TN-TFT, OCB, IPS, PS-IPS, FFS, HB-FFS, XB-FFS, PS-FFS, SA-HB-FFS, SA-XB-FFS, polymer stabilized SA-HB-FFS, polymer stabilized SA-XB-FFS, positive VA, or positive PS-VA type. The media have an improved low temperature stability (LTS) and high long-term stability against UV radiation and elevated temperatures.

### BACKGROUND

Liquid-crystal displays (LCDs) are used in many areas for the display of information. LCDs are used both for direct-view displays and for projection-type displays. The electro-optical modes used are, for example, the twisted nematic (TN), super twisted nematic (STN), optically compensated bend (OCB), and electrically controlled birefringence (ECB) modes, together with their various modifications, as well as others. All these modes utilize an electric field which generated substantially perpendicular to the substrates and the liquid-crystal layer.

Besides these modes, there are also electro-optical modes that utilize an electric field which is substantially parallel to the substrates or the liquid-crystal layer. For example, WO91/10936A1 discloses a liquid-crystal display in which the electric signals are generated in such a way that the electric fields have a significant component parallel to the liquid-crystal layer, and which has since then become known as in-plane switching IPS) display. The principles of operating such a display are described, for example, by R. A. Soref in Journal of Applied Physics, Vol. 45, No. 12, pp. 5466-5468 (1974).

IPS displays contain an LC layer between two substrates with planar orientation, where the two electrodes are arranged on only one of the two substrates and preferably have interdigitated, comb-shaped structures. Upon application of a voltage to the electrodes, an electric field with a significant component parallel to the LC layer is generated therebetween. This electric field causes realignment of the LC molecules in the layer plane.

EP0588 568B1, for example, discloses various possibilities for the design of the electrodes and for addressing an IPS display. DE19824137B4 likewise describes various embodiments of such IPS displays.

Liquid-crystalline materials for IPS displays of this type are described, for example, in DE19528104A1.

Furthermore, so-called “fringe-field switching” (FFS) displays have been reported (see, inter alia, S. H. Jung et al., Jpn. J. Appl. Phys., Volume 43, No. 3, 2004, 1028), which contain two electrodes on the same substrate, one of which is structured in a comb-shaped manner and the other is unstructured. A strong, so-called “fringe field” is thereby generated, i.e., a strong electric field close to the edge of the electrodes, and, throughout the cell, an electric field which has both a strong vertical component and also a strong horizontal component. FFS displays have a low viewing-angle dependence of the contrast. FFS displays usually contain an LC medium with positive dielectric anisotropy, and an alignment layer, usually of polyimide, which provides planar alignment to the molecules of the LC medium.

Liquid-crystal displays of the IPS and FFS electro-optical mode are in particular suitable for use in modern desktop monitors, TV sets, and multimedia applications. The liquid-crystalline media (LC media) according to the present invention are preferably used in displays of this type. In general, dielectrically positive liquid-crystalline media having rather lower values of the dielectric anisotropy are used in FFS displays, but in some cases, LC media having a dielectric anisotropy of only about 3 or even less are also used in IPS displays.

A further improvement has been achieved by the HB-FFS mode. One of the unique features of the HB-FFS mode, in contrast to the traditional FFS technology, is that it enables higher transmittance, which allows operation of the panel with less energy consumption.

Another recently developed mode is the XB-FFS mode, wherein the LC medium additionally contains a polar liquid crystal compound with low dielectric anisotropy.

Liquid-crystal compositions which are suitable for LCDs and especially for FFS and IPS displays are known in prior art, for example, from JPH07181439A, EP0667 555B1, EP0673986B1, DE19509410A1, DE19528106A1, and DE19528107B4. However, these compositions have certain disadvantages. Amongst other deficiencies, most of them result in disadvantageously long addressing times, have inadequate values of the resistivity, and/or require excessively high operating voltages. Both an improvement in the operating properties and an improvement in the shelf life are necessary here.

WO2010/099853A1 and DE102010027099A1 disclose thiophene-containing LC media. WO2010/099853A1 teaches compounds containing a thiophene-2,5-diyl unit which is linked directly to a 2- and/or 6-substituted 1,4-phenylene unit. WO2010/099853A1 describes the development of novel materials for use in LC displays. The objectives described therein were achieved by the provision of compounds of the general formula:

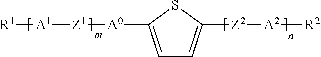

where A⁰ denotes a 2,6-difluoro-1,4-phenylene unit, A¹ and A², besides other meanings, denote a 1,4-phenylene or 1,4-cyclohexylene unit, and Z¹ and Z² denote a bridging element or a single bond.

Specific examples described are, for example, the following compounds (see WO2010/099853A1):

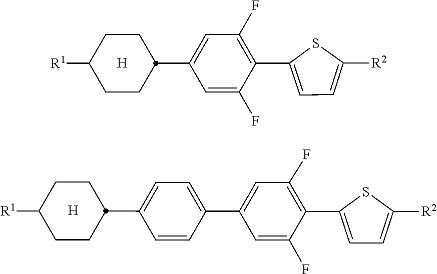

For many practical applications in LC displays, known LC media comprising thiophene compounds have only a moderate LTS. Exposure to temperatures below −20° C. commonly results in an undesired formation of smectic phases. In particular, LC media comprising thiophene compounds as well a large amount of dilutant such as CC-3-V or CC-3-V1 often show an insufficient LTS and are therefore not suitable for use at low temperatures.

JPH01240592A describes a liquid crystal composition for TN and STN applications having a wide nematic phase range and comprising inter alia tolane compounds of the following structure:

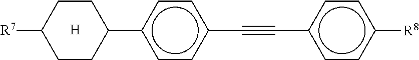

The document does not mention dilutants such as CC-3-V, CC-3-V1, or mesogenic thiophene compounds.

FFS and IPS displays can be operated as active-matrix displays (AMD) or passive-matrix displays (PMD). In the case of active-matrix displays, individual pixels are usually addressed by integrated, non-linear active elements such as, for example, thin-film transistors (TFTs), while in the case of passive-matrix displays, individual pixels are usually addressed by the multiplex method.

The displays according to the present invention are preferably by an active matrix, preferably by a matrix of TFT. However, the liquid crystals according to the invention can also advantageously be used in displays having other known addressing means.

Typical applications of in-plane switching (IPS) and fringe field switching (FFS) technologies are monitors, notebooks, televisions, mobile telephones, tablet PCs, etc.

Both the IPS and the FFS technology have certain advantages over other LCD technologies, such as, for example, the vertical alignment (VA) technology, e.g., a broad viewing-angle dependency of the contrast.

The provision of LC media and the use thereof in a display having high transmission, a good black state, and a high contrast ratio is a central challenge for modern FFS and IPS applications. In addition, modern applications also require good low-temperature stability and fast addressing times.

Matrix liquid crystal display (MFK) displays with full array LED backlighting, which have become increasingly common in recent years, include a large number of light-emitting diodes (LEDs) arranged directly behind the layer with the FK medium. Modern high-performance InGaN LEDs sometimes reach operating temperatures of more than 70° C. and, depending on the design, can emit UV radiation beside visible light. Direct contact between the LEDs and the LC medium therefore places special demands on the UV stability and temperature resistance of the LC medium. State-of-the-art MFK displays therefore do not meet today's requirements.

Recently, MFK displays have also been increasingly used in outdoor applications such as PIDs (Public Information Displays) for displaying various types of information at train stations, roads, airports, hotels and shopping malls. Compared to conventional MFK displays, such as those used in TV applications, PIDs need to have a much higher long-term resistance to solar UV radiation and elevated temperatures, as well as a wider operating temperature range. Additionally, such displays are also commonly exposed to temperatures as low as −20° C. and therefore need to have an appropriate low-temperature stability (LTS) and a broad nematic phase range. Since suitable LC media have not been available until now, display types with a relatively high energy consumption had been used for such purposes.

### SUMMARY OF THE INVENTION

The present invention has the objective of providing LC media, in particular for FFS and IPS displays, but also for TN, transparent displays, positive VA or STN displays, and in particular for active-matrix displays like those addressed by TFTs, which do not exhibit the disadvantages indicated above or only do so to a lesser extent, and preferably have a high specific resistance, low threshold voltage, high dielectric anisotropy, a good low-temperature stability (LTS), a broad nematic phase range, fast response times, low rotational viscosities, excellent long term stability against UV radiation and increased operating temperatures, and high brightness. In other words, such LC media should be suitable for outdoor use in energy-saving LC displays.

These objectives have been achieved by providing LC media as described and claimed hereinafter.

In case of FFS displays, there is a need for further optimization of response time, contrast, brightness, and reliability. However, it was found that the liquid-crystalline materials of the prior art often do not achieve all these requirements at the same time.

It has now been surprisingly found that LC media according to the present invention, which contain a combination of one or more compounds of Formula I and at least one compound of Formula T1 and/or T2, show several improvements, especially when being used in FFS-mode displays, such as a good solubility, an excellent LTS value, a broad nematic phase range, a low ratio of γ₁/K₁, and fast response times.

The liquid-crystal media according to the present invention are especially suitable for use in liquid-crystal displays of the FFS, HB-FFS, XB-FFS, and IPS mode based on dielectrically positive liquid crystals and polymer-stabilized variants thereof.

The subject matter of the present invention is a LC medium, characterised in that it comprises one or more compounds of Formula I:

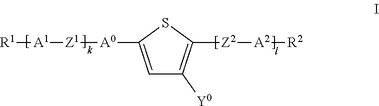

in which the individual substituents have the following meanings:
R¹ and R² each, independently of one another, denotes a H atom, an alkyl or an alkoxy group having 1 to 12 C atoms, or an alkenyl or an alkenyloxy group having 2 to 12 C atoms, in which one or more non-adjacent CH₂ groups are optionally substituted by —C≡C—, —CF₂O—, —OCF₂—, —CH═CH—,

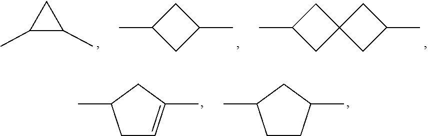

—O—, —CO—O— or —O—CO— in such a way that O atoms are not linked directly to one another, and in which one or more H atoms may be replaced by a halogen atom or a cycloalkyl or cycloalkoxy group having 3 to 12 C atoms, in which one or more H atoms may be replaced by a halogen atom,
Y⁰ denotes a H atom, an alkyl group having 1 to 3 C atoms, or an alkenyl group having 2 to 3 C atoms in which one or more non-adjacent CH₂ groups are optionally substituted by —C═C—, —CF₂O—, —OCF₂—, —CH═CH—, —O—, —CO—O—, or —O—CO— in such a way that O atoms are not linked directly to one another;
A⁰, A¹, A² each, independently of one another, denote phenylene-1,4-diyl, in which, in addition, one or two CH groups may be replaced by N and one or more H atoms may be replaced by halogen, CN, CH₃, CHF₂, CH₂F, CF₃, OCH₃, OCHF₂, or OCF₃, cyclohexane-1,4-diyl, in which, in addition, one or two non-adjacent CH₂ groups may be replaced, independently of one another, by O and/or S and one or more H atoms may be replaced by F, cyclohexene-1,4-diyl, bicyclo[1.1.1]pentane-1,3-diyl, bicyclo[2.2.2]octane-1,4-diyl, spiro[3.3]heptane-2,6-diyl, tetrahydropyran-2,5-diyl, or 1,3-dioxane-2,5-diyl;
Z¹ and Z² each, independently of one another, denote-CF₂O—, —OCF₂—, —CH₂O—, —OCH₂—, —CO—O—, —O—CO—, —C₂H₄—, —C₂F₄—, —CF₂CH₂—, —CH₂CF₂—, —CFHCFH—, —CFHCH₂—, —CH₂CFH—, —CF₂CFH—, —CFHCF₂—, —CH═CH—, —CF═CH—, —CH═CF—, —CF═CF—, —C═C—, or a single bond; and
k and l each, independently of one another, denote 0, 1, 2, or 3.

In addition to one or more compounds of Formula I as defined above, the LC medium comprises one or more compounds selected from the Formulae T1 and T2:

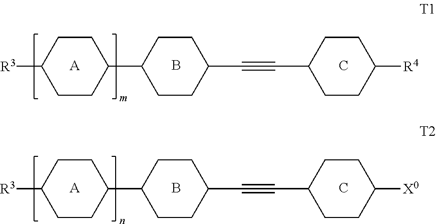

in which

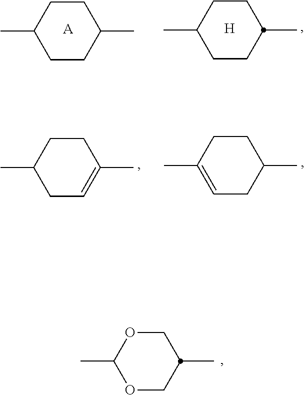

denotes

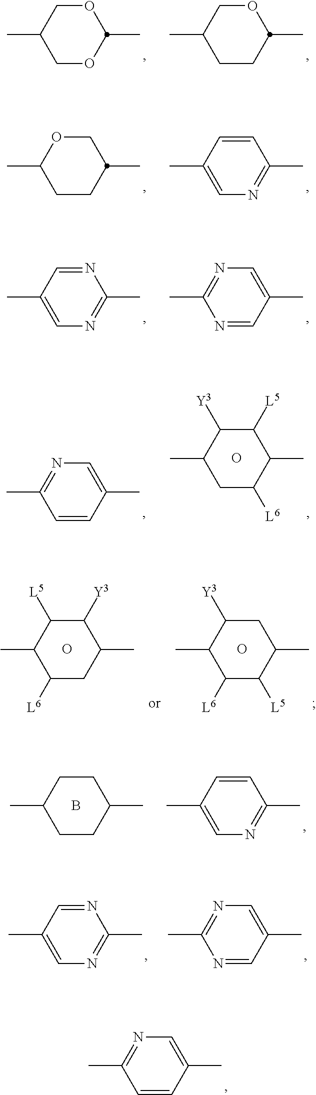

denotes

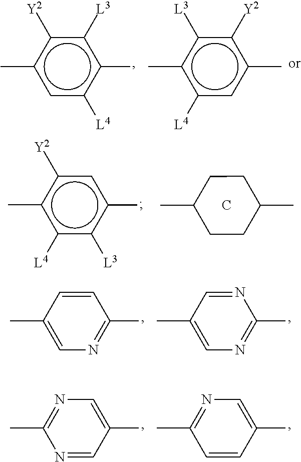

denotes

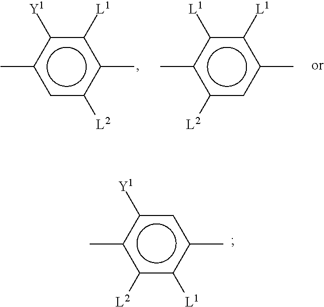

R³ and R⁴ each, independently from one another, denote an alkyl or an alkoxy group having 1 to 12 C atoms or an alkenyl group having 2 to 12 C atoms in which one or more CH₂ groups are optionally substituted by —C═C—, —CF₂O—, —OCF₂—, —CH═CH—,

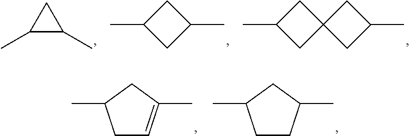

—O—, —CO—O—, or —O—CO— in such a way that O atoms are not linked directly to one another, and in which one or more H atoms may be replaced by a halogen atom;
L¹⁻⁶ each, independently from one another, denote H or F;
X⁰ denotes F, Cl, CN, SF₅, SCN, NCS, a halogenated alkyl group or halogenated alkoxy group having 1 to 6 C atoms, or a halogenated alkenyl group or halogenated alkenyloxy group having 2 to 6 C atoms;
Y¹⁻³ each, independently from one another, denote H, a straight-chain or branched alkyl or alkoxy group having 1 to 6 or 3 to 6 C atoms, or a cycloalkyl or a cycloalkoxy group having 3 to 6 C atoms; and
m and n each, independently of one another, denote 0 or 1.

The invention further relates to the use of a LC medium as described above and below for electro-optical purposes, in particular for the use in liquid-crystal displays, shutter glasses, LC windows, 3D applications, preferably in TN, PS-TN, STN, TN-TFT, OCB, IPS, PS-IPS, FFS, HB-FFS, XB-FFS, PS-HB-FFS, PS-XB-FFS, SA-HB-FFS, SA-XB-FFS, polymer-stabilized SA-HB-FFS, polymer-stabilized SA-XB-FFS, positive VA, and positive PS-VA displays, very preferably in LCOS, FFS, HB-FFS, IPS, PS-HB-FFS, and PS-IPS displays.

The invention further relates to an electro-optical liquid-crystal display containing a LC medium, as described above and below, in particular a TN, PS-TN, STN, TN-TFT, OCB, IPS, PS-IPS, FFS, HB-FFS, XB-FFS, PS-HB-FFS, PS-XB-FFS, SA-HB-FFS, SA-XB-FFS, polymer-stabilized SA-HB-FFS, polymer-stabilized SA-XB-FFS, positive VA, positive PS-VA, or transparent display, preferably a FFS, HB-FFS, IPS, PS-HB-FFS, or PS-IPS display.

### DETAILED DESCRIPTION OF THE INVENTION

In the present application, all atoms also include their isotopes. In some embodiments, one or more hydrogen atoms (H) may be replaced by deuterium (D); a high degree of deuteration enables or simplifies analytical determination of compounds, in particular in the case of low concentrations.

In the formulae above and below, if R¹, R², R³, R⁴, or R⁰ preferably denotes an alkyl group and/or an alkoxy group, this may be straight-chain or branched. It is preferably straight-chain, has 2, 3, 4, 5, 6, or 7 C atoms and accordingly preferably denotes ethyl, propyl, butyl, pentyl, hexyl, heptyl, ethoxy, propoxy, butoxy, pentoxy, hexyloxy, or heptyloxy, furthermore methyl, octyl, nonyl, decyl, undecyl, dodecyl, tridecyl, tetradecyl, pentadecyl, methoxy, octyloxy, nonyloxy, decyloxy, undecyloxy, dodecyloxy, tridecyloxy, or tetradecyloxy. R⁰ preferably denotes straight-chain alkyl having 2 to 6 C atoms.

Oxaalkyl preferably denotes straight-chain 2-oxapropyl (=methoxymethyl), 2-(=ethoxymethyl), or 3-oxabutyl (=2-methoxyethyl), 2-, 3-, or 4-oxapentyl, 2-, 3-, 4-, or 5-oxahexyl, 2-, 3-, 4-, 5-, or 6-oxaheptyl, 2-, 3-, 4-, 5-, 6-, or 7-oxaoctyl, 2-, 3-, 4-, 5-, 6-, 7-, or 8-oxanonyl, 2-, 3-, 4-, 5-, 6-, 7-, 8-, or 9-oxadecyl.

If R¹, R², R³, R⁴, or R⁰ denotes an alkoxy or oxaalkyl group, it may also contain one or more additional oxygen atoms, provided that oxygen atoms are not linked directly to one another.

In another preferred embodiment, one or more of R¹, R², R³, R⁴, or R⁰ are selected from the group consisting of

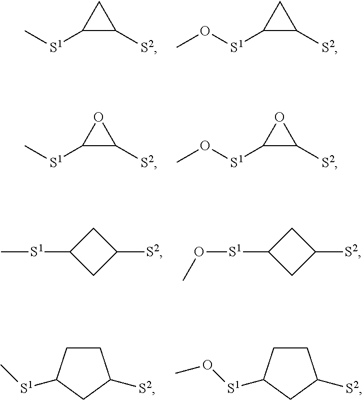

—S¹—F, —O—S¹—F, —O—S¹—O—S², wherein S¹ is C₁₋₁₂-alkylene or C₂₋₁₂-alkenylene and S² is H, C₁₋₁₂-alkyl or C₂₋₁₂-alkenyl, and very preferably, one or more of R¹, R², R³, R⁴, or R⁰ are selected from the group consisting of

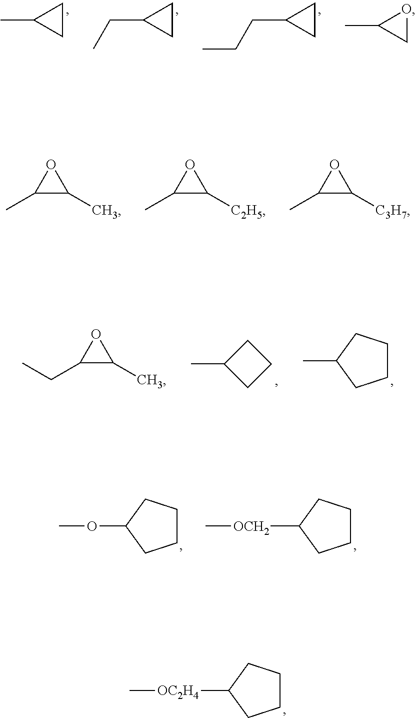

—OCH₂OCH₃, —O(CH₂)₂OCH₃, —O(CH₂)₃OCH₃, —O(CH₂)₄OCH₃, —O(CH₂)₂F, —O(CH₂)₃F, and —O(CH₂)₄F.

If R¹, R², R³, R⁴, or R⁰ denotes an alkyl group in which one CH₂ group has been replaced by —CH═CH—, this may be straight-chain or branched. It is preferably straight-chain and has 2 to 10 C atoms. Accordingly, it denotes, in particular, vinyl, prop-1- or -2-enyl, but-1-, -2-, or -3-enyl, pent-1-, -2-, -3-, or -4-enyl, hex-1-, -2-, -3-, -4-, or -5-enyl, hept-1-, -2-, -3-, -4-, -5-, or -6-enyl, oct-1-, -2-, -3-, -4-, -5-, -6-, or -7-enyl, non-1-, -2-, -3-, -4-, -5-, -6-, -7-, or -8-enyl, dec-1-, -2-, -3-, -4-, -5-, -6-, -7-, -8-, or -9-enyl.

If R¹, R², R³, R⁴, or R⁰ denotes an alkyl or alkenyl group which is at least monosubstituted by halogen, this group is preferably straight-chain, and halogen is preferably F. In the case of polysubstitution, halogen is preferably F. The resultant groups also include perfluorinated groups. In the case of monosubstitution, the fluorine or chlorine substituent may be in any desired position but is preferably in the ω-position.

In the formulae above and below, X⁰ is preferably CN, SCN, NCS, a mono- or poly-fluorinated alkyl or alkoxy group having 1, 2, or 3 C atoms, or a mono- or polyfluori-nated alkenyl group having 2 or 3 C atoms. X⁰ is particularly preferably CN, CF₃, CHF₂, OCF₃, OCHF₂, OCFHCF₃, OCFHCHF₂, OCFHCHF₂, OCF₂CH₃, OCF₂CHF₂, OCF₂CHF₂, OCF₂CF₂CHF₂, OCF₂CF₂CHF₂, OCFHCF₂CF₃, OCFHCF₂CHF₂, OCF₂CF₂CF₃, OCH═CF₂, or CH═CF₂, very particularly preferably F or OCF₃, furthermore CF₃, OCF═CF₂, OCHF₂, or OCH═CF₂.

In the LC media according to the present invention, the use of compounds of Formula I in combination with one or more compounds selected from the Formulae T1 and T2 and, preferably, with compounds of Formulae Z¹ to Z⁸ or their sub-formulae helps achieve a high LTS value, an increased value of ε_{⊥}, and at the same time a decrease of the rotational viscosity and the ratios of γ₁/K₂ and γ₁/K₁, and thus fast response times. Hence, the LC media are highly suitable for automotive applications such as navigation systems or various instruments.

### Compounds of Formula I

Preference is given to LC media comprising the compounds of Formula I in which A⁰ denotes phenylene-1,4-diyl, in which, in addition, one or two CH groups may be replaced by N and one or more H atoms may be replaced by halogen, CN, CH₃, CHF₂, CH₂F, OCH₃, OCHF₂, CF₃, or OCF₃. Particularly preferred are compounds in which A⁰ denotes

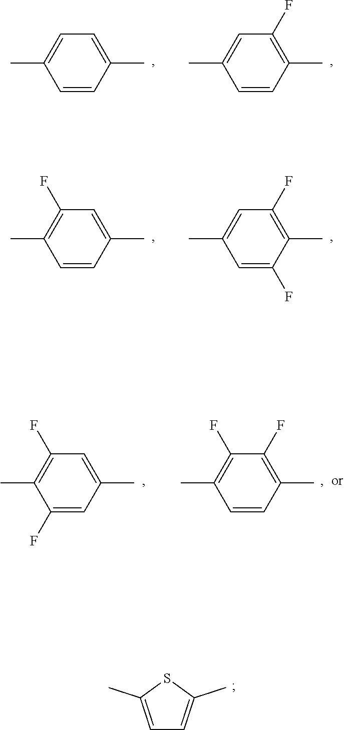

more preferred

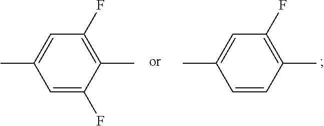

and very particularly preferably in which
A⁰

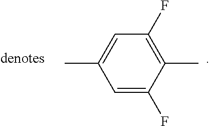

The preferred compounds of the Formula I result in LC media having a particularly high clearing point, low rotational viscosity, a broad nematic phase range, high birefringence, and an excellent thermal and UV stability.

Preference is furthermore given to compounds of the Formula I in which k and I denote 0, 1, or 2, particularly preferably 0 or 1. Particular preference is given to compounds of the Formula I in which I denotes 0, i.e., the thiophene ring is a terminal ring. Preference is furthermore given to compounds of the Formula I in which k denotes 0, 1, or 2, preferably 1 or 2, and very particularly preferably 1.

A⁰, A¹, and A² in Formula I particularly preferably denote phenylene-1,4-diyl, which may also be mono- or polysubstituted by F, furthermore cyclohexane-1,4-diyl, cyclohexenylene-1,4-diyl, tetrahydropyran-2,5-diyl, or 1,3-dioxane-2,5-diyl.

Z¹ and Z² in Formula I particularly preferably denote-CF₂O—, —OCF₂—, or a single bond, wherein the single bond is particularly preferred.

A¹ and A² in Formula I particularly preferably denote

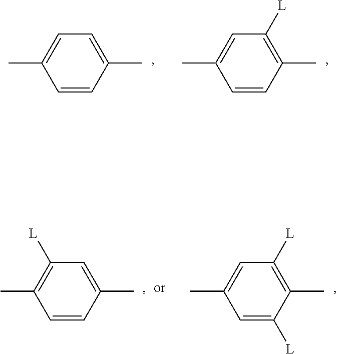

preferably unsubstituted 1,4-phenylene, in which L denotes halogen, CF₃, or CN, preferably F.

Preference is furthermore given to compounds of the Formula I in which R¹ and R² each, independently of one another, denote H, F, Cl, Br, —CN, —SCN, —NCS, SF₅, halogen, or alkyl, alkenyl, or alkynyl having up to 8, preferably up to 5 C atoms, each of which is optionally substituted by halogen, in particular by F.

Particularly preferred groups R¹ and R² in Formula I denote H, halogen, or alkyl, alkenyl, alkynyl, or alkoxy having up to 12, preferably up to 8 C atoms, each of which is optionally substituted by halogen, in particular by F, particularly preferred are H, F, or alkyl, alkenyl, or alkynyl having up to 8 C atoms. Preferably, at least one group is not H, particularly preferably both groups R¹ and R² are not H. R¹ is very particularly preferably equal to alkyl. R² is furthermore preferably H, alkyl, or fluorine. Very particularly preferably, R¹ is alkyl and R² is H or alkyl. R¹, R² each, independently of one another, very particularly preferably denote unbranched alkyl having 1 to 5 C atoms. If R¹ and R² denote substituted alkyl, alkoxy, alkenyl, or alkynyl, the total number of C atoms in the two groups R¹ and R² is preferably less than 10.

Preferred alkyl groups are, for example, methyl, ethyl, n-propyl, n-butyl, n-pentyl, n-hexyl, n-heptyl, and n-octyl.

Preferred alkenyl groups are, for example, ethenyl, propenyl, butenyl, and pentenyl.

Preferred alkynyl groups are, for example, ethynyl, propynyl, butynyl, pentynyl, hexynyl, heptynyl, and octynyl.

Preferred alkoxy groups are, for example, methoxy, ethoxy, n-propoxy, n-butoxy, n-pentoxy, n-hexoxy, n-heptoxy, and n-octoxy.

Halogen preferably denotes F or Cl, F being mostly preferred.

Particularly preferred compounds of the Formula I are those selected from the following sub-formulae:

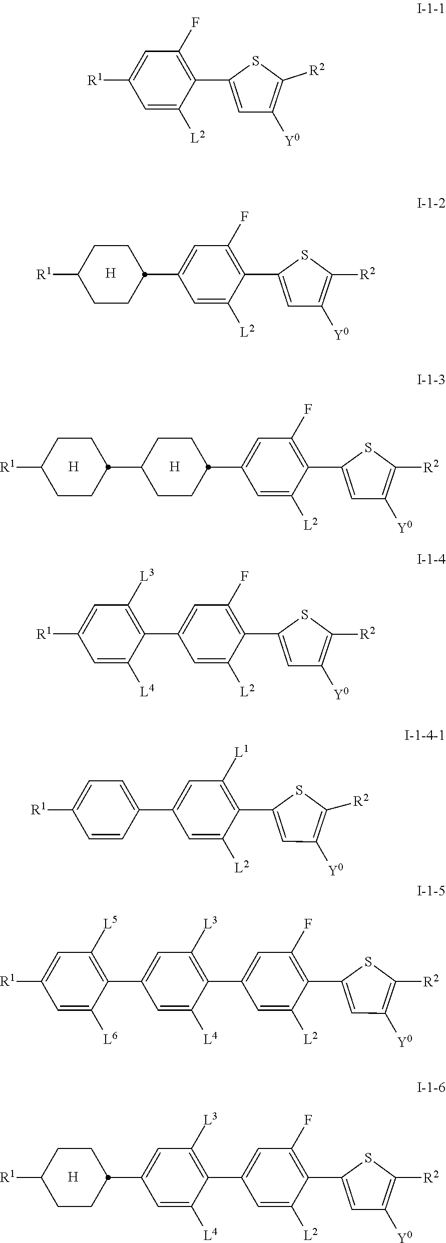

in which Y⁰, R¹, and R² have the meanings indicated in general Formula I, and L¹ to L⁶ independently denote H or F. R¹ and R² therein preferably denote optionally fluorinated alkyl or alkoxy having 1 to 12 C atoms, optionally fluorinated alkenyl or alkynyl having 2 to 12 C atoms, or optionally fluorinated cycloalkyl having 3 to 12 C atoms. Y⁰ is preferably a H atom or a methyl group.

Particularly preferred are optionally fluorinated alkyl, alkenyl, or alkynyl having up to 5 C atoms. L² in the Formulae I-1-1 to I-1-6 preferably denotes F. In the Formulae I-1-4 to I-1-6, L³ and L⁴ preferably denote H. In the Formulae I-1-4 to I-1-6, L³ and L⁴ preferably denote F.

In a particularly preferred embodiment, the compounds of Formula I are selected from the following structures:

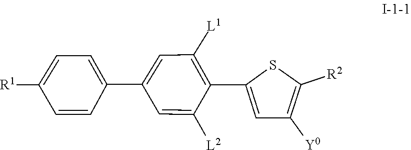

Wherein
R¹ has the same meaning as in the general Formula I;
R² denotes a straight-chain or branched alkyl or alkoxy group having 1 to 7 or 3 to 7 C atoms, an akenyl, alkenyloxy, or alkoxyalkyl group having 2 to 7 C atoms, or a cycloalkyl or cycloalkoxy group having 3 to 12 C atoms, in which one or more non-adjacent CH₂ groups are optionally substituted by —C═C—, —CF₂O—, —OCF₂—, —CH═CH—,

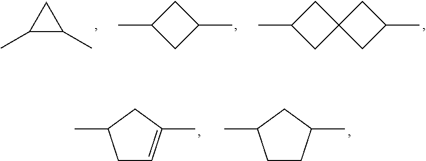

—O—, —CO—O—, or —O—CO— in such a way that O atoms are not linked directly to one another, and in which one or more H atoms may be replaced by a halogen atom; and
Y⁰ denotes a H atom or a straight-chain alkyl group having 1 to 3 C atoms or a branched alkyl group having 3 C atoms.

LC media according to the present invention having a particularly high LTS, broad nematic phase range, high long-term stability against UV radiation and elevated temperatures, and a low rotational viscosity are obtainable with the following compounds of the general Formula I:

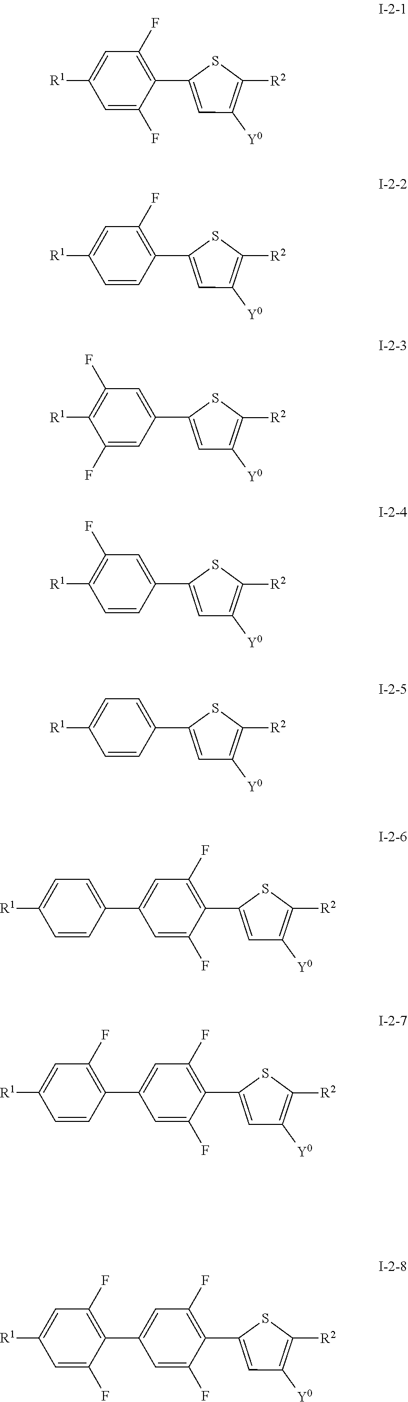

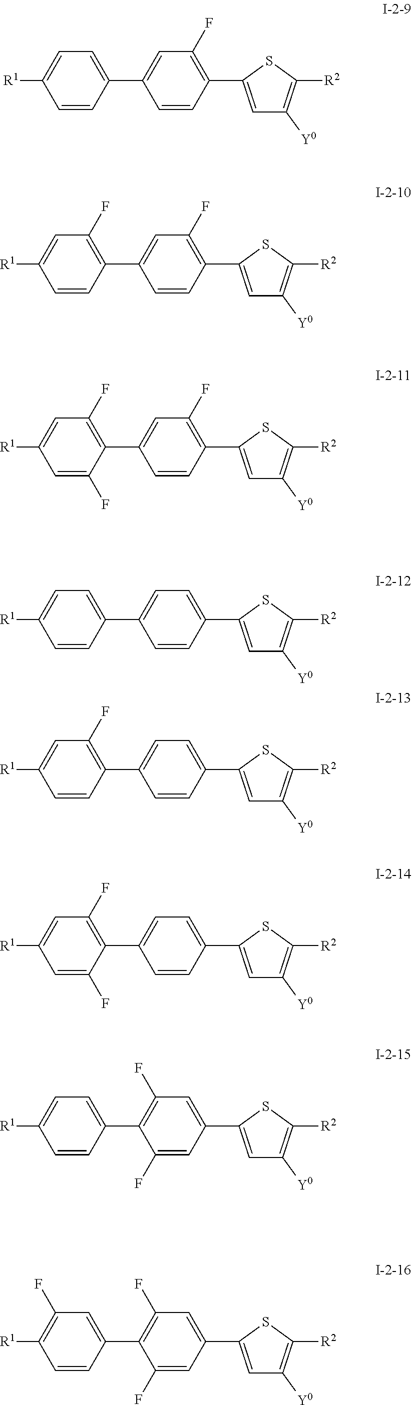

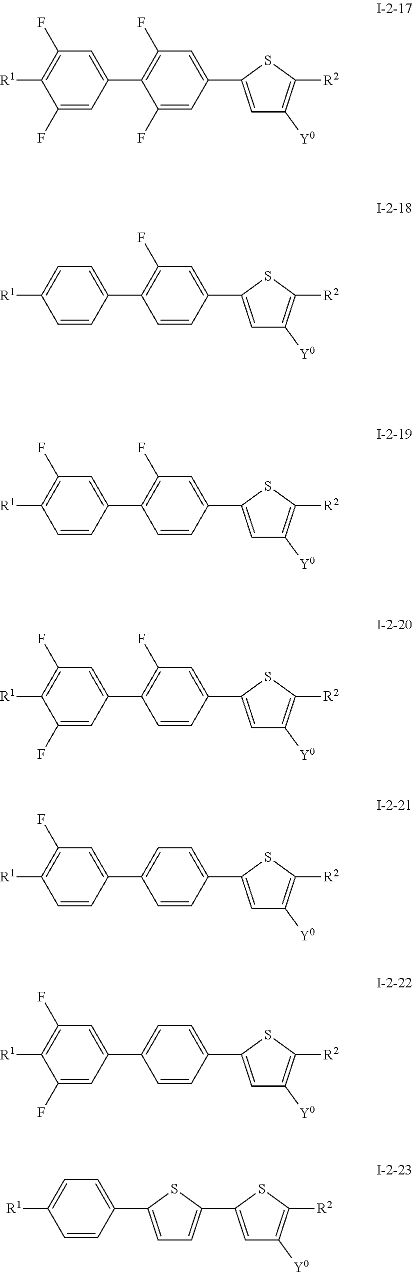

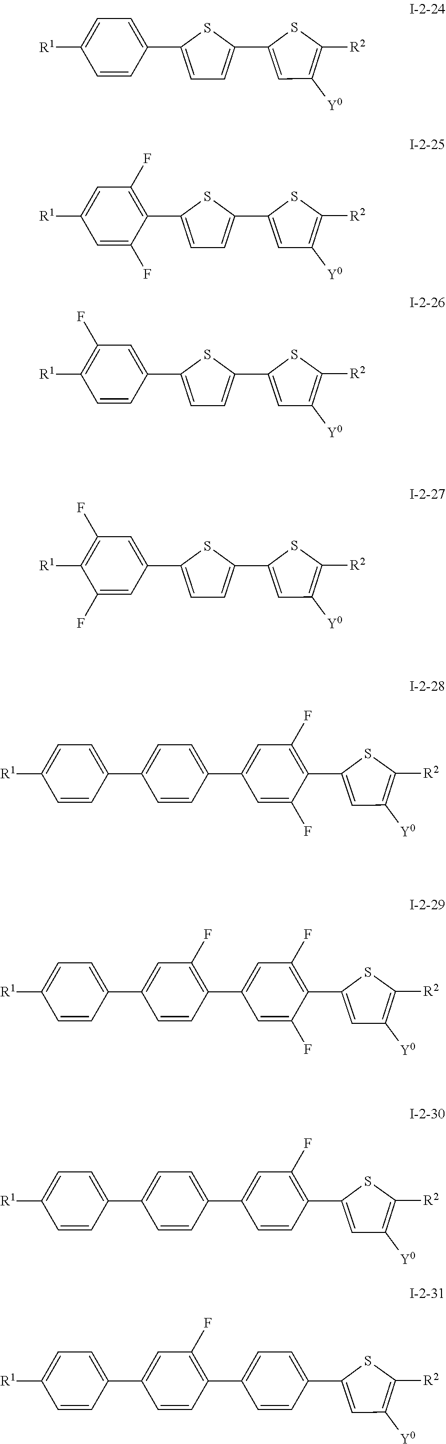

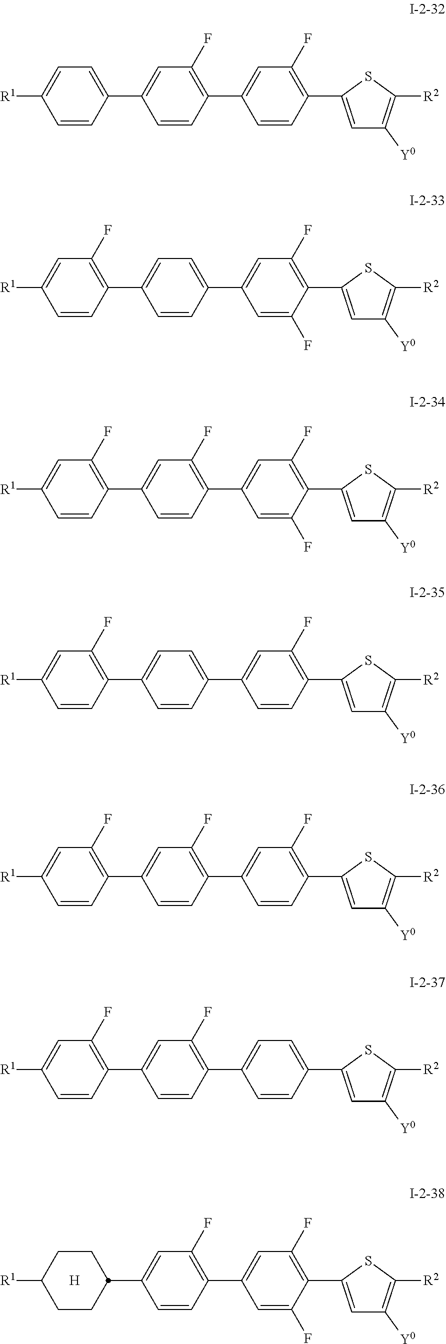

wherein Y⁰, R¹, and R² are as defined above.

Additionally, LC media comprising the following compounds of Formula I are particularly preferred:

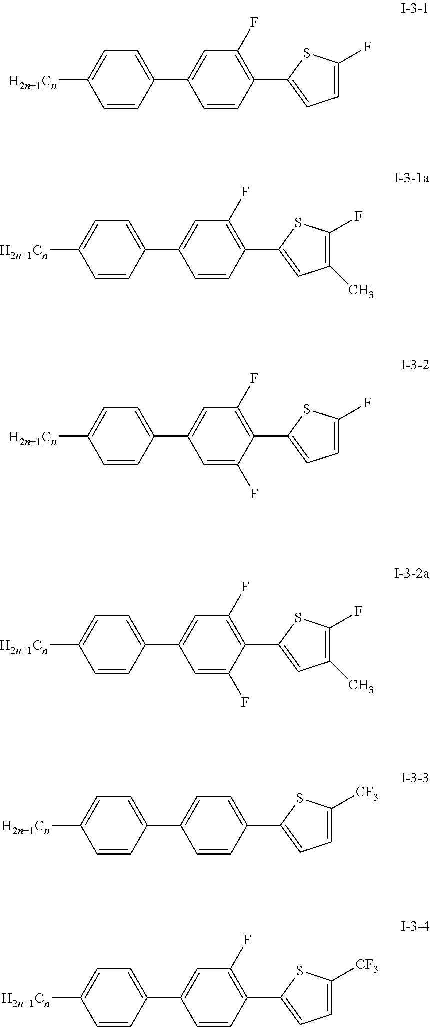

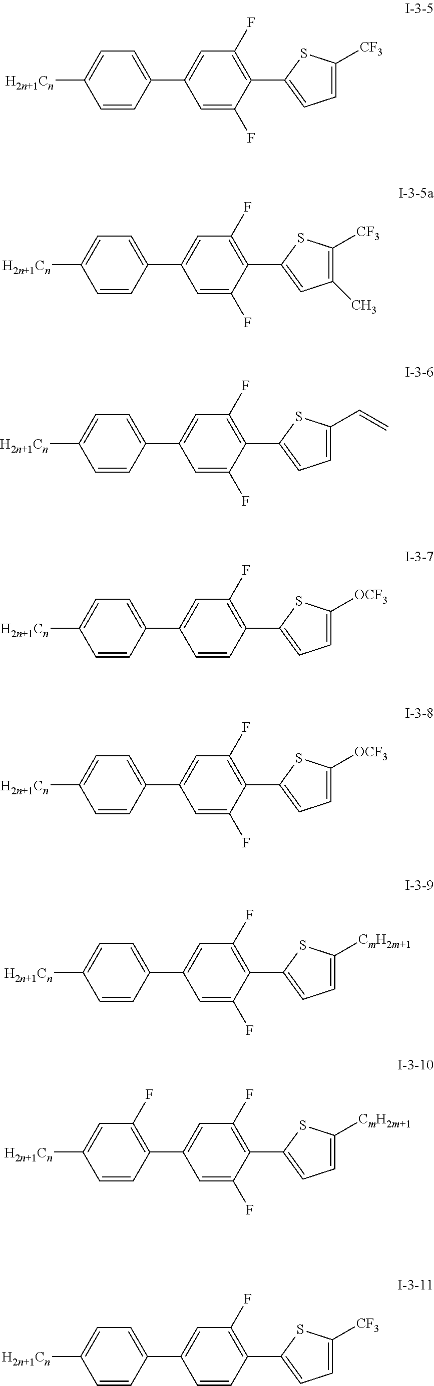

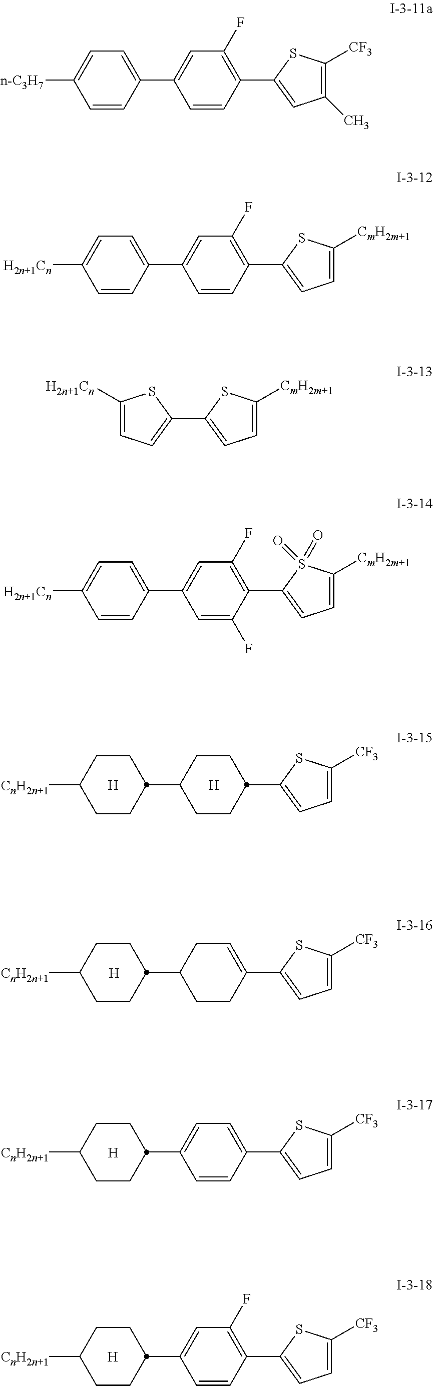

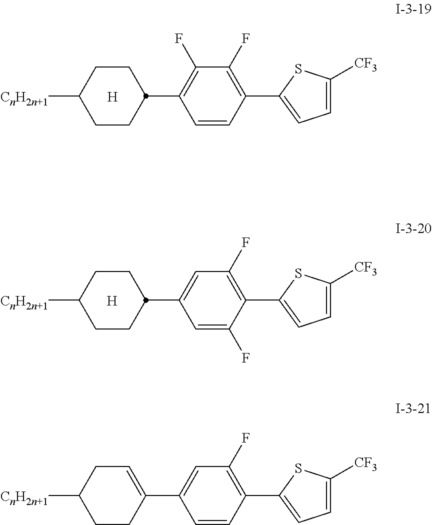

Mostly preferred compounds of Formula I include, in particular, one or more of the following:

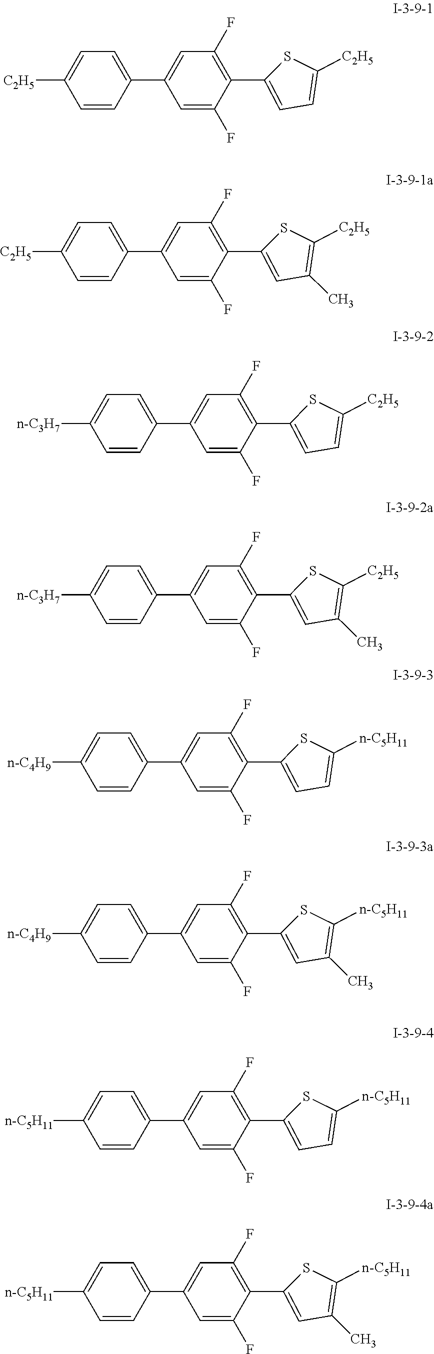

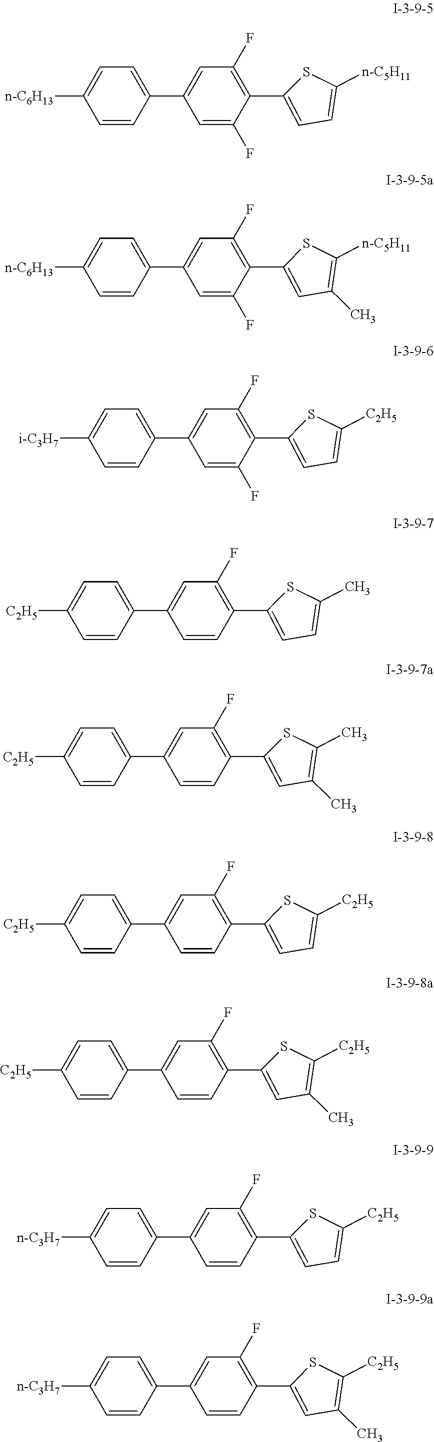

As a further possibility the following compounds of Formula I can be used.

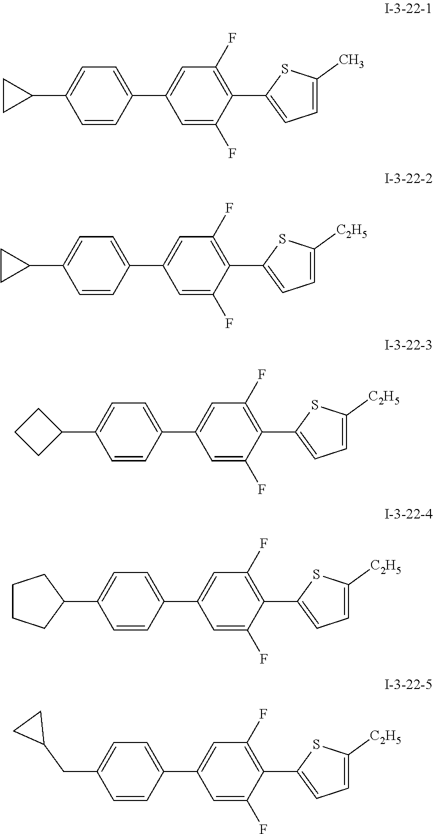 [SMILES: Cc1ccc(-c2c(F)cc(-c3ccc(C4CC4)cc3)cc2F)s1 ; CCc1ccc(-c2c(F)cc(-c3ccc(C4CC4)cc3)cc2F)s1 ; CCc1ccc(-c2c(F)cc(-c3ccc(C4CCC4)cc3)cc2F)s1 ; CCc1ccc(-c2c(F)cc(-c3ccc(C4CCCC4)cc3)cc2F)s1 ; CCc1ccc(-c2c(F)cc(-c3ccc(CC4CC4)cc3)cc2F)s1]

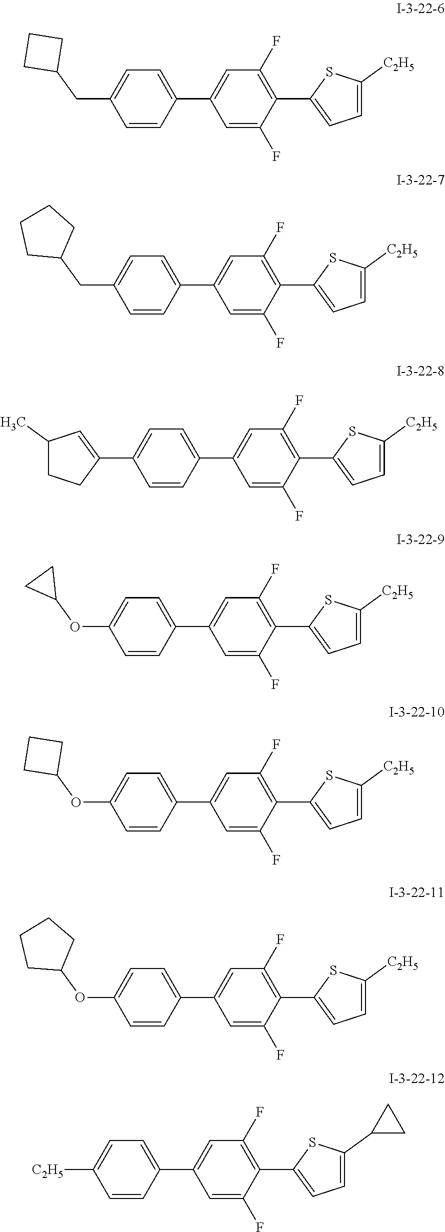

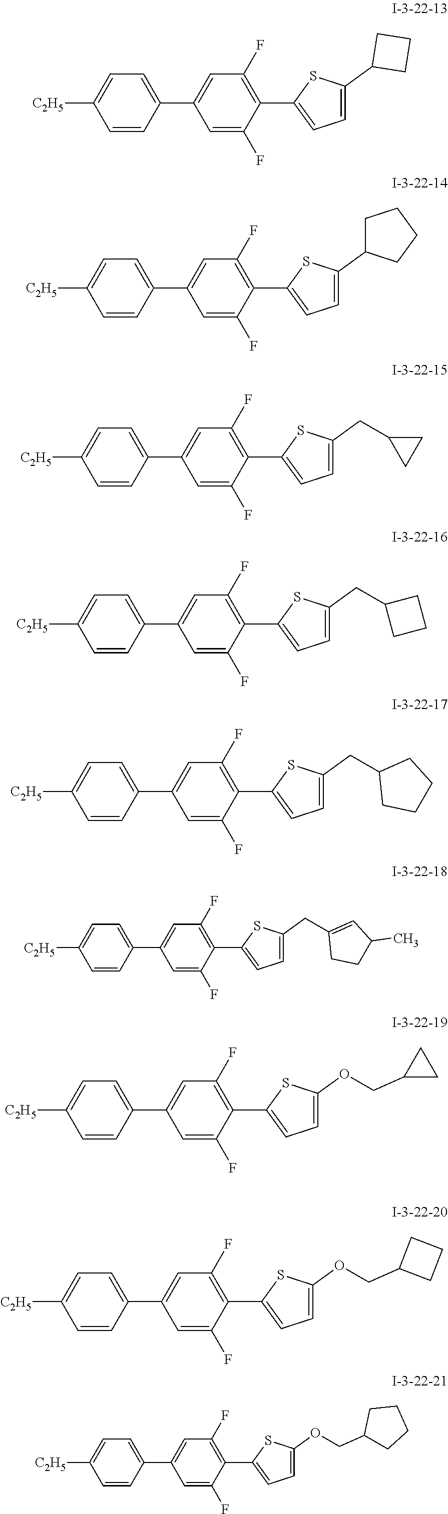

As a further possibility, the following compounds of Formula I can be used:

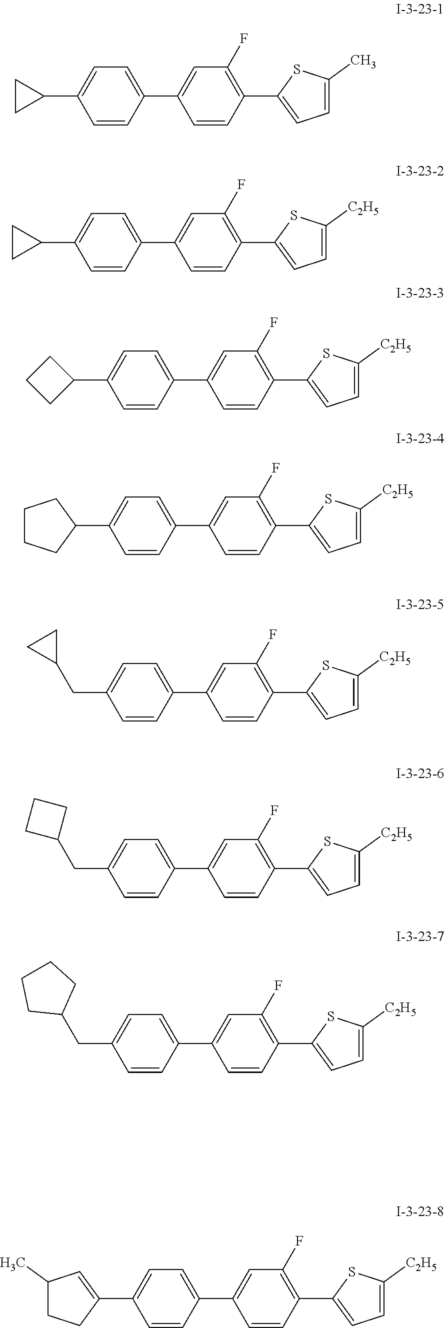

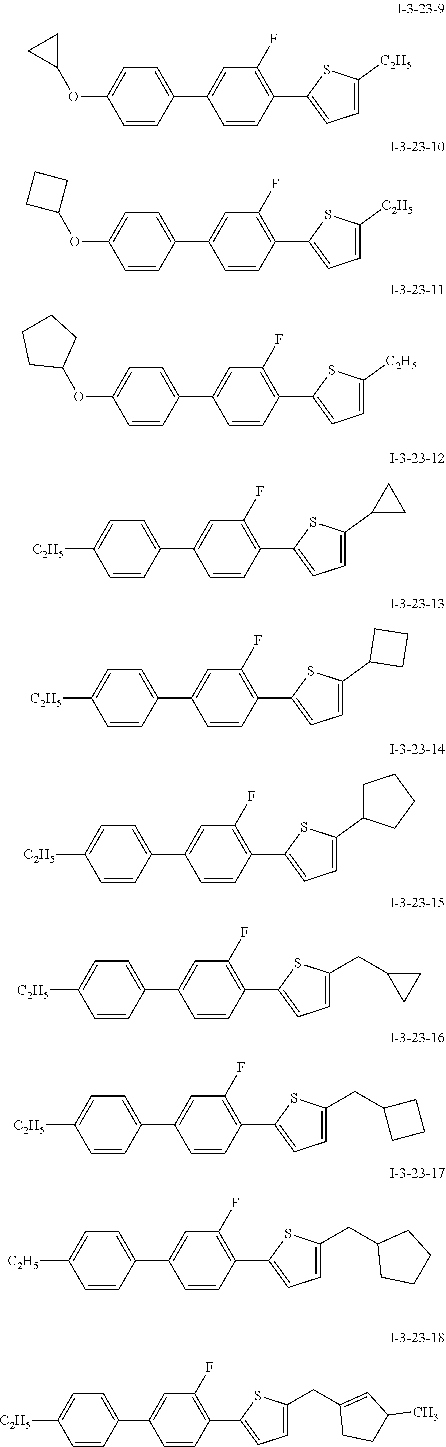

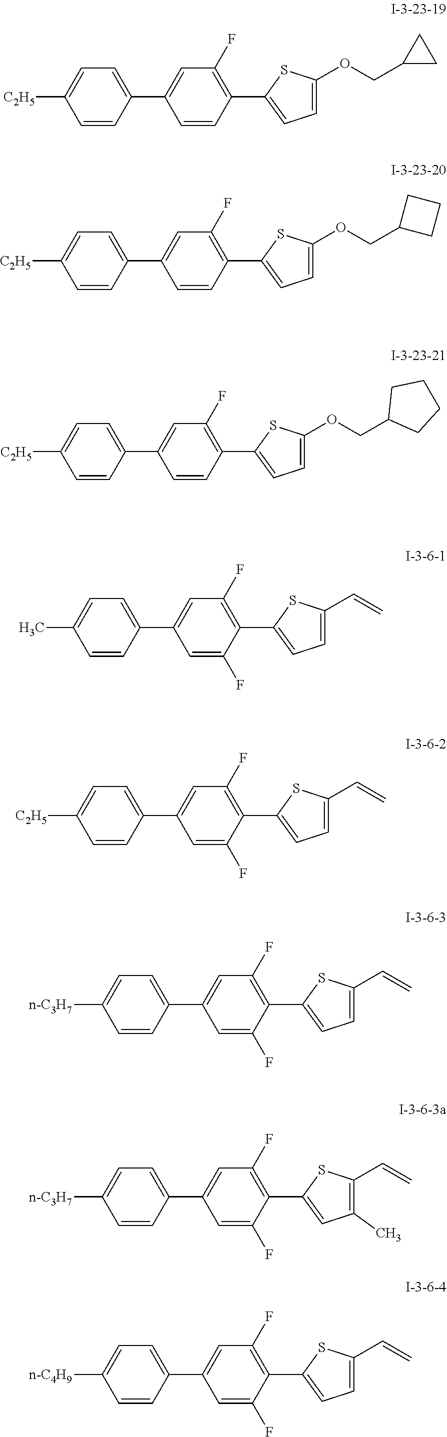

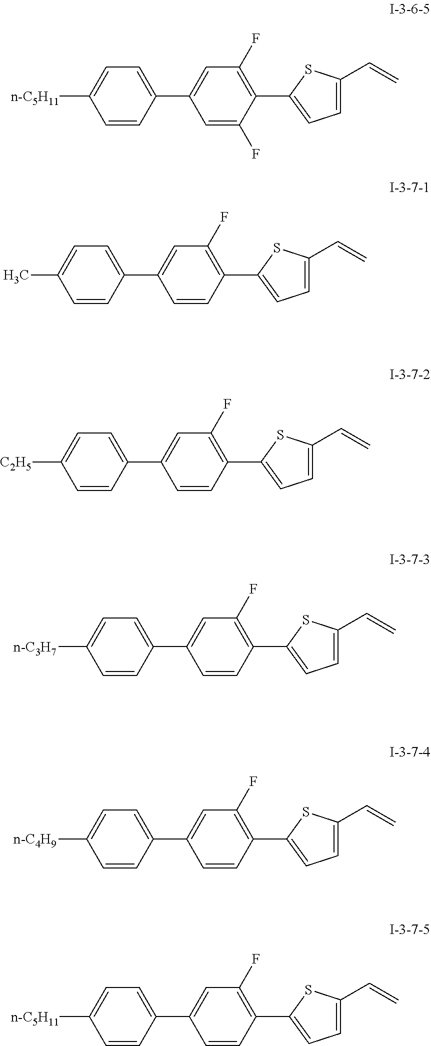

The compounds of the Formula I can be prepared analogously to processes known to the person skilled in the art and described in standard works of organic chemistry, such as, for example, in Houben-Weyl, Methoden der organischen Chemie [Methods of Organic Chemistry], Thieme-Verlag, Stuttgart.

### Compounds of Formulae T1 and T2

Preferably, the one or more compounds of the Formulae T1 and T2 are selected from the group consisting of the compounds of the following formulae:

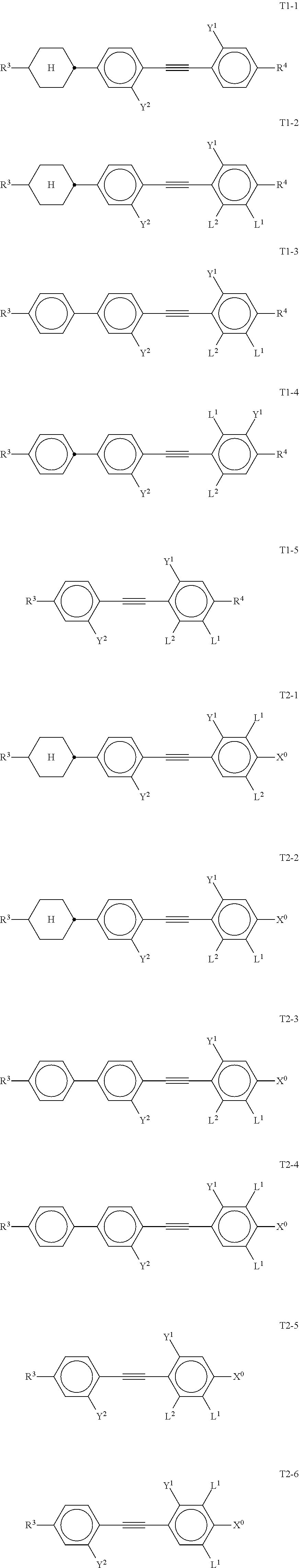

in which
R³ and R⁴ each, independently from one another, denote an alkyl or an alkoxy group having 1 to 6 C atoms or an alkenyl group having 2 to 6 C atoms in which one or more CH₂ groups are optionally substituted by —C≡C—, —CF₂O—, —OCF₂—, —CH═CH—,

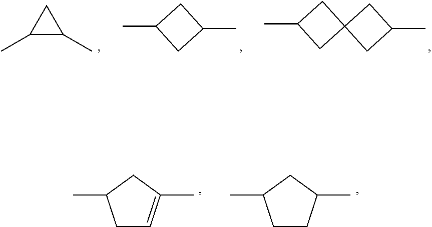

—O—, —CO—O—, or —O—CO— in such a way that O atoms are not linked directly to one another, and in which one or more H atoms may be replaced by a halogen atom;
L¹ and L² each, independently from one another, denote H or F;
X⁰ denotes CN, SCN, NCS, or a halogenated alkyl group having 1 to 6 C atoms; and
Y¹ and Y² each, independently from one another, denote H, a straight-chain or branched alkyl or alkoxy group having 1 to 6 or 3 to 6 C atoms, or a cycloalkyl or a cycloalkoxy group having 3 to 6 C atoms, preferably H or CH₃.

Although the choice of the substituent R³ and R⁴ in the Formula I is not particularly limited, it is particularly advantageous to choose R³ and R⁴ being an alkyl or a cycloalkyl group having up to 6 C atoms, wherein R³ and R⁴ selected from the group consisting of methyl, ethyl, n-propyl, i-propyl, n-butyl, s-butyl, i-butyl, and cyclopentyl are particularly preferred. Y⁰ may also be represented by a CH₃ group.

In a particularly preferred embodiment, the compounds of general Formulae T1 and T2 can be represented by one of the following:

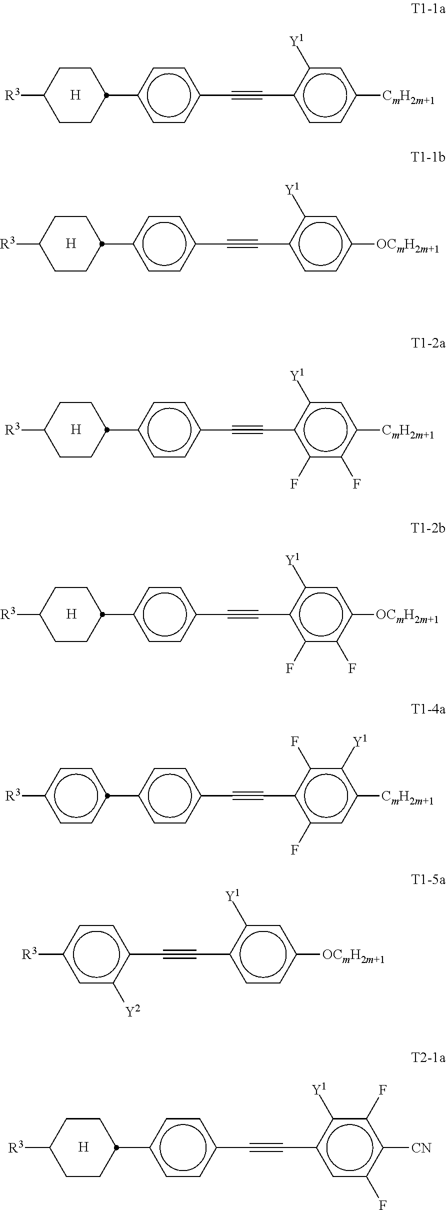

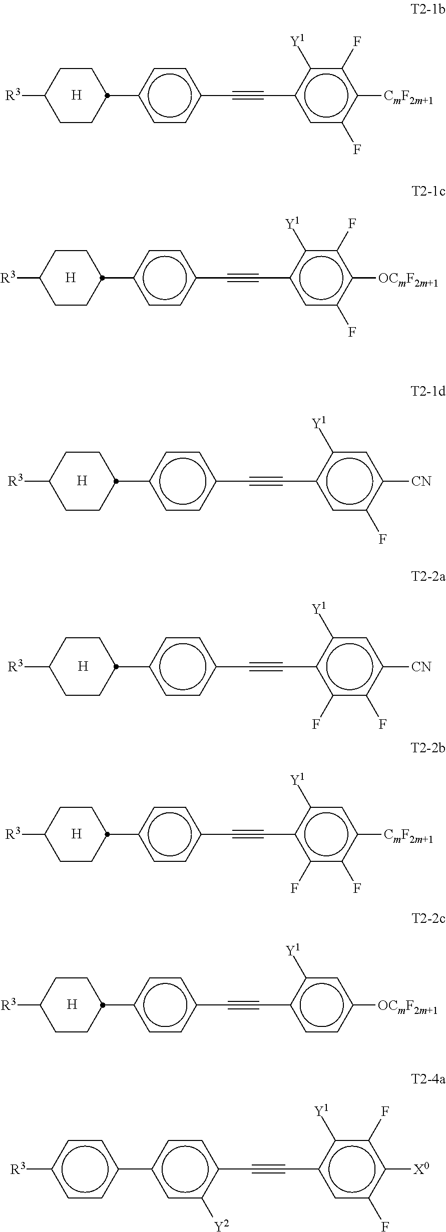

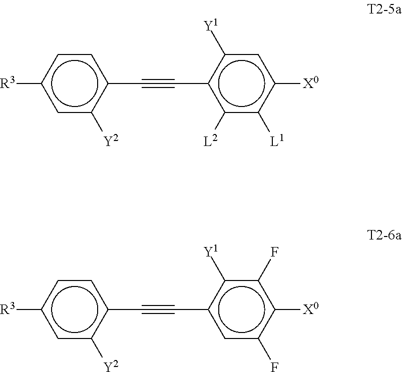

in which
R³ is an alkyl group having 1 to 6 C atoms in which one or more CH₂ groups are optionally substituted by —C≡C—, —CF₂O—, —OCF₂—,

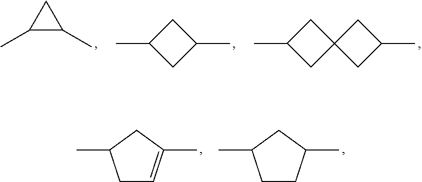

—O—, —CO—O—, or —O—CO— in such a way that O atoms are not linked directly to one another, and in which one or more H atoms may be replaced by a halogen atom, preferably an alkyl group having 1 to 4 C atoms, an alkenyl or alkenyloxy group having 2 to 6 C atoms, or a cycloalkyl or cycloalkyloxy group having 3 to 6 C atoms, wherein vinyl, allyl, or cyclopentyl are particularly preferable;
Y¹ denotes H or CH₃, preferably H; and
m denotes 1, 2, 3, or 4.

In the context of the present invention, use of compounds of sub-formula T1-1a offers advantages over the use of T1-1b in terms of low temperature stability of the resulting LC medium.

Very preferred compounds of Formula T1 are those selected from the group consisting of the following subformulae:

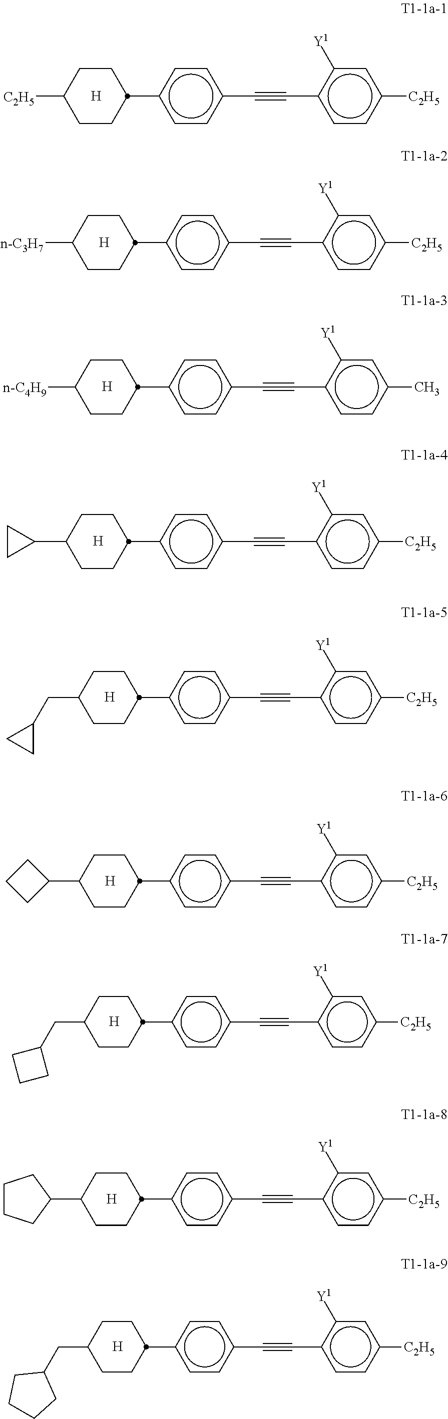

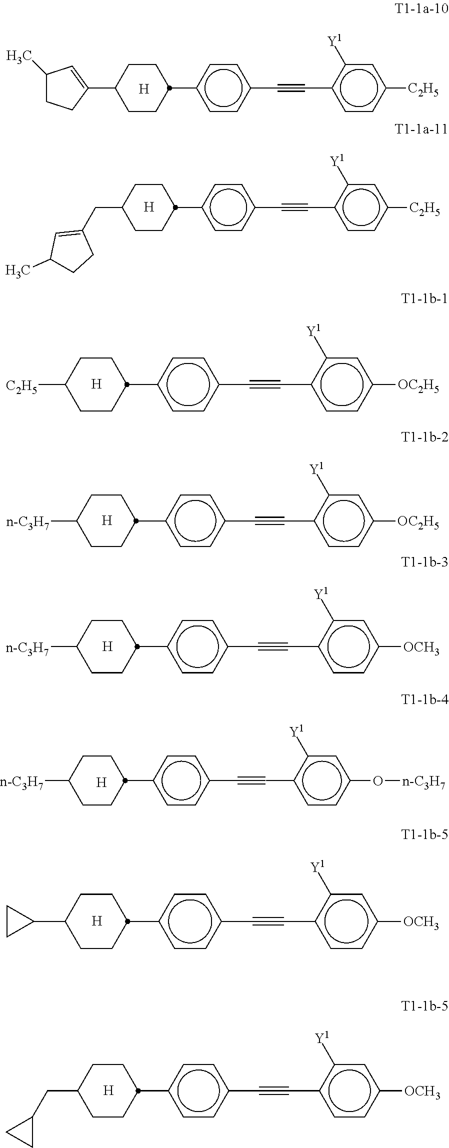

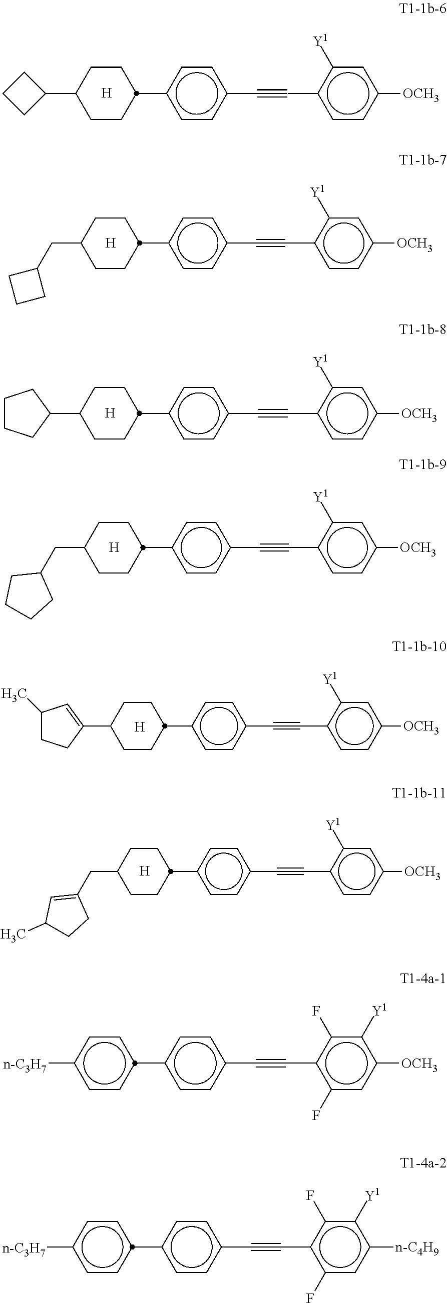

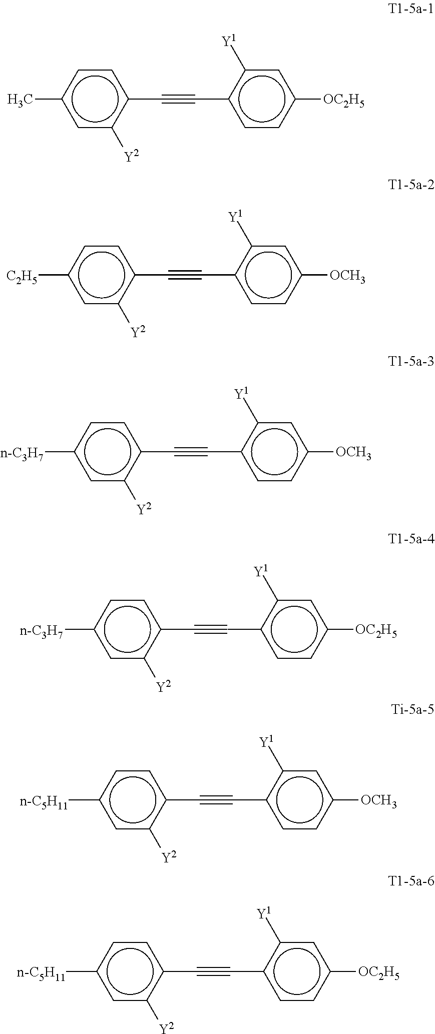

wherein Y¹ is H or CH₃, preferably H.

Very preferred compounds of Formula T2 are those selected from the group consisting of the following subformulae:

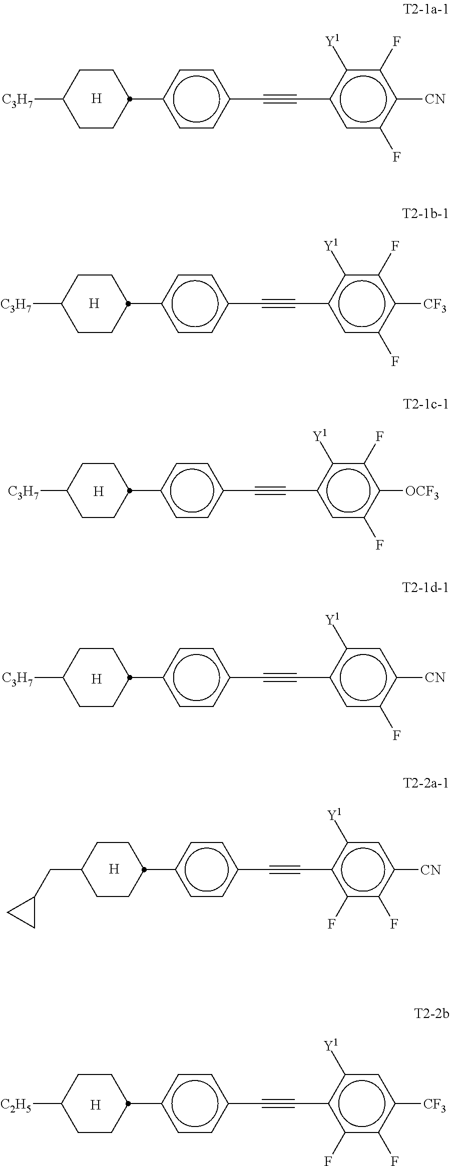

wherein Y¹ is H or CH₃, preferably H.

The LC medium of the present invention preferably comprises 1% to 20% by weight, more preferably 2% to 15% by weight, particularly preferably 3% to 10% by weight of compounds of general Formulae T1 and/or T2.

### Further Components

Preferably, the LC medium contains, in addition to the one or more compound of Formula I and T1 and/or T2, one or more compounds selected from the following formulae:

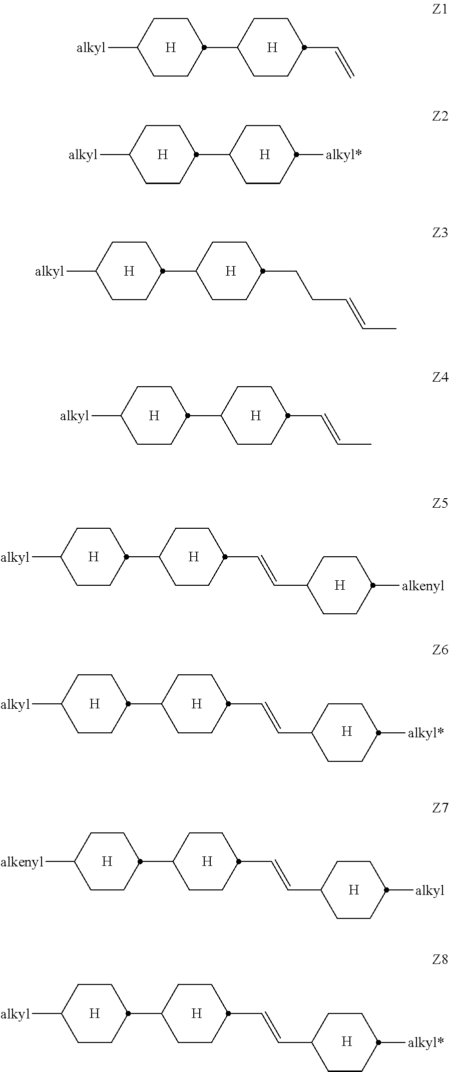

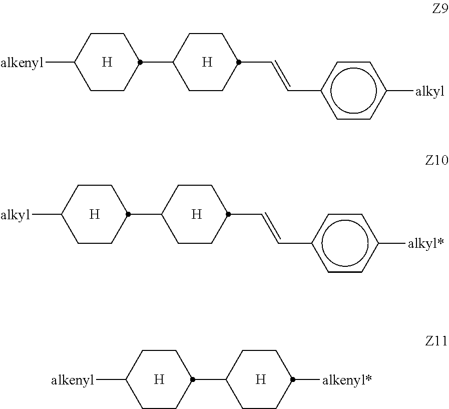

wherein
“alkyl” and “alkyl*” are, independently from one another, C₁₋₆-alkyl, and preferably denotes ethyl, propyl, butyl, or pentyl, very preferably ethyl, propyl, or butyl; and
“alkenyl” and “alkenyl*” preferably denote C₂₋₆-alkenyl. Very preferred are compounds of Formula Z1 and Z2.

Preferred compounds of Formula Z1 to Z11 are those selected from the following subformulae:

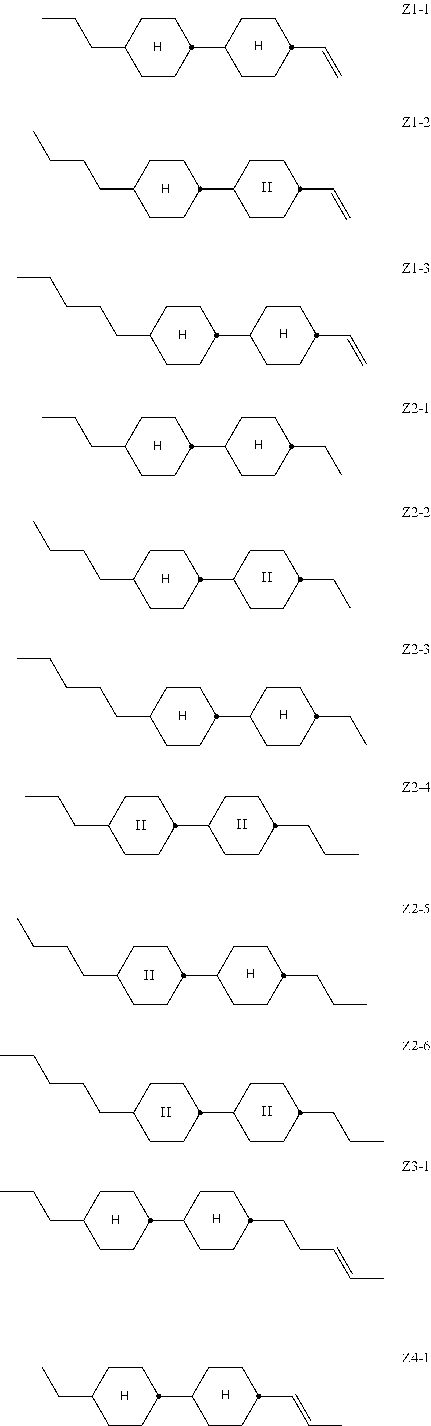

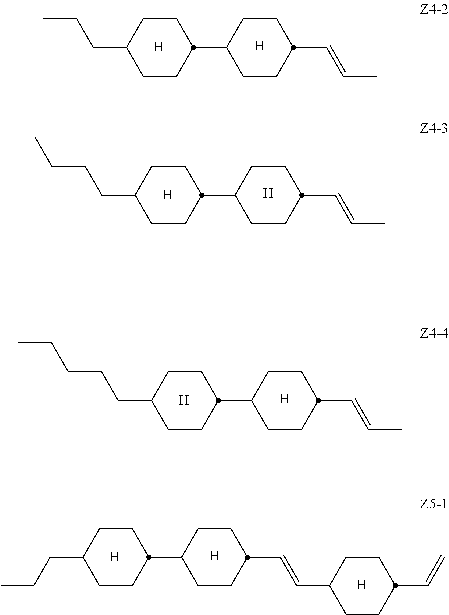

In another preferred embodiment, the medium contains one or more compounds of Formula Z1 or its preferred subformulae and/or one or more compounds selected from Formulae Z2, Z3, Z4, Z5, and their preferred subformulae.

Preferably, the total proportion of compounds of Formula Z1, Z2, Z3, Z4, Z5 and Z6 or their subformulae, such as CC-3-V in the medium is from 10 to 65%, very preferably from 20 to 60%, most preferably from 25 to 55% by weight. In yet a more preferred embodiment, the compound of Formula Z1-1 is used in concentrations ranging from 10 wt. % to 60 wt. %, more preferably 25 wt. % to 50 wt. %, based on the total weight of the LC medium. In a further preferred embodiment, the LC medium comprises 50 wt. % to 70 wt. % of compounds represented by Formulae Z1-1 and Z4-2 in total.

Preferably, the LC medium contains 1, 2, or 3 compounds selected from the Formulae Z1, Z2, Z3, Z4 and their subformulae.

The LC medium may additionally comprise one or more compounds of the following general formulae:

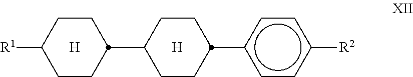

in which
R¹ and R² each, independently from one another, denote C₁₋₆-alkyl, C₁₋₆-alkoxy, or C₂₋₆-alkenyl.

The compounds of the Formula XII are preferably described by the following subformulae:

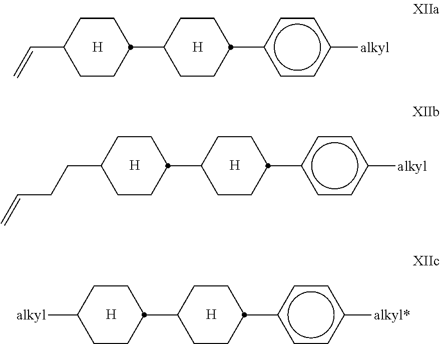

wherein
“alkyl” and “alkyl*” each, independently from one another, denote methyl, butyl, pentyl, or hexyl.

Particular preference is given to the compounds of the Formulae XIIa and XIIc. In the Formula XIIb, “alkyl” preferably, independently of one another, denotes n-C₃H₇, n-C₄H₉, or n-C₅H₁₁, in particular n-C₃H₇. In the Formula XIIc, “alkyl” preferably denotes n-C₃H₇ and “alkyl*” is preferably CH₃ or n-C₃H₇.

Particularly preferred compounds of Formula XII are described by the following structures:

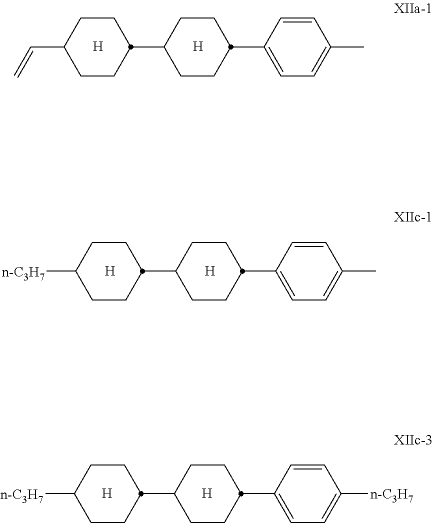

The LC medium may additionally comprise one or more compounds selected from the following formulae:

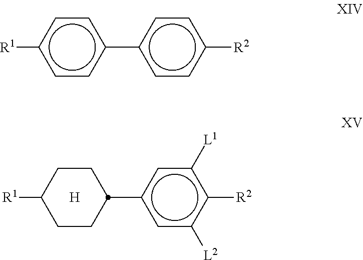

in which L¹ and L² have the meanings indicated in Formula T1, and R¹ and R² each, independently of one another, denote n-alkyl, alkoxy, oxaalkyl, fluoroalkyl, or alkenyl, each having up to 6 C atoms, and preferably each, independently of one another, denote alkyl having 1 to 6 C atoms; in the compound of the Formula XIV, at least one of the groups R¹ and R² preferably denotes alkenyl having 2 to 6 C atoms.

The LC medium may further comprise one or more compounds of the Formula XIV in which at least one of the groups R¹ and R² denotes alkenyl having 2 to 6 C atoms, preferably those selected from the following subformulae:

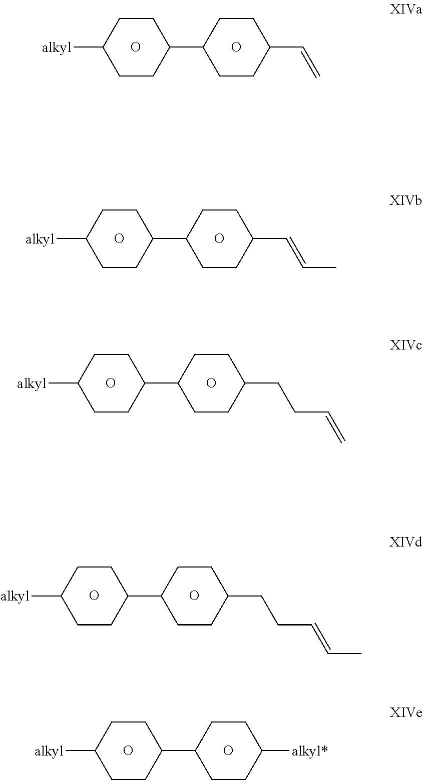

in which “alkyl” and “alkyl*” have the meaning indicated above, and each, independently of one another, preferably denotes methyl, ethyl, or propyl.

The compounds of the Formula XIV are preferably selected from the following subformulae:

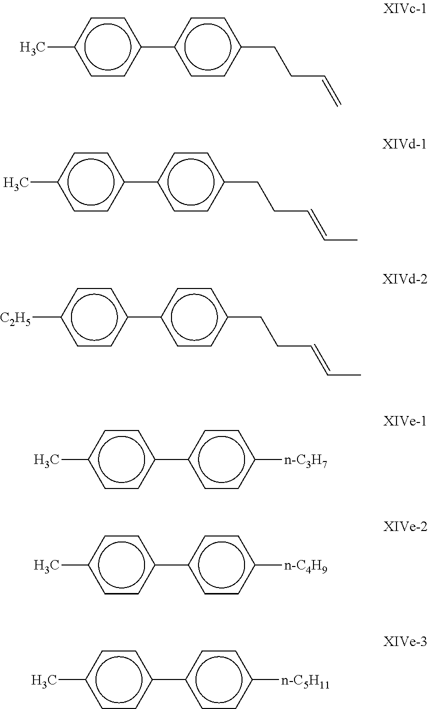

Very preferred are compounds of Formulae XIVd1, XIVe-1, XIVe-2, and XIVe-3.

In yet a further embodiment, the LC medium may comprise one or more compounds of the Formula XVI.

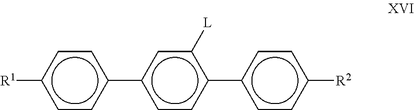

in which
R¹ and R² have the meanings indicated in Formula I, and preferably each, independently of one another, denote alkyl having 1 to 6 C atoms; and
L denotes H or F.

Particularly preferred compounds of the Formula XVI are those of the subformulae:

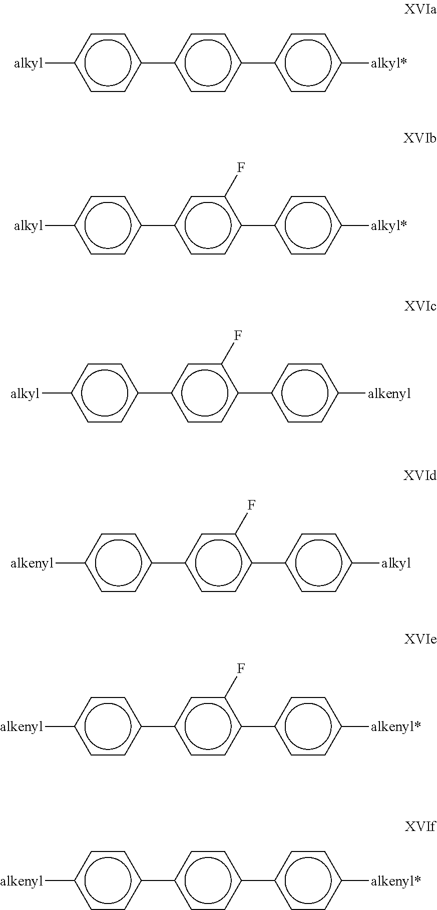

in which
alkyl and alkyl* each, independently of one another, denote a straight-chain alkyl group having 1 to 6 C atoms, in particular ethyl, propyl, or pentyl, and
alkenyl and alkenyl* each, independently of one another, denote a straight-chain alkenyl group having 2 to 6 C atoms, in particular CH₂═CHC₂H₄, CH₃CH═CHC₂H₄, CH₂═CH, and CH₃CH═CH.

Particular preference is given to the compounds of the Formulae XVIb and XVIc. Very particular preference is given to the compounds of the following subformulae:

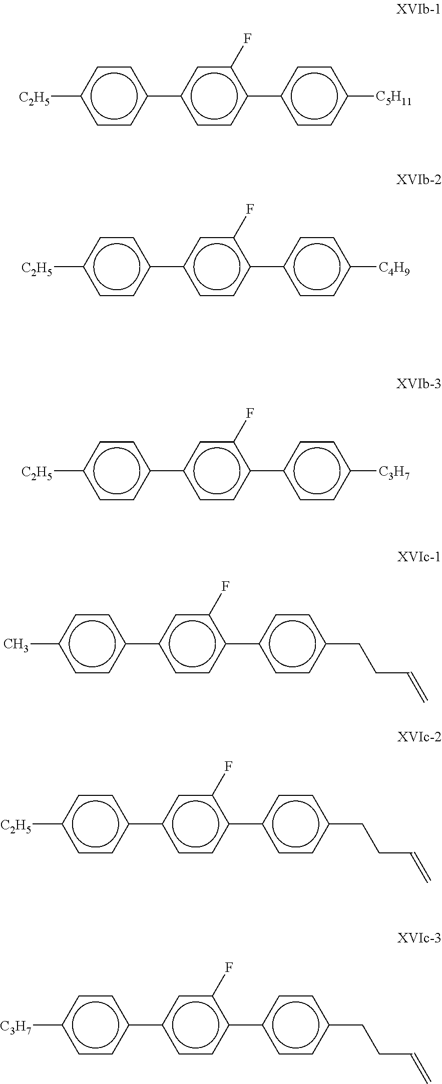

Very preferred is the compound of Formula XVIc-2.

In a further preferred embodiment, the LC medium may comprise one or more compounds of the following formulae:

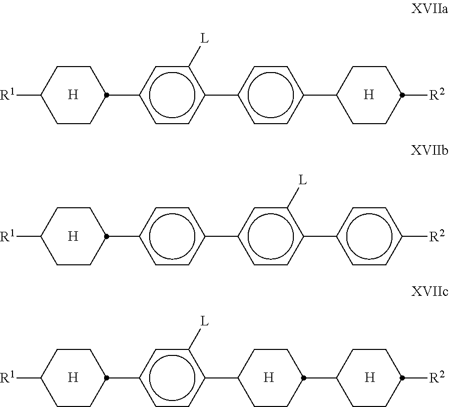

in which
R¹ and R² have the meanings indicated in Formula I, respectively, and preferably each, independently of one another, denote alkyl having 1 to 6 C atoms; and
L denotes H or F.

Very preferred are compounds of Formula XVIIa, wherein L is H, as well as compounds of Formula XVIIb, wherein L is F.

The LC medium may additionally comprise one or more compounds of the following formulae:

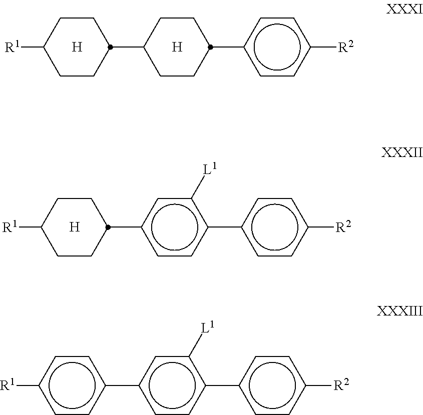

in which L, R¹ and R² have the meanings indicated in Formula Y for L¹, R¹, and R², respectively. R¹ and R² preferably denote alkyl, alkoxy, oxaalkyl, fluoroalkyl, or alkenyl, each having up to 6 C atoms.

In a further preferred embodiment, the LC medium may comprise one or more compounds selected from Formulae XXXIVa and XXXIVb:

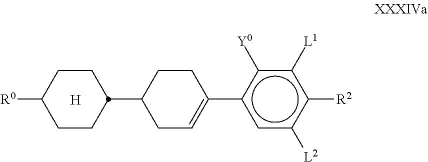

in which the individual radicals, on each occurrence identically or differently, and each, independently of one another, have the following meaning:
R⁰ denotes an alkyl group having 1 to 12 C atoms or an alkenyl group having 2 to 12 C atoms, in which one or more CH₂ groups are optionally substituted by —C≡C—, —CF₂O—, —OCF₂—, —CH═CH—,

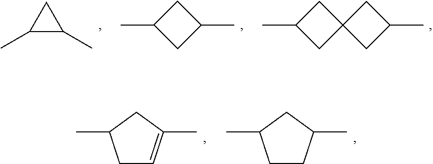

—O—, —CO—O—, or —O—CO— in such a way that O atoms are not linked directly to one another, and in which one or more H atoms may be replaced by a halogen atom;
R² denotes an alkyl group having 1 to 6 C atoms, or an alkenyl group having 2 to 6 C atoms, in which one or more CH₂ groups are optionally substituted by —C≡C—, —CF₂O—, —OCF₂—, —CH═CH—,

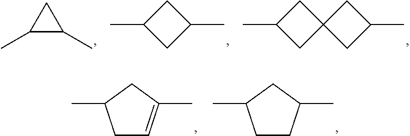

—O—, —CO—O—, or —O—CO— in such a way that O atoms are not linked directly to one another, and in which one or more H atoms may be replaced by a halogen atom;
L¹ and L² denotes H, F, or Cl; and
Y⁰ H or CH₃;

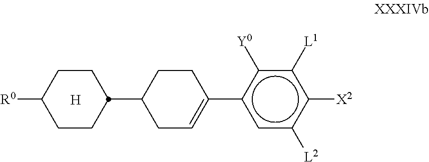

in which the individual substituents, on each occurrence identically or differently, and each, independently of one another, have the following meanings:
R⁰ denotes an alkyl group having 1 to 12 C atoms or an alkenyl group having 2 to 12 C atoms, in which one or more CH₂ groups are optionally substituted by —C═C—, —CF₂O—, —OCF₂—, —CH═CH—,

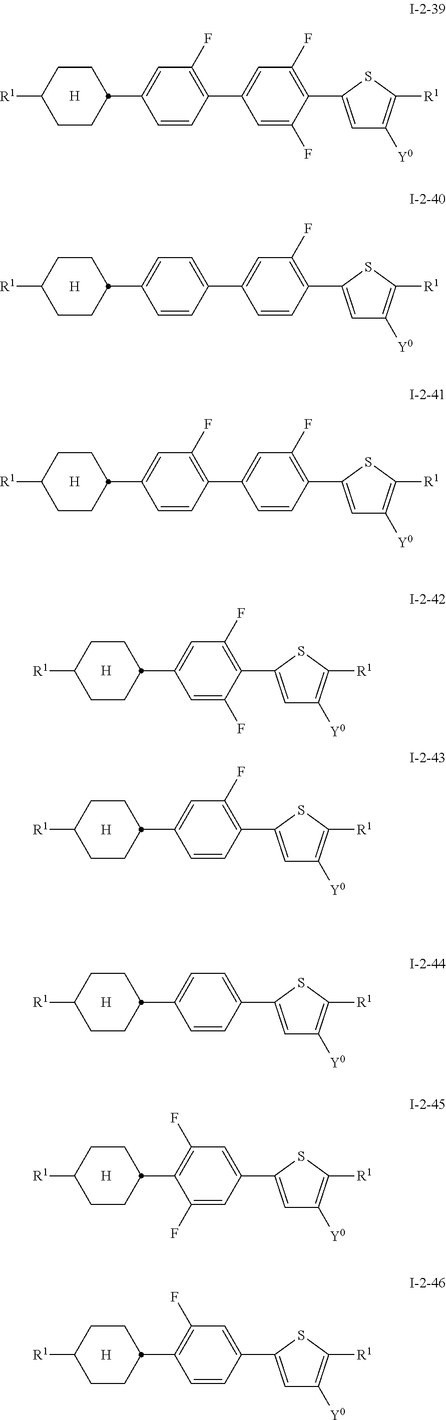

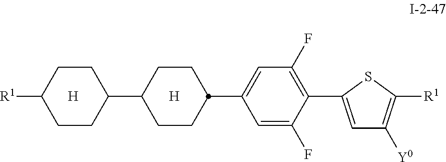

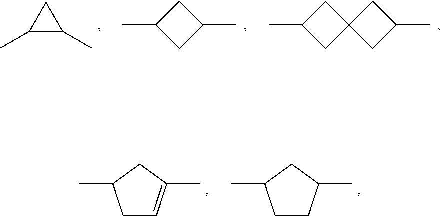

—O—, —CO—O—, or —O—CO— in such a way that O atoms are not linked directly to one another, and in which one or more H atoms may be replaced by a halogen atom;
X² denotes a F atom, an alkyl or alkoxy group having 1 to 6 C atoms, or an alkenyl or alkenyloxy group having 2 to 6 C atoms, in which one or more H atoms are replaced by a F atom, preferably F, CF₃, or OCF₃,
L¹ and L² denote H, F, or Cl; and
Y⁰ denotes H or CH₃.

In a particularly preferred embodiment, the compounds of general Formulae XXXIVa and XXXIVb can be represented by one of the following:

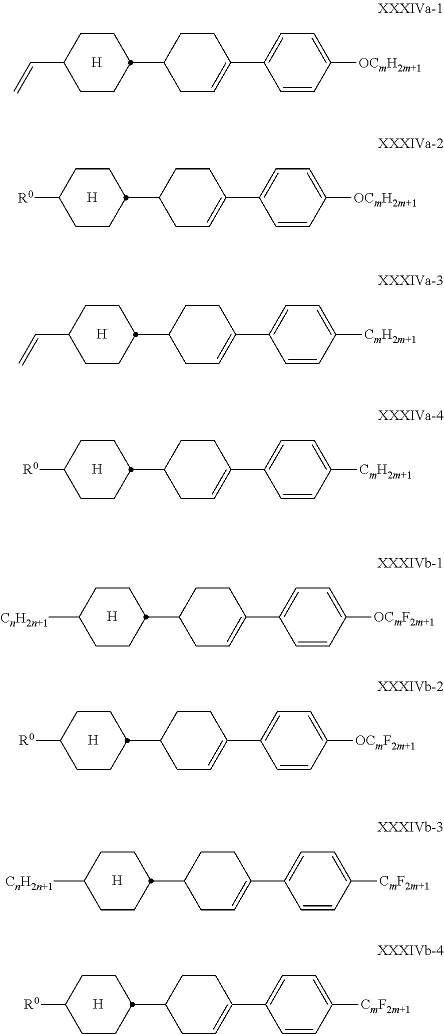

in which
R⁰ is an alkyl group having 1 to 12 C atoms in which one or more CH₂ groups are optionally substituted by —C═C—, —CF₂O—, —OCF₂—,

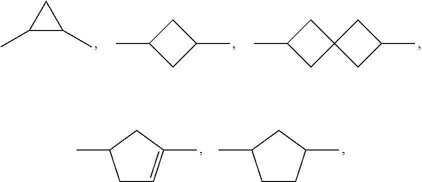

—O—, —CO—O—, or —O—CO— in such a way that O atoms are not linked directly to one another, and in which one or more H atoms may be replaced by a halogen atom, preferably an alkyl group having 1 to 4 C atoms, an alkenyl or alkenyloxy group having 2 to 6 C atoms, or a cycloalkyl or cycloalkyloxy group having 3 to 6 C atoms, wherein vinyl, allyl, or cyclopentyl are particularly preferable;
n denotes 1, 2, 3, 4, or 5; and
m denotes 1, 2, 3 or 4.

The compound(s) of the Formula XXXIV, in particular of the Formula XXXIVa, is (are) preferably employed in the LC media according to the invention in amounts of 0.5-10% by weight, particularly preferably 1-5% by weight.

In a further embodiment, the LC medium may comprise one or more compounds of the following formulae:

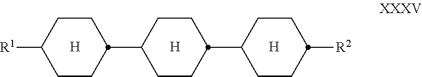

in which R¹ and R² have the meanings indicated for compound of Formula I.

Preferably, R¹ denotes alkyl or alkenyl having 1-6 or 2-6 C atoms, respectively, and R² denotes alkenyl having 2-6 C atoms.

Preferred compounds of Formula XXXV include, in particular:

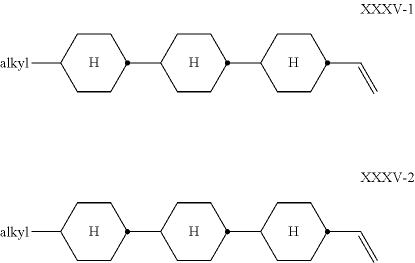

in which “alkyl” denotes an alkyl group having 1 to 6 C atoms.

In some further embodiments, the LC medium may comprise one or more compounds of the following formulae:

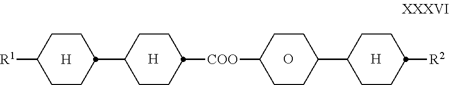

in which R¹ and R² have the meanings indicated in Formula I, and preferably each, independently of one another, denote alkyl having 1 to 6 C atoms.

The LC medium may additionally comprise one or more compounds selected from the following formulae:

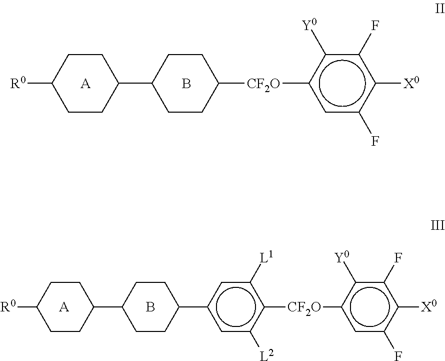

wherein the individual groups, independently of each other and on each occurrence identically or differently, have the following meanings:

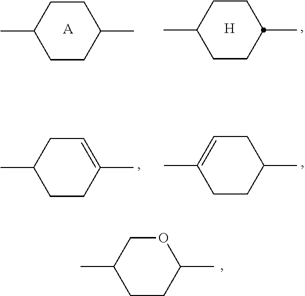

denotes

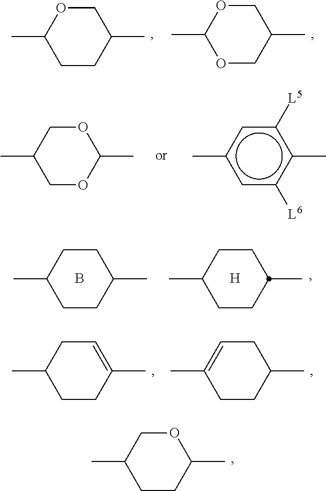

denotes

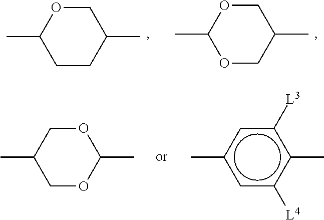

R⁰ has one of the meanings given for R¹ in Formula I;
X⁰ denotes F, Cl, or a halogenated alkyl group, halogenated alkenyl group, halogenated alkoxy group, or halogenated alkenyloxy group having up to 6 C atoms;
L¹⁻⁶ denote H or F; and
Y⁰ denotes H or CH₃.

Preferred compounds of Formulae II and III are those wherein Y⁰ is H.

Further preferred compounds of Formula II and III are those wherein R⁰ denotes alkyl having 1 to 6 C atoms, very preferably ethyl or propyl, and X⁰ denotes F or OCF₃, very preferably F.

In a preferred embodiment, the LC medium comprises one or more compounds of Formula II selected from the following subformulae:

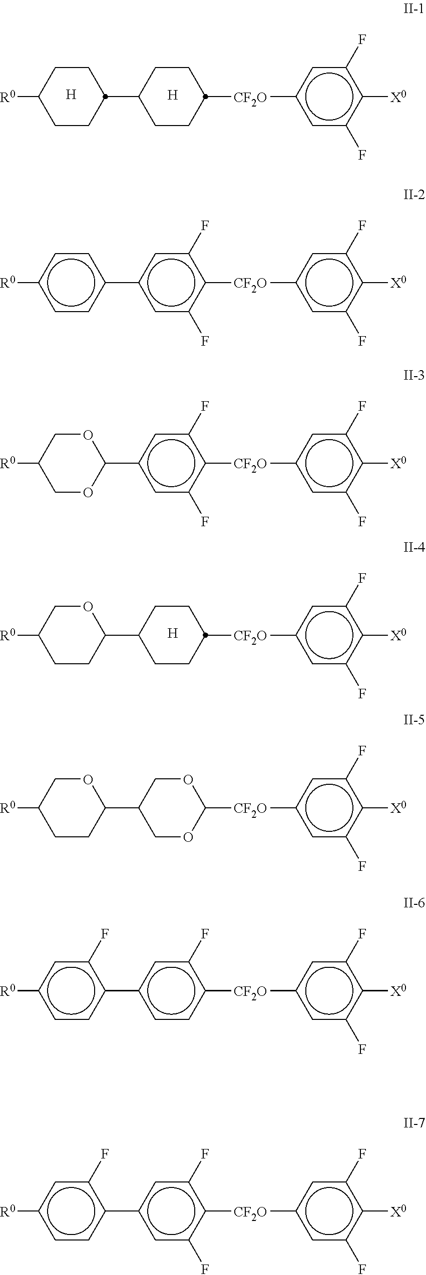

in which R⁰ and X⁰ have the meanings given in Formula II.

Preferred compounds are those of Formula II-1, II-2, and II-3, very preferred those of Formula II-1 and II-2.

In the compounds of Formulae II-1 to II-7, R⁰ preferably denotes alkyl having 1 to 6 C atoms, very preferably ethyl or propyl, and X⁰ preferably denotes F or OCF₃, very preferably F.

In a further preferred embodiment, the LC medium contains one or more compounds of Formula II or their subformulae as described above and below, wherein Y⁰ is CH₃, very preferably the medium according to this preferred embodiment comprises one or more compounds of Formula II selected from the following subformulae:

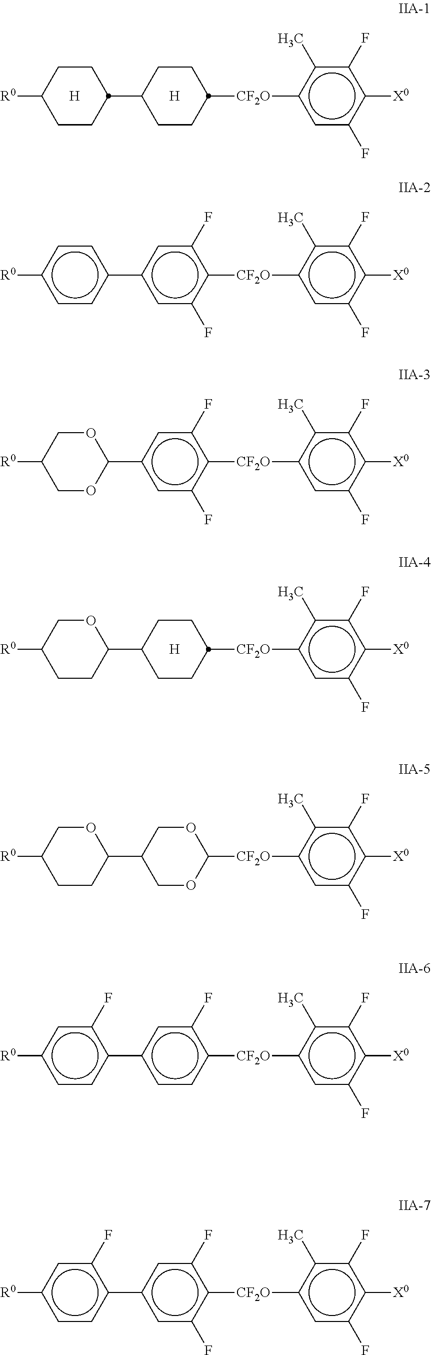

in which R⁰ and X⁰ have the meanings given in Formula II.

Preferred compounds are those of Formula IIA-1, IIA-2, and IIA-3, very preferred those of Formula IIA-1 and IIA-2.

In the compounds of Formulae IIA-1 to IIA-7, R⁰ preferably denotes alkyl having 1 to 6 C atoms, very preferably ethyl or propyl, and X⁰ preferably denotes F or OCF₃, very preferably F.

In a further preferred embodiment, the LC medium comprises one or more compounds of Formula III selected from the following subformulae:

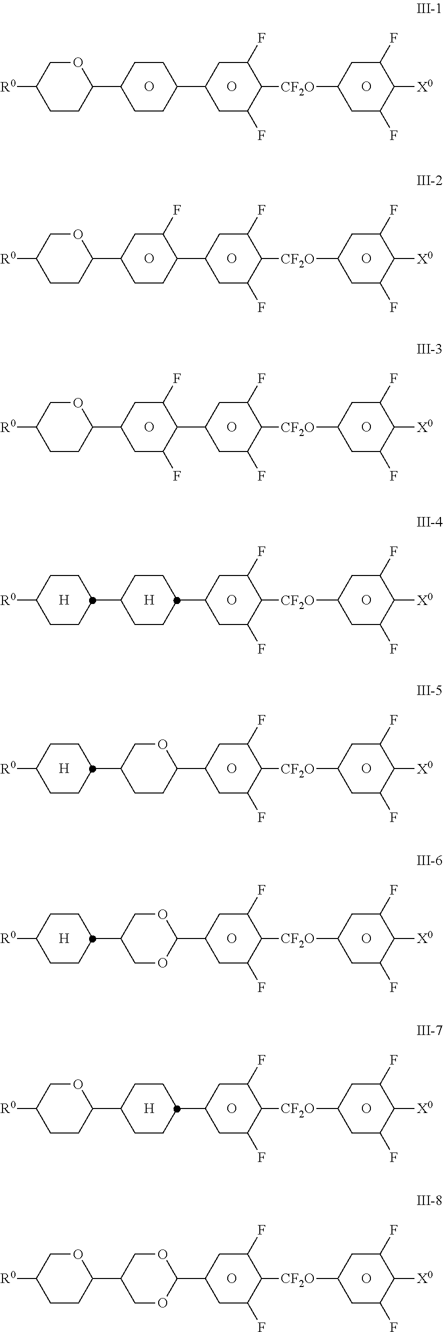

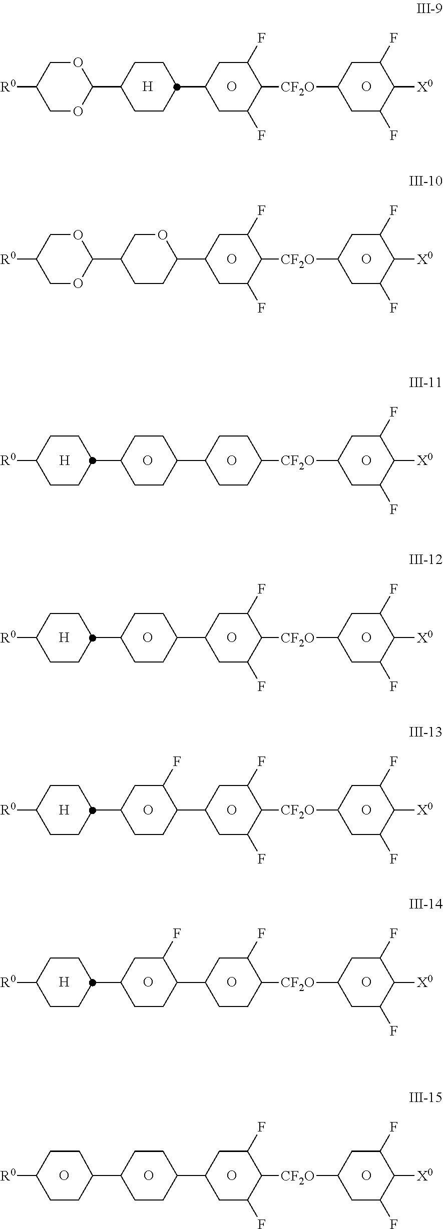

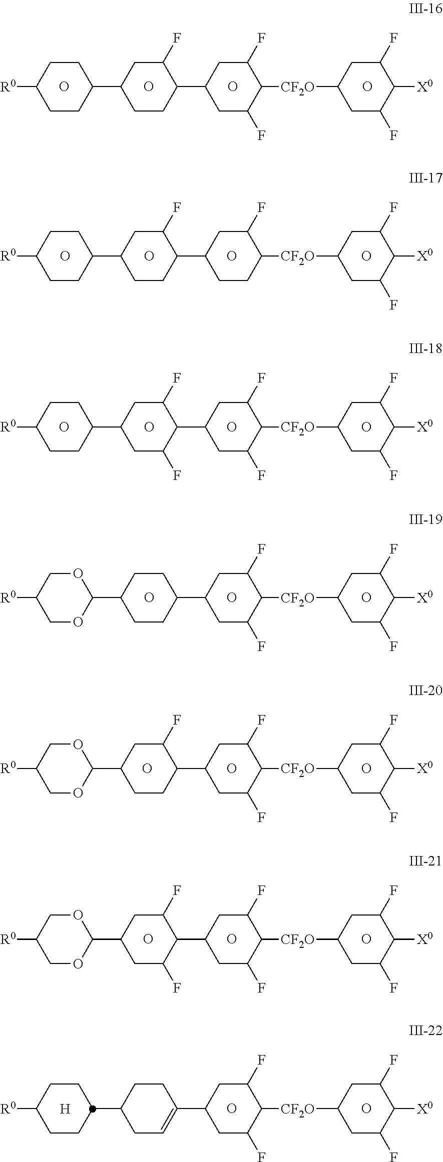

in which R⁰ and X⁰ have the meanings given in Formula II.

Preferred compounds are those of Formula III-1, III-4, III-6, III-16, III-19, and III-20.

In the compounds of Formulae III-1 to III-21, R⁰ preferably denotes alkyl having 1 to 6 C atoms, very preferably ethyl or propyl, X⁰ preferably denotes F or OCF₃, very preferably F, and Y² preferably denotes F.

In yet a further embodiment, the LC medium contains one or more compounds of Formula III or their subformulae, as described above and below, wherein Y⁰ is CH₃. Very preferably, LC the medium according to this preferred embodiment comprises one or more compounds of Formula III selected from the following subformulae:

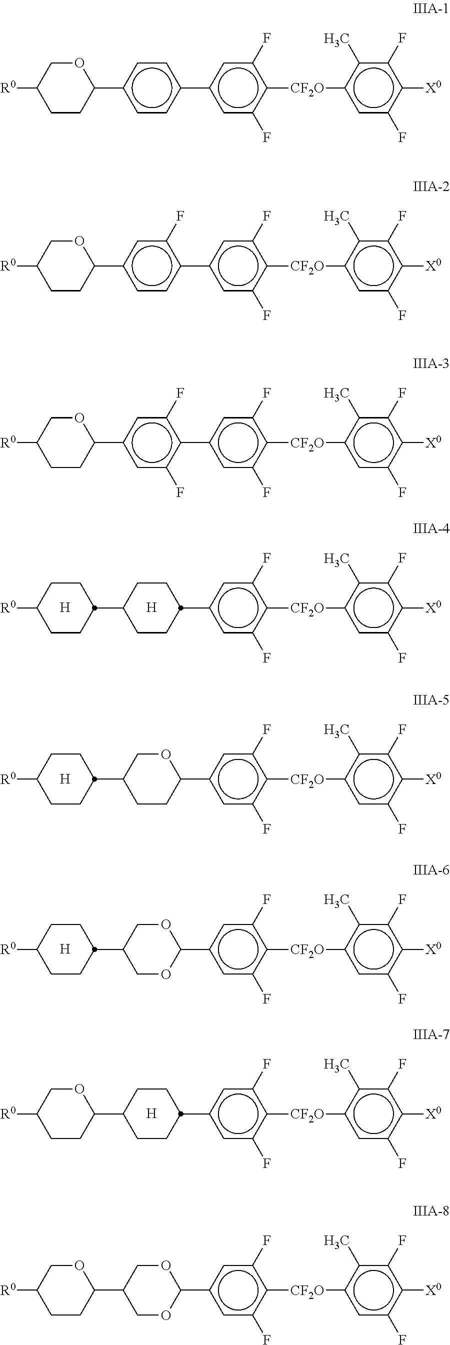

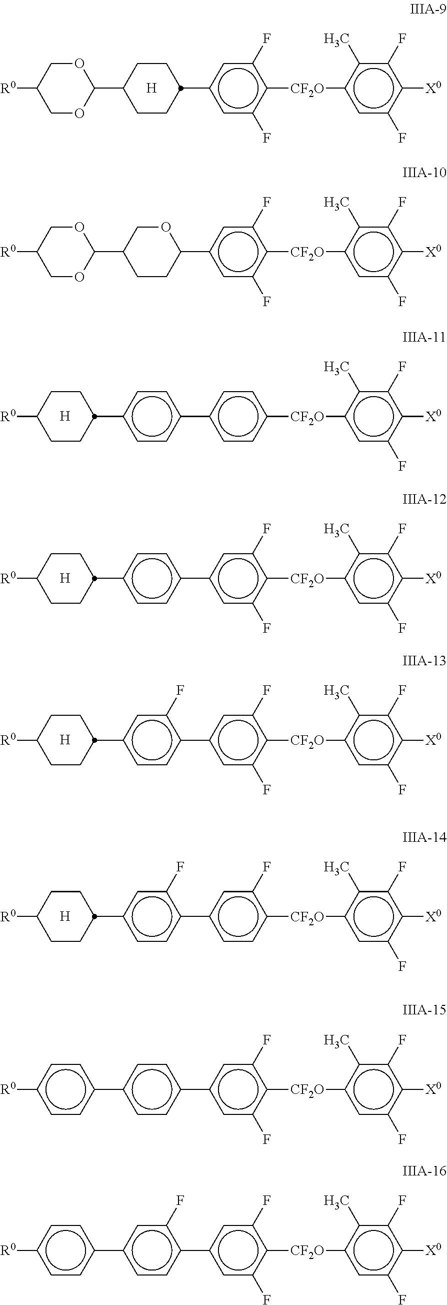

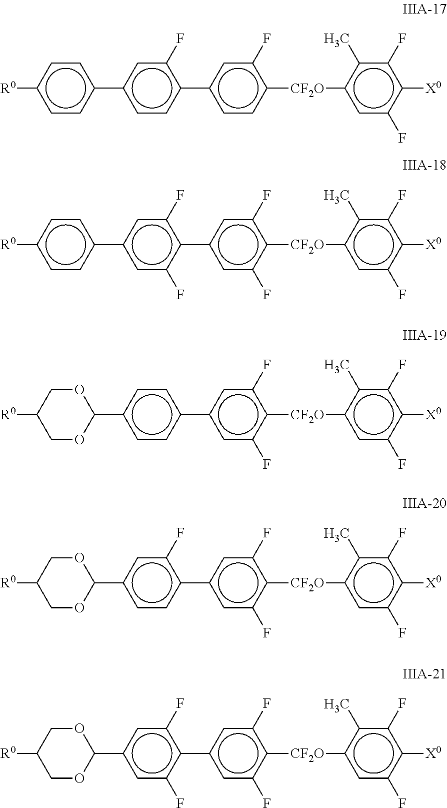

in which R⁰ and X⁰ have the meanings given in Formula III.

Preferred compounds are those of Formula IIIA-1, IIIA-4, IIIA-6, IIIA-16, IIIA-19, and IIIA-20.

In the compounds of Formulae IIIA-1 to IIIA-21, R⁰ preferably denotes alkyl having 1 to 6 C atoms, very preferably ethyl or propyl, X⁰ preferably denotes F or OCF₃, very preferably F, and Y² preferably denotes F.

In a further embodiment, the LC medium additionally comprises one or more compounds selected from the following formulae:

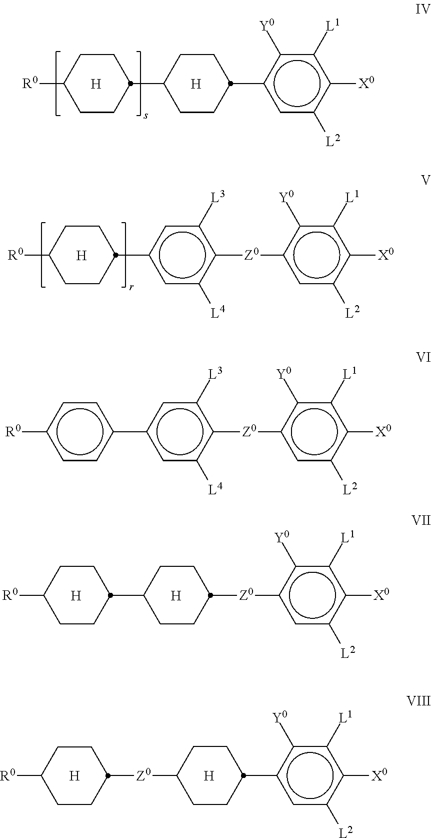

in which
R⁰, X⁰, Y⁰, and L¹⁻⁵ have the meanings indicated in Formulae II and III;
Z⁰ denotes —C₂H₄—, —(CH₂)₄—, —CH═CH—, —CF═CF—, —C₂F₄—, —CH₂CF₂—, —CF₂CH₂—, —CH₂O—, —OCH₂—, —COO—, —CF₂O—, or —OCF₂—, in the Formulae V and VI, also a single bond; and
r denotes 0 or 1; and
s denotes 0 or 1.

The compounds of the Formula IV are preferably selected from the following formulae:

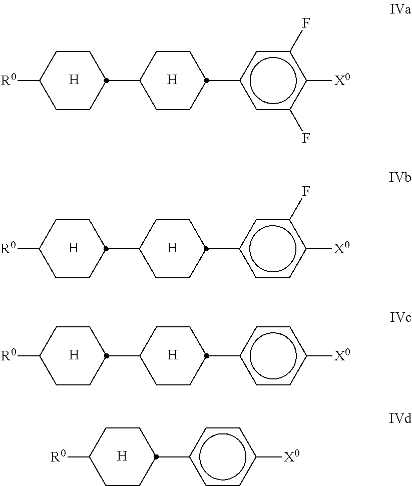

in which R⁰ and X⁰ have the meanings indicated in Formulae II and III.

R⁰ preferably denotes alkyl having 1 to 6 C atoms. X⁰ preferably denotes F or OCF₃, furthermore OCF═CF₂ or Cl.

The compounds of the Formula IVa are preferably represented by the following subformula:

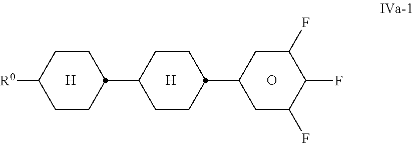

The compounds of the Formula IVb are preferably represented by the following subformula:

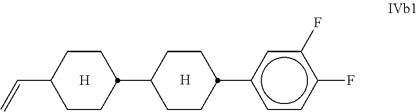

The compounds of the Formula IVc are preferably represented by the following subformula:

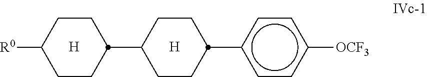

in which R⁰ has the meanings indicated in Formula II and is preferably propyl or pentyl.

The compound(s) of the Formula IVc, in particular of the Formula IVc-1, is/are preferably employed in the LC media according to the invention in amounts of 1-20% by weight, particularly preferably 2-15% by weight.

The compounds of the Formula V are preferably selected from the following subformulae:

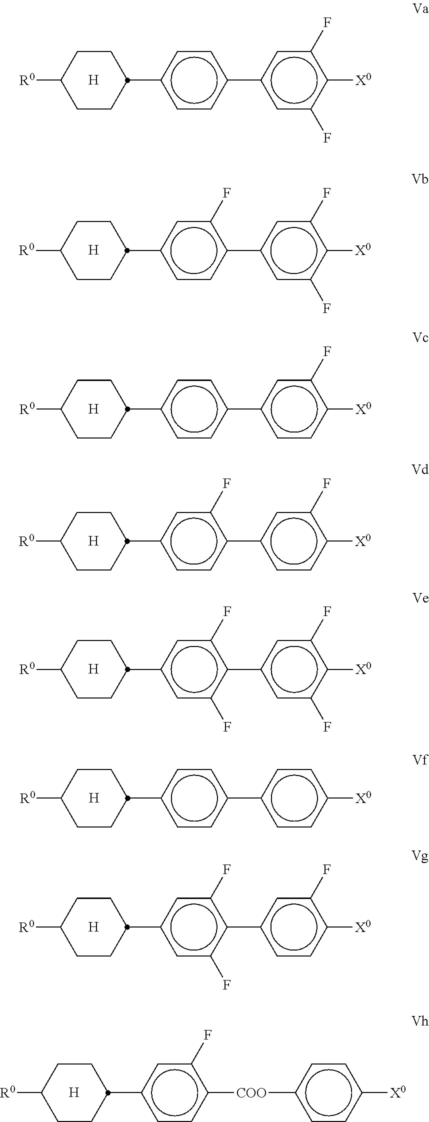

in which R⁰ and X⁰ have the meanings indicated in Formula II.

R⁰ preferably denotes alkyl having 1 to 6 C atoms. X⁰ preferably denotes F and OCF₃, furthermore OCHF₂, CF₃, OCF═CF₂, and OCH═CF₂;

The compounds of the Formula VI are preferably selected from the following subformulae:

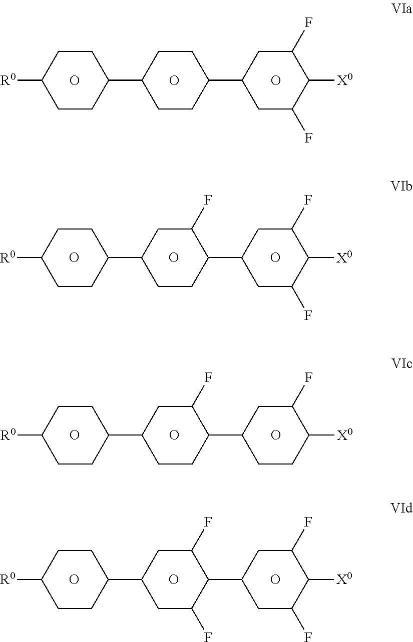

in which R⁰ and X⁰ have the meanings indicated in Formula II.

R⁰ preferably denotes alkyl having 1 to 6 C atoms. X⁰ preferably denotes F, furthermore OCF₃, CF₃, CF═CF₂, OCHF₂, and OCH═CF₂.

The compounds of the Formula VII are preferably selected from the following subformulae:

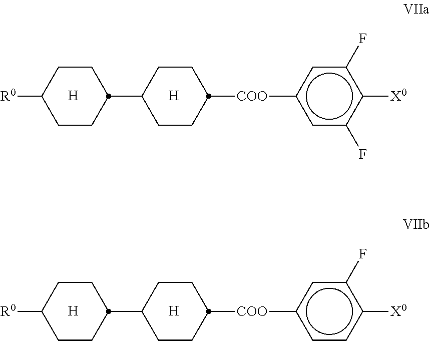

in which R⁰ and X⁰ have the meanings indicated in Formula II.

R⁰ preferably denotes alkyl having 1 to 6 C atoms. X⁰ preferably denotes F, furthermore OCF₃, OCHF₂, and OCH═CF₂.

In some embodiments, the LC medium additionally comprises one or more compounds selected from the following formulae:

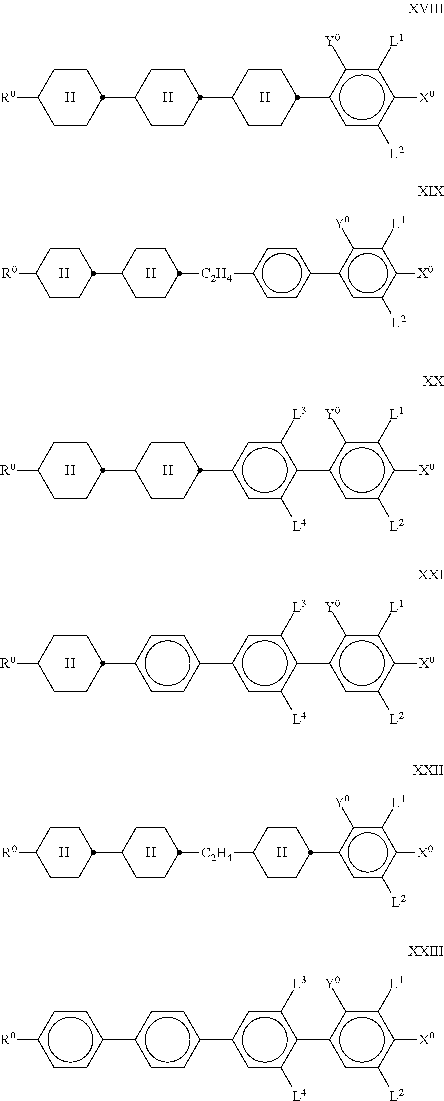

in which
R⁰ and X⁰ each, independently of one another, have one of the meanings indicated in Formula II;
L¹⁻⁴ each, independently of one another, denote H or F;
Y⁰ denotes H or CH₃, preferably H;
X⁰ is preferably F, Cl, CF₃, OCF₃, or OCHF₂; and
R⁰ preferably denotes alkyl, alkoxy, oxaalkyl, fluoroalkyl, or alkenyl, each having up to 6 C atoms.

Very preferably, the LC medium according to the invention comprises one or more compounds of the Formula XXa:

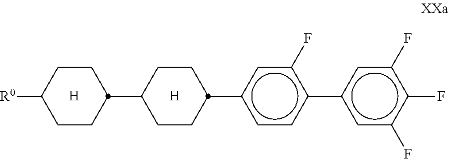

in which R⁰ has the meanings of R¹ in Formula I. R⁰ preferably denotes straight-chain alkyl, in particular ethyl, n-propyl, n-butyl, or n-pentyl and very particularly preferably n-propyl.

The compound(s) of the Formula XX, in particular of the Formula XXa, is (are) preferably employed in the LC media according to the invention in amounts of 0-15% by weight, particularly preferably 1-10% by weight.

Very preferably, the LC medium according to the invention comprises one or more compounds of the Formula XXIa:

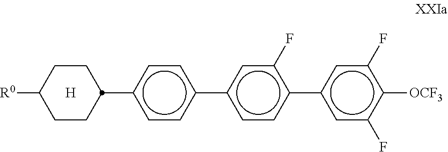

in which R⁰ has the meaning of R¹ in Formula I. R⁰ preferably denotes straight-chain alkyl, in particular ethyl, n-propyl, n-butyl, or n-pentyl and very particularly preferably n-propyl.

The compound(s) of the Formula XXI, in particular of the Formula XXIa, is (are) preferably employed in the LC media according to the invention in amounts of 1-15% by weight, particularly preferably 2-10% by weight.

Further preferably, the LC medium according to the invention comprises one or more compounds of the Formula XXIIIa:

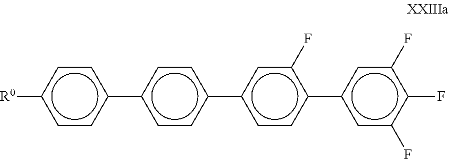

in which R⁰ has the meaning of R¹ in Formula I. R⁰ preferably denotes straight-chain alkyl group, in particular ethyl, n-propyl, n-butyl, or n-pentyl and very particularly preferably n-propyl.

The compound(s) of the Formula XXIII, in particular of the Formula XXIIIa, is (are) preferably employed in the LC media according to the invention in amounts of 0.5-5% by weight, particularly preferably 0.5-2% by weight.

The LC medium may additionally comprise one or more compounds of the Formula XXIV:

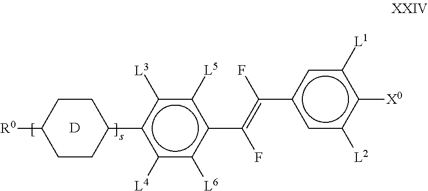

in which
R⁰, X⁰, and L¹⁻⁶ have the meanings indicated in Formula III;
s denotes 0 or 1; and

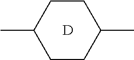

denotes

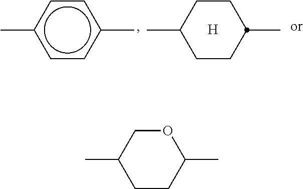

In the Formula XXIV, X⁰ may also denote an alkyl group having 1 to 6 C atoms or an alkoxy group having 1 to 6 C atoms. The alkyl or alkoxy group is preferably straight-chain.

R⁰ preferably denotes alkyl having 1 to 6 C atoms. X⁰ preferably denotes F.

The compounds of the Formula XXIV are preferably selected from the following subformulae:

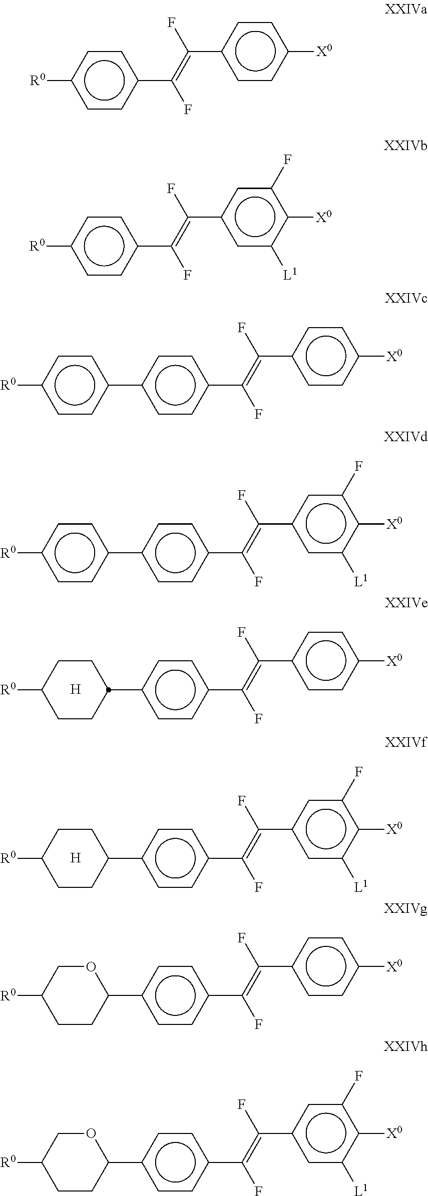

in which
R⁰, X⁰, and L¹ have the meanings indicated in Formula III. R⁰ preferably denotes alkyl having 1 to 6 C atoms. X⁰ preferably denotes F,

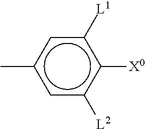

is preferably

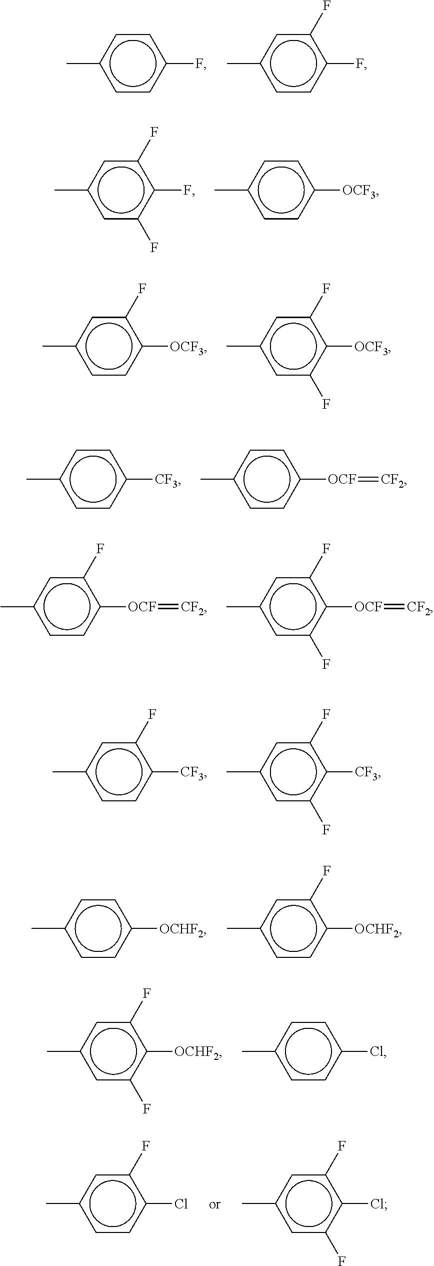

and
R⁰ is straight-chain alkyl or alkenyl having 2 to 6 C atoms;

The LC medium may further comprise one or more compounds of the following formulae:

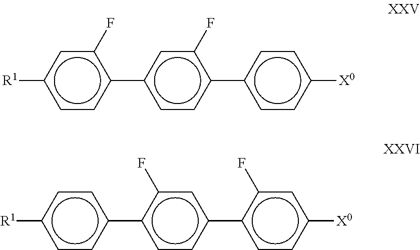

in which R¹ and X⁰ have the meanings of R⁰ and X⁰ indicated in Formula II, respectively. R¹ preferably denotes alkyl having 1 to 6 C atoms. X⁰ preferably denotes F or Cl. In the Formula XXIV, X⁰ very particularly preferably denotes Cl.

The LC medium may further comprise one or more compounds of the following formulae:

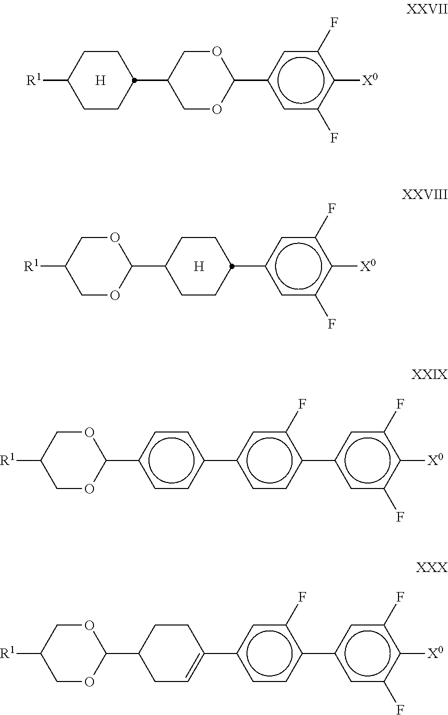

in which R¹ and X⁰ have the meanings of R⁰ and X⁰ indicated in Formula II, respectively. R¹ preferably denotes alkyl having 1 to 6 C atoms. X⁰ preferably denotes F. The medium according to the invention particularly preferably comprises one or more compounds of the Formula XXIX, in which X⁰ preferably denotes F.

The compound(s) of the Formulae XXVI-XXIX is (are) preferably employed in the LC media according to the invention in amounts of 1-20% by weight, particularly preferably 1-15% by weight. Particularly preferred LC media comprise at least one compound of the Formula XXIX.

Very preferably, the LC medium according to the invention comprises one or more compounds of the Formula XXIXa:

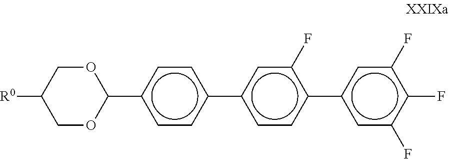

in which R¹ has the meanings indicated in Formula I, and preferably denotes straight-chain alkyl, in particular ethyl, n-propyl, n-butyl, or n-pentyl, and very particularly preferably n-propyl.

The compound(s) of the Formula XXIXa is (are) preferably employed in the LC media according to the invention in amounts of 1-15% by weight, particularly preferably 2-10% by weight.

The LC medium may further comprise one or more compounds of the following pyrimidine or pyridine compounds of the formulae:

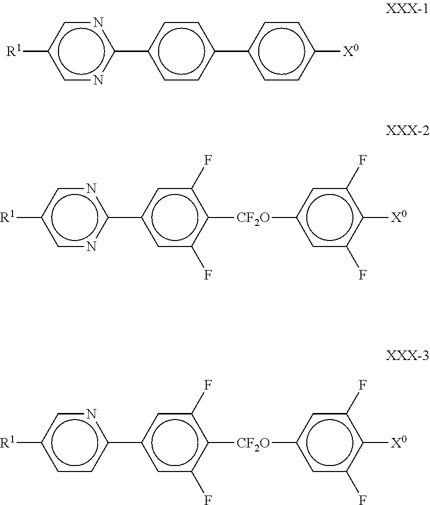

in which R¹ and X⁰ have the meanings indicated in Formula II for R⁰ and X⁰, respectively. R¹ preferably denotes alkyl having 1 to 6 C atoms. X⁰ preferably denotes F. The medium according to the invention particularly preferably comprises one or more compounds of the Formula XXX-1, in which X⁰ preferably denotes F. The compound(s) of the Formulae XXX-1 to XXX-3 is (are) preferably employed in the LC media according to the invention in amounts of 1-20% by weight, particularly preferably 1-15% by weight.

In one preferred embodiment according to the present invention, the LC medium contains, in addition to the compounds of Formula I and T1 and/or T2, one or more compounds selected from the Formulae Y and B:

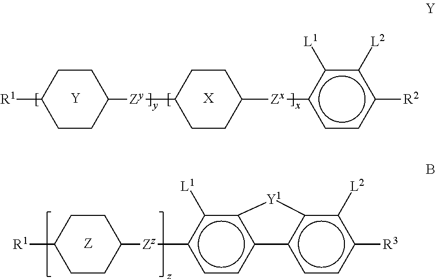

in which the individual groups, on each occurrence identically or differently, and each, independently of one another, have the following meanings:

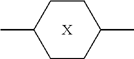

denotes

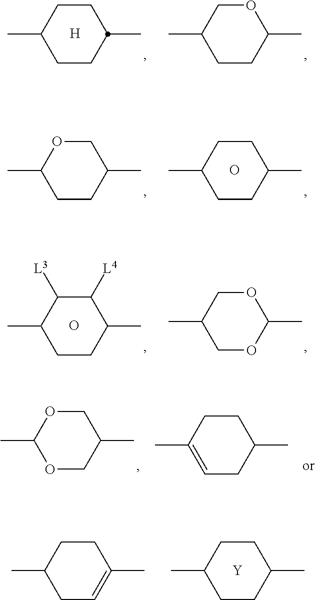

denotes

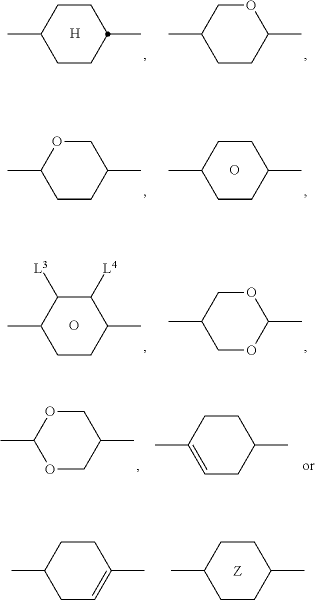

denotes

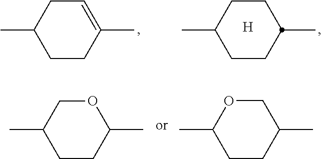

R¹, R² have one of the meanings given for R¹ and R² in Formula I;
R³ has one of the meanings given for R¹;
Z^{x}, Z^{y} denote —CH₂CH₂—, —CH═CH—, —CF₂O—, —OCF₂—, —CH₂O—, —OCH₂—, —CO—O—, —O—CO—, —C₂F₄—, —CF═CF—, —CH═CH—CH₂O—, or a single bond, preferably a single bond;
Z^{z} denotes CH₂O, —O—, —C₂H₄—, —OCH₂—, or a single bond;
Y¹ denotes —CH₂—, —O—, or —S—;
L¹⁻⁴ denote H, F, or Cl, preferably H or F, very preferably F;
X, y denote 0, 1, or 2, with x+y≤3; and
Z denotes 0 or 1.
wherein, in Formula B, the dibenzofuran or dibenzothiophene group may also be further substituted by a methyl or methoxy group; and
wherein the compounds of Formula Y contain at least one substituent L¹⁻⁴ that is F or Cl, preferably F.

Advantageously, the LC medium according to this first preferred embodiment contains one or more compounds of Formula I and T1 and/or T2, one or more compounds selected from Formulae Z1, Z2, and Z3, and one or more compounds selected from Formulae Y and B.

The LC media according to this first preferred embodiment are especially suitable for use in LC displays of the HB-FFS or PS-HB-FFS mode as well as in transparent displays.

In the compounds of Formula Y and its subformulae, R¹ and R² preferably denote straight-chain alkyl or alkoxy having 1 to 6 C atoms, furthermore alkenyl having 2 to 6 C atoms, in particular vinyl, 1E-propenyl, 1E-butenyl, 3-butenyl, 1E-pentenyl, 3E-pentenyl, or 4-pentenyl.

In the compounds of Formula Y and its subformulae, preferably both groups L¹ and L² denote F. In another preferred embodiment of the present invention, in the compounds of Formula Y and its subformulae, one of the groups L¹ and L² denotes F and the other denotes Cl.

In a further preferred embodiment of the present invention, the LC medium contains one or more compounds of Formula Y selected from the following subformulae:

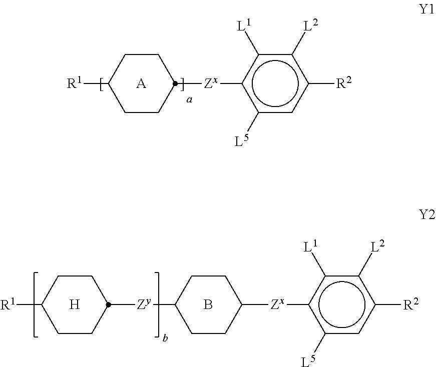

wherein
L¹, L², R¹, R², Z^{x}, Z^{y}, x, and y
   have the meanings given in Formula Y or one of the preferred meanings given above in Formula I;
a denotes 1 or 2;
b denotes 0 or 1;

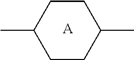

denotes

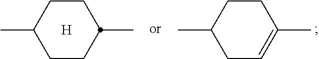

denotes

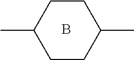

denotes

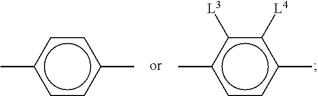

L³, L⁴ denote F or Cl, preferably F; and
L⁵ denotes a H atom or CH₃.

Preferably, in the compounds of Formula Y¹ and Y², both L¹ and L² denote F or one of L¹ and L² denotes F and the other denotes Cl, or both L³ and L⁴ denote F or one of L³ and L⁴ denotes F and the other denotes Cl.

Preferably, the LC medium comprises one or more compounds of the Formula Y¹ selected from the group consisting of the following subformulae:

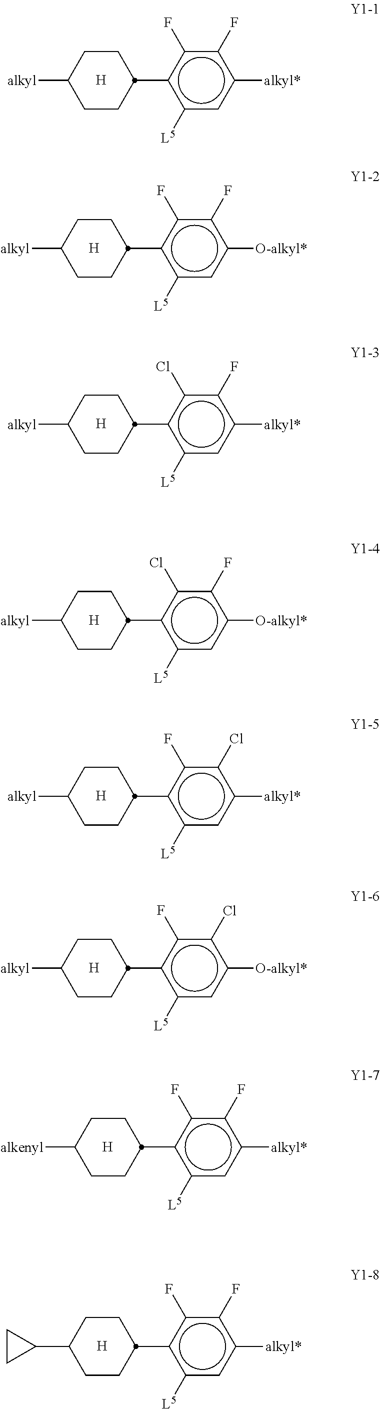

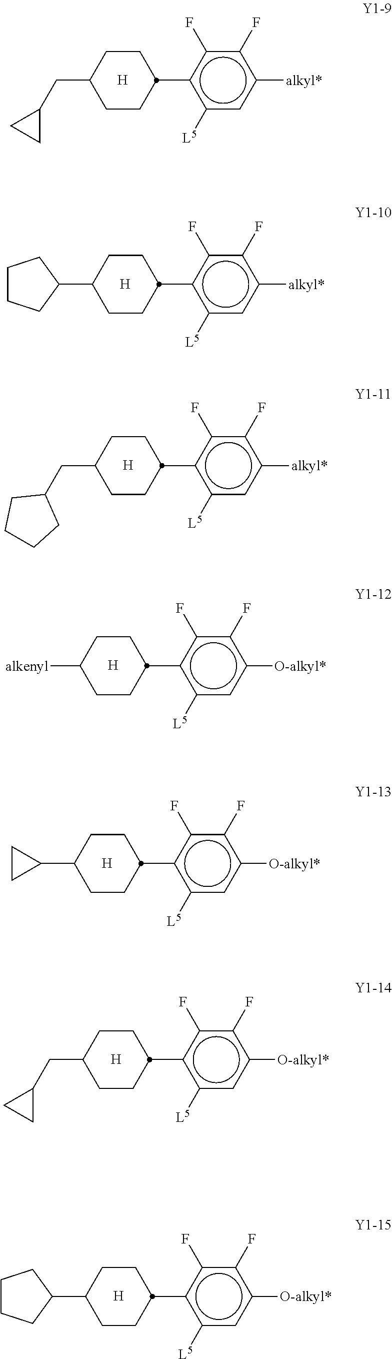

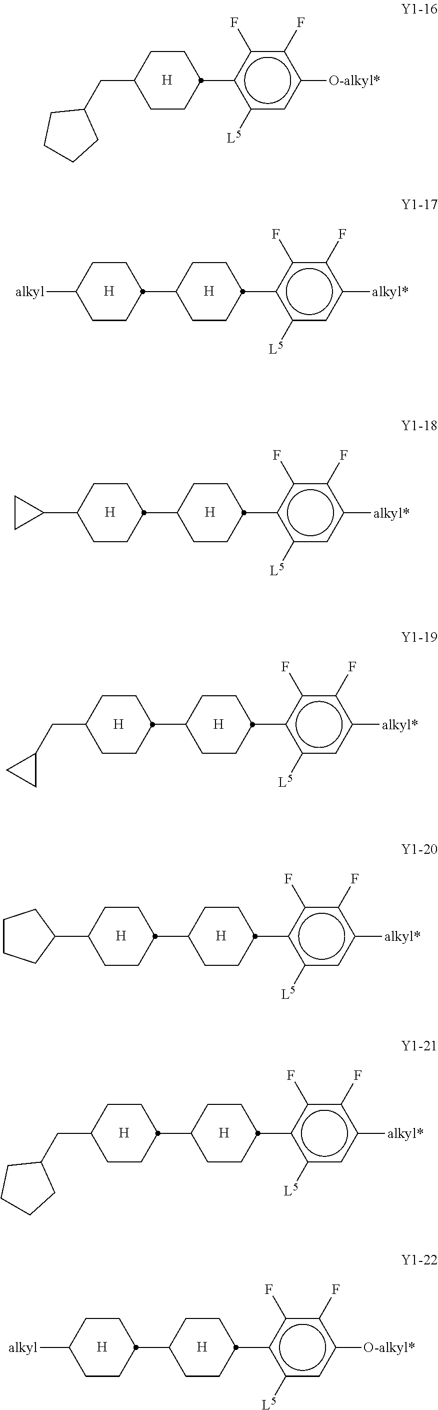

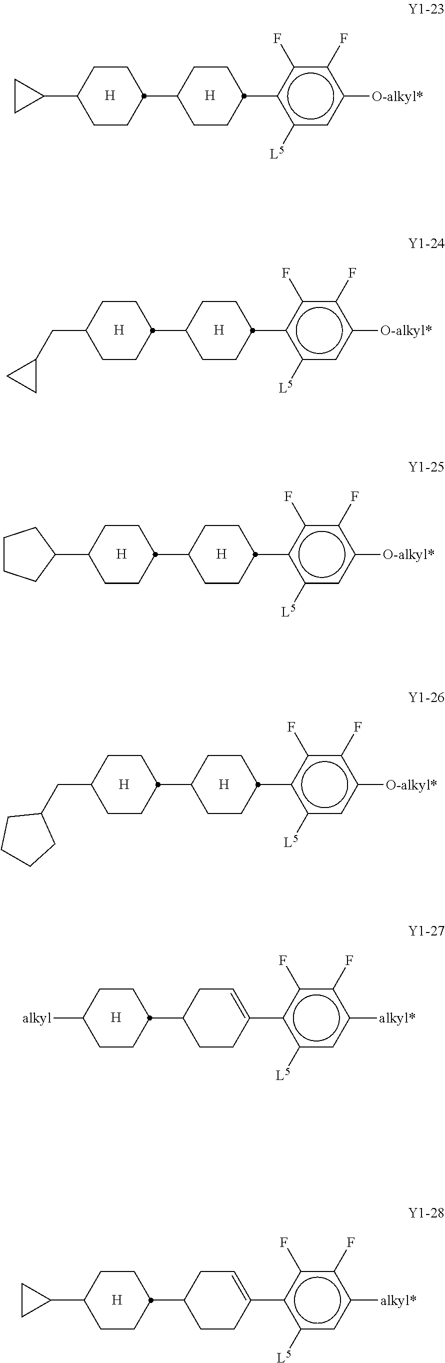

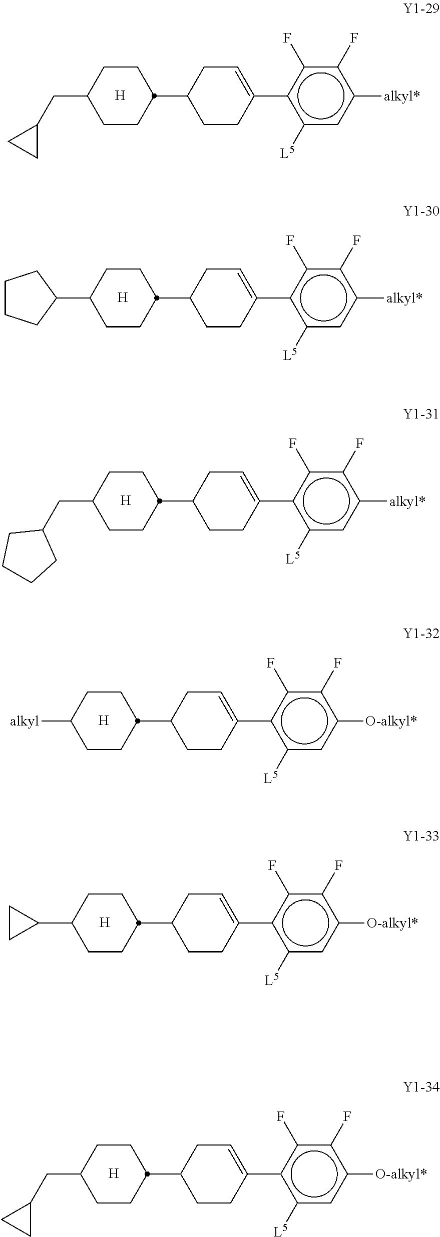

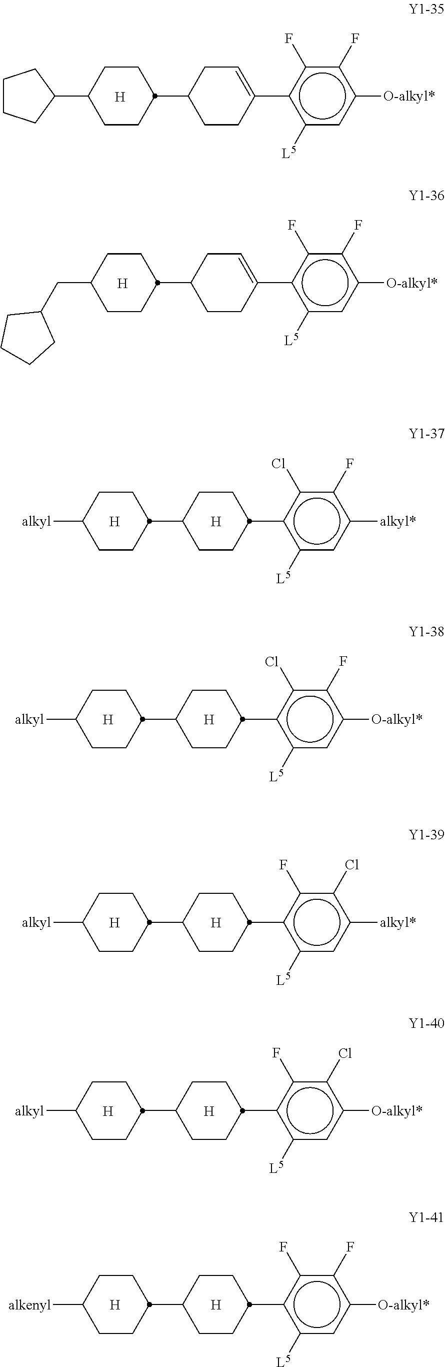

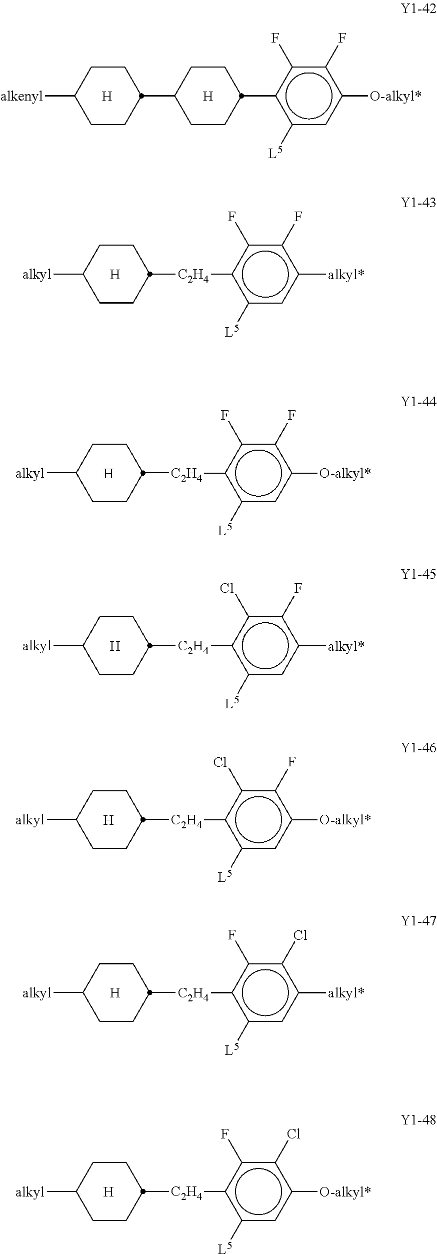

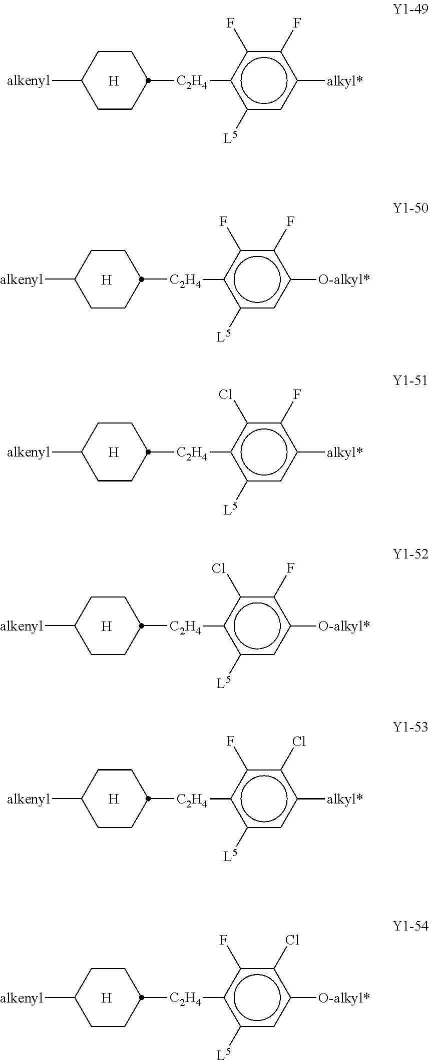

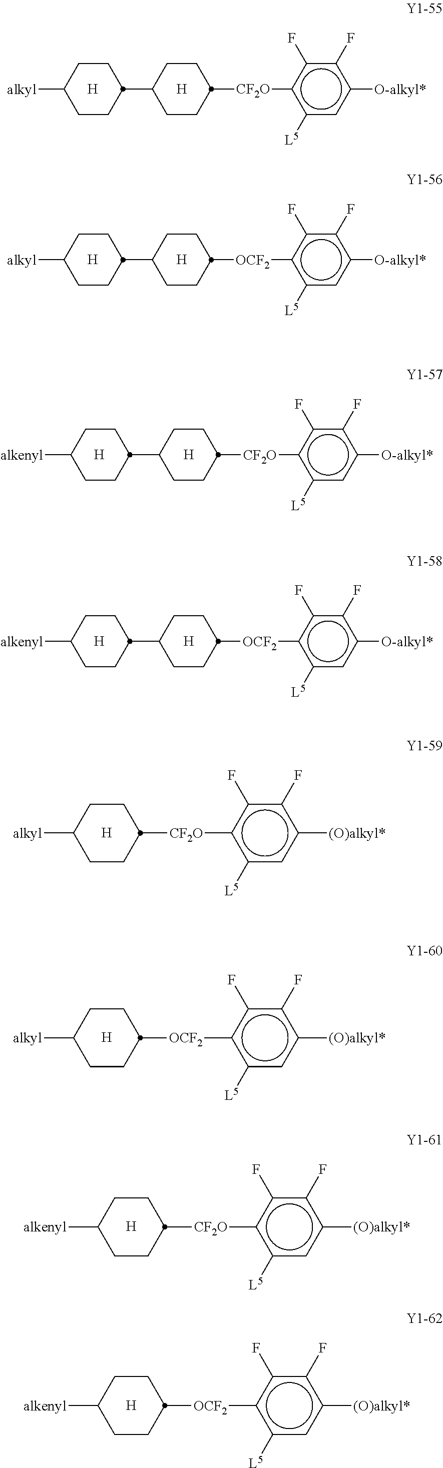

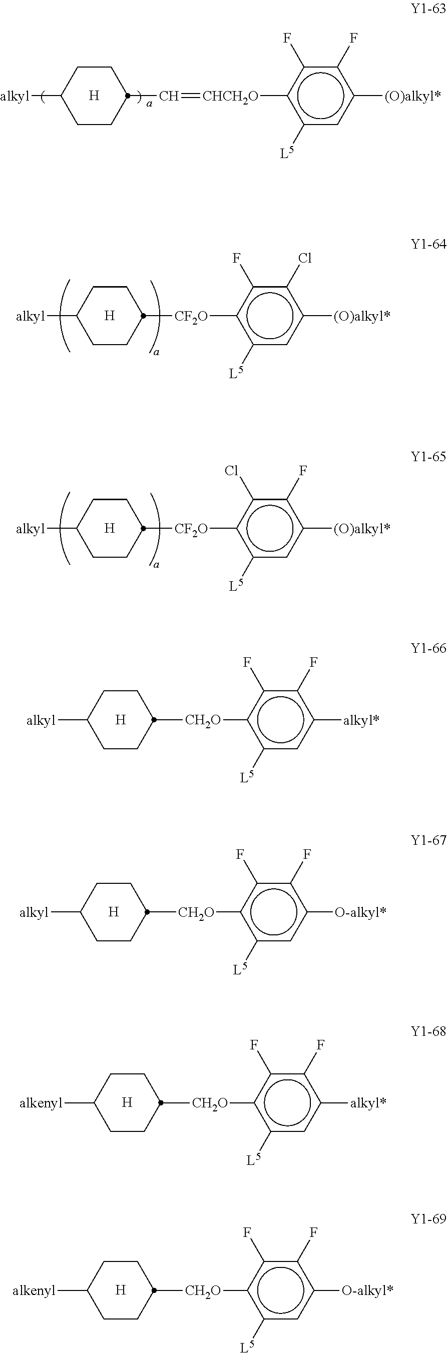

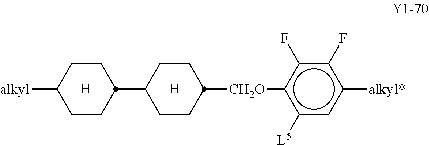

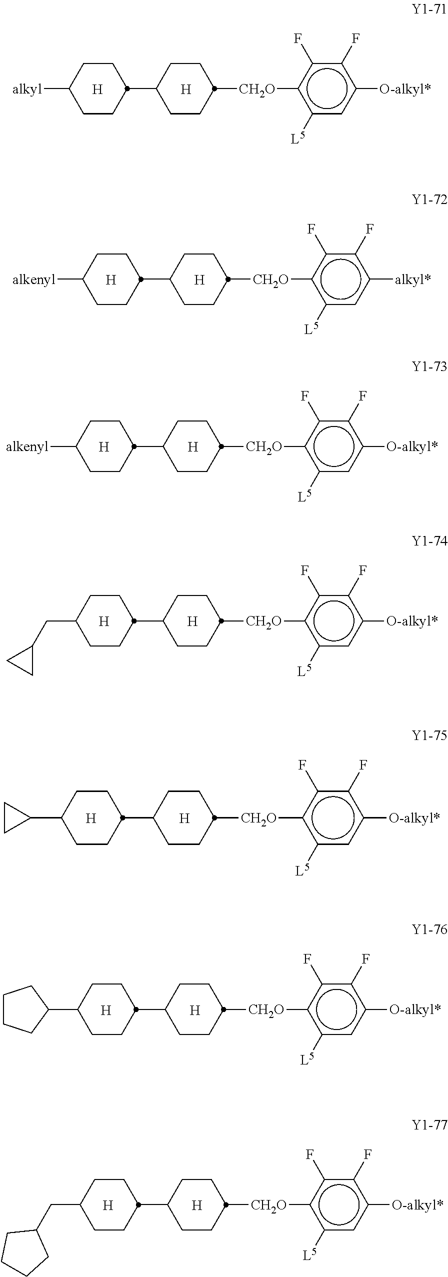

in which
a denotes 1 or 2;
“alkyl” and “alkyl*” each, independently of one another, denote a straight-chain alkyl group having 1 to 6 C atoms;
“alkenyl” denotes a straight-chain alkenyl group having 2 to 6 C atoms; and
L⁵ denotes a H atom or CH₃.
“alkenyl” preferably denotes CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH—, or CH₃—CH═CH—(CH₂)₂—.

Very preferably, the LC medium contains one or more compounds of Formula Y¹ selected from Formulae Y1-1, Y1-2, Y1-7, Y1-12, Y1-17, Y1-22, Y1-40, Y1-41, Y1-42, Y1-44, Y1-50, and Y1-68. L⁵ preferably denotes a H atom.

Further preferably, the LC medium comprises one or more compounds of the Formula Y2 selected from the group consisting of the following subformulae:

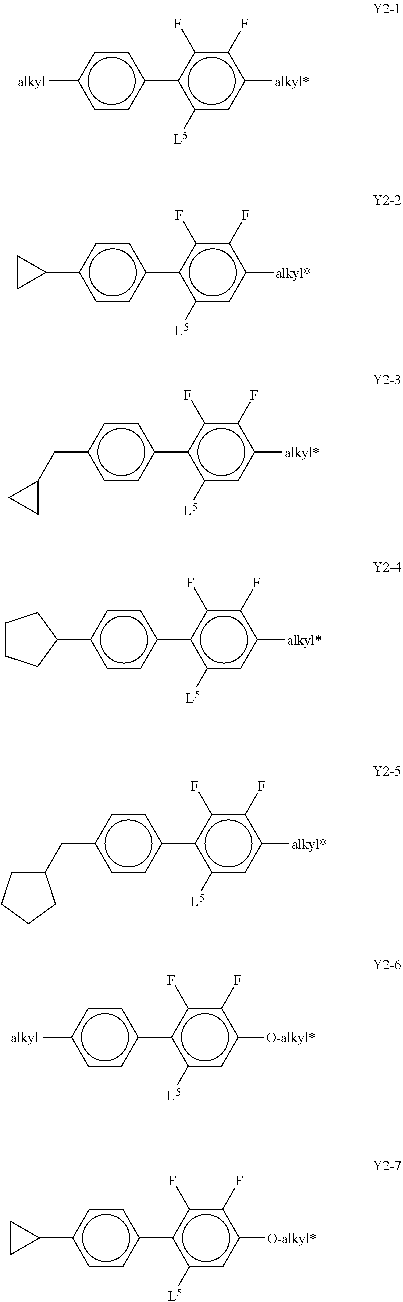

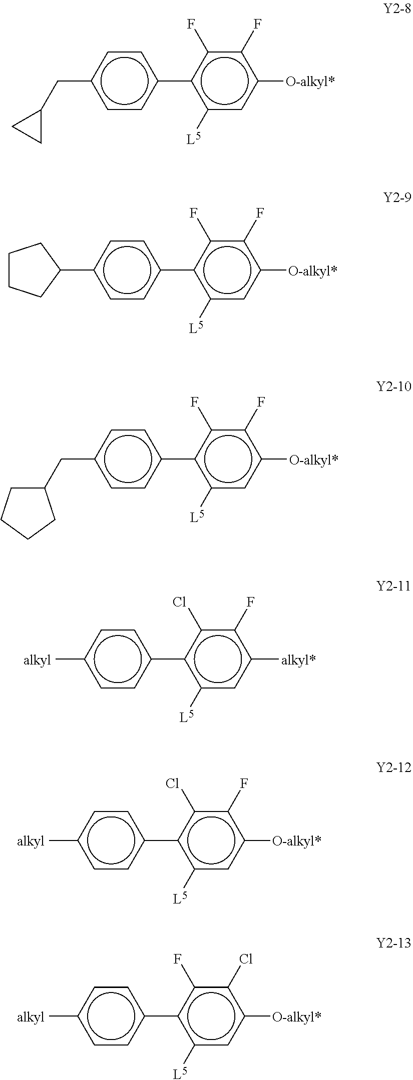

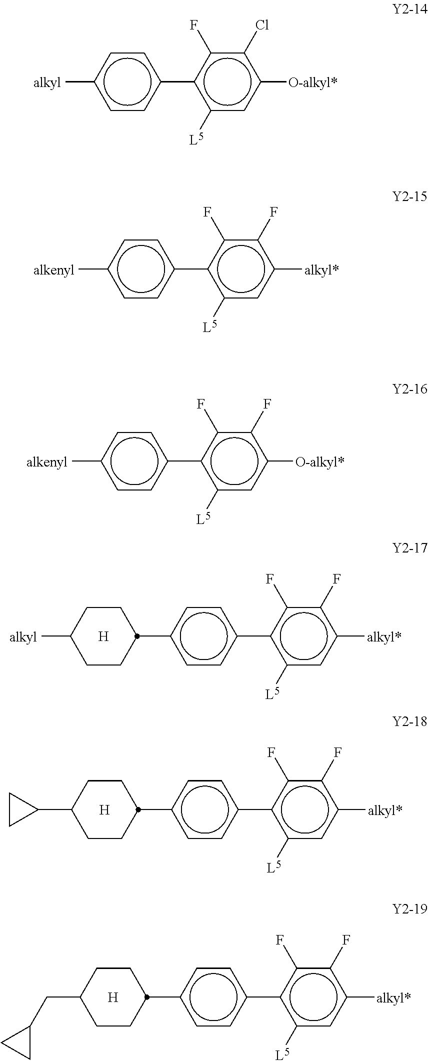

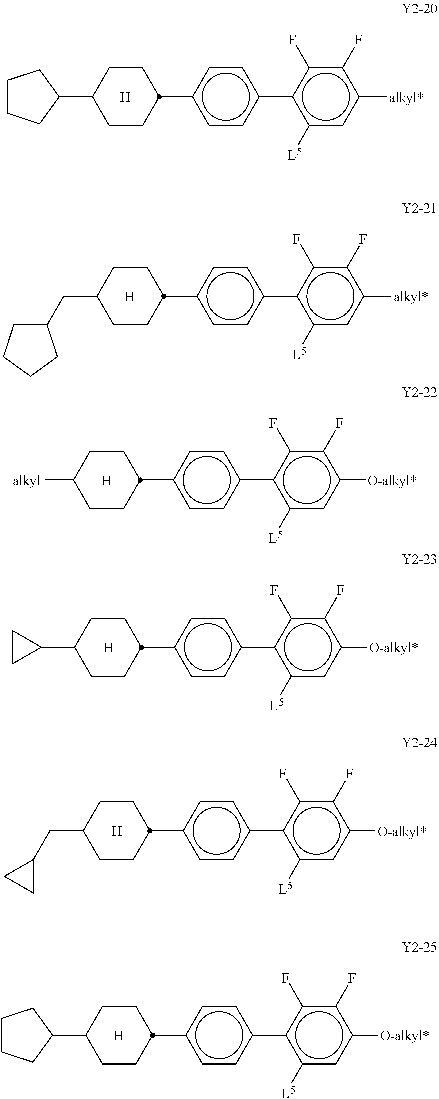

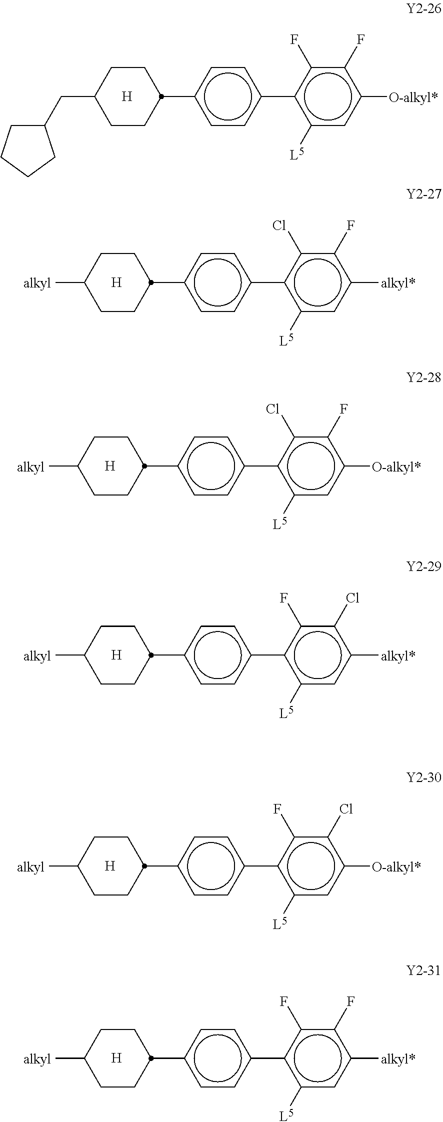

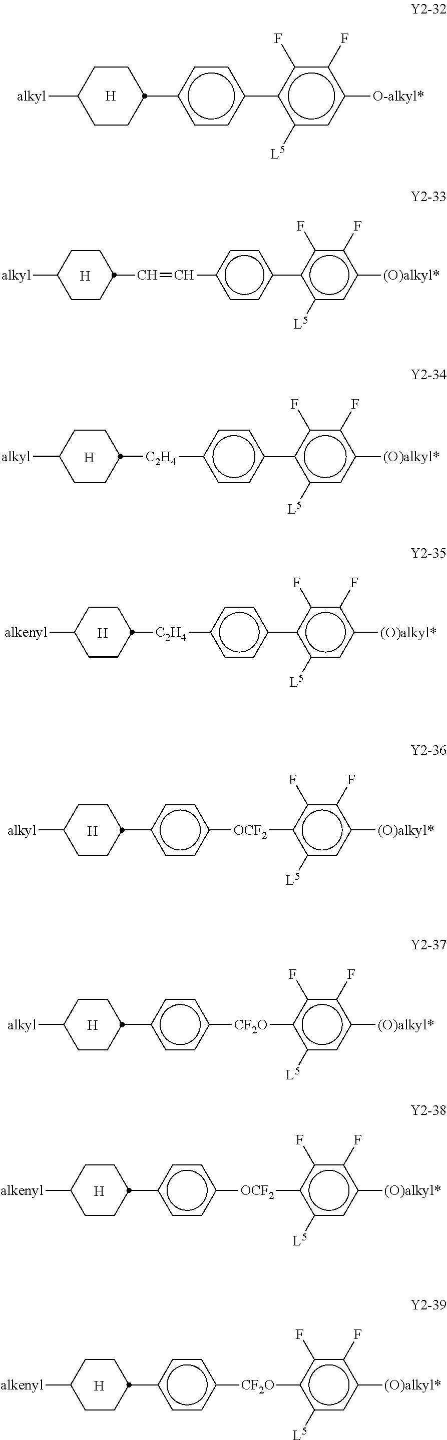

in which
“alkyl” and “alkyl*” each, independently of one another, denote a straight-chain alkyl group having 1 to 6 C atoms;
“alkenyl” denotes a straight-chain alkenyl group having 2 to 6 C atoms;
(O) denotes an oxygen atom or a single bond; and
L⁵ denotes a H atom or CH₃, preferably a H atom.

“alkenyl” preferably denotes CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH—, or CH₃—CH═CH—(CH₂)₂—.

Very preferably, the LC medium contains one or more compounds of Formula Y2 selected from Formulae Y2-2 and Y2-10.

The proportion of the compounds of Formula Y1 or its subformulae in the LC medium is preferably from 0 to 10% by weight.

The proportion of the compounds of Formula Y2 or its subformulae in the LC medium is preferably from 0 to 10% by weight.

The total proportion of the compounds of Formula Y1 and Y2 or their subformulae in the LC medium is preferably from 1 to 20%, very preferably from 2 to 15% by weight.

Preferably, the LC medium contains 1, 2, or 3 compounds of Formula Y1 and Y2 or their subformulae, very preferably selected from Formulae Y¹⁻², Y¹⁻²², Y¹⁻⁶⁶, Y1-70, Y2-6, and Y2-22.

In another preferred embodiment of the present invention, the
LC medium contains one or more compounds of Formula Y selected from the following subformula:

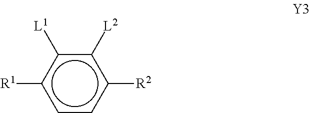

wherein L¹, L², R¹, and R² have one of the meanings given in Formula Y or one of the preferred meanings as given in Formulae I and its subformulae.

Preferred compounds of the Formula Y³ are selected from the group consisting of the following subformulae:

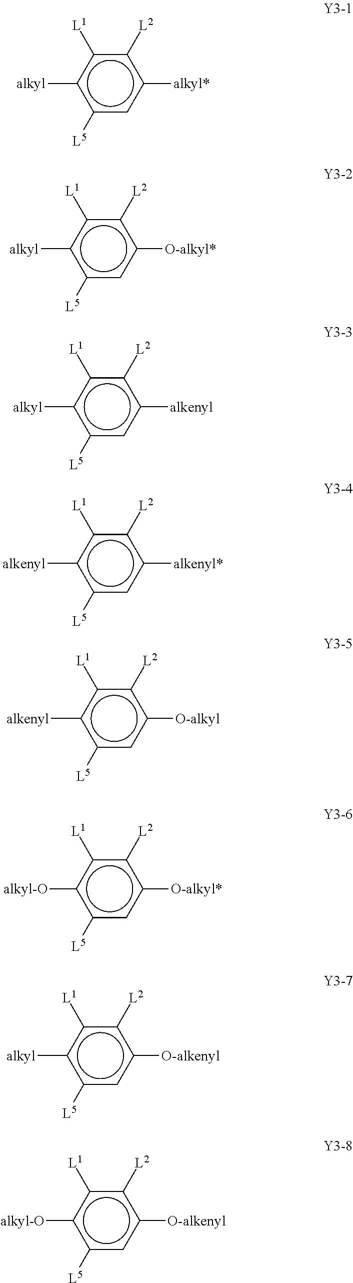

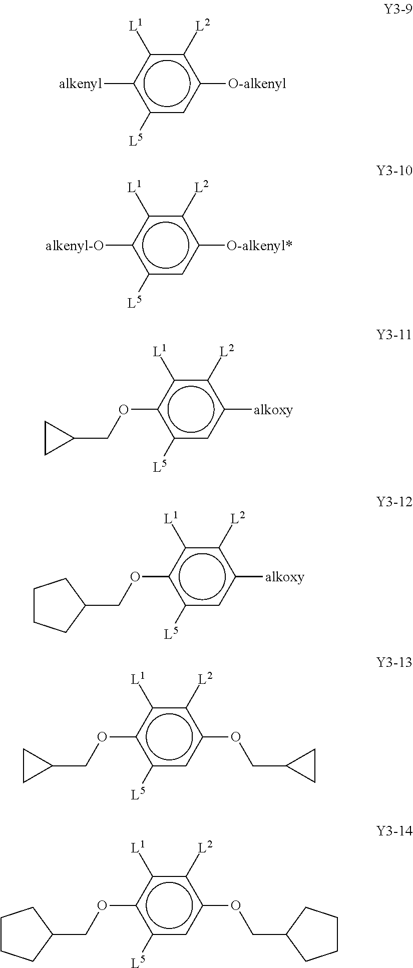

in which,
“alkyl” and “alkyl*” each, independently of one another, denote a straight-chain alkyl group having 1 to 6 C atoms;
“alkenyl” and “alkenyl*” each, independently of one another, denote a straight-chain alkenyl group having 2 to 6 C atoms; and
O denotes an oxygen atom or a single bond.

“alkenyl” and “alkenyl*” preferably denote CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH—, or CH₃—CH═CH—(CH₂)₂—.

Particularly preferred compounds of the Formula Y3 are selected from the group consisting of following subformulae:

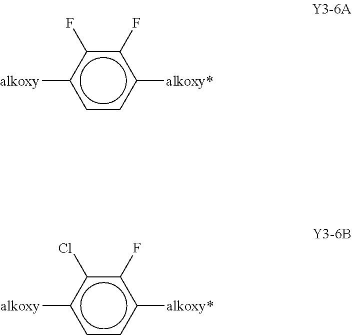

wherein “alkoxy” and “alkoxy*” each, independently of one another, preferably denote straight-chain alkoxy with 3, 4, or 5 C atoms.

Preferably, in the compounds of Formula Y3 and its subformulae both L¹ and L² denote F. Further, preferably in the compounds of Formula Y3, one of the groups L¹ and L² denotes F and the other denotes Cl.

The proportion of the compounds of Formula Y3 or its subformulae in the LC medium is preferably from 1 to 10%, very preferably from 1 to 6% by weight.

Preferably, the LC medium contains 1, 2, or 3 compounds of Formula Y3 or its subformulae, preferably of Formula Y3-6, very preferably of Formula Y3-6A.

In another preferred embodiment the present invention, the LC medium contains one or more compounds of Formula Y selected from the subformula Y⁴:

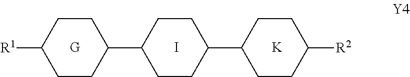

in which R¹ and R² each, independently of one another, have one of the meanings indicated above in Formula Y, and

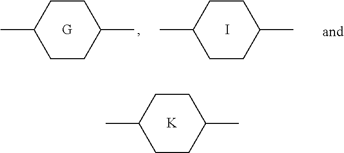

each, independently of one another, denote

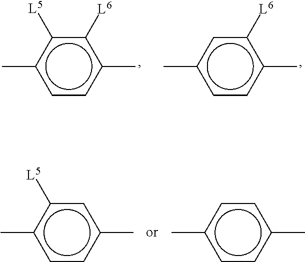

in which
L⁵ denotes F or Cl, preferably F;
L⁶ denotes F, Cl, OCF₃, CF₃, CH₃, CH₂F, or CHF₂, preferably F;
preferably at least one of the rings G, I, and K is different from unsubstituted benzene.

Preferred compounds of the Formula Y⁴ are selected from the group consisting of the following subformulae:

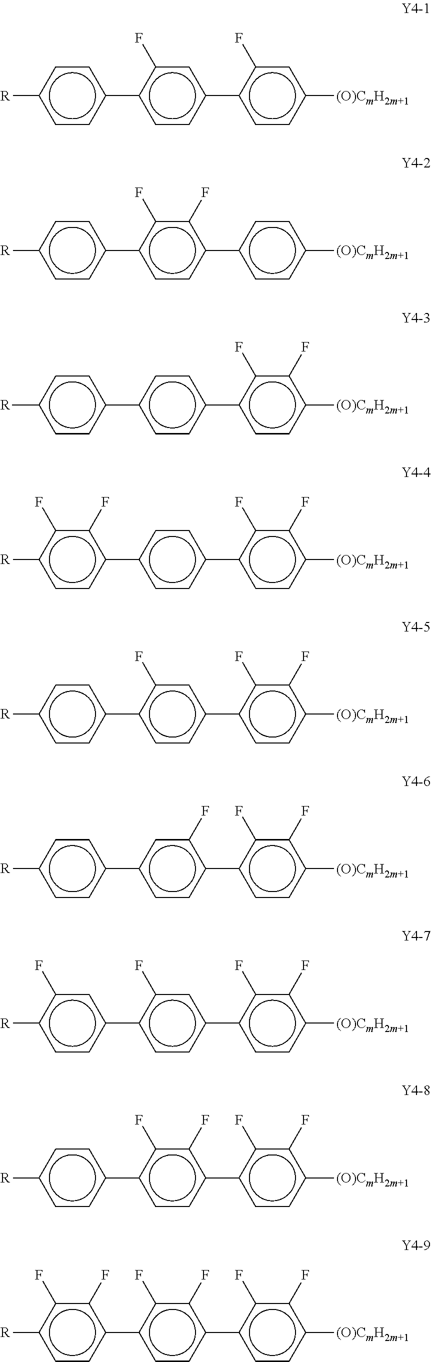

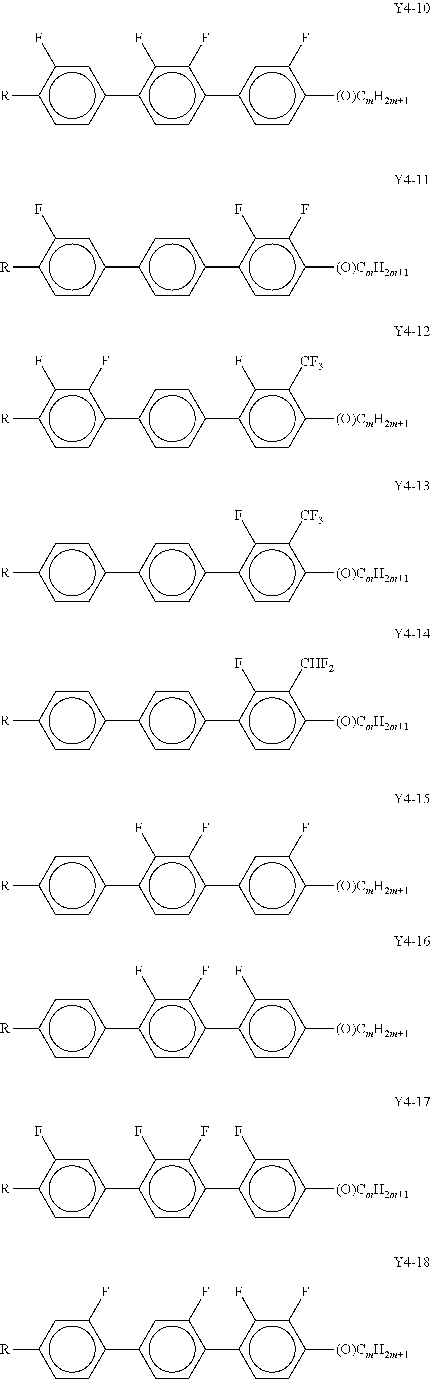

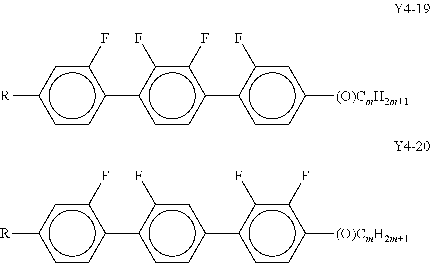

R denotes a straight-chain alkyl or alkoxy group having 1 to 7 C atoms;
R* denotes a straight-chain alkenyl group having 2 to 7 C atoms;
(O) denotes an oxygen atom or a single bond; and
m denotes an integer from 1 to 6.

R* preferably denotes CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH—, or CH₃—CH═CH—(CH₂)₂—.

R preferably denotes methyl, ethyl, propyl, butyl, pentyl, hexyl, methoxy, ethoxy, propoxy, butoxy, or pentoxy.

The proportion of the compounds of Formula Y4 or its subformulae in the LC medium is preferably from 1 to 10%, very preferably from 1% to 6% by weight.

Particularly preferred compounds are those of the subformulae:

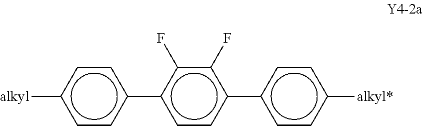

in which
alkyl and alkyl* each, independently of one another, denote a straight-chain alkyl group having 1 to 6 C atoms, in particular ethyl, propyl, or pentyl.

Use of the following compounds is particularly advantageous:

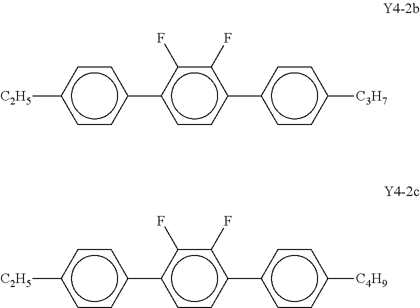

In another preferred embodiment the present invention, the LC medium contains one or more compounds of Formula Y selected from the group consisting of the following subformulae:

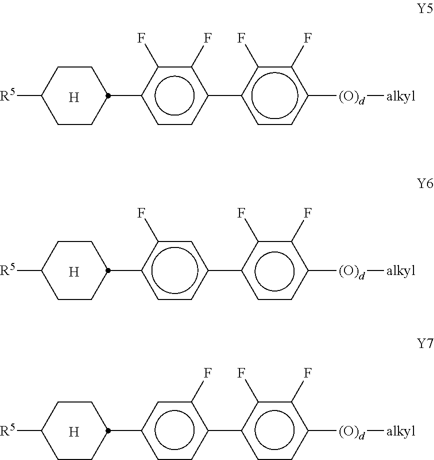

in which
R⁵ has one of the meanings indicated above in Formula Y for R¹;
“alkyl” denotes a straight-chain alkyl group having 1 to 6 C atoms; and
L^{x} denotes H or F.

R⁵ in these compounds is particularly preferably C₂₋₆-alkyl or -alkoxy or C₂₋₆-alkenyl, d is preferably 1. X in these compounds is particularly preferably F. The LC medium according to the invention preferably comprises one or more compounds of the above-mentioned formulae in amounts of ≥5% by weight.

In the compounds of Formula B and its subformulae, R¹ and R³ preferably denote straight-chain alkyl or alkoxy having 1 to 6 C atoms, in particular methoxy, ethoxy, propoxy, or butoxy, furthermore alkenyl having 2 to 6 C atoms, in particular vinyl, 1E-propenyl, 1E-butenyl, 3-butenyl, 1E-pentenyl, 3E-pentenyl, or 4-pentenyl.

Further preferred embodiments are indicated below:
The LC medium comprises one or more compounds of Formula Y selected from the following subformula:

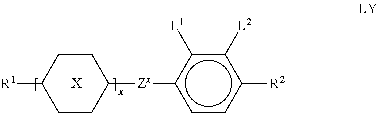

wherein R¹, R², L¹, L², X, x and Z^{x} have the meanings given in Formula Y, and wherein at least one of the rings X is cyclohexenylene.

Preferably, both groups L¹ and L² denote F. Further preferably, one of the groups L¹ and L² denotes F and the other denotes Cl.

The compounds of the Formula LY are preferably selected from the group consisting of the following subformulae:

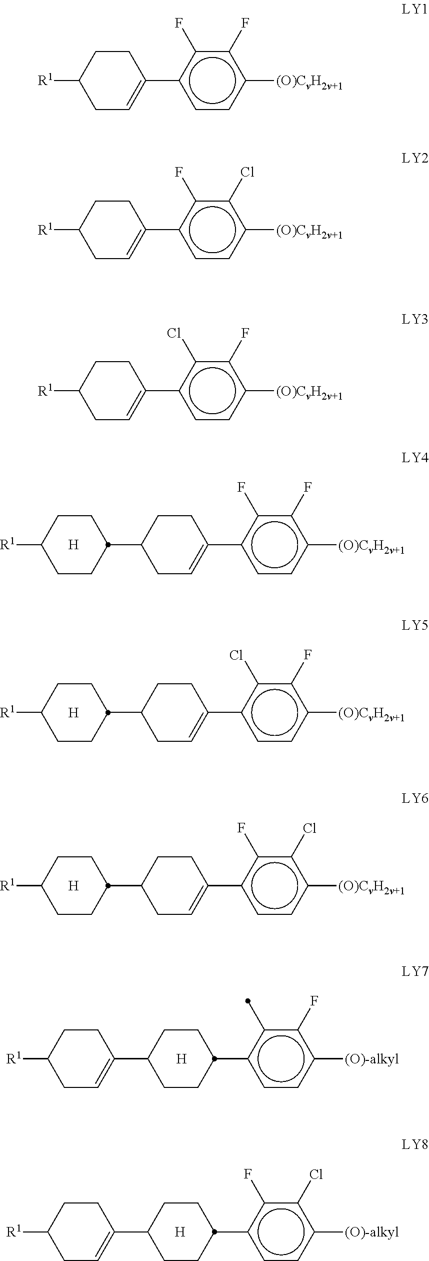

in which R¹ has the meaning indicated in Formula Y above, (O) denotes an oxygen atom or a single bond, and v denotes an integer from 1 to 6. R¹ preferably denotes straight-chain alkyl having 1 to 6 C atoms or straight-chain alkenyl having 2 to 6 C atoms, in particular CH₃, C₂H₅, n-C₃H₇, n-C₄H₉, n-C₅H₁₁, CH₂═CH—, CH₂═CHCH₂CH₂—, CH₃—CH═CH—, CH₃—CH₂—CH═CH—, CH₃—(CH₂)₂—CH═CH—, CH₃-(CH₂)₃—CH═CH—, or CH₃—CH═CH—(CH₂)₂—.

Very preferred are compounds of Formula LY4.

Preferably, the LC medium contains 1, 2, or 3 compounds of Formula LY, very preferably of Formula LY4.

The proportion of the compounds of Formula LY or its subformulae in the LC medium is preferably from 1 to 10% by weight.
The LC medium comprises one or more compounds of Formula Y selected from the following subformula:

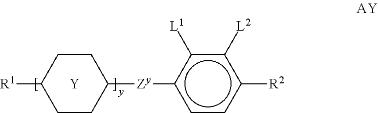

wherein R¹, R², L¹, L², Y, y, and Z^{y} have the meanings given in Formula Y, and wherein at least one of the rings Y is tetrahydropyrane.

The compounds of the Formula AY are preferably selected from the group consisting of the following subformulae:

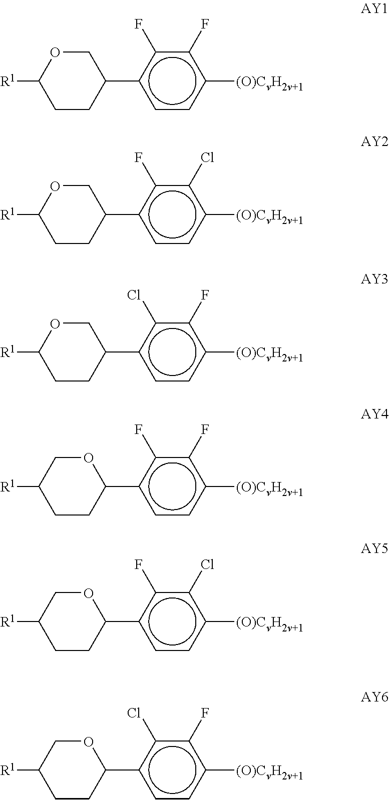

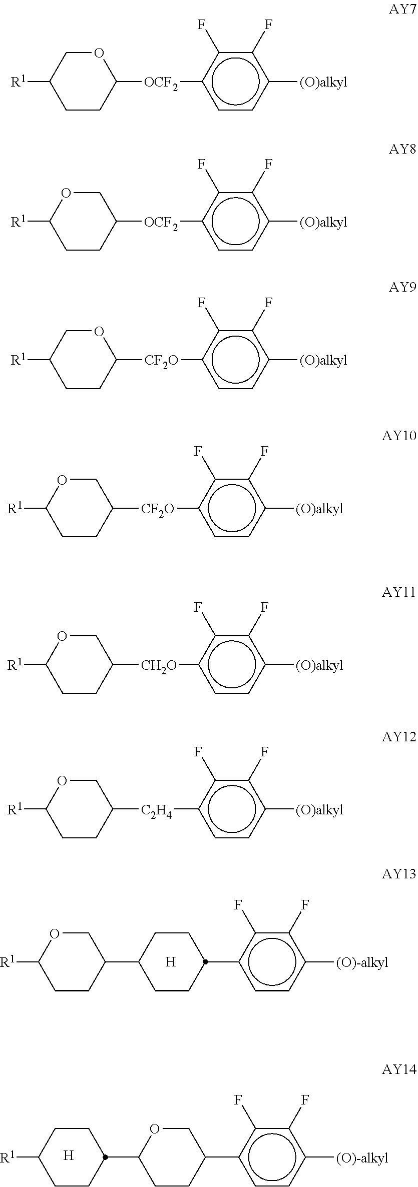

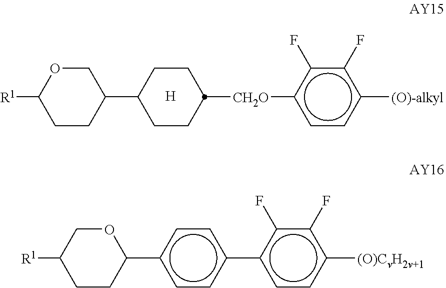

R¹ has the meaning indicated above;
“alkyl” denotes a straight-chain alkyl group having 1 to 6 C atoms;
(O) denotes an oxygen atom or a single bond; and
V denotes an integer from 1 to 6.

R¹ preferably denotes straight-chain alkyl having 1 to 6 C atoms or straight-chain alkenyl having 2 to 6 C atoms, in particular CH₃, C₂H₅, n-C₃H₇, n-C₄H₉, n-C₅H₁₁, CH₂═CH—, CH₂═CHCH₂CH₂—, CH₃—CH═CH—, CH₃—CH₂—CH═CH—, CH₃—(CH₂)₂—CH═CH—, CH₃—(CH₂)₃—CH═CH—, or CH₃—CH═CH—(CH₂)₂—.

In a preferred embodiment of the present invention, the LC medium contains one or more compounds of Formula B selected from the following subformulae:

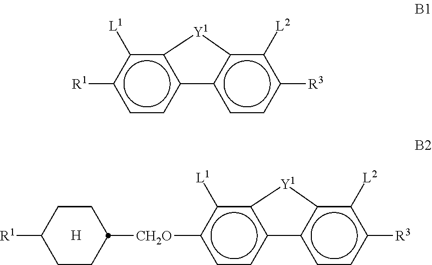

wherein L¹, L², R¹, and R³ have the meanings given in Formula B.

Preferred compounds of Formula B1 are selected from the following subformulae:

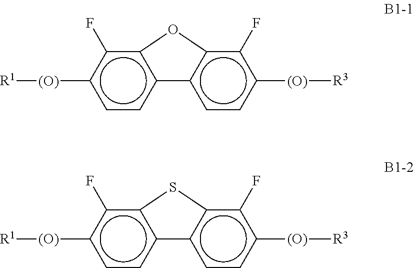

wherein R¹ and R³ independently denote a straight-chain alkyl group having 1 to 6 C atoms, in which one or more CH₂ groups are optionally substituted by —C≡C—, —CF₂O—, —OCF₂—, —CH═CH—,

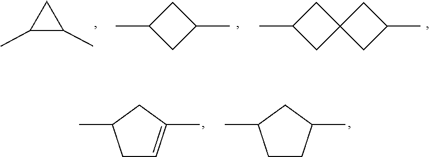

—O—, —CO—O—, or —O—CO— in such a way that O atoms are not linked directly to one another, and in which one or more H atoms may be replaced by a halogen atom.

Very preferred are compounds of Formula B1-1 and B1-2 wherein both groups (O) denote an oxygen atom and R¹ and R³ independently denote an alkyl group being methyl, ethyl, propyl, butyl, pentyl or hexyl, which are preferably straight-chained. Very preferably one “alkyl” is ethyl and the other “alkyl” is n-pentyl.

Very preferred are compounds of Formula B1-2.

Preferably, the compounds of the Formula B1-1 are selected from the group of compounds of Formulae B1-1-1 to B1-1-11, preferably of Formula B1-1-6:

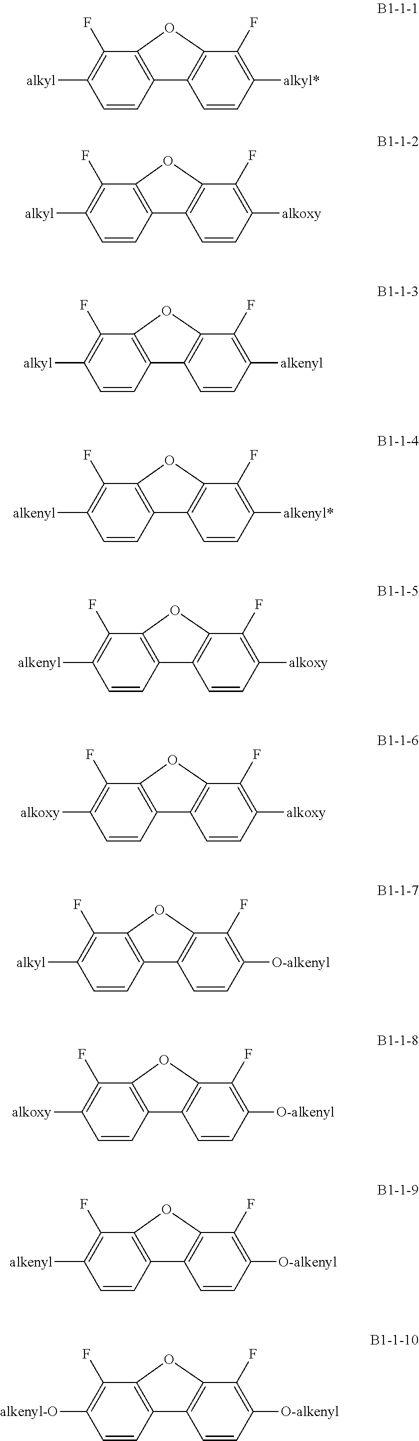

in which
“alkyl” and “alkyl”′ each, independently of one another, denote a straight-chain alkyl group having 1 to 6 C atoms;
“alkenyl” and “alkenyl*” each, independently of one another, denote a straight-chain alkenyl group having 2 to 6 C atoms; and
“alkoxy” and “alkoxy*”
   each, independently of one another, denote a straight-chain alkoxy group having 1 to 6 C atoms.

Preferably, the compounds of the Formula B1-2 are selected from the group of compounds of Formulae B1-2-1 to B1-2-10, preferably of Formula B1-2-6:

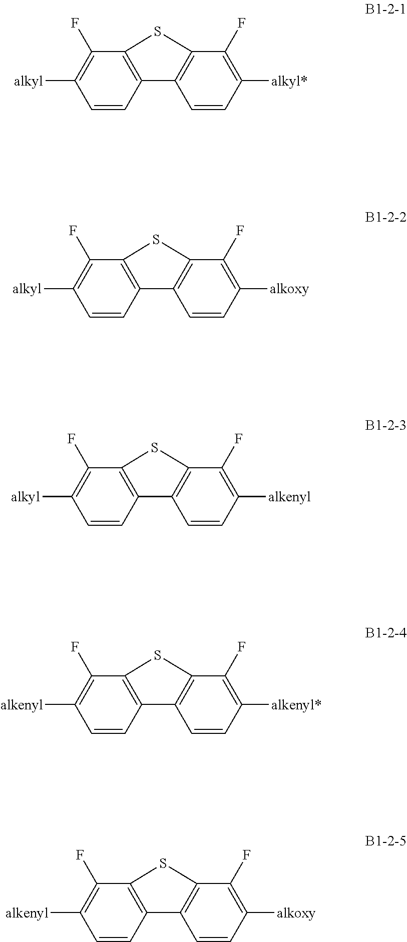

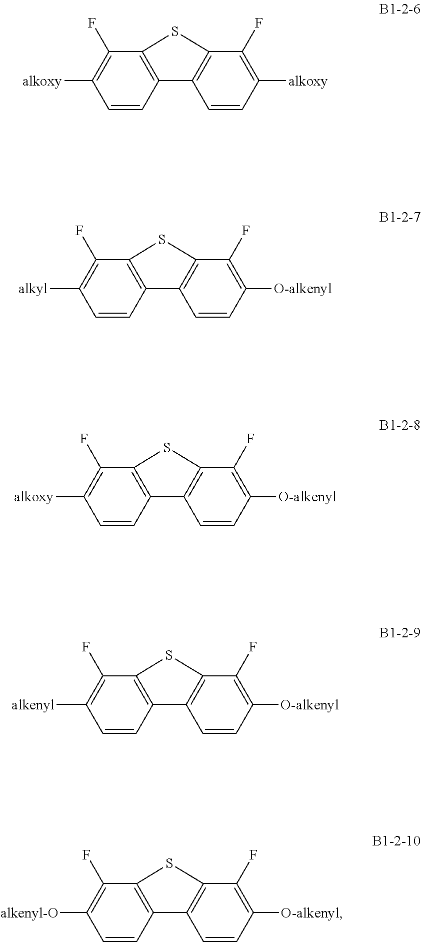

in which
“alkyl” and “alkyl*” each, independently of one another, denote a straight-chain alkyl group having 1 to 6 C atoms;
“alkenyl” and “alkenyl*”
   each, independently of one another, denote a straight-chain alkenyl group having 2 to 6 C atoms; and
“alkoxy” and “alkoxy*”
   each, independently of one another, denote a straight-chain alkoxy group having 1 to 6 C atoms.

Optionally, the LC medium comprises one or more compounds of the Formula B1-1A and/or B1-2A:

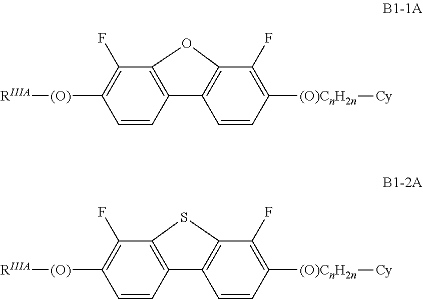

in which
(O) denotes O or a single bond;
R^{IIIA} denotes alkyl or alkenyl having up to 7 C atoms or a group Cy-CₘH₂ₘ₊₁—;
m and n are, identically or differently, 0, 1, 2, 3, 4, 5, or 6, preferably 1, 2, or 3, very preferably 1; and
Cy denotes a cycloaliphatic group having 3, 4, or 5 ring atoms, which is optionally substituted with alkyl or alkenyl each having up to 3 C atoms, or with halogen or CN, and preferably denotes cyclopropyl, cyclobutyl, or cyclopentyl.

The compounds of Formulae B1-1A and/or B1-2A are contained in the LC medium either alternatively or in addition to the compounds of Formulae B1-1 and B1-2, preferably additionally.

Very preferred compounds of the Formulae B1-1A and/or B1-2A are the following:

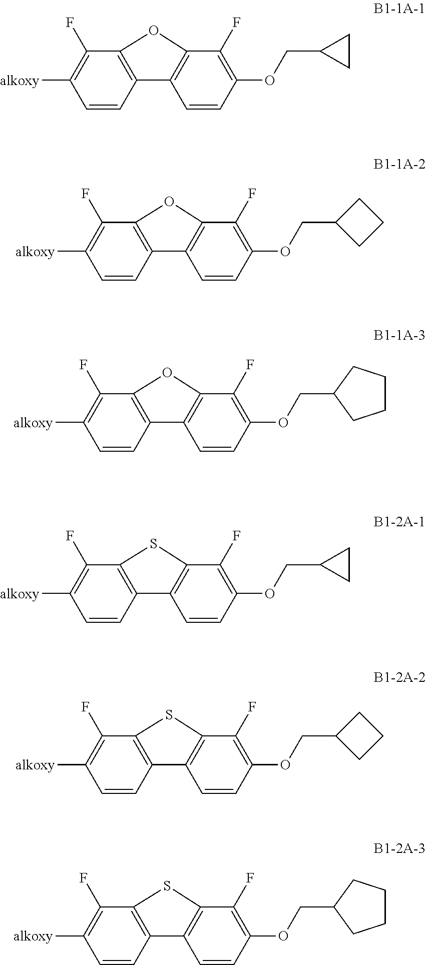

in which
“alkoxy” denotes a straight-chain alkoxy group having 1 to 6 C atoms or alternatively —(CH₂)ₙF, in which n is 2, 3, 4, or 5, preferably C₂H₄F.

The proportion of the compounds of Formula B1 or its subformulae in the LC medium is preferably from 1 to 20%, very preferably from 1 to 15% by weight.

Preferably, the LC medium contains 1, 2 or 3 compounds of Formula B1 or its subformulae.

In a preferred embodiment of the present invention, the LC medium may comprise one or more compounds of Formula B2-2:

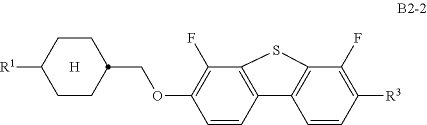

in which
R¹, R³ identically or differently, denote H or an alkyl or alkoxy group having 1 to 6 C atoms, in which one or more CH₂ groups in these groups are optionally replaced, independently of one another, by —C═C—, —CF₂O—, —OCF₂—, —CH═CH—,

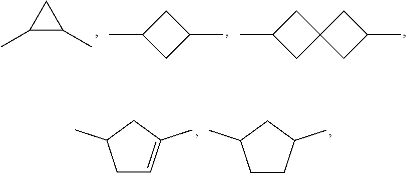

O—, —CO—O—, or —O—CO— in such a way that O atoms are not linked directly to one another, and in which, in addition, one or more H atoms may be replaced by halogen.

The compounds of Formula B2-2 are preferably selected from the group of compounds of the Formulae B2-2-1 to B2-2-10:

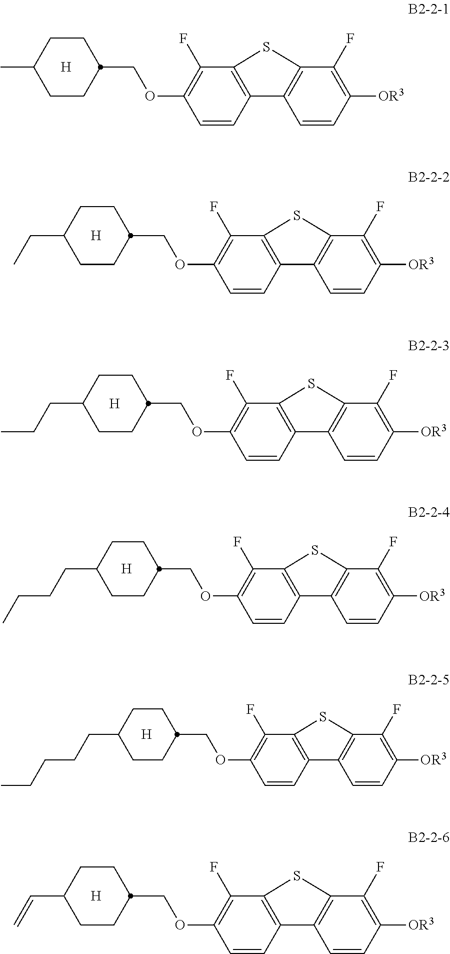

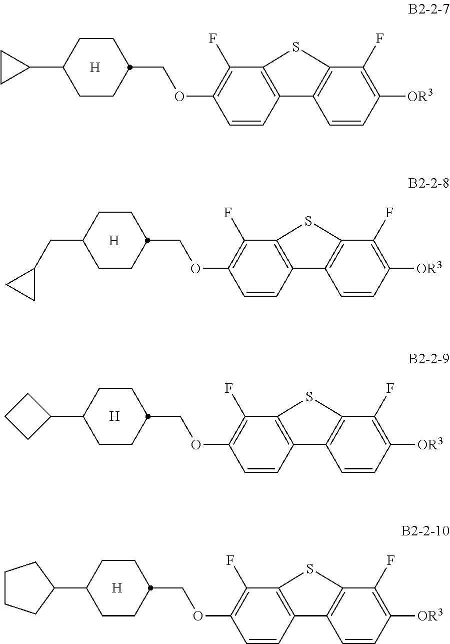

in which R³ denotes alkyl having 1 to 6 C atoms, preferably ethyl, n-propyl, or n-butyl, or alternatively cyclopropylmethyl, cyclobutylmethyl, or cyclopentylmethyl, or alternatively —(CH₂)ₙF, in which n is 2, 3, 4, or 5, preferably C₂H₄F.

Particularly preferred compounds of Formula B2 are selected from the following subformulae:

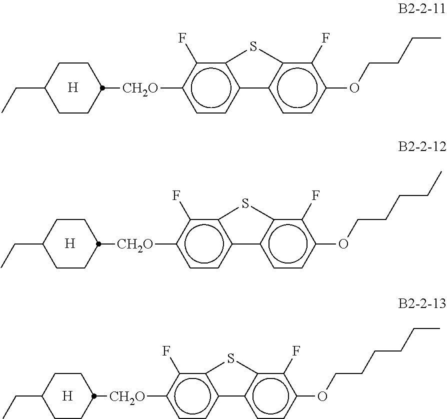

The proportion of the compounds of Formula B2 or its subformulae in the LC medium is preferably from 1 to 20%, very preferably from 1 to 15% by weight.

Preferably, the LC medium contains 1, 2, or 3 compounds of Formula B2 or its subformulae.

Preferred compounds of Formula B3 are selected from the following subformulae:

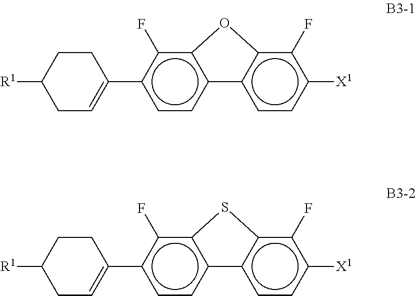

wherein R¹ has one of the meanings given in Formula B3 and preferably denotes straight-chain alkyl having 1 to 6 C atoms, very preferably methyl, ethyl, propyl, butyl, pentyl, or hexyl, more preferably ethyl or propyl, most preferably propyl, and X¹ has one of the meanings given in Formula B3 and preferably denotes CF₃ or OCF₃.

Preferred compounds of Formula B3 are selected from the following subformulae:

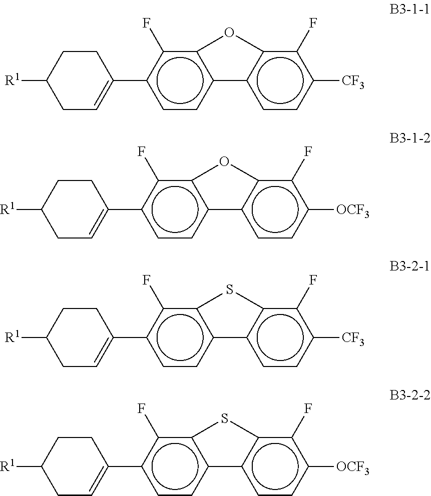

wherein R¹ has one of the meanings given in Formula B3 and preferably denotes straight-chain alkyl having 1 to 6 C atoms, very preferably methyl, ethyl, propyl, butyl, pentyl, or hexyl, more preferably ethyl or propyl, most preferably propyl.

Most preferred are compounds of Formulae B3-1-1 and B3-2-2.

In a further preferred embodiment, the LC medium contains one or more compounds of Formula B or its subformulae B1, B2, B3, B1-1, B1-2, B2-1, B2-2, B2-3, B3-1, B3-2, B3-1-1, B3-1-2, B3-2-1, and B3-2-2 wherein the dibenzofuran or dibenzothiophene group is substituted by a methyl or methoxy group, preferably by a methyl group, more preferably in p-position to the substituent F, very preferably in p-position to the substituent F (i.e., in m-position to the terminal group R² or X¹).

The proportion of the compounds of Formula B3 or its subformulae in the LC medium is preferably from 1 to 20%, very preferably from 1 to 10% by weight.

Preferably, the LC medium contains 1, 2 or 3 compounds of Formula B3 or its subformulae.

Preferably, the total proportion of compounds of Formula Y and B or their subformulae in the LC medium is from 2 to 25%, very preferably from 3 to 20% by weight.

### Compounds of Formula ST

In some preferred embodiments of the present invention, the LC media may further comprise one or more compounds of general Formula ST:

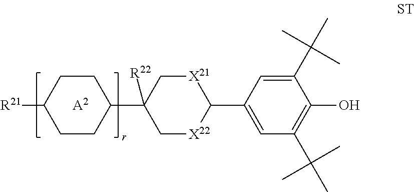

in which the individual substituents have the following meanings:

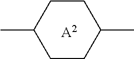

denotes

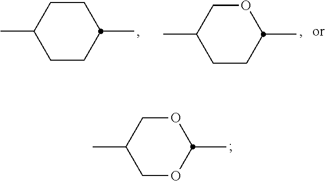

X²¹, X²² each, independently of one another, denote —O—, —CH₂—, —CHR²³—, or —N—R²³—;
R²¹ and R²² each, independently of one another, denote a H atom or an alkyl or alkoxy group having 1 to 12 C atoms, an alkenyl, alkynyl, alkenyloxy, or alkoxyalkyl group having 2 to 12 C atoms, or a cycloalkyl group having 3 to 12 C atoms, in which one or more non-adjacent CH₂ groups are optionally substituted by —C≡C—, —CF₂O—, —OCF₂—, —CH═CH—,

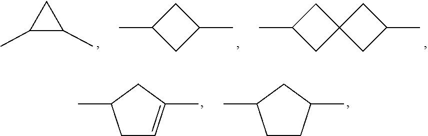

—O—, —CO—O— or —O—CO— in such a way that O atoms are not linked directly to one another, and in which one or more H atoms may be replaced by a halogen atom or a cycloalkyl or a cycloalkoxy group having 3 to 12 C atoms, in which one or more H atoms may be replaced by a halogen atom;
R²³ denotes a H atom or an alkyl or alkoxy group having 1 to 10 C atoms; and
r denotes 0 or 1.

LC media comprising compounds of the following subformulae ST-1, ST-2 and ST-3 showed a particularly high long-term thermal and UV stability:

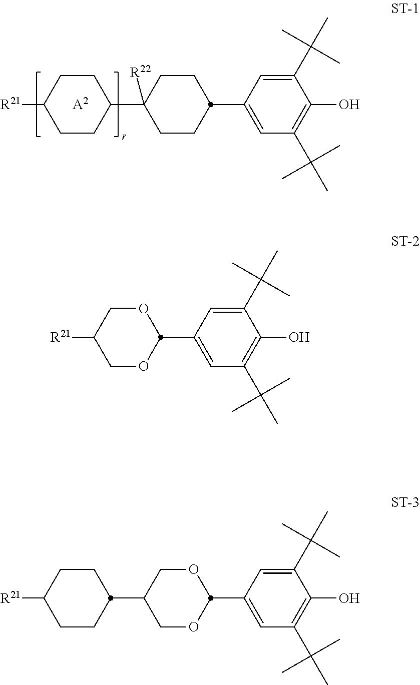

in which the individual substituents have the following meanings:

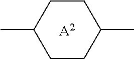

denotes

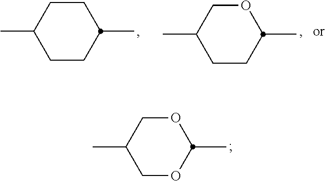

R²¹ and R²² each, independently of one another, denote a H atom or an alkyl or alkoxy group having 1 to 7 C atoms; and
r denotes 0 or 1.

In particularly preferred embodiments, the compounds of general Formula ST can be selected from the following specific structures:

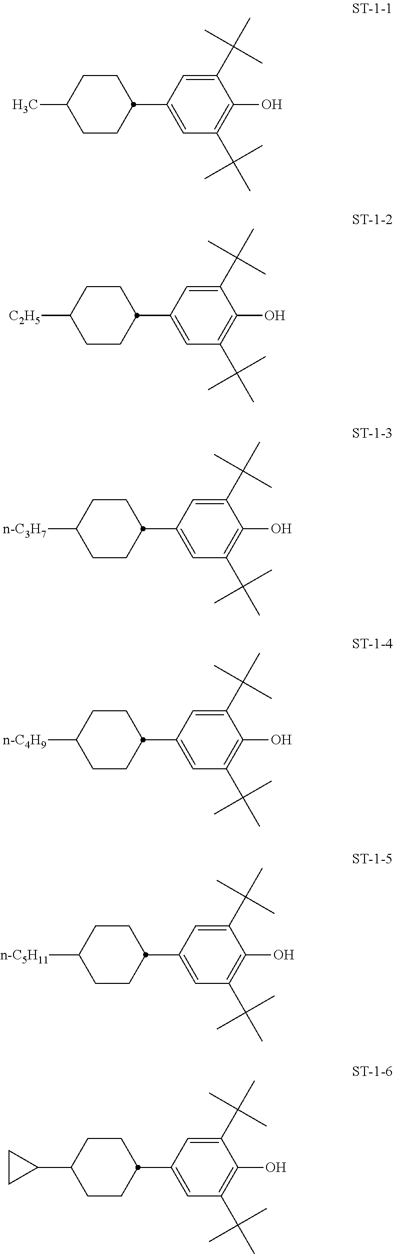

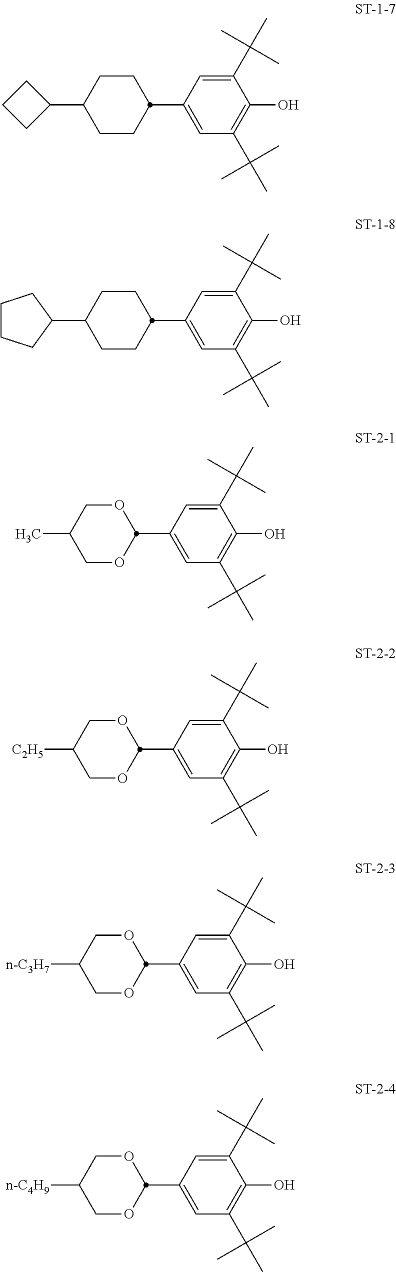

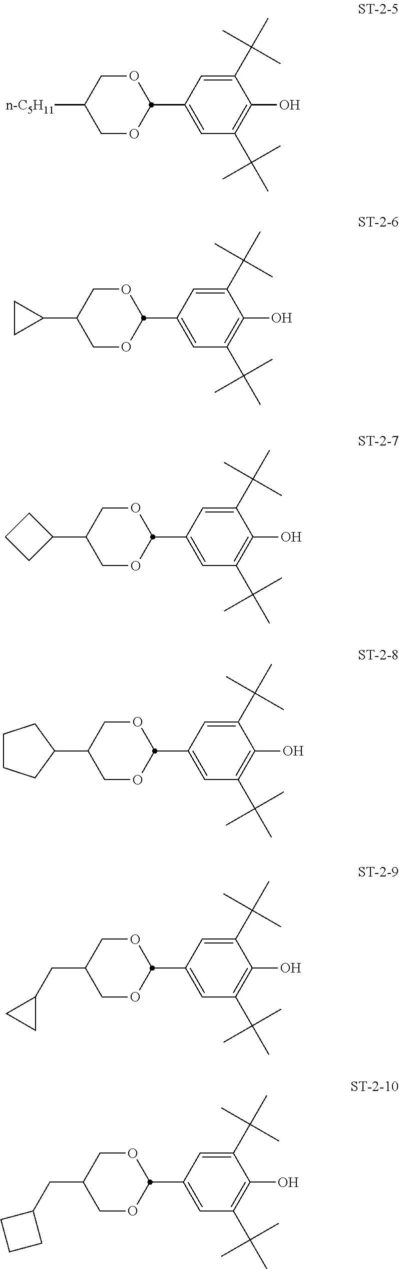

In a further preferred embodiment, the LC medium according to the present invention may comprise at least one further sterically hindered phenol, which is mentioned in Table B below.

### Compounds of Formula H

In some preferred embodiments of the present invention, the LC media may further comprise at least one compound of the Formula H:

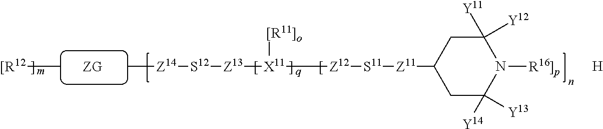

in which
R¹¹ each, independently of one another, denotes a H atom, F, or an alkyl group having 1 to 20 C atoms, in which one —CH₂— group or, if present, a plurality of —CH₂— groups, may be replaced by —O— or —C(═O)—, but two adjacent —CH₂— groups cannot be replaced by —O—, and one or, if present, a plurality of —CH₂— groups may be replaced by —CH═CH— or —C═C—, and in which one H atom or a plurality of H atoms may be replaced by F, OR¹³, N(R¹³)(R¹⁴), or R¹⁵;
R¹² each, independently of one another, denotes a H atom, an alkyl group having 1 to 20 C atoms, in which one —CH₂— group or a plurality of —CH₂— groups may be replaced by —O— or —C(═O)—, but two adjacent —CH₂— groups cannot be replaced by —O—, a hydrocarbon radical which contains a cycloalkyl or alkyl-cycloalkyl unit and in which one —CH₂— group or a plurality of —CH₂— groups may be replaced by —O— or —C(═O)—, but two adjacent —CH₂— groups cannot be replaced by —O—, and in which one H atom or a plurality of H atoms may be replaced by F, OR¹³, N(R¹³)(R¹⁴), R¹⁵, or an aromatic or heteroaromatic hydrocarbon radical, in which one H atom or a plurality of H atoms may be replaced by OR¹³, N(R¹³)(R¹⁴) or R¹⁵;
R¹³ and R¹⁴ each, independently of one another, denotes an alkyl or acyl group having 1 to 10 C atoms or an aromatic hydrocarbon or carboxylic acid radical having 6 to 12 C atoms;
R¹⁵ each, independently of one another, denotes an alkyl group having 1 to 10 C atoms, in which one —CH₂— group or a plurality of —CH₂— groups may be replaced by —O— or —C(═O)—, but two adjacent —CH₂— groups cannot be replaced by —O—;
R¹⁶ each, independently of one another, denotes a H atom, an alkyl group or an alkoxy group having 1 to 10 C atoms, an O-cycloalkyl group having 3 to 12 C atoms, O′, or OH;
S¹¹ and S¹² each, independently of one another, denote an alkylene group having 1 to 20 C atoms, in which one —CH₂— group or, if present, a plurality of —CH₂— groups may be replaced by —O— or —C(═O)—, but two adjacent —CH₂— groups cannot be replaced by —O—, and in which one H atom or a plurality of H atoms may be replaced by F, OR¹³, N(R¹³)(R¹⁴), or R¹⁵, or denote a single bond;
Y¹¹ to Y¹⁴ each, independently of one another, denote methyl or ethyl;
X¹¹ denotes C;
Z¹¹ to Z¹⁴ each, independently of one another, denote —O—, —(C═O)—, —O—(C═O)—, —(C═O)—O—, —O—(C═O)—O—, —(N—R¹³)—, —N—R¹³—(C═O)— or a single bond; if S¹¹ is a single bond, both Z¹¹ and Z¹² do not simultaneously denote —O—; if S¹² is a single bond, both Z¹³ and Z¹⁴ do not simultaneously denote —O—; and, if q denotes 0, both Z¹² and Z¹³ do not simultaneously denote —O—;
p denotes 1 or 2;
q denotes 0 or 1;
o denotes (3-p);
n denotes an integer from 1 to 10;
m denotes an integer from 0 to 8, wherein
n*p denotes an integer from 1 to 10, preferably from 3 to 8, and

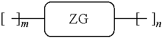

denotes an organic moiety having (m+n) bonding sites.

In some preferred embodiments of the present compounds of the invention, in the denotes

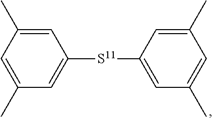

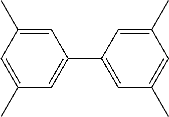 [SMILES: Cc1cc(C)cc(-c2cc(C)cc(C)c2)c1]

(biphenyl-1,1′,3,3′-tetrayl), or
Formula H:

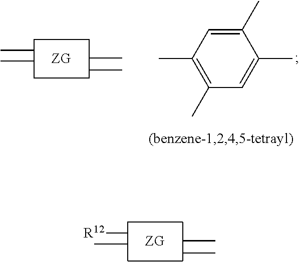

denotes

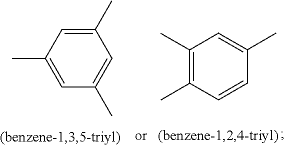

denotes —(CH₂—)₂, —(CH₂—)₃, —(CH₂—)₄, —(CH₂—)₅, —(CH₂—)₆, —(CH₂—)₇, or —(CH₂—)₈, i.e.,

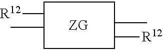

ethane-1,2-diyl, propane-1,3-diyl, butane-1,4-diyl, pentane-1,5-diyl, hexane-1,6-diyl, heptane-1,7-diyl, or octane-1,8-diyl;

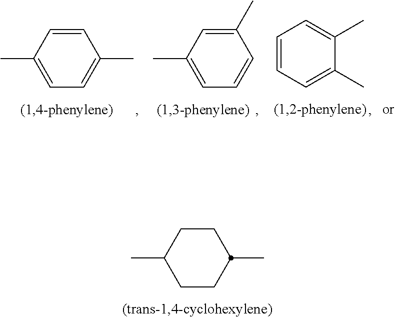

and/or
wherein
-Z¹²-S¹¹-Z¹¹- on each occurrence, independently of one another, denotes —O—, —S¹¹—O—, —O—S¹¹—O—, —(C═O)—O—S¹¹—O—, —O—(C═O)—S¹¹—O—, —O—(C═O)—S¹¹—(C═O)—O—, —O—S¹¹—(C═O)—O—, —(C═O)—O—S¹¹—O—, —(C═O)—O—S¹¹—O—(C═O)—, —(N—R¹³)—S¹¹—O—, —(N—R¹³—C(═O)—S¹¹—(C═O)—O—, or a single bond, preferably —O—, —S¹¹—O—, —O—S¹¹—O—, —(C═O)—O—S¹¹—O—, —O—(C═O)—S¹¹—O—, or —O—S¹¹—(C═O)—O—, and/or
S¹¹ preferably denotes an alkylene group having 1 to 20 C atoms; and/or
R¹¹ if present, denotes alkyl, alkoxy or H, preferably H or alkyl; and/or
R¹¹ denotes H, methyl, ethyl, propyl, isopropyl, 3-heptyl, or cyclohexyl.

In a preferred embodiment of the present application, in the compounds of the Formula H:

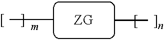

denotes a group selected from the group of the formulae:

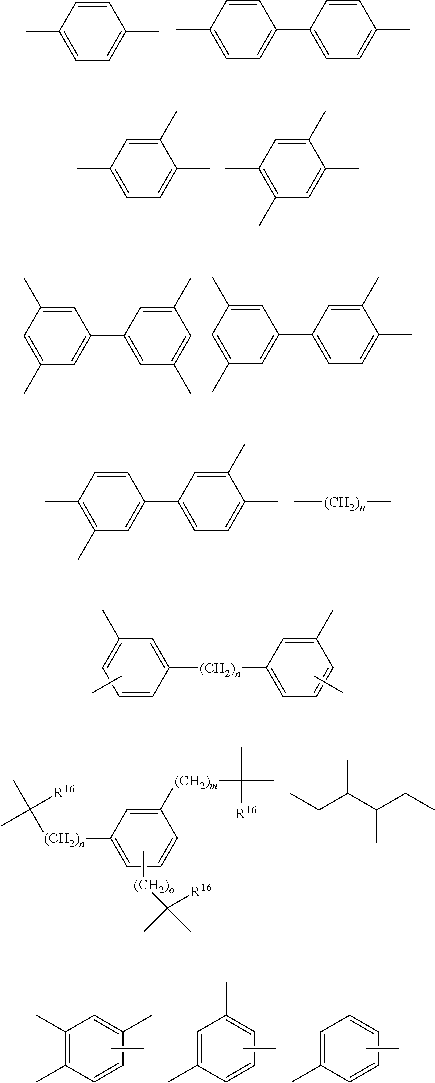

In a further preferred embodiment of the present invention, in the compounds of the Formula H:

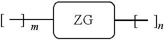

denotes a group selected from the group of the formulae:

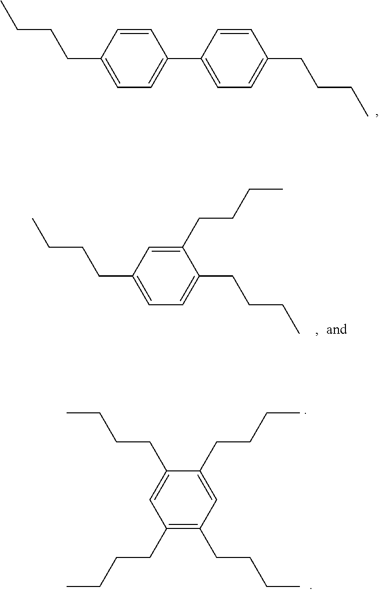

In yet a further preferred embodiment of the present invention, in the compounds of the Formula H in which p preferably denotes 1,

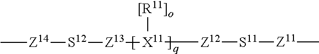

denotes

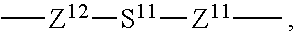

preferably —O—S¹¹—O—, —S¹¹—O— or —O—S¹¹—, particularly preferably —O—S¹¹—O— or —S¹¹—O—.

In a further preferred embodiment of the present invention, in the compounds of the Formula H, the group

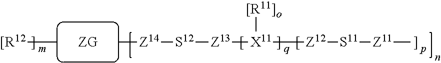

denotes a group selected from the group of the formulae

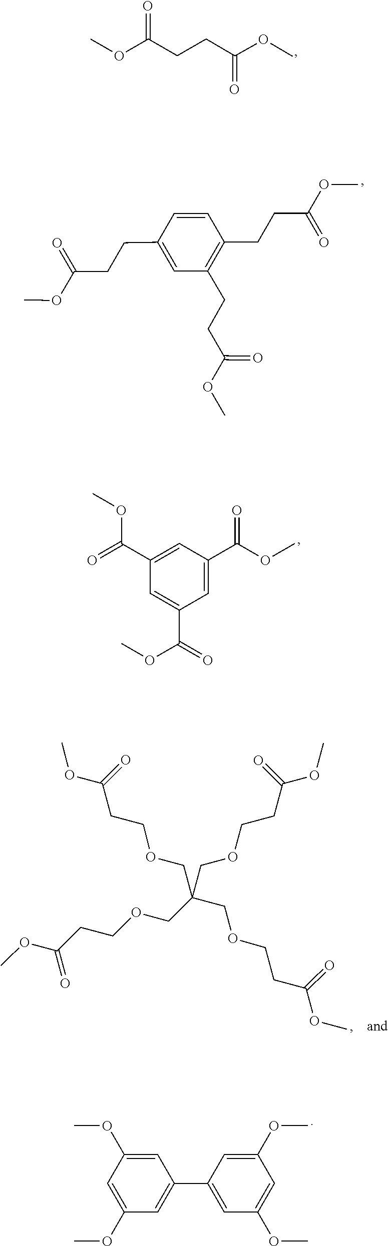

In a further preferred embodiment of the present invention in which p is 2, which may be identical to or different from those described above, in the compounds of the Formula H,

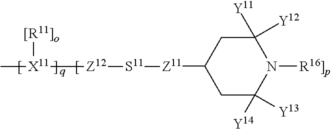

denotes a group selected from the group of the formulae

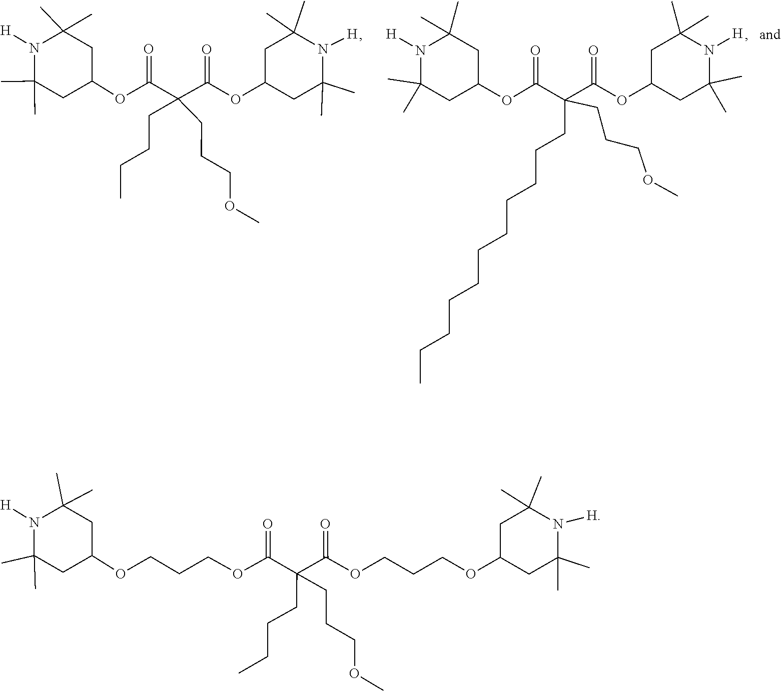

In yet a further preferred embodiment of the present invention, which may be identical to or different from those described above, in the compounds of the Formula H, the group

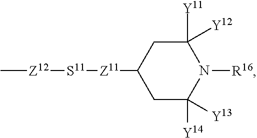

on each occurrence, independently of one another, denotes

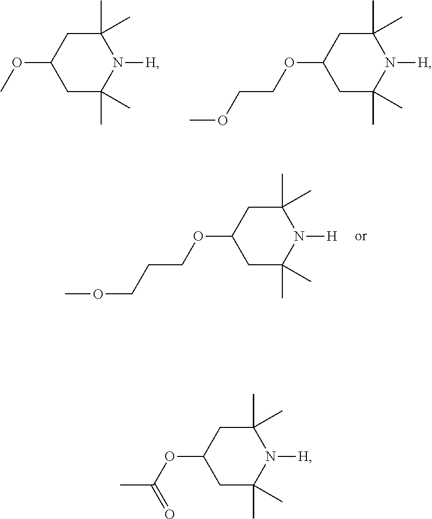

preferably

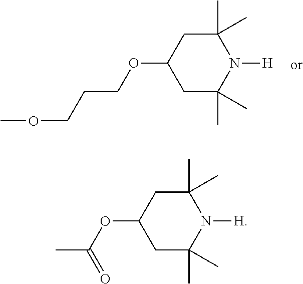

Compounds of the following general Formulae H-1-1, H-1-2, and H-1-3 were shown to be particularly efficient UV stabilizers in the LC media, in particular, in terms of VHR stability:

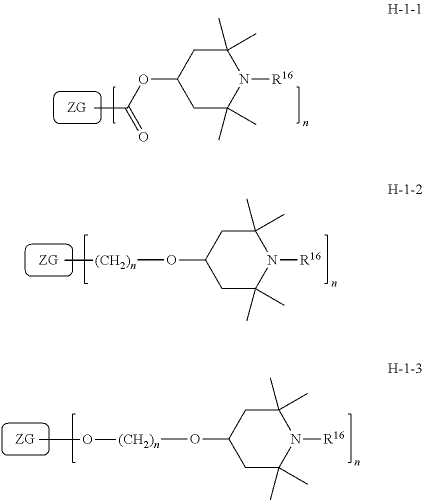

wherein ZG, R¹⁶, and n are as defined above and n denotes an integer from 1 to 8. These compounds are highly suitable as stabilizers in the LC media and stabilize the VHR of the LC media upon a UV exposure.

In a particularly preferred embodiment, the one or more compounds of the Formula H may be selected from the group consisting of the compounds the following Formulae H-2-1 to H-2-6:

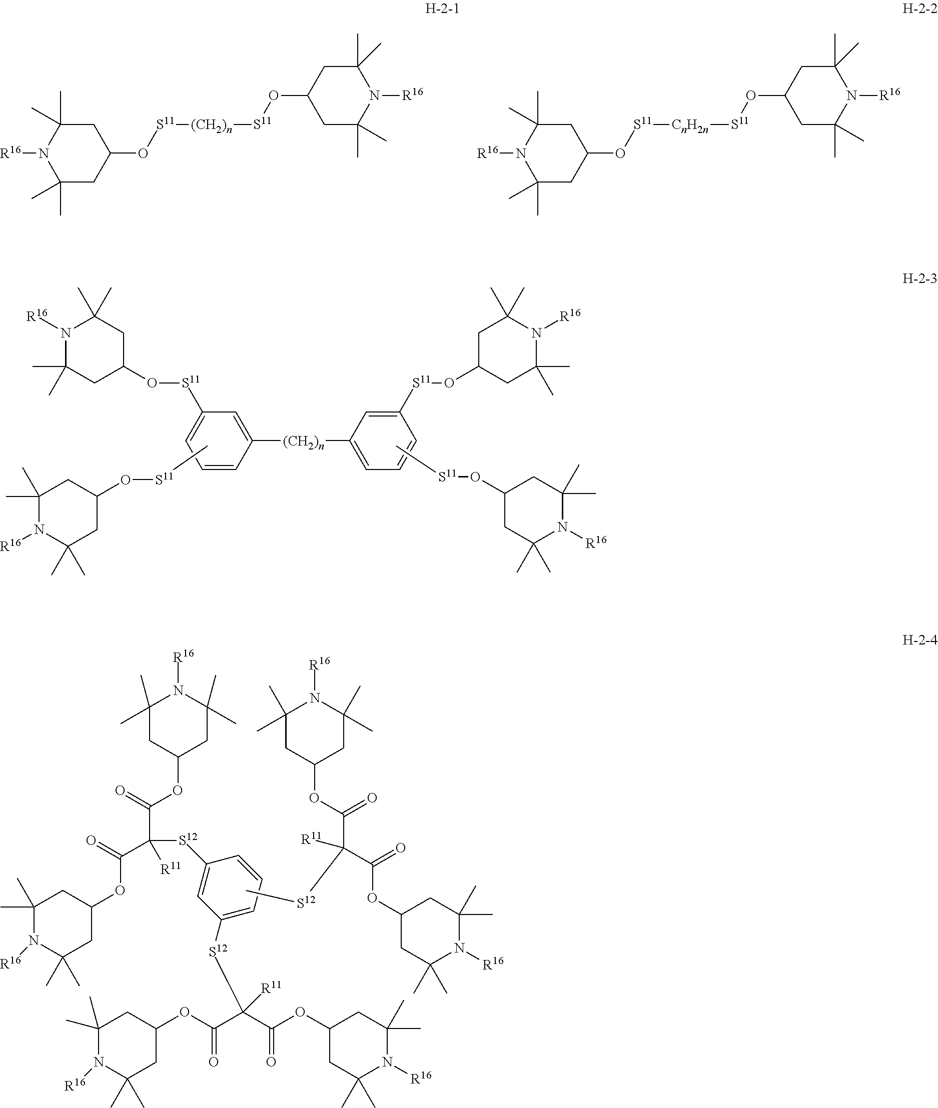

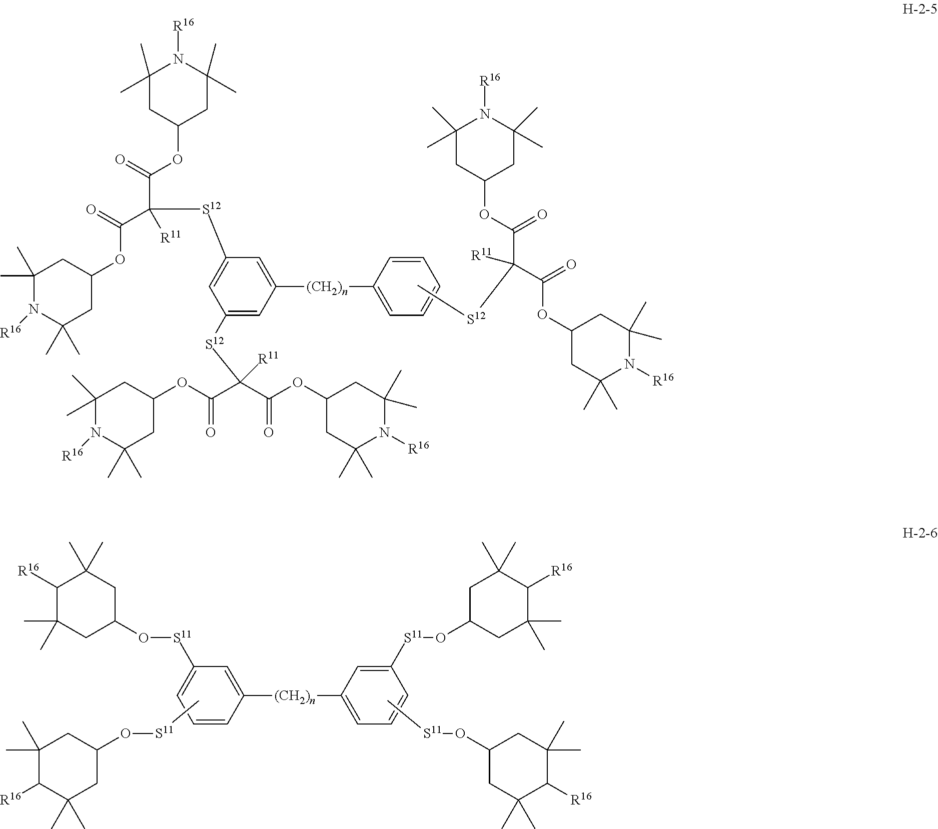

in which
R¹¹ each, independently of one another, denotes an H atom, an alkyl group having 1 to 20 C atoms, in which one —CH₂— group or, if present, a plurality of —CH₂— groups may be replaced by —O— or —C(═O)—, but two adjacent —CH₂— groups cannot be replaced by —O—, and one or, if present, a plurality of —CH₂— groups may be replaced by —CH═CH— or —C═C—, and in which one H atom or a plurality of H atoms may be replaced by F, OR¹³, N(R¹³)(R¹⁴), or R¹⁵;
R¹⁶ denotes a H atom or O*;
n denotes an integer from 0 to 12; and
S¹¹ and S¹² each, independently of one another, denote an alkylene group having 1 to 20 C atoms, in which one —CH₂— group or, if present, a plurality of —CH₂— groups may be replaced by —O— or —C(═O)—, but two adjacent —CH₂— groups cannot be replaced by —O—, and in which one H atom or a plurality of H atoms may be replaced by F, OR¹³, N(R¹³)(R¹⁴), or R¹⁵, or denote a single bond.

In a preferred embodiment of the present invention, the LC media according to the invention comprise in each case one or more compounds of the Formula H selected from the following group of the compounds of the formulae:

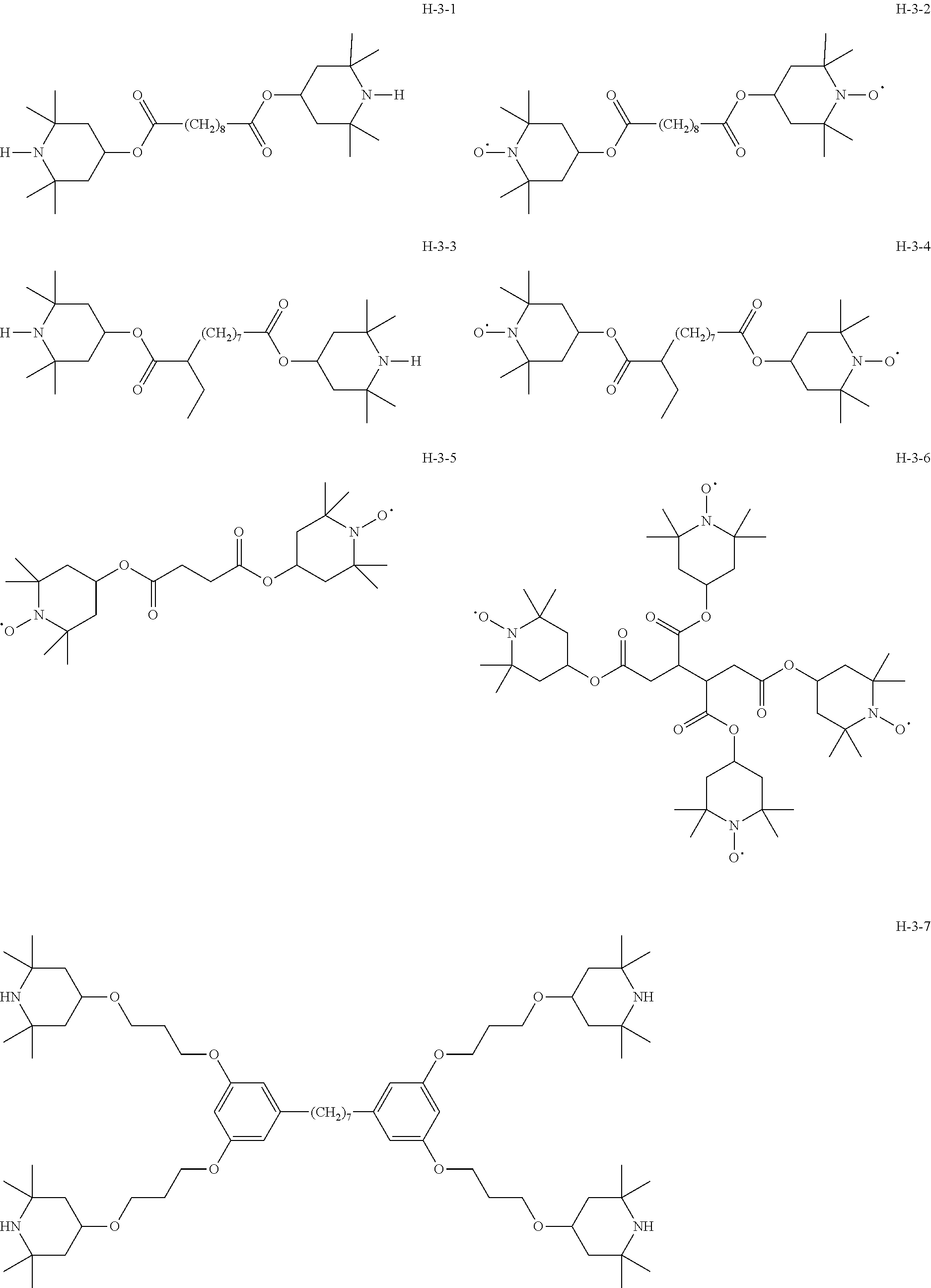

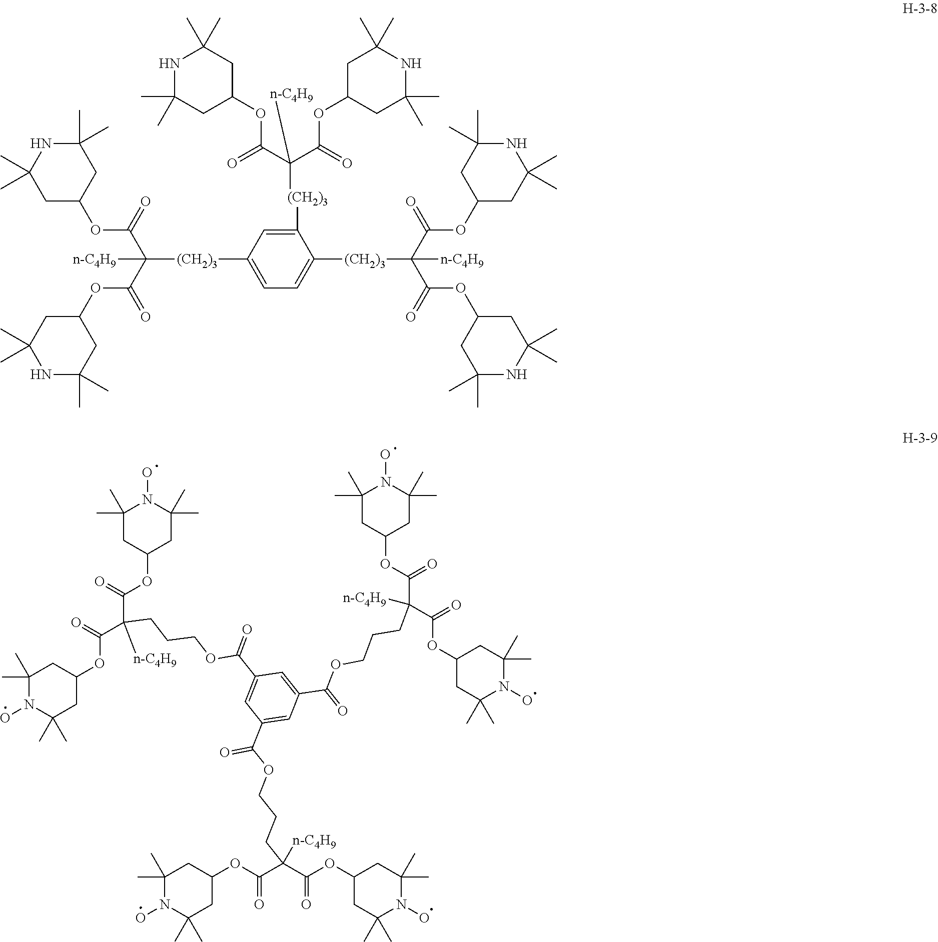

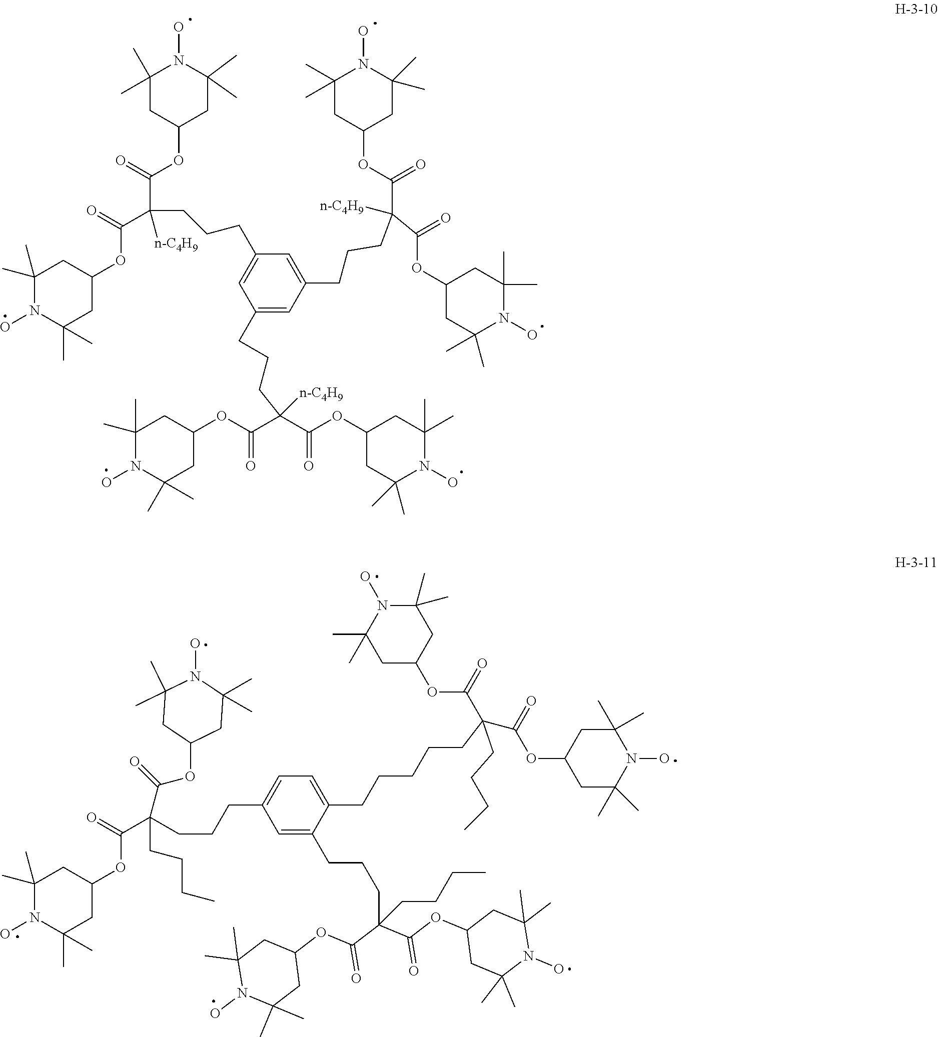

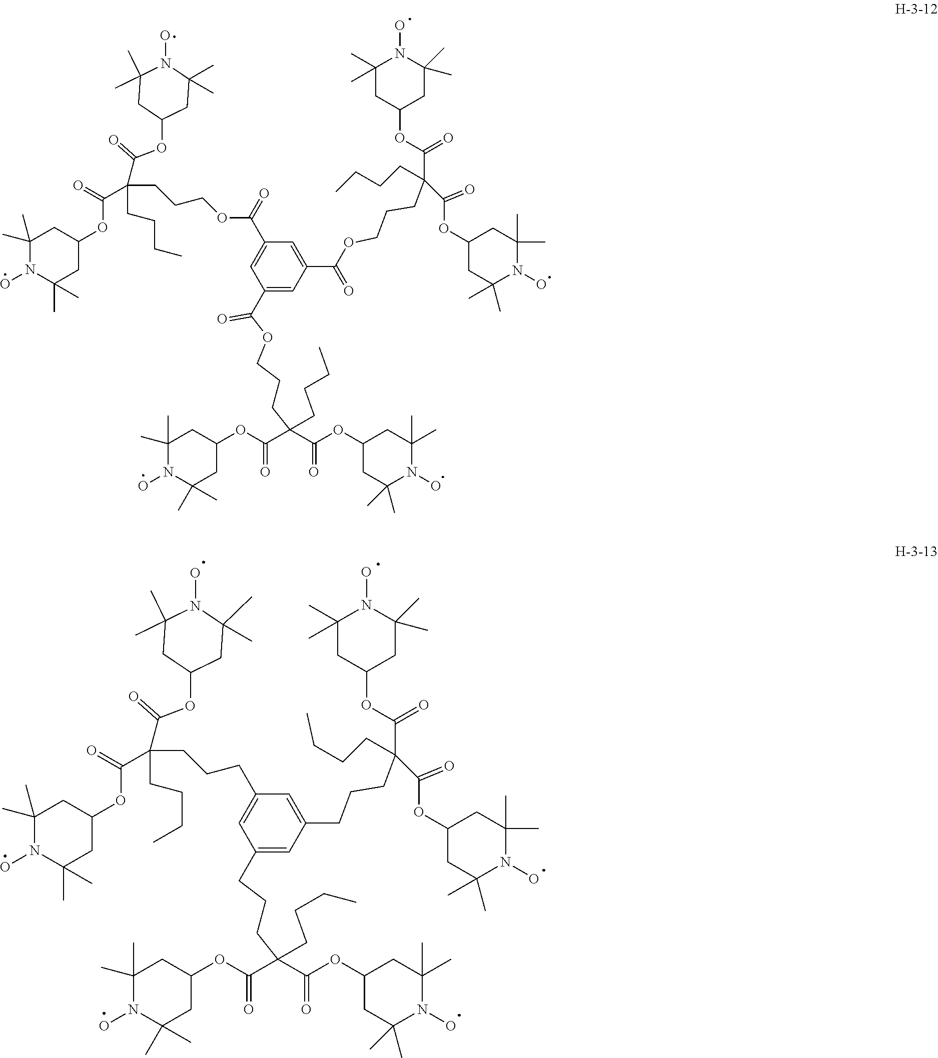

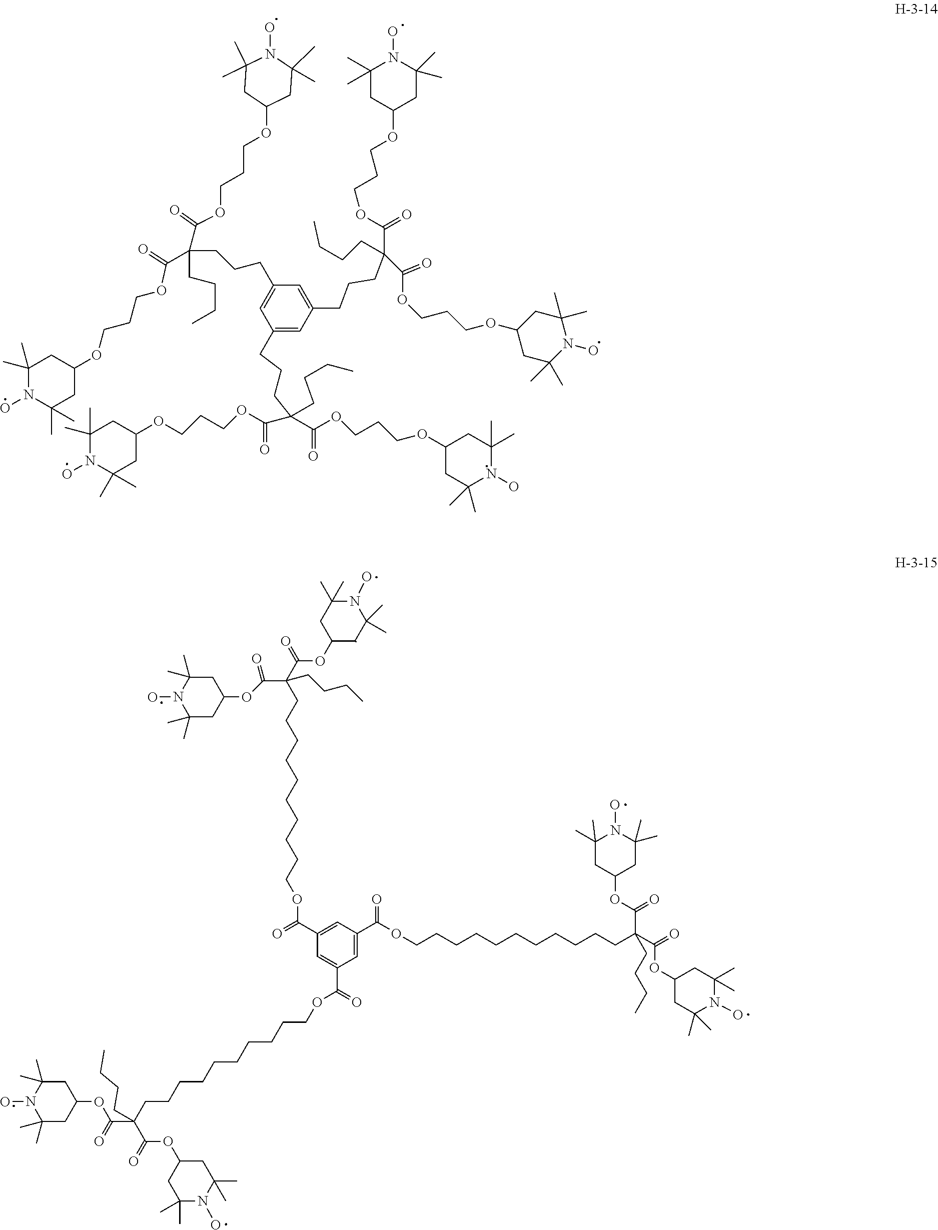

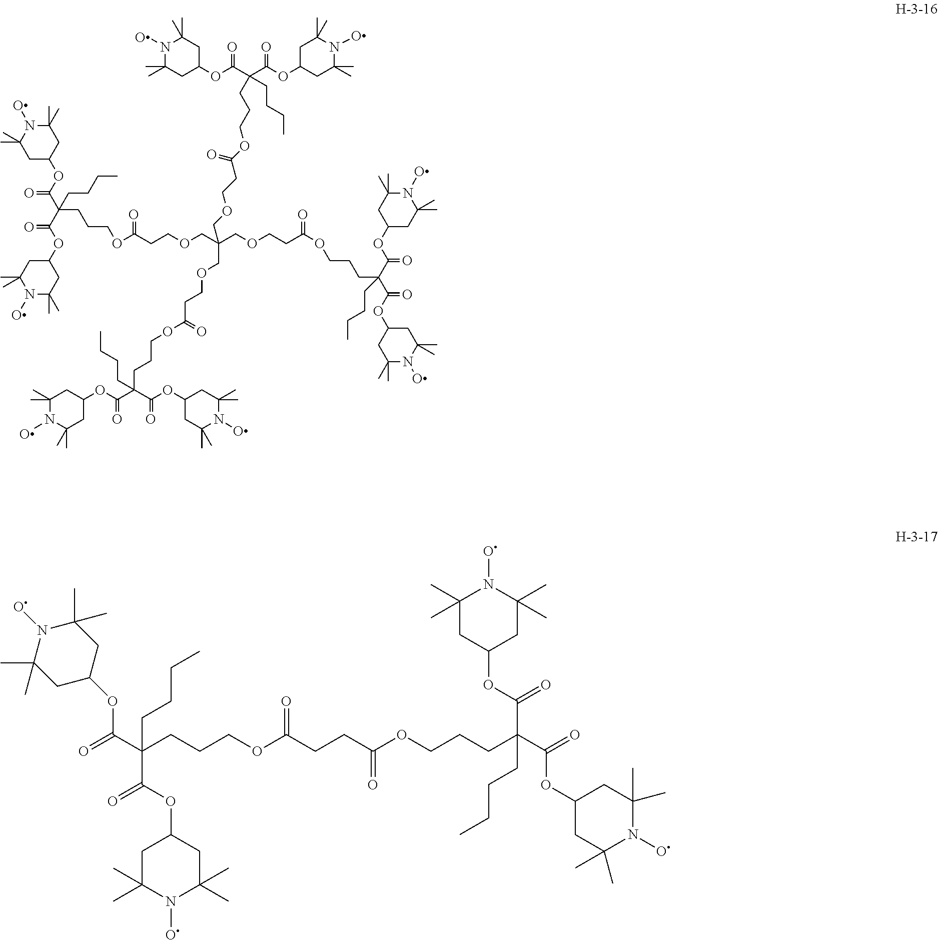

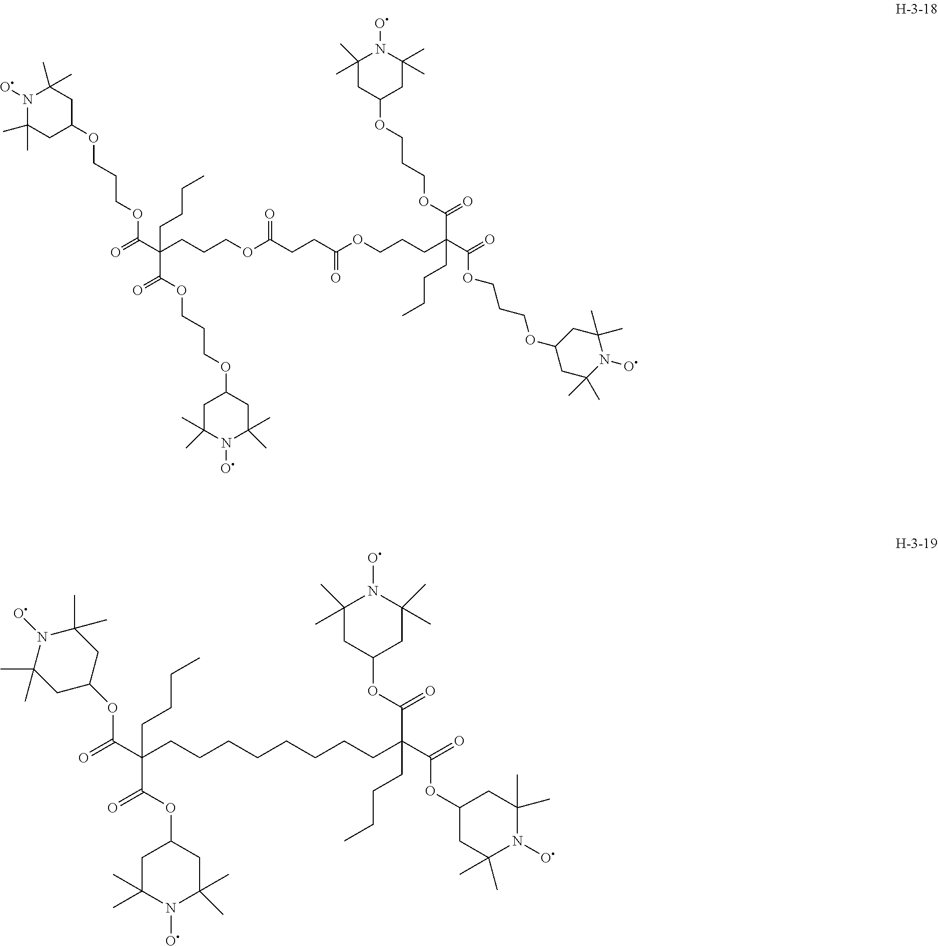

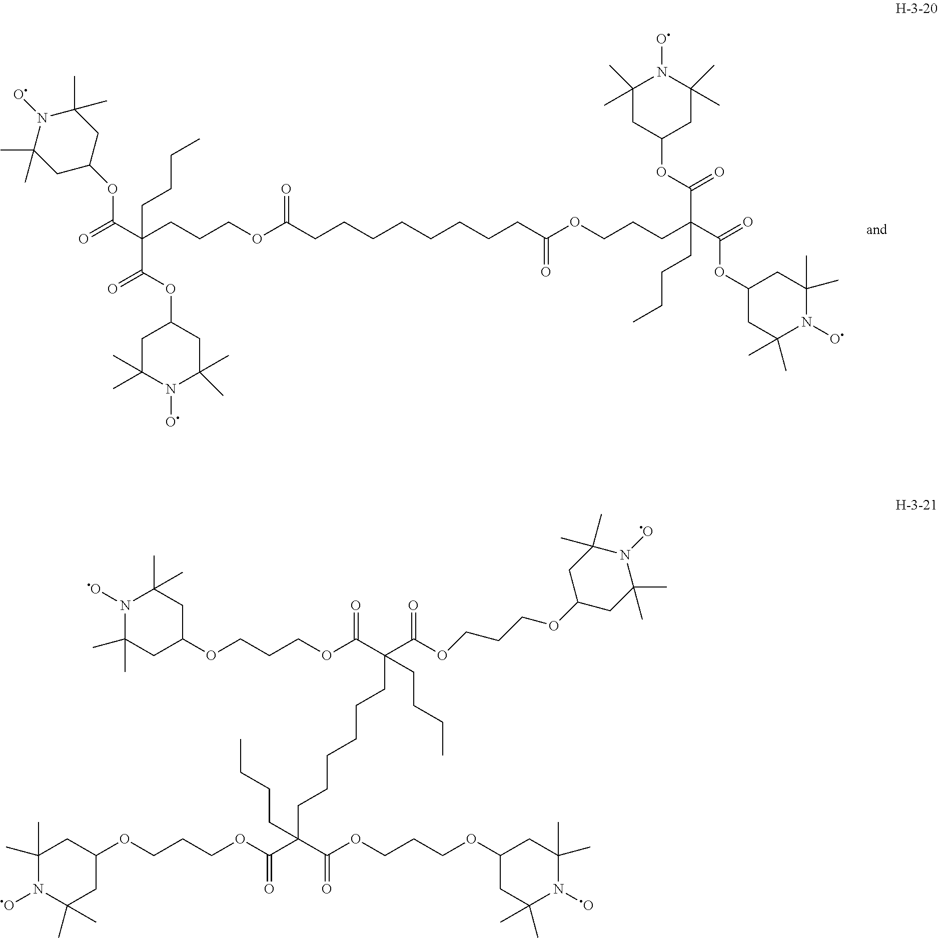

Further preferred LC media are selected from the following preferred embodiments, including any combination thereof:

The total content of compounds of the Formula I in the LC medium is preferably 1 to 35% by weight, preferably 5 to 30% by weight, and particularly preferably 10 to 28% by weight, based on the weight of the LC medium.

It has proved surprisingly advantageous to select the compounds of Formula I in such a way that they can be described in the LC medium of the invention by a single formula selected from I-1-1 to I-1-17 and I-2-1 to Jan. 2, 1953. It is particularly preferred that all compounds of Formula I can be described by one of the following formulae:

I-3-1, I-3-2, I-3-3, I-3-4, I-3-5, I-3-6, I-3-7, I-3-8, I-3-9, I-3-10, I-3-11, I-3-12, I-3-15, I-3-16, I-3-17, I-3-18, I-3-19, I-3-20, I-3-21, and I-3-22.

In some embodiments, the LC medium according to the invention may also comprise at least one, preferably at least two compounds of one of the following formulae: I-3-9-2, I-3-9-3, I-3-9-4, I-3-9-5, I-3-9-6, I-3-9-7, I-3-9-8, I-3-9-9, I-3-22-4, I-3-6-3, and I-3-7-3.

It has been shown that a combination of at least two different compounds of Formula I in the LC medium of the present invention not only has a better solubility than a single compound of Formula I but also exhibits significantly improved stability to UV radiation and elevated temperatures. The stabilizing effect of the compounds of the general Formula H is thereby synergistically enhanced.

If two compounds of Formula I are present in the LC medium of the invention, their weight ratio is preferably between 10:90 and 90:10, particularly preferably between 20:80 and 80:20, even more preferably between 30:70 and 70:30, based on the total weight of the two compounds of Formula I.

The preferred content of the one or more compounds of Formula H in the LC medium depends inter alia on the inherent chemical stability of the LC medium as well as on the nature of the compound of Formula H. Compounds of Formula H in which R¹⁶ denotes O*, which are known as NO radical type HALS, are preferably used in proportion ranging from 50 ppm to 1000 ppm, based on the weight of the LC medium. Compounds of Formula H in which R¹⁶ denotes an H atom, which are known as NH radical type HALS, are advantageously used in proportion ranging from 50 ppm to 2000 ppm, based on the weight of the LC medium.

Further preferred embodiments are as follows:
The LC medium comprises one or more compounds of Formula I or its sub-formulae, a compound of Formula T1 and/or T2 and one or more compounds selected from the group consisting of Formulae Z1, Z2, Z3, Z4, Z5, Y, B, LY, AY, II, III, IV, V, VI, VII, VIII, IX, X, XI, XII, XIII, XIV, XV, XVI, XVIIa, XVIIb, XVIIc, XVIII, XIX, XX, XXI, XII, XXIII, XXIV, XXV, XXVI, XXVII, XXVIII, XXIX, XXX, XXX1, XXX2, XXX3, XXXI, XXXII, XXXIII, XXXIV and their sub-formulae.
The LC medium comprises one or more compounds of Formula I or its sub-formulae, a compound of Formula T1 and/or T2 and one or more compounds selected from the group consisting of Formulae Z1, Z2, Z3, Z4, Z5, Y, B, II, III, IV, VI, IX, X, XIV, XVI, XVIIa, XVIIb, XVIIc, XX, XII, XXIII, XXIX, XXXI, XXXIV and their sub-formulae.
The LC medium comprises one or more compounds of the Formula II, preferably selected from the group consisting of Formulae II-1, II-2, and II-3, very preferably from Formulae II-1 and II-2. The individual concentration of each of these compounds is preferably from 2 to 15% by weight. The total concentration of these compounds is preferably from 5 to 25% by weight.
The LC medium comprises one or more compounds of the Formula III, preferably selected from the group consisting of Formulae III-1, III-4, III-6, III-16, III-19, and III-20, very preferably from the group consisting of Formulae III-1, III-6, III-16, and III-20. The individual concentration of each of these compounds is preferably from 2 to 15% by weight. The total concentration of these compounds is preferably from 5 to 30% by weight.
The LC medium comprises one or more compounds of the Formula IV, preferably selected from Formula IVa or IVc, very preferably from Formula IVa1 or IVc1, most preferably of Formula IVc1. The individual concentration of each of these compounds is preferably from 2 to 15% by weight. The total concentration of these compounds is preferably from 5 to 20% by weight.
The LC medium comprises one or more compounds of the Formula VI, preferably selected from Formula VIb. The individual concentration of each of these compounds is preferably from 1 to 20% by weight. The total concentration of these compounds is preferably from 5 to 20% by weight.
The LC medium comprises one or more compounds of the Formula Z1, preferably selected from Formula Z1-1. The total concentration of these compounds is preferably from 1 to 25% by weight.
The LC medium comprises one or more compounds of the Formula Z2, preferably selected from Formulae Z2-1 and Z2-2. The total concentration of these compounds is preferably from 2 to 35%, very preferably from 3 to 25% by weight.
The LC medium comprises from 5 to 20% by weight of compounds of Formula Z3, preferably of Formula Z3-1.
The LC medium comprises from 5 to 20% by weight of compounds of Formula Z4, preferably of Formula Z4-1.
The LC medium comprises from 10 to 65%, very preferably from 20 to 60% by weight of compounds of Formula Z5.
The LC medium comprises one or more compounds of the Formula XII, preferably of the Formula XIIa or XIIb, very preferably of Formula XIIa, most preferably of Formula XIIa1. The concentration of these compounds is preferably from 2 to 15% by weight.
The LC medium comprises from 1 to 15% by weight of compounds of Formula XIIb.
The LC medium comprises one or more compounds of the Formula XIV, preferably of the Formula XIVd, very preferably of Formula XIVd1. The concentration of these compounds is preferably from 2 to 10% by weight.
The LC medium comprises one or more compounds of the Formula XVIb, preferably of Formula XVIb-1, XVIb-2 and/or XVIb-3. The concentration of these compounds is preferably from 2 to 15% by weight.
The LC medium comprises one or more compounds of the Formula XVIc, preferably of Formula XVIc-1, XVIc-2 and/or XVIc-3. The concentration of these compounds is preferably from 2 to 20% by weight.
The LC medium comprises one or more compounds of the Formula XVIg, preferably of the Formula XVIg-1 and/or XVIg-2. The total concentration of these compounds is preferably from 5 to 25% by weight.
The LC medium comprises one or more compounds selected from the group consisting of the Formulae XVIIa, XVIIb and XVIIc, very preferably of Formula XVIIa wherein L is H and of Formula XVIIb wherein L is F. The total concentration of these compounds is preferably from 0.5 to 5% by weight.
The LC medium comprises one or more compounds of the Formula XX, preferably of the Formula XXa. The concentration of these compounds is preferably from 2 to 10% by weight.
The LC medium comprises one or more compounds of the Formula XXI, preferably of the Formula XXIa. The concentration of these compounds is preferably from 2 to 10% by weight.
The LC medium comprises one or more compounds of the Formula XXIII, preferably of the Formula XXIIIa. The concentration of these compounds is preferably from 0.5 to 5% by weight.
The LC medium comprises one or more compounds of the Formula XXIX, preferably of the Formula XXIXa. The concentration of these compounds is preferably from 2 to 10% by weight.
The LC medium comprises one or more compounds of the Formula XXX, preferably of the Formula XXXa. The concentration of these compounds is preferably from 2 to 10% by weight.
The LC medium comprises one or more compounds of the Formula XXXI. The concentration of these compounds is preferably from 2 to 10% by weight.
The LC medium comprises one or more compounds of the Formula XXXI. The concentration of these compounds is preferably from 2 to 10% by weight.
The LC medium comprises one or more compounds of the Formula XXXIV, preferably of the Formula XXXIVa. The concentration of these compounds is preferably from 1 to 5% by weight.
The LC medium comprises one or more compounds of Formula I, preferably of Formula I-2-6, a compound of Formula T1 and/or T2, one or more compounds selected from the group consisting of the Formulae Z1, Z2, Z3, Z4, Z5, and their sub-formulae, one or more compounds selected from the group consisting of Formula XIV and their sub-formulae, one or more compounds selected from the group consisting of Formulae II, III, IV, VI, XX, XXIII, XXIX, and their sub-formulae, and one or more compounds selected from the group consisting of the Formulae XII, XVI, XVIIa, XVIIb, XVIIc, XXXI, XXXIV, and their sub-formulae.
The LC medium comprises one or more compounds of Formula I, preferably of Formula I-2-6, a compound of Formula T1 and/or T2, one or more compounds selected from the group consisting of the Formulae Z1, Z2, Z3, Z4, Z5, and their sub-formulae, one or more compounds selected from the group consisting of Formulae Z1-1, Z2-2, Z5, XIVd, and their sub-formulae, one or more compounds selected from the group consisting of Formulae II, III, IVc, VIb, XXa, XXIIIa, XXIXa, and their sub-formulae, and one or more compounds selected from the group consisting of the Formulae XIIb, XVIb, XVIc, XVIIa, XVIIb, XVIIc, XXXI, XXXIVa, and their sub-formulae.
The LC medium comprises one or more, preferably two or more, compounds of Formula I, preferably of Formula I-2-6, a compound of Formula T1 and/or T2, one or more compounds selected from the group consisting of the Formulae Z1, Z2, Z3, Z4, Z5, and their sub-formulae, one or more compounds of Formula Y, preferably selected from the group consisting of the Formulae Y1 and Y2, one or more compounds selected from the group consisting of Formula XIV and their sub-formulae, one or more compounds selected from the group consisting of Formulae II, III, IV, VI, XX, XXIII, XXIX, and their sub-formulae, and one or more compounds selected from the group consisting of the Formulae XII, XVI, XVIIa, XVIIb, XVIIc, XXXI, XXXIV, and their sub-formulae.
The LC medium comprises one or more, preferably two or more, compounds of Formula I, preferably of Formula I-2-6, a compound of Formula T1 and/or T2, one or more compounds selected from the group consisting of the Formulae Z1, Z2, Z3, Z4, Z5, and their sub-formulae, one or more compounds of Formula B, preferably selected from the group consisting of the Formulae B1, B2, and B3, one or more compounds selected from the group consisting of Formulae Z1-1, Z2-2, Z5, XIVd, and their sub-formulae, one or more compounds selected from the group consisting of Formulae II, III, IVc, VIb, XXa, XXIIIa, XXIXa, and their sub-formulae, and one or more compounds selected from the group consisting of the Formulae XIIb, XVIb, XVIc, XVIIa, XVIIb, XVIIc, XXXI, XXXIVa, and their sub-formulae.
Besides the compounds of the Formulae I and T1 and/or T2, the LC medium comprises further compounds selected from the group of the compounds of the Formula Z1, Z2, Z3, Z4, Z5, Y, B, IV, XII, XIV, XVI, XVIIa, XVIIb, XVIIc, XXI, XXIII, XXIX, XXX, XXXI, XXIV, and their sub-formulae.
Besides the compounds of the Formulae I and T1 and/or T2, the LC medium comprises further compounds selected from the group of the compounds of the Formula Z1, Z2, Z3, IV, XII, XIV, XVI, XVIIa, XVIIb, XVIIc, XXI, XXIII, XXIX, XXX, XXXI, XXIV, and their sub-formulae.
The proportion of compounds of Formula I or its sub-formulae in the LC medium is from 1 to 30%, very preferably from 2 to 25%, most preferably from 2 to 20% by weight.
The proportion of compounds of the Formula Z1, Z2 and Z3 or their sub-formulae in the LC medium as a whole is from 10 to 65%, very preferably from 20 to 60%.
The proportion of compounds of the Formula Y or its sub-formulae in the LC medium as a whole is from 1 to 20%, very preferably from 2 to 15%.
The proportion of compounds of the Formula B or its sub-formulae in the LC medium as a whole is from 1 to 20%, very preferably from 2 to 18%.
The proportion of compounds of the Formulae II, III, IV-VIII, XVIII-XXIII, and XXVII-XXX in the LC medium as a whole is 30 to 60% by weight.
The proportion of compounds of the Formulae IX-XV in the LC medium as a whole is 40 to 70% by weight.
The proportion of compounds of the Formulae XIV, XVIIa-c, and XXXI-XXXIV in the LC medium as a whole is 0.5 to 15% by weight.

The term “alkyl” or “alkyl*” in this application encompasses straight-chain and branched alkyl groups having 1 to 6 or 3 to 6 carbon atoms, in particular the straight-chain groups methyl, ethyl, propyl, butyl, pentyl, and hexyl. Groups having 2 to 5 carbon atoms are generally preferred.

The term “alkenyl” or “alkenyl*” encompasses straight-chain and branched alkenyl groups having 2 to 6 or 3 to 6 carbon atoms, in particular the straight-chain groups. Preferred alkenyl groups are C₂-C₇-1E-alkenyl, C₄-C₆-3E-alkenyl, in particular C₂-C₆-1E-alkenyl. Examples of particularly preferred alkenyl groups are vinyl, 1E-propenyl, 1E-butenyl, 1E-pentenyl, 1E-hexenyl, 3-butenyl, 3E-pentenyl, 3E-hexenyl, 4-pentenyl, 4Z-hexenyl, 4E-hexenyl, and 5-hexenyl. Groups having up to 5 carbon atoms are generally preferred, in particular CH₂═CH and CH₃CH═CH.

The term “fluoroalkyl” preferably encompasses straight-chain groups having a terminal fluorine, i.e., fluoromethyl, 2-fluoroethyl, 3-fluoropropyl, 4-fluorobutyl, 5-fluoropentyl, 6-fluorohexyl, and 7-fluoroheptyl. However, other positions of the fluorine are not excluded.

The term “oxaalkyl” or “alkoxy” preferably encompasses straight-chain groups of the formula CₙH₂ₙ₊₁—O—(CH₂)ₘ, in which n and m each, independently of one another, denote 1 to 6. m may also denote 0. Preferably, n=1 and m=1-6 or m=0 and n=1-3. Further preferably the alkoxy or oxaalkyl group can also contain one or more further O atoms such that oxygen atoms are not directly linked to one another.

Through a suitable choice of the meanings of R⁰ and X⁰, the addressing times, the threshold voltage, the steepness of the transmission characteristic lines, etc., can be modified in the desired manner. For example, 1E-alkenyl groups, 3E-alkenyl groups, 2E-alkenyloxy groups, and the like generally result in shorter addressing times, improved nematic tendencies and a higher ratio between the elastic constants K₃ (bend) and K₁ (splay) compared with alkyl and alkoxy groups. 4-alkenyl groups, 3-alkenyl groups, and the like generally give lower threshold voltages and lower values of K₃/K₁ compared with alkyl and alkoxy groups. The LC media according to the invention are distinguished, in particular, by high Δε values and thus have significantly faster response times than the LC media from the prior art.

The optimum mixing ratio of the compounds of the above-mentioned formulae depends substantially on the desired properties, on the choice of the components of the above-mentioned formulae, and on the choice of any further components that may be present.

Suitable mixing ratios within the range indicated above can easily be determined from case to case.

The total amount of compounds of the above-mentioned formulae in the LC media according to the invention is not crucial. The LC media can therefore comprise one or more further components for the purposes of optimisation of various properties. However, the observed effect on the desired improvement in the properties of the medium is generally greater, the higher the total concentration of compounds of the above-mentioned formulae.

In a particularly preferred embodiment, the LC media according to the invention comprise compounds of the Formulae IV to VIII (preferably IV and V) in which X⁰ denotes F, OCF₃, OCHF₂, OCH═CF₂, OCF═CF₂, or OCF₂—CF₂H. A favourable synergistic action with the compounds of the Formulae I, T1 and/or T2 results in particularly advantageous properties. In particular, LC media comprising compounds of the Formulae I, T1 and/or T2, II, and III are distinguished by their low threshold voltage.

The individual compounds of the above-mentioned formulae and the sub-formulae thereof which can be used in the LC media according to the invention are either known or can be prepared analogously to the known compounds.

The invention also relates to a process for the preparation of a LC medium as described above and below, by mixing one or more compounds of the Formula I with one or more compounds of the Formulae Y1, Y2, or Y3, one or more compounds of Formula B, and one or more compounds selected from the group consisting of Formulae II, III, IV, VI, XIV, XII, XVI, XVIIa, XVIIb, XVIIc, XX, XXIII, XXIX, XXXI, and XXXIV.

In another preferred embodiment of the present invention, the LC medium additionally comprises one or more polymerizable compounds. The polymerizable compounds are preferably selected from Formula M

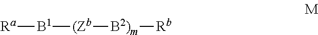

in which the individual groups, on each occurrence identically or differently, and each, independently of one another, have the following meaning:
R^{a} and R^{b} denote P, P-Sp-, H, F, Cl, Br, I, —CN, —NO₂, —NCO, —NCS, —OCN, —SCN, SF₅, or straight-chain or branched alkyl having 1 to 25 or 3 to 25 C atoms, in which, in addition, one or more non-adjacent CH₂ groups may each be replaced, independently of one another, by —C(R⁰)═C(R⁰⁰)—, —C═C—, —N(R⁰⁰)—, —O—, —S—, —CO—, —CO—O—, —O—CO—, or —O—CO—O— in such a way that O and/or S atoms are not linked directly to one another, and in which, in addition, one or more H atoms may be replaced by F, Cl, Br, I, CN, P, or P-Sp-, where, if B¹ and/or B² contain a saturated C atom, R^{a} and/or R^{b} may also denote a group which is spiro-linked to this saturated C atom;
wherein at least one of the groups Ra and Rb denotes or contains a group P or P-Sp-, wherein
P denotes a polymerizable group;
Sp denotes a spacer group or a single bond;
B¹ and B² denotes an aromatic, heteroaromatic, alicyclic, or heterocyclic group, preferably having 4 to 25 ring atoms, which may also contain fused rings, and which is unsubstituted or mono- or poly-substituted by L;
Z^{b} denotes —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, CR⁰R⁰⁰, or a single bond;
R⁰ and R⁰⁰ each, independently of one another, denote H or alkyl having 1 to 12 C atoms;
m denotes 0, 1, 2, 3, or 4;
n1 denotes 1, 2, 3, or 4,
L denotes P, P-Sp-, OH, CH₂OH, F, Cl, Br, I, —CN, —NO₂, —NCO, —NCS, —OCN, —SCN, —C(═O)N(Rₓ)₂, —C(═O)Y₁, —C(═O)Rₓ, —N(Rₓ)₂, optionally substituted silyl, optionally substituted aryl having 6 to 20 C atoms, or straight-chain or branched alkyl, alkoxy, alkylcarbonyl, alkoxycarbonyl, alkylcarbonyloxy, or alkoxycarbonyloxy having 1 to 25 or 3 to 25 C atoms, in which, in addition, one or more H atoms may be replaced by F, Cl, P, or P-Sp-;
P and Sp have the meanings indicated above;
Y¹ denotes halogen; and
R^{x} denotes P, P-Sp-, H, halogen, or straight-chain, branched, or cyclic alkyl having 1 to 25 or 3 to 25 C atoms, in which, in addition, one or more non-adjacent CH₂ groups may be replaced by —O—, —S—, —CO—, —CO—O—, —O—CO—, or —O—CO—O— in such a way that O and/or S atoms are not linked directly to one another, and in which, in addition, one or more H atoms may be replaced by F, Cl, P, or P-Sp-, an optionally substituted aryl or aryloxy group having 6 to 40 C atoms, or an optionally substituted heteroaryl or heteroaryloxy group having 2 to 40 C atoms.

Particularly preferred compounds of the Formula M are those in which B1 and B2 each, independently of one another, denote 1,4-phenylene, 1,3-phenylene, naphthalene-1,4-diyl, naphthalene-2,6-diyl, phenanthrene-2,7-diyl, 9,10-dihydro-phenanthrene-2,7-diyl, anthracene-2,7-diyl, fluorene-2,7-diyl, coumarine, or flavone, where, in addition, one or more CH groups in these groups may be replaced by N, cyclohexane-1,4-diyl, in which, in addition, one or more non-adjacent CH₂ groups may be replaced by O and/or S, 1,4-cyclohexenylene, bicycle-[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl, or octahydro-4,7-methanoindane-2,5-diyl, where all these groups may be unsubstituted or mono- or poly-substituted by L as defined above.

Particularly preferred compounds of the Formula M are those in which B1 and B2 each, independently of one another, denote 1,4-phenylene, 1,3-phenylene, naphthalene-1,4-diyl, or naphthalene-2,6-diyl.

Very preferred compounds of Formula M are selected from the following formulae:

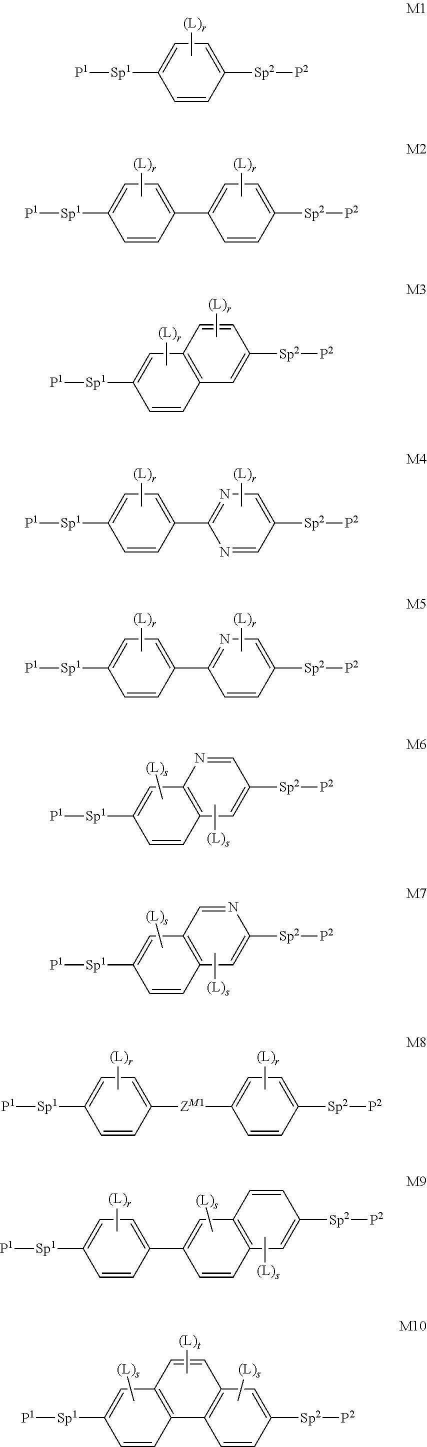

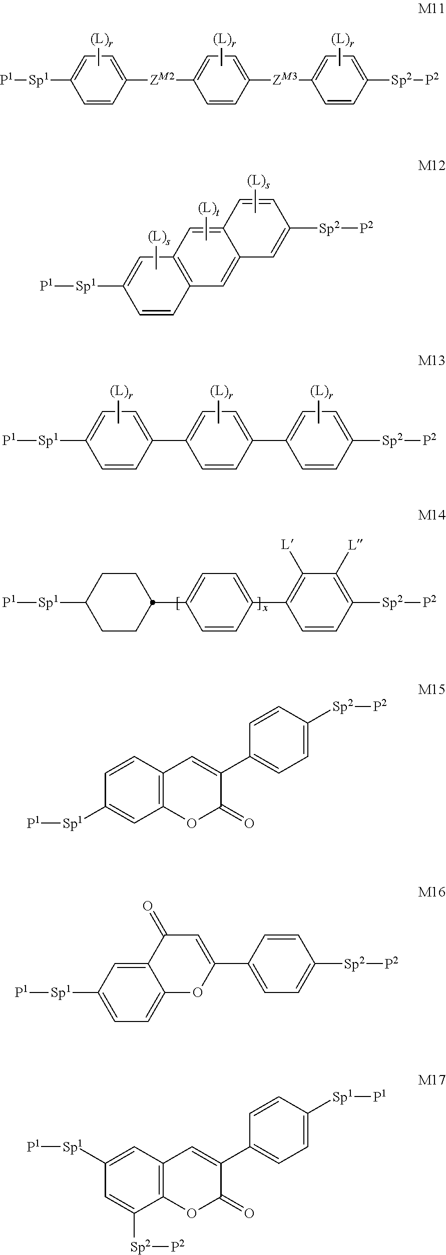

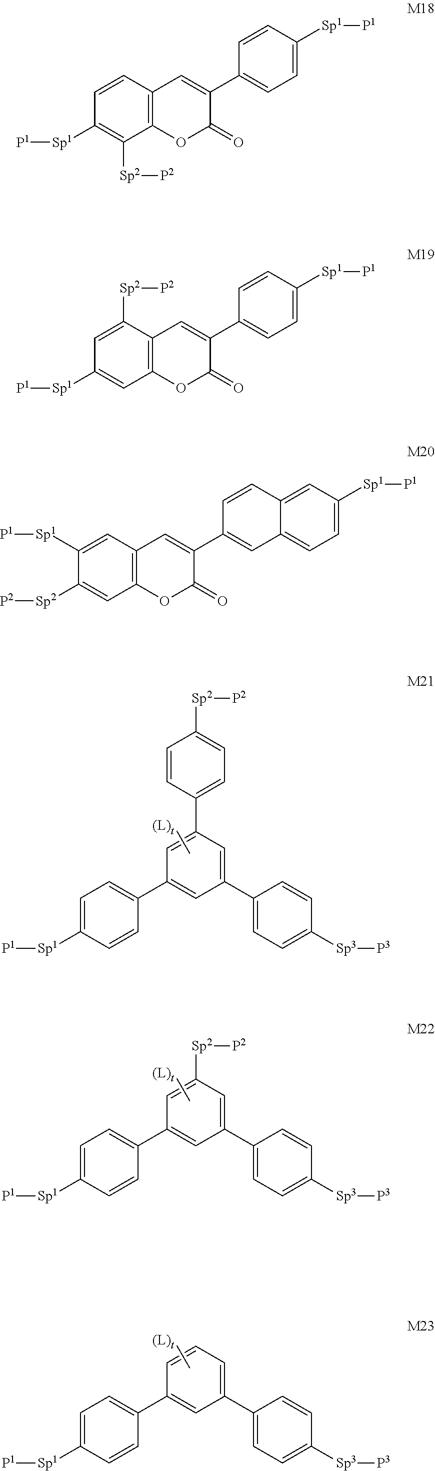

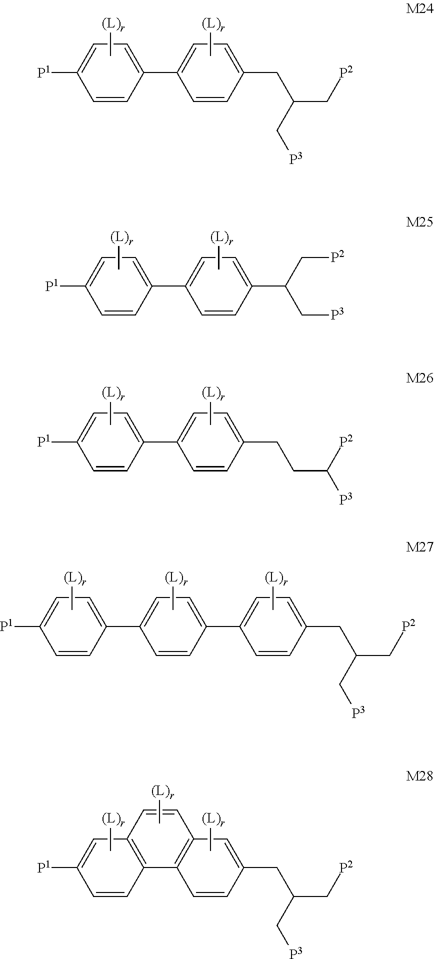

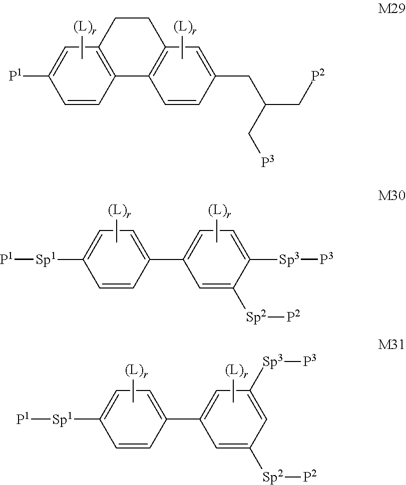

in which the individual groups, on each occurrence identically or differently, and each, independently of one another, have the following meaning:
P¹, P², P³ denote a polymerizable group, preferably selected from vinyloxy, acrylate, methacrylate, fluoroacrylate, chloroacrylate, oxetane, and epoxy,
Sp¹, Sp², Sp³ denote a single bond or a spacer group where, in addition, one or more of the groups P¹-Sp¹—, P²-Sp²—, and P³-Sp³- may denote R^{aa}, with the proviso that at least one of the groups P¹-Sp¹-, P²-Sp², and P³-Sp³-present is different from R^{aa}, preferably —(CH₂)ₚ₁—, —(CH₂)ₚ₁—O—, —(CH₂)ₚ₁—CO—O—, or —(CH₂)ₚ₁—O—CO—O—, wherein p1 is an integer from 1 to 12;
R^{aa} denotes H, F, Cl, CN, or straight-chain or branched alkyl having 1 to 25 C atoms, in which, in addition, one or more non-adjacent CH₂ groups may each be replaced, independently of one another, by —C(R⁰)═C(R⁰⁰)—, —C═C—, —N(R⁰)—, —O—, —S—, —CO—, —CO—O—, —O—CO—, or —O—CO—O— in such a way that O and/or S atoms are not linked directly to one another, and in which, in addition, one or more H atoms may be replaced by F, Cl, CN, or P¹-Sp¹—, particularly preferably straight-chain or branched, optionally mono- or poly-fluorinated alkyl, alkoxy, alkenyl, alkynyl, alkylcarbonyl, alkoxycarbonyl, alkylcarbonyloxy, or alkoxycarbonyloxy having 1 to 12 or 3 to 12 C atoms (where the alkenyl and alkynyl groups have at least two C atoms and the branched groups have at least three C atoms);
R⁰, R⁰⁰ denote H or alkyl having 1 to 12 C atoms;
R^{y} and R^{z} denote H, F, CH₃, or CF₃;
X¹, X², X³ denote —CO—O—, —O—CO—, or a single bond;
Z^{M1} denotes —O—, —CO—, —C(R^{y}R^{z})— or —CF₂CF₂—;
Z^{M2}, Z^{M3} denote —CO—O—, —O—CO—, —CH₂O—, —OCH₂—, —CF₂O—, —OCF₂—, or —(CH₂)ₙ—, where n is 2, 3, or 4;
L denotes F, Cl, CN, or straight-chain or branched, optionally mono- or poly-fluorinated alkyl, alkoxy, alkenyl, alkynyl, alkylcarbonyl, alkoxycarbonyl, alkylcarbonyloxy, or alkoxycarbonyloxy having 1 to 12 or 3 to 12 C atoms;
L′, L″ denote H, F, or Cl;
r denotes 0, 1, 2, 3, or 4;
S denotes 0, 1, 2, or 3;
t 0, 1, or 2; and
X 0 or 1.

Especially preferred are compounds of Formulae M2 and M13.

Further preferred are trireactive compounds M15 to M31, in particular M17, M18, M19, M22, M23, M24, M25, M30, and M31.

In the compounds of Formulae M1 to M31, the group

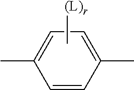

is preferably

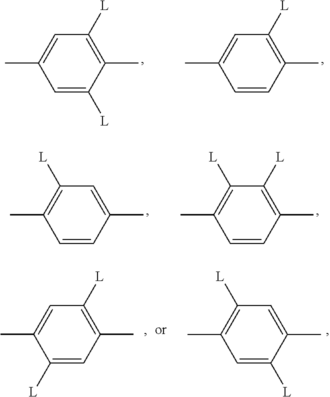

wherein L on each occurrence, identically or differently, has one of the meanings given above or below, and is preferably F, Cl, CN, NO₂, CH₃, C₂H₅, C(CH₃)₃, CH(CH₃)₂, CH₂CH(CH₃)C₂H₅, OCH₃, OC₂H₅, COCH₃, COC₂H₅, COOCH₃, COOC₂H₅, CF₃, OCF₃, OCHF₂, OC₂F₅, or P-Sp-, very preferably F, Cl, CN, CH₃, C₂H₅, OCH₃, COCH₃, OCF₃, or P-Sp-, more preferably F, Cl, CH₃, OCH₃, COCH₃, or OCF₃, especially F or CH₃.

Preferred compounds of Formulae M1 to M31 are those wherein P¹, P², and P³ denote an acrylate, methacrylate, oxetane, or epoxy group, very preferably an acrylate or methacrylate group.

Further preferred compounds of Formulae M1 to M31 are those wherein Sp¹, Sp², and Sp³ are a single bond.

Further preferred compounds of Formulae M1 to M31 are those wherein one of Sp¹, Sp², and Sp³ is a single bond and another one of Sp¹, Sp², and Sp³ is different from a single bond.

Further preferred compounds of Formulae M1 to M31 are those wherein those groups Sp¹, Sp², and Sp³ that are different from a single bond denote —(CH₂)ₛ₁—X″—, wherein s1 is an integer from 1 to 6, preferably 2, 3, 4, or 5, and X″ is the linkage to the benzene ring and is —O—, —O—CO—, —CO—O—, —O—CO—O—, or a single bond.

Particular preference is given to LC media comprising one, two or three polymerizable compounds of Formula M, preferably selected from Formulae M1 to M31.

Further preferably the LC media according to the present invention comprise one or more polymerizable compounds selected from Table E below.

Preferably, the proportion of polymerizable compounds in the LC medium, preferably selected from Formula M and Table E, is from 0.01 to 5%, very preferably from 0.05 to 1%, most preferably from 0.1 to 0.5%.

It was observed that the addition of one or more polymerizable compounds to the LC medium, like those selected from Formula M and Table E, leads to advantageous properties like fast response times. Such a LC medium is especially suitable for use in PSA displays where it shows low image sticking, a quick and complete polymerization, the quick generation of a low pretilt angle which is stable after UV exposure, a high reliability, high VHR value after UV exposure, and a high birefringence. By appropriate selection of the polymerizable compounds, it is possible to increase the absorption of the LC medium at longer UV wavelengths, so that it is possible to use such longer UV wavelengths for polymerization, which is advantageous for the display manufacturing process.

The polymerizable group P is a group which is suitable for a polymerization reaction, such as, for example, free-radical or ionic chain polymerization, polyaddition or polycondensation, or for a polymer-analogous reaction, for example addition or condensation onto a main polymer chain. Particular preference is given to groups for chain polymerization, in particular those containing a C═C double bond or —C≡C— triple bond, and groups which are suitable for polymerization with ring opening, such as, for example, oxetane or epoxide groups.

Preferred groups P are selected from the group consisting of CH₂═CW¹—CO—O—, CH₂═CW¹—CO—,

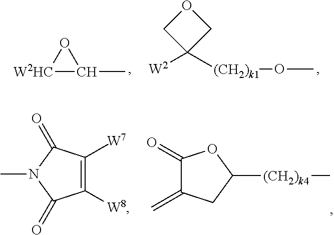

CH₂═CW²—(O)ₖ₃—, CW¹═CH—CO—(O)ₖ₃—, CW¹═CH—CO—NH—, CH₂═CW¹—CO—NH—, CH₃—CH═CH—O—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)₂N—CO—, HO—CW²W³—, HS—CW²W³—, HW²N—, HO—CW²W³—NH—, CH₂═CW¹—CO—NH—, CH₂═CH—(COO)ₖ₁-Phe-(O)ₖ₂—, CH₂═CH—(CO)ₖ₁-Phe-(O)ₖ₂—, Phe-CH═CH—, HOOC—, OCN— and W⁴W⁵W⁶Si—, in which W¹ denotes H, F, Cl, CN, CF₃, or phenyl or alkyl having 1 to 5 C atoms, in particular H, F, Cl, or CH₃, W² and W³ each, independently of one another, denote H or alkyl having 1 to 5 C atoms, in particular H, methyl, ethyl, or n-propyl, W⁴, W⁵, and W⁶ each, independently of one another, denote Cl, oxaalkyl, or oxacarbonylalkyl having 1 to 5 C atoms, W⁷ and W⁸ each, independently of one another, denote H, Cl, or alkyl having 1 to 5 C atoms, Phe denotes 1,4-phenylene, which is optionally substituted by one or more radicals L as defined for Formula M above which are other than P-Sp-, k1, k2, and k3 each, independently of one another, denote 0 or 1, k3 preferably denotes 1, and k4 denotes an integer from 1 to 10.

Very preferred groups P are selected from the group consisting of CH₂═CW¹—CO—O—, CH₂═CW¹—CO—,

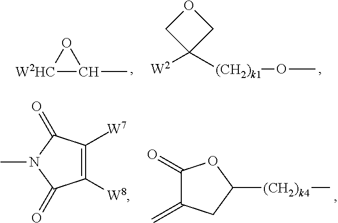

CH₂═CW²—O—, CH₂═CW²—, CW¹═CH—CO—(O)ₖ₃—, CW¹═CH—CO—NH—, CH₂═CW¹—CO—NH—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)₂N—CO—, CH₂═CW¹—CO—NH—, CH₂═CH—(COO)ₖ₁-Phe-(O)ₖ₂—, CH₂═CH—(CO)ₖ₁-Phe-(O)ₖ₂—, Phe-CH═CH—, and W⁴W⁵W⁶Si—, in which W¹ denotes H, F, Cl, CN, CF₃, or phenyl or alkyl having 1 to 5 C atoms, in particular H, F, Cl, or CH₃, W² and W³ each, independently of one another, denote H or alkyl having 1 to 5 C atoms, in particular H, methyl, ethyl, or n-propyl, W⁴, W⁵, and W⁶ each, independently of one another, denote Cl, oxaalkyl, or oxacarbonylalkyl having 1 to 5 C atoms, W⁷ and W⁸ each, independently of one another, denote H, Cl, or alkyl having 1 to 5 C atoms, Phe denotes 1,4-phenylene, k1, k2, and k3 each, independently of one another, denote 0 or 1, k3 preferably denotes 1, and k4 denotes an integer from 1 to 10.

Very particularly preferred groups P are selected from the group consisting of CH₂═CW¹—CO—O—, in particular CH₂═CH—CO—O—, CH₂═C(CH₃)—CO—O—, and CH₂═CF—CO—O—, furthermore CH₂═CH—O—, (CH₂═CH)₂CH—O—CO—, (CH₂═CH)₂CH—O—,

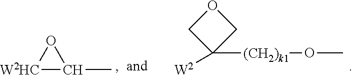

Further preferred polymerizable groups P are selected from the group consisting of vinyloxy, acrylate, methacrylate, fluoroacrylate, chloroacrylate, oxetane, and epoxide, most preferably from acrylate and methacrylate.

If Sp is different from a single bond, it is preferably of the Formula Sp″-X″, so that the respective radical P-Sp-conforms to the Formula P-Sp″-X″-, wherein
Sp″ denotes alkylene having 1 to 20, preferably 1 to 12, C atoms, which is optionally mono- or poly-substituted by F, Cl, Br, I, or CN and in which, in addition, one or more non-adjacent CH₂ groups may each be replaced, independently of one another, by —O—, —S—, —NH—, —N(R⁰)—, —Si(R⁰R⁰⁰)—, —CO—, —CO—O—, —O—CO—, —O—CO—O—, —S—CO—, —CO—S—, —N(R⁰⁰)—CO—O—, —O—CO—N(R⁰)—, —N(R⁰)—CO—N(R⁰⁰)—, —CH═CH—, or —C═C— in such a way that O and/or S atoms are not linked directly to one another;
X″ denotes —O—, —S—, —CO—, —CO—O—, —O—CO—, —O—CO—O—, —CO—N(R⁰)—, —N(R⁰)—CO—, —N(R⁰)—CO—N(R⁰⁰)—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CRO—, —CY²═CY³—, —C═C—, —CH═CH—CO—O—, —O—CO—CH═CH—, or a single bond;
R⁰ and R⁰⁰ each, independently of one another, denote H or alkyl having 1 to 20 C atoms; and
Y² and Y³ each, independently of one another, denote H, F, Cl, or CN.

X″ is preferably —O—, —S—, —CO—, —COO—, —OCO—, —O-COO—, —CO—NR⁰—, —NR⁰—CO—, —NR⁰—CO—NR⁰⁰—, or a single bond.

Typical spacer groups Sp and -Sp″-X″- are, for example, —(CH₂)ₚ₁—, —(CH₂CH₂O)_{q1}—CH₂CH₂—, —CH₂CH₂—S—CH₂CH₂—, —CH₂CH₂—NH—CH₂CH₂— or —(SiR⁰R⁰⁰-O)ₚ₁—, in which p1 is an integer from 1 to 12, q1 is an integer from 1 to 3, and R⁰ and R⁰⁰ have the meanings indicated in Formula M above.

Particularly preferred groups Sp and -Sp″-X″- are —(CH₂)ₚ₁—, —(CH₂)ₚ₁—O—, (CH₂)ₚ₁—O—CO—, —(CH₂)ₚ₁—CO—O—, or —(CH₂)ₚ₁—O—CO—O—, in which p1 and q1 have the meanings indicated above.

Particularly preferred groups Sp″ are, in each case straight-chain ethylene, propylene, butylene, pentylene, hexylene, heptylene, octylene, nonylene, decylene, undecylene, dodecylene, octadecylene, ethyleneoxyethylene, methyleneoxybutylene, ethylenethioethylene, ethylene-N-methyliminoethylene, 1-methylalkylene, ethenylene, propenylene, and butenylene.

For the production of PSA displays, the polymerizable compounds contained in the LC medium are polymerised or crosslinked (if one compound contains two or more polymerizable groups) by in-situ polymerization in the LC medium between the substrates of the LC display, optionally while a voltage is applied to the electrodes.

The structure of the PSA displays according to the invention corresponds to the usual geometry for PSA displays, as described in the prior art cited at the outset.

Geometries without protrusions are preferred, in particular those in which, in addition, the electrode on the color filter side is unstructured and only the electrode on the TFT side has slots. Particularly suitable and preferred electrode structures for PS-VA displays are described, for example, in US2006/0066793A1.

The combination of compounds of the preferred embodiments mentioned above with the polymerized compounds described above results in low threshold voltages, low rotational viscosities, very good low-temperature stabilities in the LC media, constantly high clearing points, and high VHR values.

The use of LC media containing polymerizable compounds allows the rapid establishment of a particularly low pretilt angle in PSA displays. In particular, the LC media exhibit significantly shortened response times, in particular also the grey-shade response times, in PSA displays compared with the media from the prior art.

Preference is generally given to LC media which have a nematic liquid-crystalline phase and preferably have no chiral liquid crystal phase.

The invention also relates to the use of a LC medium according to the present invention as described above and below for electro-optical purposes, in particular for the use is in shutter glasses, for 3D applications, transparent displays, in TN, PS-TN, STN, TN-TFT, OCB, IPS, PS-IPS, FFS, HB-FFS, XB-FFS, PS-FFS, positive VA, and positive PS-VA displays, and to electro-optical displays, in particular of the aforementioned types, containing a LC medium according to the present invention as described above and below, in particular a TN, PS-TN, STN, TN-TFT, OCB, IPS, PS-IPS, FFS, HB-FFS, XB-FFS, PS-FFS, positive VA (vertically aligned), or positive PS-VA display.

The invention also relates to electro-optical displays, such as, for example, STN or MLC displays, having two plane-parallel outer plates, which, together with a frame, form a cell, integrated non-linear elements for switching individual pixels on the outer plates, and a nematic liquid-crystal medium having positive dielectric anisotropy and high specific resistance located in the cell, wherein the a nematic liquid-crystal medium is a LC medium according to the present invention as described above and below.

The LC media according to the invention enable a significant broadening of the available parameter latitude. The achievable combinations of clearing point, viscosity at low temperature, excellent low temperature stability, high thermal and UV stability, and high optical anisotropy are far superior to previous materials from the prior art.

In particular, the combination of compounds of Formula I with compounds of Formula Y and/or B, and additionally with compounds selected from Formulae II-XXXIV and their sub-formulae, leads to LC media which show a moderate positive dielectric anisotropy and at the same time an increased dielectric constant ε_{⊥} perpendicular to the longitudinal axes of the liquid-crystalline molecules, while maintaining a low rotational viscosity and a low value of the ratio γ₁/K₁. This feature enables liquid-crystalline displays, especially of the FFS, HB-FFS, XB-FFS, and IPS mode, with high brightness, high transmission, and low response times.

The LC media according to the invention are suitable for mobile applications and TFT applications, such as, for example, mobile telephones and PDAs. Furthermore, the LC media according to the invention are particularly suitably for use in FFS, HB-FFS, XB-FFS, and IPS displays based on dielectrically positive liquid crystals.

The LC media according to the invention, while retaining the nematic phase down to −20° C., preferably down to −30° C., and particularly preferably down to −40° C., and having a clearing point ≥75° C., preferably ≥80° C., allow rotational viscosities γ₁ of ≤110 mPa·s, particularly preferably ≤100 mPa·s, to be achieved, thereby providing excellent MLC displays with fast response times. The rotational viscosities are determined at 20° C.

The dielectric anisotropy Δε of the LC media according to the invention at 20° C. and 1 kHz is preferably ≥+1.5, very preferably from +2 to +6.

The birefringence Δn of the LC media according to the invention at 20° C. is preferably from 0.08 to 0.15, very preferably from 0.1 to 0.14.

The rotational viscosity γ₁ of the LC media according to the invention is preferably ≤80 mPa s, more preferably ≤70 mPa s, very preferably ≤60 mPa s.

The ratio γ₁/K₁ (wherein γ₁ is the rotational viscosity and K₁ is the elastic constant for splay deformation) of the LC media according to the invention is preferably ≤4.6 mPa·s/pN, very preferably ≤4.2 mPa·s/pN, most preferably ≤4.0 mPa·s/pN.

The nematic phase range of the LC media according to the invention preferably has a width of at least 90° C., more preferably of at least 100° C., in particular at least 110° C. This range preferably extends at least from −25° C. to +80° C.

It goes without saying that, through a suitable choice of the components of the LC media according to the invention, it is also possible for higher clearing points (for example above 100° C.) to be achieved at higher threshold voltages or lower clearing points to be achieved at lower threshold voltages with retention of the other advantageous properties. At slightly elevated viscosities, it is likewise possible to obtain LC media having a higher Δε and thus low thresholds. The MLC displays according to the invention preferably operate at the first Gooch and Tarry transmission minimum [C. H. Gooch and H. A. Tarry, Electron. Lett. 10, 2-4, 1974; C. H. Gooch and H. A. Tarry, Appl. Phys., Vol. 8, 1575-1584, 1975], where, besides particularly favorable electro-optical properties, such as, for example, high steepness of the characteristic line and low angle dependence of the contrast (German patent 30 22 818), lower dielectric anisotropy is sufficient at the same threshold voltage as in an analogous display at the second minimum. This feature enables significantly higher specific resistance values to be achieved using the LC media according to the invention at the first minimum than in the case of LC media comprising cyano compounds. Through a suitable choice of the individual components and their proportions by weight, a person skilled in the art is able to set the birefringence necessary for a pre-specified layer thickness of the MLC display using simple routine methods.

Measurements of the voltage holding ratio (HR) [S. Matsumoto et al., Liquid Crystals 5, 1320 (1989); K. Niwa et al., Proc. SID Conference, San Francisco, June 1984, p. 304 (1984); G. Weber et al., Liquid Crystals 5, 1381 (1989)] have shown that LC media according to the invention comprising compounds of the Formulae ST-1, ST-2, RV, IA and IB exhibit a significantly smaller decrease in the HR on UV exposure than analogous LC media comprising cyano-phenylcyclohexanes of the formula

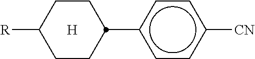

or esters of the formula

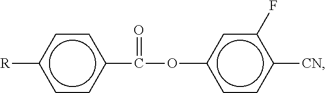

instead of the compounds of the Formulae I, ST-1, ST-2, RV, IA, and IB.

The light stability and UV stability of the LC media according to the invention are considerably better, i.e., they exhibit a significantly smaller decrease in the HR upon exposure to light, heat, or UV.

The construction of the MLC display according to the invention from polarisers, electrode base plates, and surface-treated electrodes corresponds to the usual design for displays of this type. The term usual design is broadly drawn here and also encompasses all derivatives and modifications of the MLC display, in particular including matrix display elements based on poly-Si TFTs or MIM.

A significant difference between the displays according to the invention and the hitherto conventional displays based on the twisted nematic cell consists, however, may occur in the choice of the liquid-crystal parameters of the liquid-crystal layer.

The LC media which can be used in accordance with the invention are prepared in a manner conventional per se, for example by mixing one or more compounds of claim 1 with one or more compounds of the Formulae II-XXXV or with further liquid-crystalline compounds and/or additives. In general, the desired amount of the components used in lesser amount is dissolved in the components making up the principal constituent, advantageously at an elevated temperature. It is also possible to mix solutions of the components in an organic solvent, for example in acetone, chloroform, or methanol, and to remove the solvent again, for example by distillation, after thorough mixing.

The LC media may also comprise further additives known to a person skilled in the art and described in the literature, such as, for example, polymerization initiators, inhibitors, surface-active substances, light stabilizers, antioxidants, e.g., BHT, TEMPOL, microparticles, free-radical scavengers, nanoparticles, etc. For example, 0-15% of pleochroic dyes or chiral dopants or initiators like Irgacure® 651 or Irgacure® 907 can be added. Suitable stabilizers and dopants are mentioned below in Tables C and D.

In a preferred embodiment of the present invention, the LC media contain one or more further stabilizers, preferably selected from the group consisting of the following formulae:

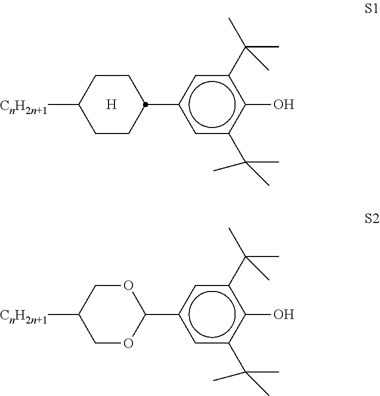

wherein n is an integer from 1 to 6, preferably 3.

Very preferred stabilizers are selected from the group consisting of the following formulae:

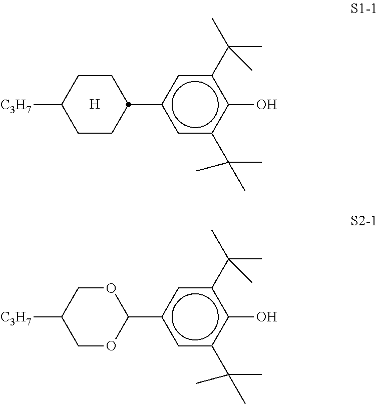

In a preferred embodiment, the LC medium comprises one or more stabilizers selected from the group consisting of Formulae S1-1 and S2-1.

In a preferred embodiment, the LC medium comprises one or more stabilizers selected from Table D.

Preferably, the proportion of stabilizers, like those of Formula S1-S3, in the LC medium is from 10 to 1000 ppm, very preferably from 30 to 1000 ppm. In yet another preferred embodiment, the proportion of stabilizers of Formula S1-S3, in the LC medium is from 100 to 10000 ppm, very preferably from 300 to 5000 ppm.

In another preferred embodiment, the LC medium according to the present invention contains a self-aligning (SA) additive, preferably in a concentration of 0.1 to 2.5%.

The LC medium according to this preferred embodiment is especially suitable for use in polymer-stabilized SA-FFS, SA-HB-FFS, or SA-XB-FFS displays.

In a preferred embodiment, the SA-FFS, SA-HB-FFS, or SA-XB-FFS display contains a polyimide alignment layer.

SA additives for use in this preferred embodiment are selected from compounds comprising a mesogenic group and a straight-chain or branched alkyl side chain that is terminated with one or more polar anchor groups selected from hydroxy, carboxy, amino, or thiol groups.

Further preferred SA additives contain one or more polymerizable groups which are attached, optionally via spacer groups, to the mesogenic group. These polymerizable SA additives can be polymerised in the LC medium under similar conditions as applied for the RMs in the PSA process.

Suitable SA additives to induce homeotropic alignment, especially for use in SA-VA mode displays, are disclosed for example in US2013/0182202A1, US2014/0138581A1, US2015/0166890A1, and US2015/0252265A1.

In another preferred embodiment, an LC medium or a polymer-stabilized SA-FFS, SA-HB-FFS, or SA-XB-FFS display according to the present invention contains one or more self-aligning additives selected from Table F below.

Furthermore, it is possible to add to the LC media, for example, 0 to 15% by weight of pleochroic dyes, furthermore nanoparticles, conductive salts, preferably ethyldimethyldodecylammonium 4-hexoxybenzoate, tetrabutylammonium tetraphenylborate, or complex salts of crown ethers (cf., for example, Haller et al., Mol. Cryst. Liq. Cryst. 24, 249-258 (1973)), for improving the conductivity, or substances for modifying the dielectric anisotropy, the viscosity and/or the alignment of the nematic phases. Substances of this type are described, for example, in DE2209127A1, DE2240864A1, DE2321632A1, DE2338281C₂, DE2450088A1, DE2637430A1, and DE2853728A1.

For the present invention and in the following examples, the structures of the LC compounds are indicated by means of acronyms, with the transformation into chemical formulae taking place in accordance with Tables A to C below. All radicals CₘH₂ₘ₊₁, CₙH₂ₙ₊₁, and CₗH₂ₗ₊₁ or CₘH₂ₘ₋₁, CₙH₂ₙ₋₁, and CₗH₂ₗ₋₁ are straight-chain alkyl groups or alkylene groups, in each case having n, m, and I C atoms, respectively.

Preferably, n, m, and I are independently of each other 1, 2, 3, 4, 5, 6, or 7. Table A shows the codes for the ring elements of the nuclei of the compound, Table B lists the bridging units, and Table C lists the meanings of the symbols for the left- and right-hand end groups of the molecules. The acronyms are composed of the codes for the ring elements with optional linking groups, followed by a first hyphen and the codes for the left-hand end group, and a second hyphen and the codes for the right-hand end group. Table D shows illustrative structures of compounds together with their respective abbreviations.

TABLE A
Ring elements

| | |
|---|---|
| C | 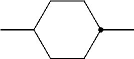 |
| D | 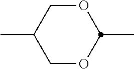 |
| DI | 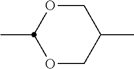 |
| A | 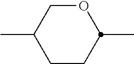 |
| AI | 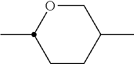 |
| P | 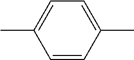 |
| G | 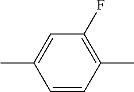 |
| GI | 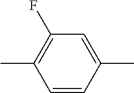 |
| U | 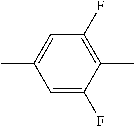 |
| UI | 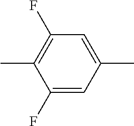 |
| Y | 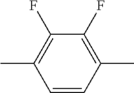 |
| U(1) | 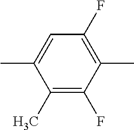 |
| P(F, Cl)Y | 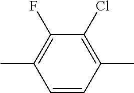 |
| P(Cl, F)Y | 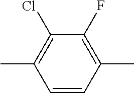 |
| np | 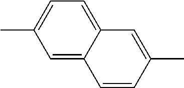 |
| n3f | 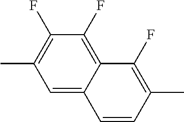 |
| nN3fI | 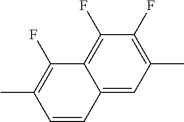 |
| th | 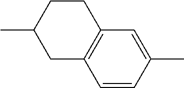 |
| thI | 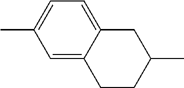 |
| tH2f | 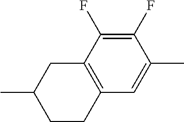 |
| tH2fI | 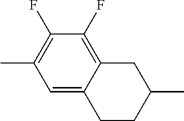 |
| o2f | 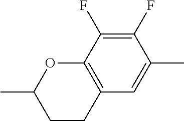 |
| o2fI | 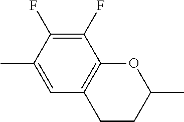 |
| dh | 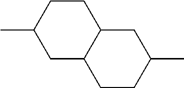 |
| B | 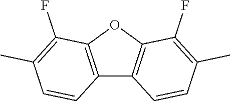 |
| B(S) | 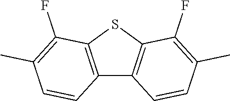 |
| O | 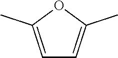 |
| S | 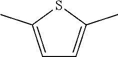 |
| K | 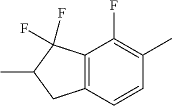 |
| KI | 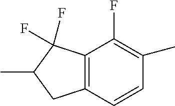 |
| L | 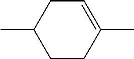 |
| LI | 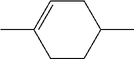 |
| F | 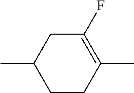 |
| FI | 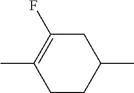 |
| Bh | 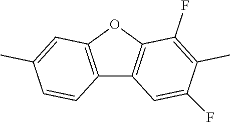 |
| Bh(S) | 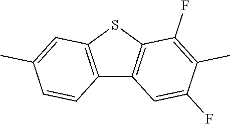 |
| Bf | 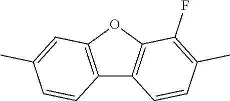 |
| Bf(S) | 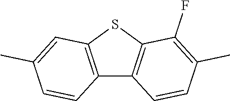 |
| Bfi | 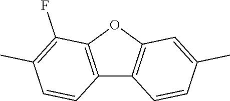 |
| Bfi(S) | 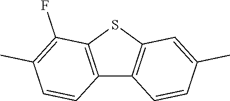 |

TABLE B
Bridging units

| | |
|---|---|
| —E— | —CH₂—CH₂— |
| —V— | —CH═CH— |
| —T— | —C═C— |
| —W— | —CF₂—CF₂— |
| —B— | —CF═CF— |
| —Z— | —CO—O— |
| —X— | —CF═CH— |
| —O— | —CH₂—O— |
| —Q— | —CF₂—O— |
| —ZI— | —O—CO— |
| —XI— | —CH═CF— |
| —OI— | —O—CH₂— |
| —QI— | —O—CF₂— |

TABLE C
End groups

| On the left individually or in combi- | | On the right individually or in com- | |
|---|---|---|---|
| nation | | bination | |
| n- | CₙH₂ₙ₊₁— | -n | —CₙH₂ₙ₊₁ |
| nO- | CₙH₂ₙ₊₁—O— | -On | —O—CₙH₂ₙ₊₁ |
| V- | CH₂═CH— | -V | —CH═CH₂ |
| nV- | CₙH₂ₙ₊₁—CH═CH— | -nV | —CₙH₂ₙ—CH═CH₂ |
| Vn- | CH₂═CH—CₙH₂ₙ— | -Vn | —CH═CH—CₙH₂ₙ₊₁ |
| nVm- | CₙH₂ₙ₊₁—CH═CH—CₘH₂ₘ— | -nVm | —CₙH₂ₙ—CH═CH—CₘH₂ₘ₊₁ |
| N— | N≡C— | —N | —C≡N |
| S— | S═C═N— | —S | —N═C═S |
| F— | F— | —F | —F |
| CL- | Cl— | -CL | —Cl |
| M- | CFH₂— | -M | —CFH₂ |
| D- | CF₂H— | -D | —CF₂H |
| T- | CF₃— | -T | —CF₃ |
| MO- | CFH₂O— | -OM | —OCFH₂ |
| DO- | CF₂HO— | -OD | —OCF₂H |
| TO- | CF₃O— | -OT | —OCF₃ |
| A- | H—C≡C— | -A | —C≡C—H |
| nA- | CₙH₂ₙ₊₁—C≡C— | -An | —C≡C—CₙH₂ₙ+1 |
| NA- | N≡C—C≡C— | -AN | —C≡C—C≡N |
| (cn)- | 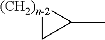 | -(cn) | 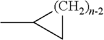 |
| (cn)m- | 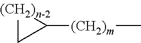 | -m(cn) | 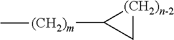 |
| -. . . n . . .- | —CₙH_{2n—} | -. . . n . . . | —CₙH_{2n—} |
| -. . . M . . .- | —CFH— | -. . . M . . . | —CFH— |
| -. . . D . . . - | —CF₂— | -. . . D . . . | —CF₂— |
| -. . . V . . . - | —CH═CH— | -. . . V . . . | —CH═CH— |
| -. . . Z . . .- | —CO—O— | -. . . Z . . . | —CO—O— |
| -. . . Zl . . .- | —O—CO— | -. . . Zl . . . | —O—CO— |
| -. . . K . . .- | —CO— | -. . . K . . . | —CO— |
| -. . . W . . .- | —CF═CF— | -. . . W . . . | —CF═CF— |

in which n and m are each integers, and the three dots “ . . . ” are placeholders for other abbreviations from this table.

The following abbreviations are used:

n, m, k, and l are, independently of one another, each an integer, preferably 1 to 12 preferably 1 to 6, k and l possibly may be also 0 and preferably are 0 to 4, more preferably 0 or 2, and most preferably 2, n preferably is 1, 2, 3, 4, or 5, in the combination “-nO-” it preferably is 1, 2, 3, or 4, preferably 2 or 4, m preferably is 1, 2, 3, 4, or 5, in the combination “-Om” it preferably is 1, 2, 3, or 4, more preferably 2 or 4. The combination “-IVm” preferably is “2V1”.

Preferred LC medium components are shown in Tables D and E.

TABLE D

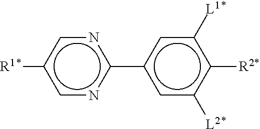

PYP

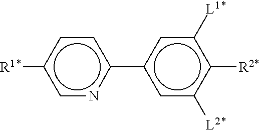

PYRP

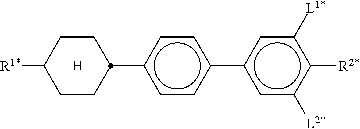

BCH

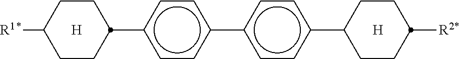

CBC

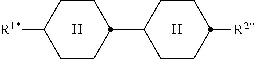

CCH

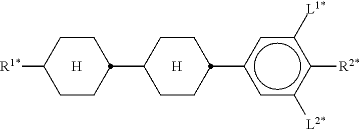

CCP

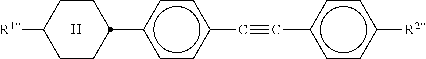

CPTP

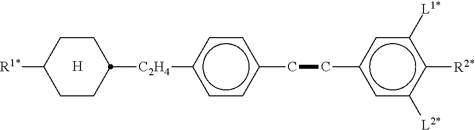

CEPTP

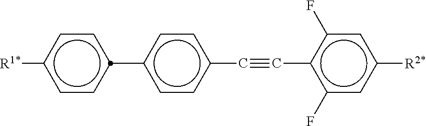

PPTUI

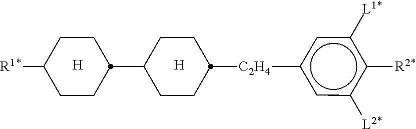

ECCP

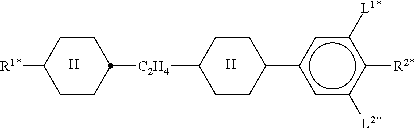

CECP

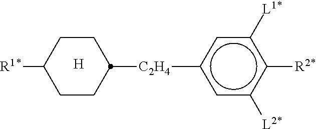

EPCH

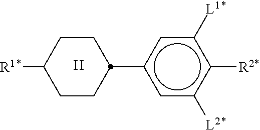

PCH

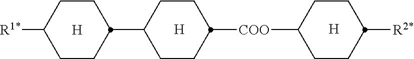

CH

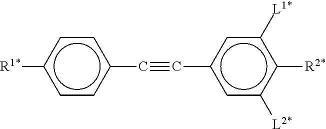

PTP

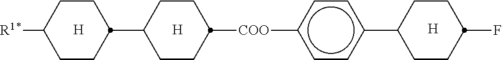

CCPC

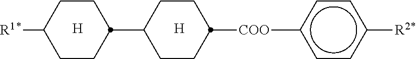

CP

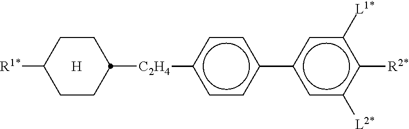

BECH

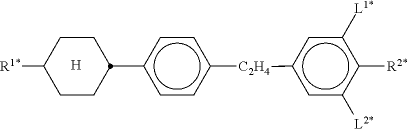

EBCH

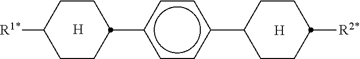

CPC

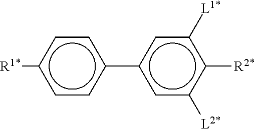

B

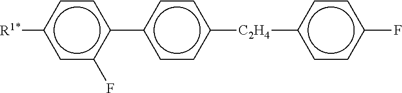

FET-nF

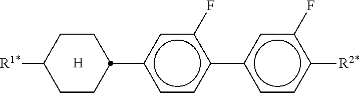

CGG

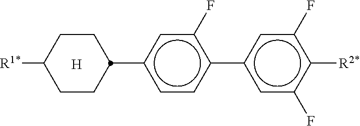

CGU

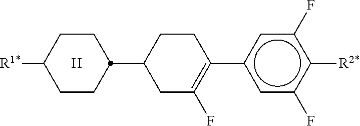

CFU

### Table E

In the following formulae, n and m each, independently of one another, denote 0, 1, 2, 3, 4, 5, 6, 7, 8, 9, 10, 11, or 12, in particular 2, 3, or 5, furthermore 0, 4, or 6.

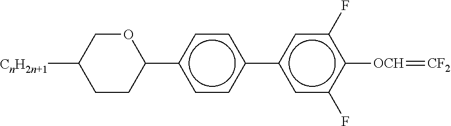

APU-n-OXF

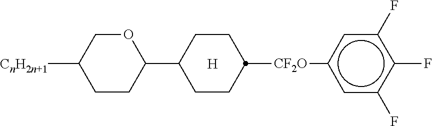

ACQU-n-F

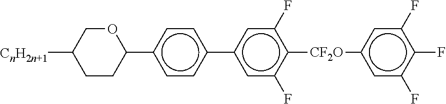

APUQU-n-F

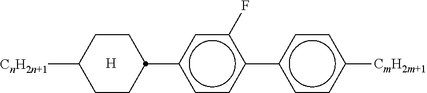

BCH-n.Fm

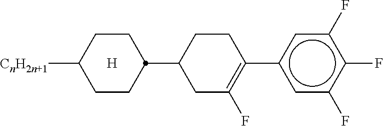

CFU-n-F

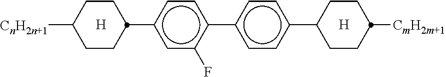

CBC-nmF

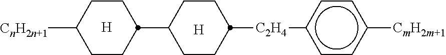

ECCP-nm

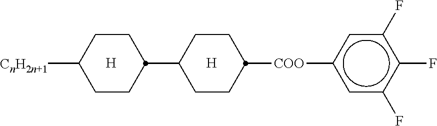

CCZU-n-F

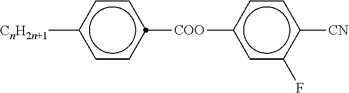

MEnN.F

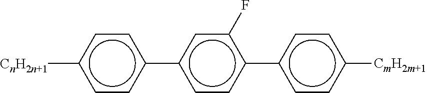

PGP-n-m

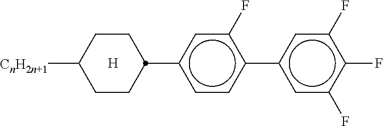

CGU-n-F

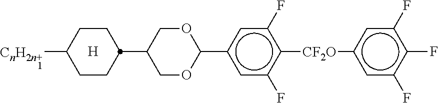

CDUQU-n-F

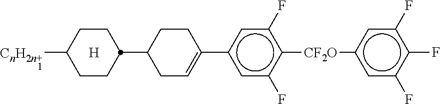

CLUQU-n-F

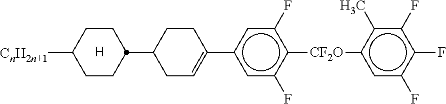

CLUQU(1)-n-F

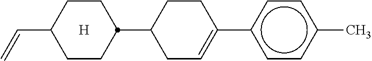

CLP-V-n

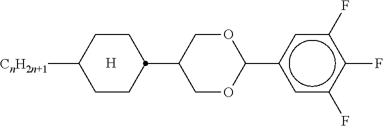

CDU-n-F

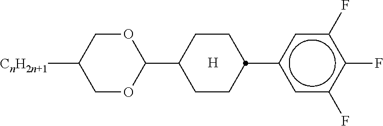

DUCU-n-F

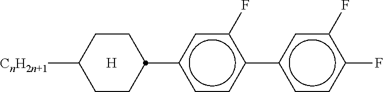

CGG-n-F

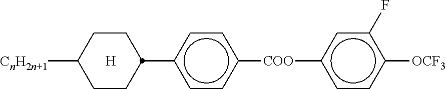

CPZG-n-OT

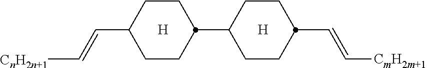

CC-nV-Vm

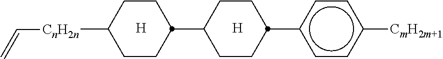

CCP-Vn-m

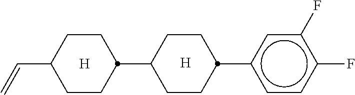

CCG-V-F

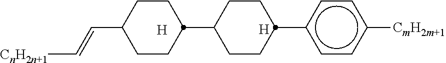

CCP-nV-m

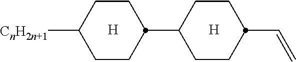

CC-n-V

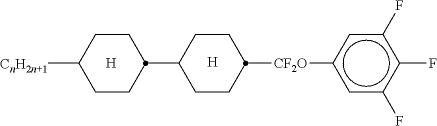

CCQU-n-F

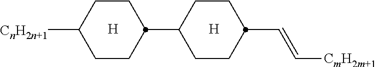

CC-n-Vm

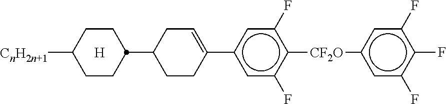

CLUQU-n-F

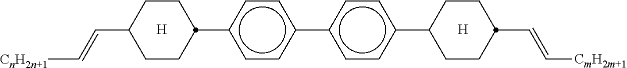

CPP-nV-Vm

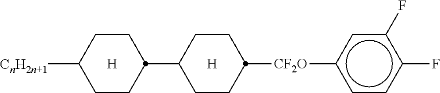

CCQG-n-F

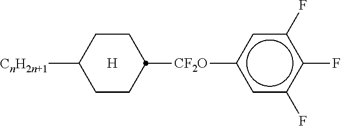

CQU-n-F

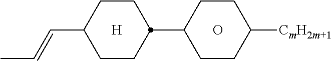

CP-1V-m

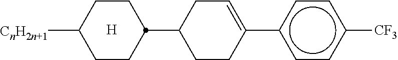

CLP-n-T

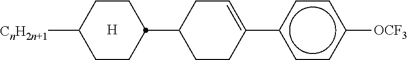

CLP-n-OT

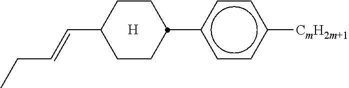

CP-2V-m

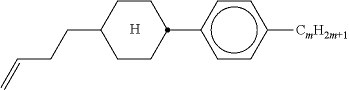

CP-V2-m

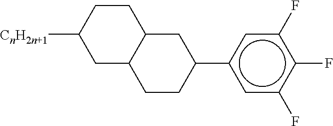

Dec-U-n-F

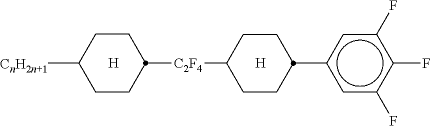

CWCU-n-F

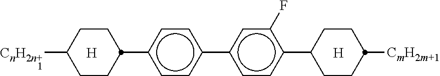

CPGP-n-m

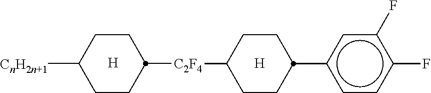

CWCG-n-F

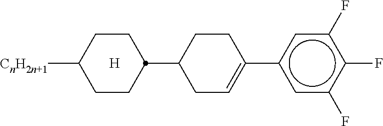

CLU-n-F

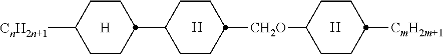

CCOC-n-m

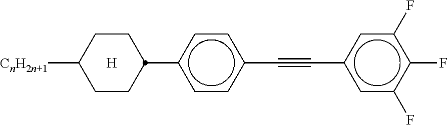

CPTU-n-F

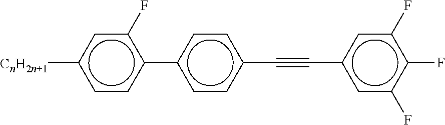

GPTU-n-F

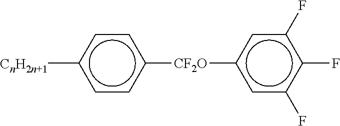

PQU-n-F

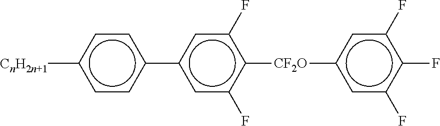

PUQU-n-F

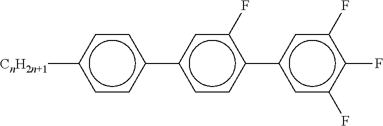

PGU-n-F

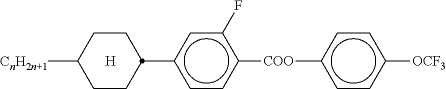

CGZP-n-OT

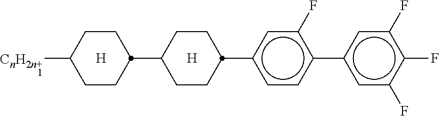

CCGU-n-F

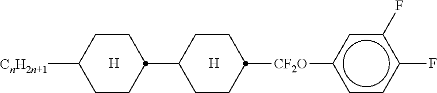

CCQG-n-F

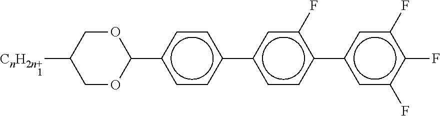

DPGU-n-F

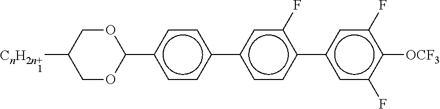

DPGU-n-OT

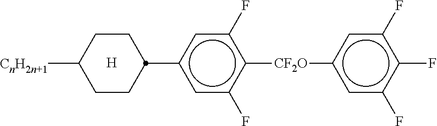

CUQU-n-F

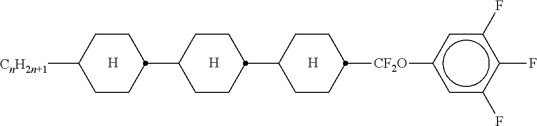

CCCQU-n-F

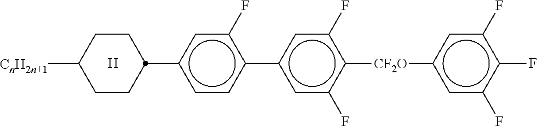

CGUQU-n-F

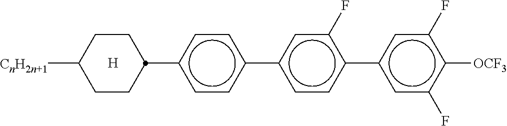

CPGU-n-OT

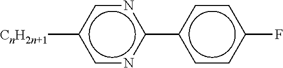

PYP-nF

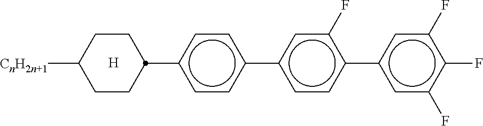

CPGU-n-F

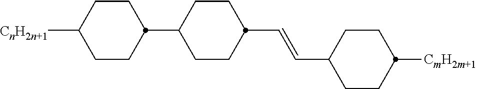

CCVC-n-m

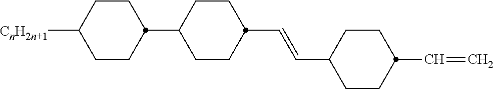

CCVC-n-V

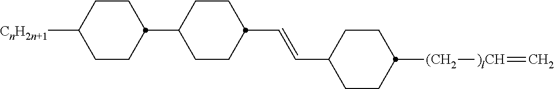

CCVC-n-IV

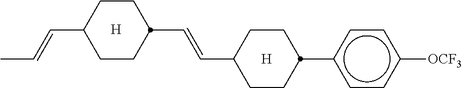

CVCP-1V-OT

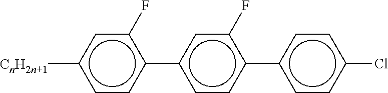

GGP-n-Cl

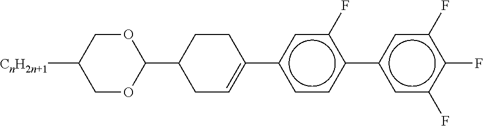

DLGU-n-F

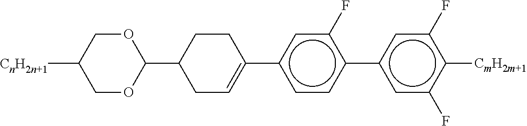

DLGU-n-m

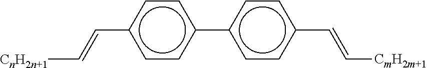

PP-nV-Vm

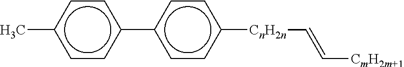

PP-1-nVm

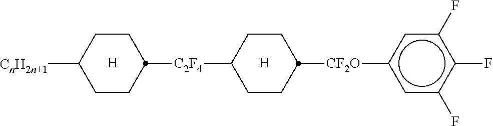

CWCQU-n-F

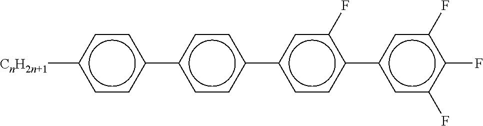

PPGU-n-F

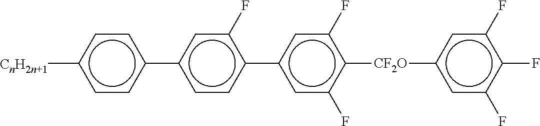

PGUQU-n-F

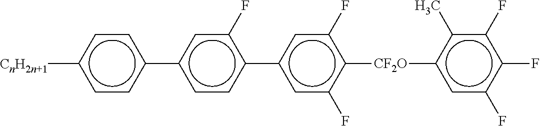

PGUQU(1)-n-F

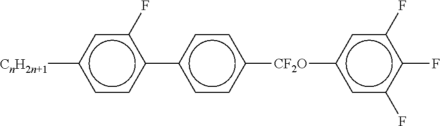

GPQU-n-F

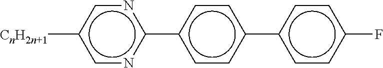

MPP-n-F

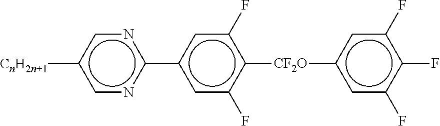

MUQU-n-F

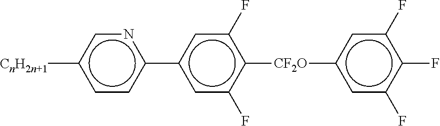

NUQU-n-F

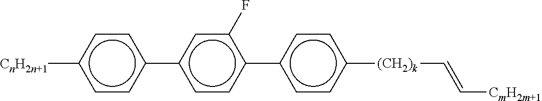

PGP-n-kVm

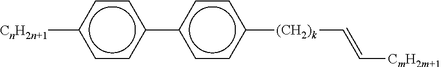

PP-n-kVm

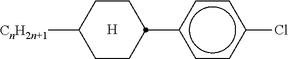

PCH-nCl

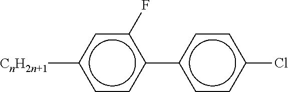

GP-n-Cl

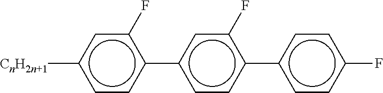

GGP-n-F

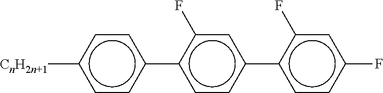

PGIGI-n-F

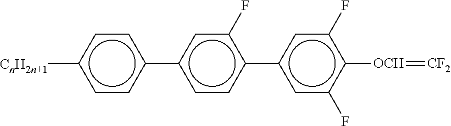

PGU-n-OXF

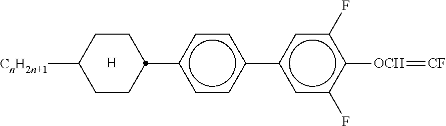

CPU-n-OXF

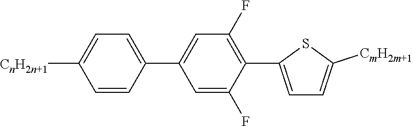

PUS-n-m

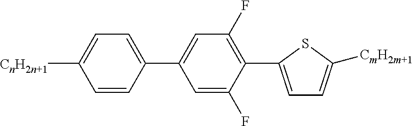

PGS-n-m

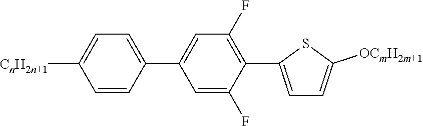

PUS-n-Om

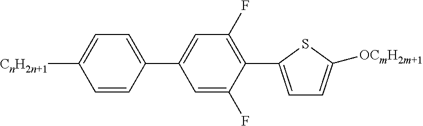

PGS-n-Om

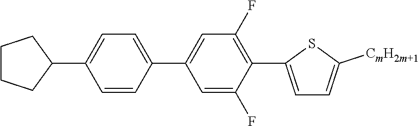

PUS-(c5)-m

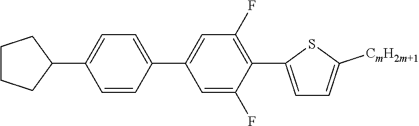

PGS-(c5)-m

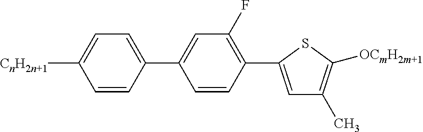

PGS(1)-n-m

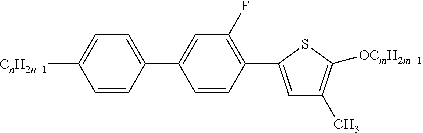

PGS(1)-n-Om

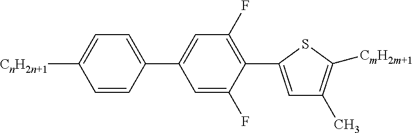

PUS(1)-n-m

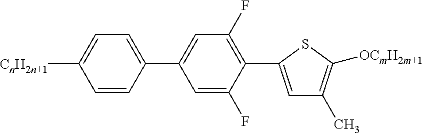

PUS(1)-n-Om

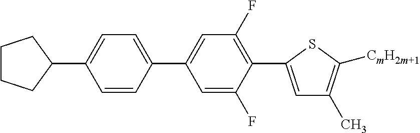

PUS(1)-(c5)-m

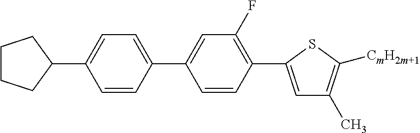

PGS(1)-(c5)-m

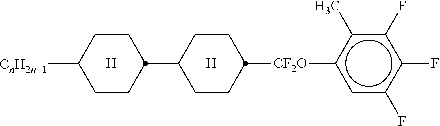

CCQU-n-F(1)

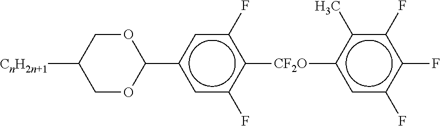

DUQU-n-F(1)

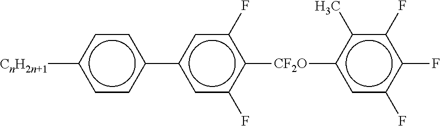

PUQU-n-F(1)

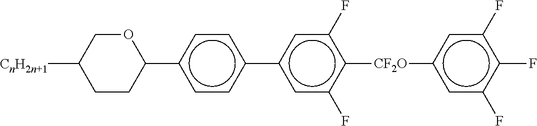

APUQU-n-F(1)

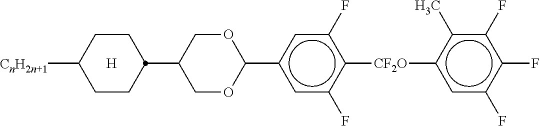

CDUQU-n-F(1)

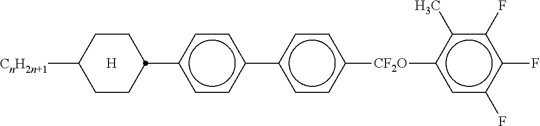

CPPQU-n-F(1)

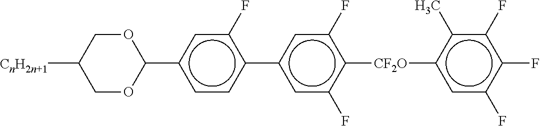

DGUQU-n-F(1)

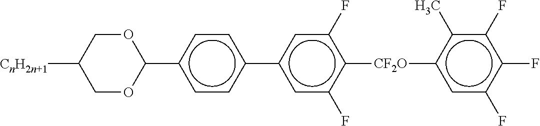

DPUQU-n-F(1)

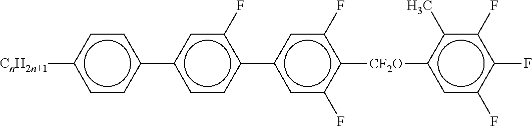

PGUQU-n-F(1)

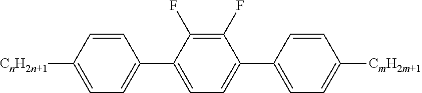

PYP-n-m

Particular preference is given to LC media which comprise at least one, two, three, four or more compounds from Table E.

### Table F

Table F indicates possible dopants which are generally added to the LC media according to the invention. The LC media preferably comprise 0-10% by weight, in particular 0.01-5% by weight and particularly preferably 0.01-3% by weight of dopants.

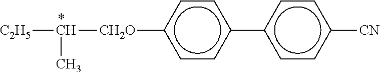

C 15

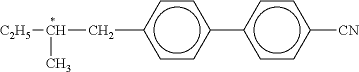

CB 15

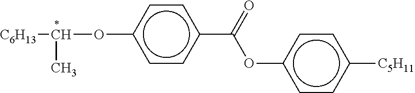

CM 21

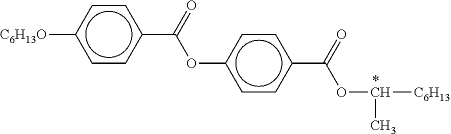

R/S-811

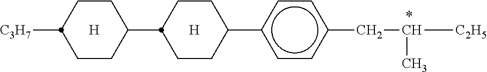

CM 44

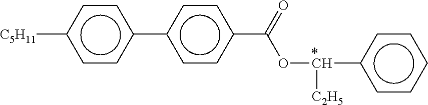

CM 45

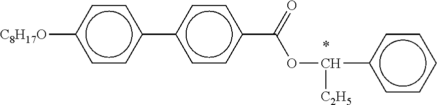

CM 47

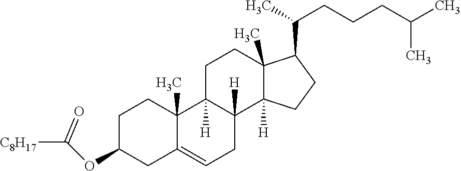

CN

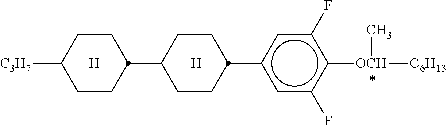

R/S-2011

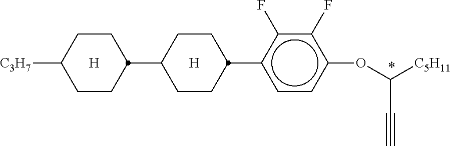

R/S-3011

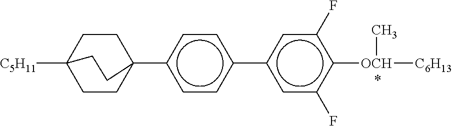

R/S-4011

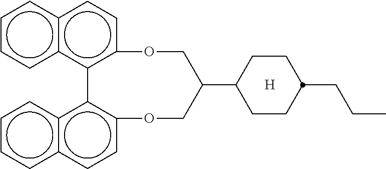

R/S-5011

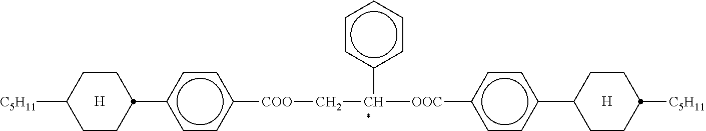

R/S-1011

### Table G

Stabilizers, which can additionally be added, for example, to the LC media according to the invention in amounts of 0-10% by weight, preferably 100 ppm to 10 000 ppm by weight, are mentioned below.

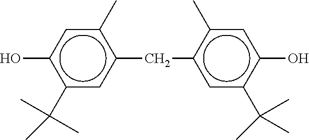

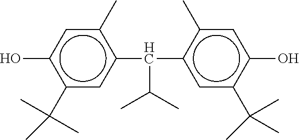

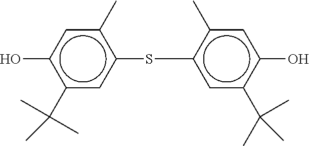

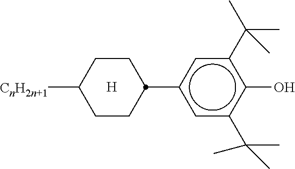

n = 1, 2, 3, 4, 5, 6, or 7

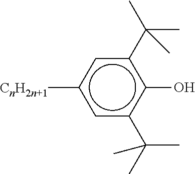

n = 1, 2, 3, 4, 5, 6, or 7

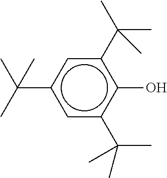

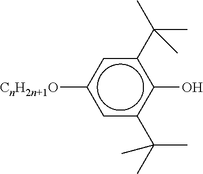

n = 1, 2, 3, 4, 5, 6, or 7

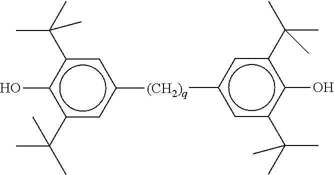

q = 1, 2, 3, 4, 5, 6, or 7

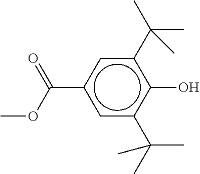

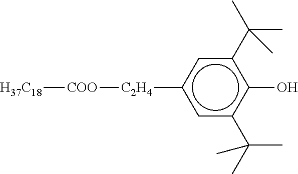

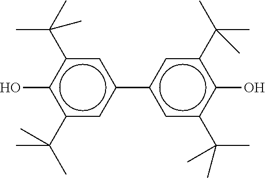

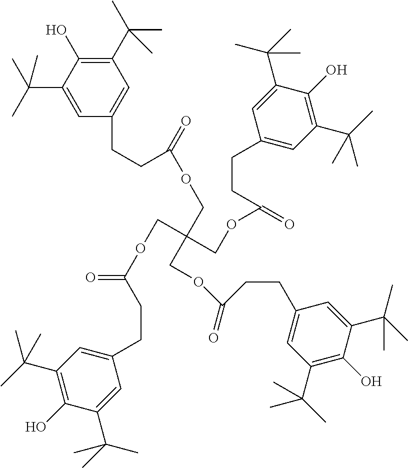 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

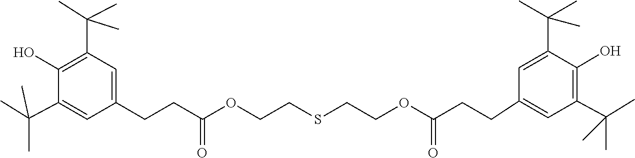 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

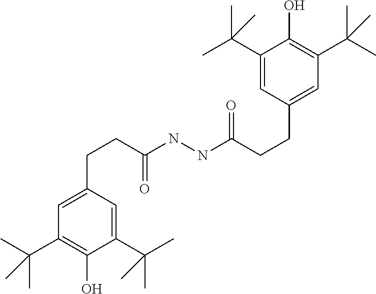 [SMILES: CC(C)(C)c1cc(CCC(=O)NNC(=O)CCc2cc(C(C)(C)C)c(O)c(C(C)(C)C)c2)cc(C(C)(C)C)c1O]

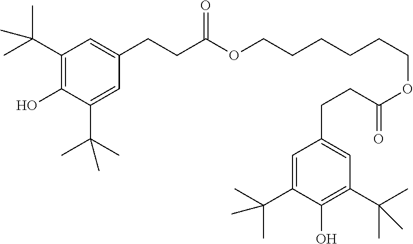 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

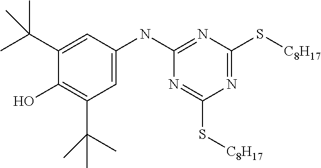

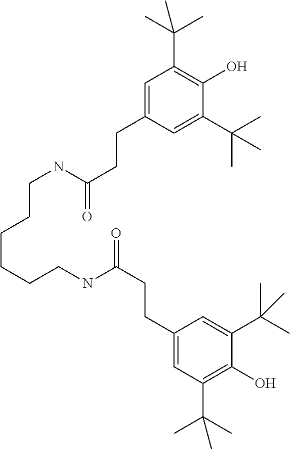

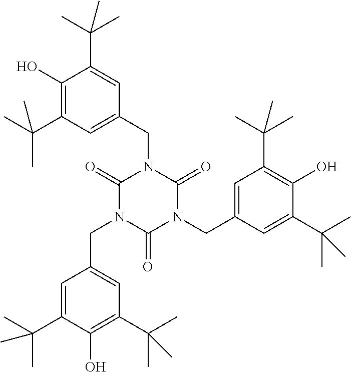 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

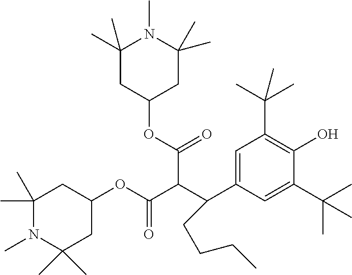 [SMILES: CCCCC(c1cc(C(C)(C)C)c(O)c(C(C)(C)C)c1)C(C(=O)OC1CC(C)(C)N(C)C(C)(C)C1)C(=O)OC1CC(C)(C)N(C)C(C)(C)C1]

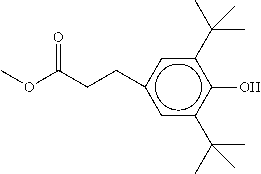

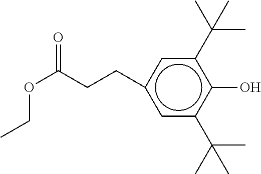

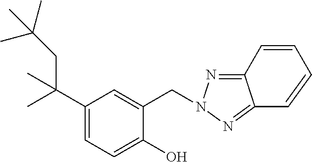 [SMILES: CC(C)(C)CC(C)(C)c1ccc(O)c(Cn2nc3ccccc3n2)c1]

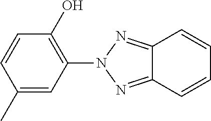 [SMILES: Cc1ccc(O)c(-n2nc3ccccc3n2)c1]

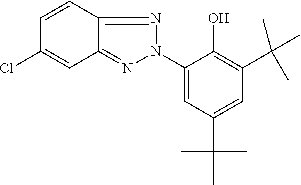 [SMILES: CC(C)(C)c1cc(-n2nc3ccc(Cl)cc3n2)c(O)c(C(C)(C)C)c1]

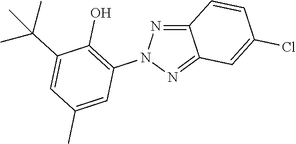 [SMILES: Cc1cc(-n2nc3ccc(Cl)cc3n2)c(O)c(C(C)(C)C)c1]

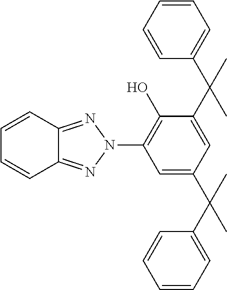 [SMILES: CC(C)(c1ccccc1)c1cc(-n2nc3ccccc3n2)c(O)c(C(C)(C)c2ccccc2)c1]

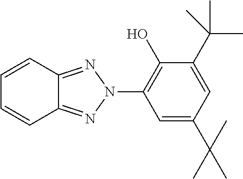 [SMILES: CC(C)(C)c1cc(-n2nc3ccccc3n2)c(O)c(C(C)(C)C)c1]

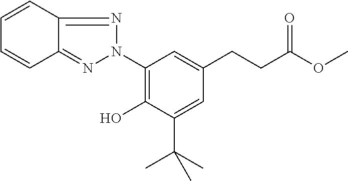 [SMILES: COC(=O)CCc1cc(-n2nc3ccccc3n2)c(O)c(C(C)(C)C)c1]

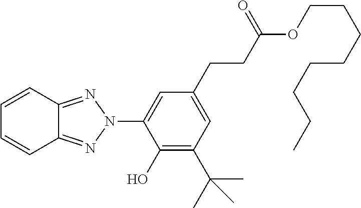 [SMILES: CCCCCCCCOC(=O)CCc1cc(-n2nc3ccccc3n2)c(O)c(C(C)(C)C)c1]

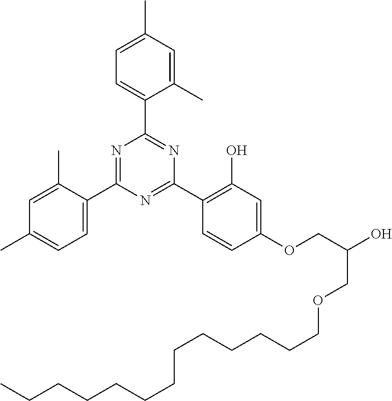 [SMILES: CCCCCCCCCCCCCOCC(O)COc1ccc(-c2nc(-c3ccc(C)cc3C)nc(-c3ccc(C)cc3C)n2)c(O)c1]

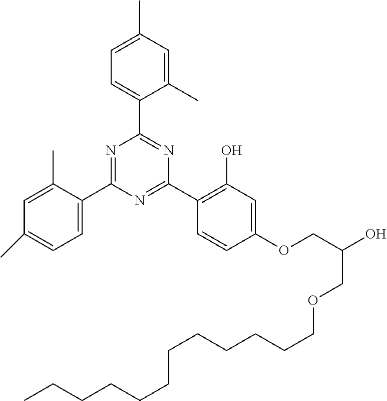 [SMILES: CCCCCCCCCCCCOCC(O)COc1ccc(-c2nc(-c3ccc(C)cc3C)nc(-c3ccc(C)cc3C)n2)c(O)c1]

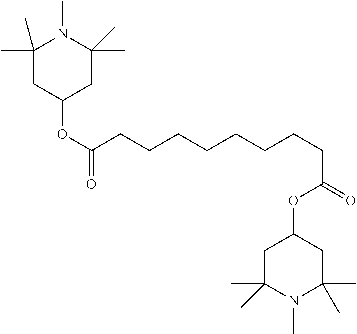

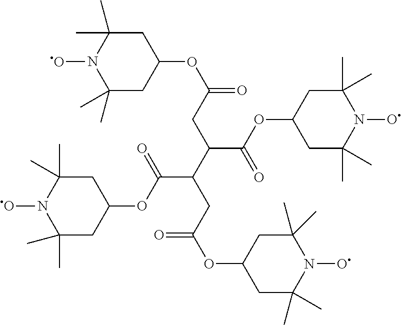

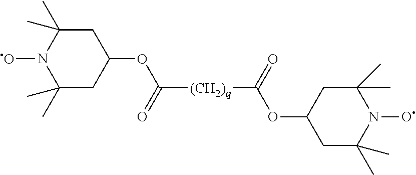

q = 1, 2, 3, 4, 5, 6, 7, 8, 9, or 10

### Table H

Table H shows illustrative reactive mesogenic compounds (RMs) which can be used in the LC media in accordance with the present invention.

| | |
|---|---|
| 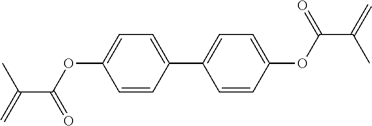 | RM-1 |
| 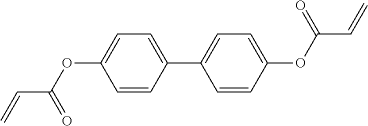 | RM-2 |
| 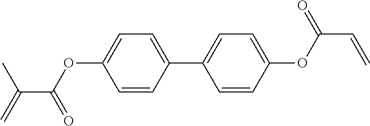 | RM-3 |
| 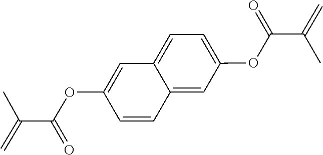 | RM-4 |
| 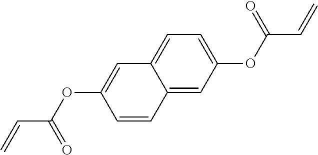 | RM-5 |
| 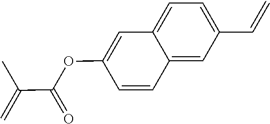 | RM-6 |
| 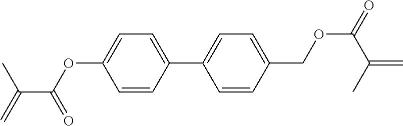 | RM-7 |
| 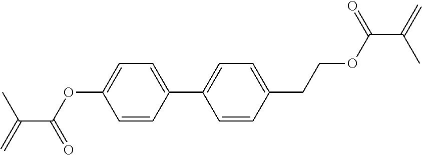 | RM-8 |
| 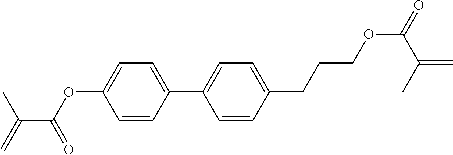 | RM-9 |
| 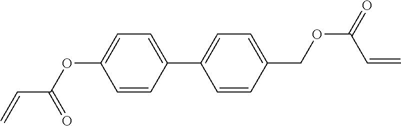 | RM-10 |
| 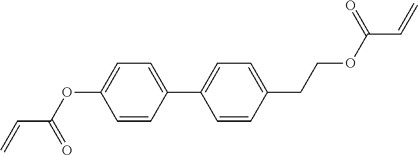 | RM-11 |
| 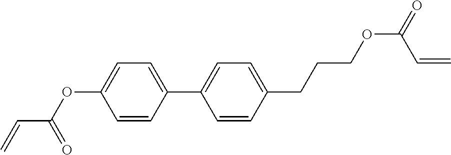 | RM-12 |
| 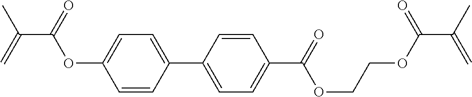 | RM-13 |
| 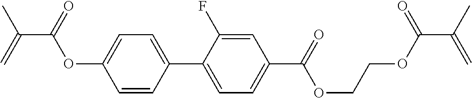 | RM-14 |
| 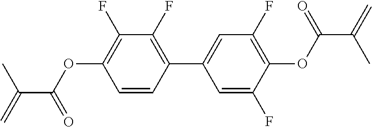 | RM-15 |
| 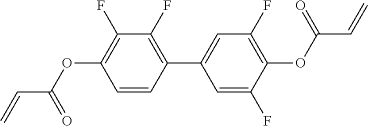 | RM-16 |
| 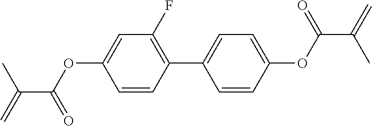 | RM-17 |
| 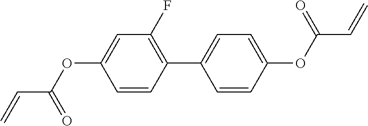 | RM-18 |
| 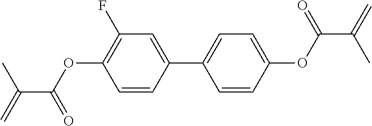 | RM-19 |
| 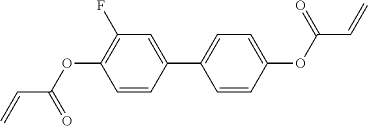 | RM-20 |
| 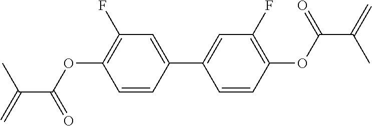 | RM-21 |
| 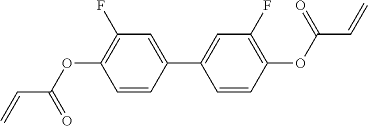 | RM-22 |
| 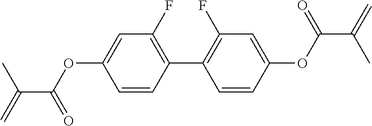 | RM-23 |
| 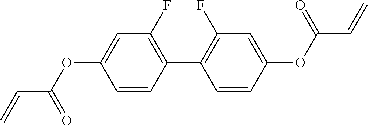 | RM-24 |
| 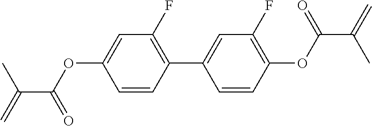 | RM-25 |
| 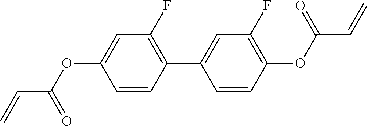 | RM-26 |
| 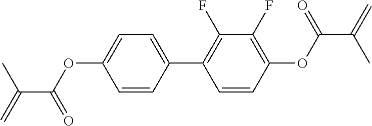 | RM-27 |
| 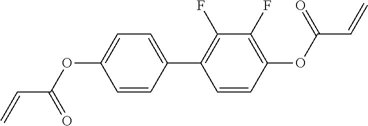 | RM-28 |
| 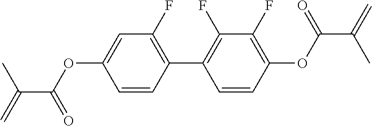 | RM-29 |
| 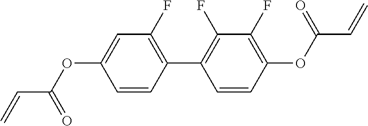 | RM-30 |
| 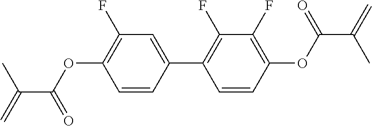 | RM-31 |
| 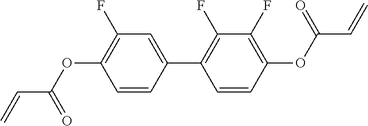 | RM-32 |
| 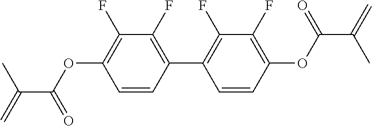 | RM-33 |
| 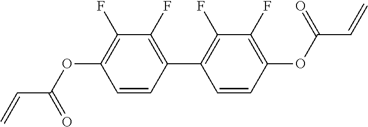 | RM-34 |
| 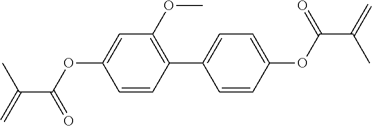 | RM-35 |
| 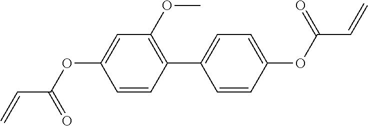 | RM-36 |
| 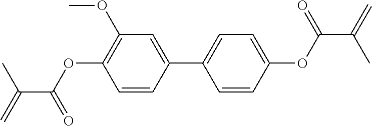 | RM-37 |
| 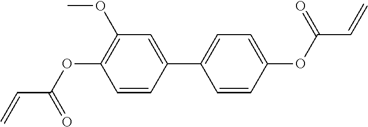 | RM-38 |
| 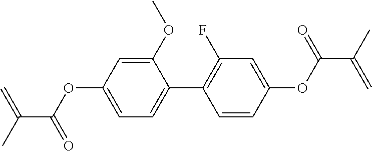 | RM-39 |
| 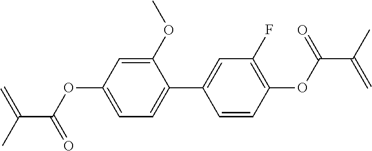 | RM-40 |
| 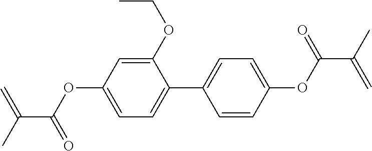 | RM-41 |
| 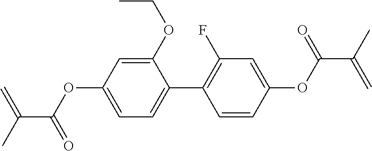 | RM-42 |
| 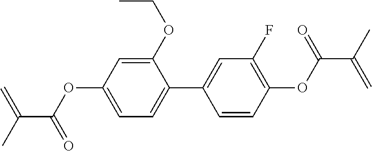 | RM-43 |
| 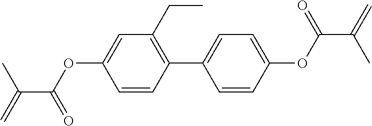 | RM-44 |
| 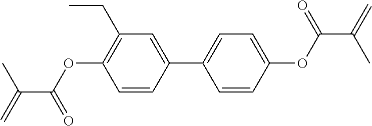 | RM-45 |
| 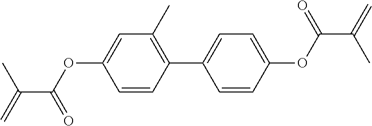 | RM-46 |
| 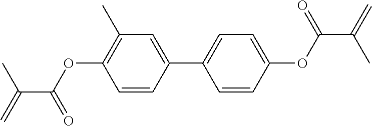 | RM-47 |
| 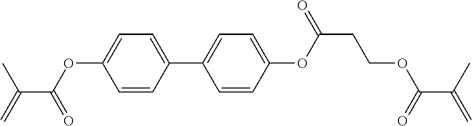 | RM-48 |
| 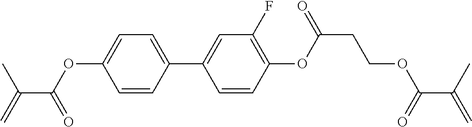 | RM-49 |
| 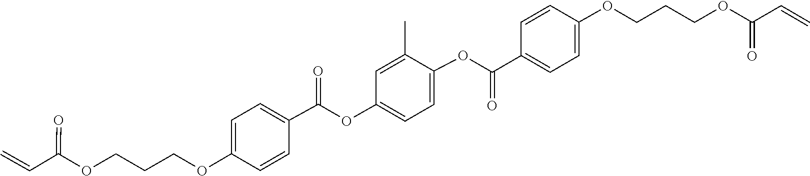 | RM-50 |
| 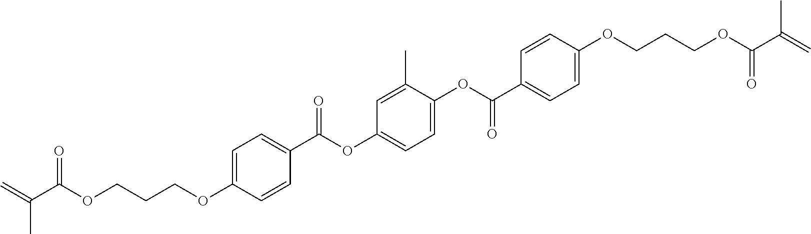 | RM-51 |
| 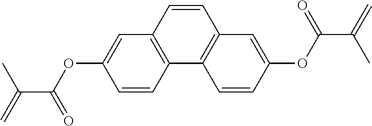 | RM-52 |
| 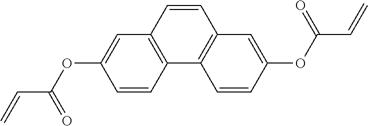 | RM-53 |
| 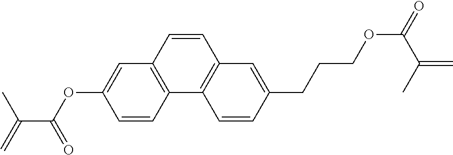 | RM-54 |
| 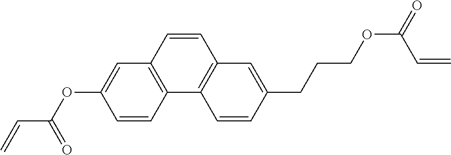 | RM-55 |
| 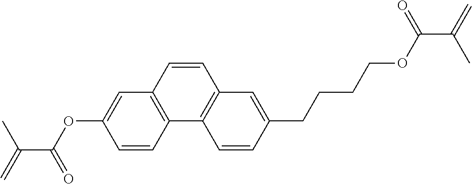 | RM-56 |
| 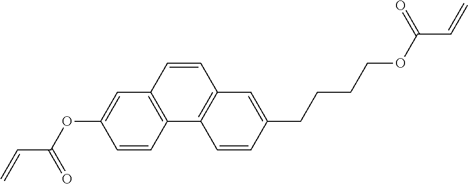 | RM-57 |
| 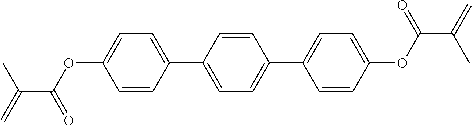 | RM-58 |
| 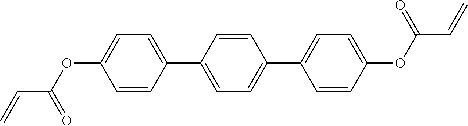 | RM-59 |
| 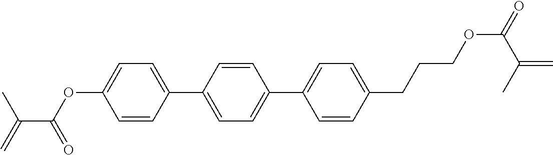 | RM-60 |
| 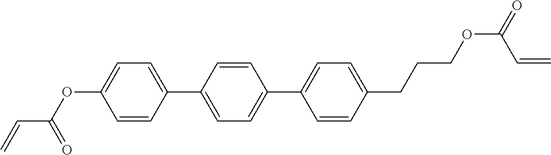 | RM-61 |
| 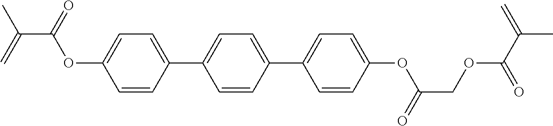 | RM-62 |
| 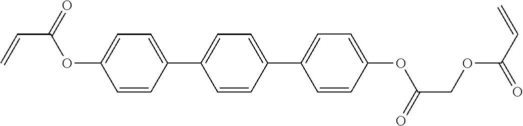 | RM-63 |
| 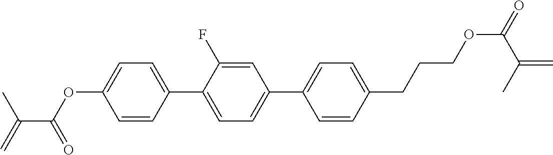 | RM-64 |
| 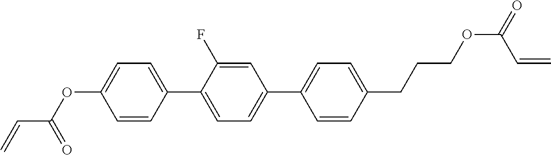 | RM-65 |
| 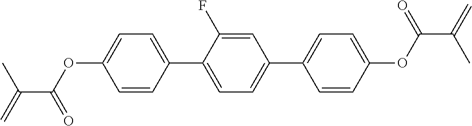 | RM-66 |
| 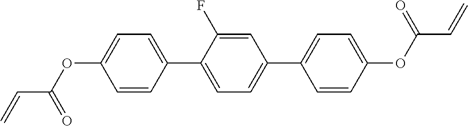 | RM-67 |
| 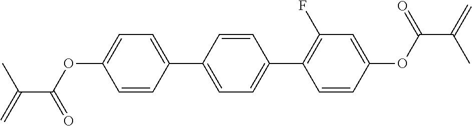 | RM-68 |
| 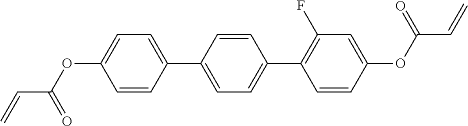 | RM-69 |
| 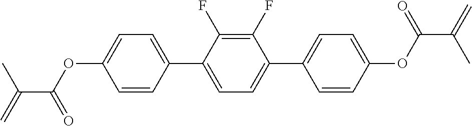 | RM-70 |
| 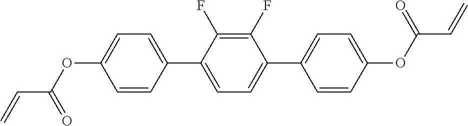 | RM-71 |
| 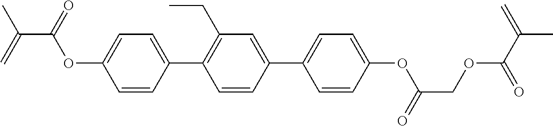 | RM-72 |
| 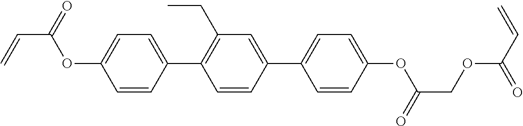 | RM-73 |
| 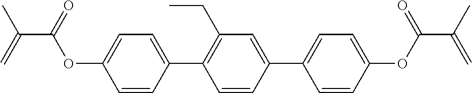 | RM-74 |
| 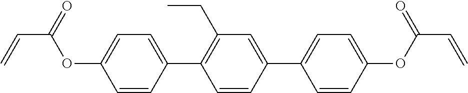 | RM-75 |
| 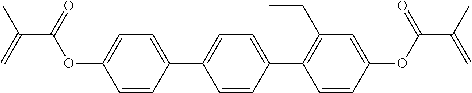 | RM-76 |
| 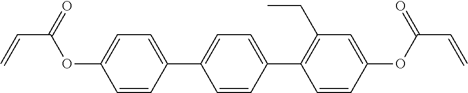 | RM-77 |
| 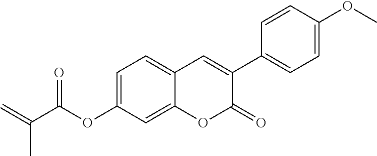 | RM-78 |
| 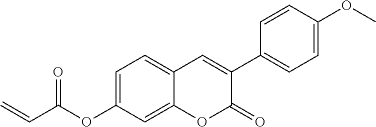 | RM-79 |
| 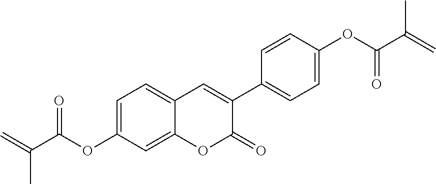 | RM-80 |
| 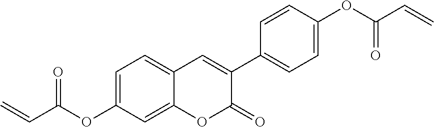 | RM-81 |
| 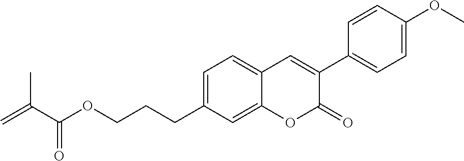 | RM-82 |
| 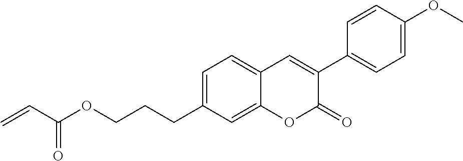 | RM-83 |
| 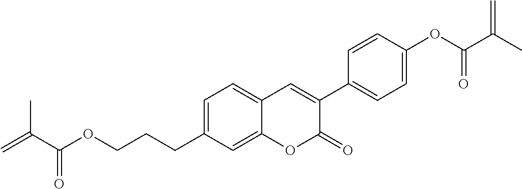 | RM-84 |
| 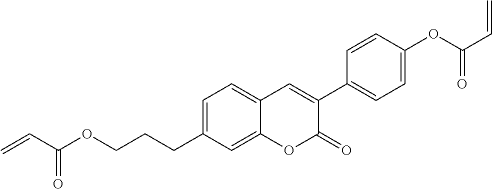 | RM-85 |
| 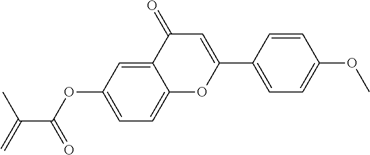 | RM-86 |
| 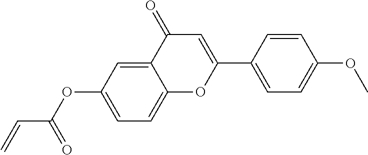 | RM-87 |
| 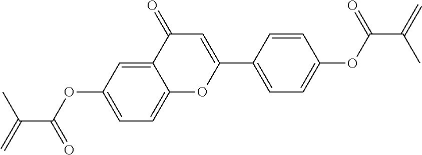 | RM-88 |
| 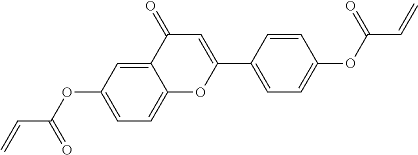 | RM-89 |
| 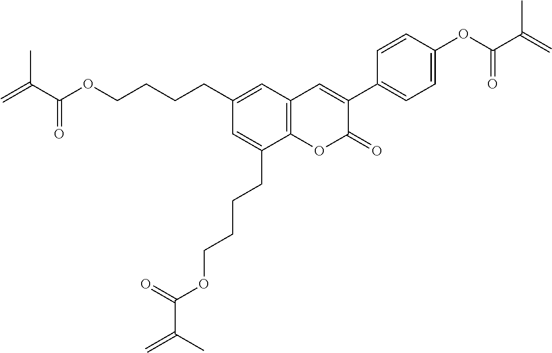 | RM-90 |
| 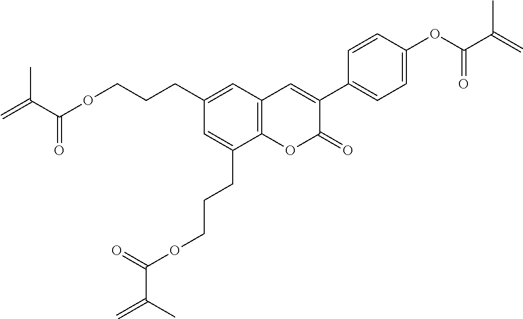 | RM-91 |
| 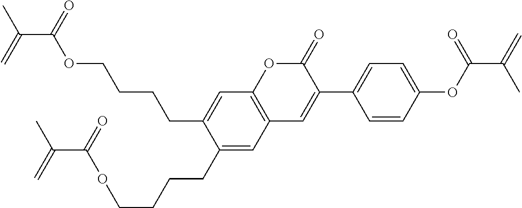 | RM-92 |
| 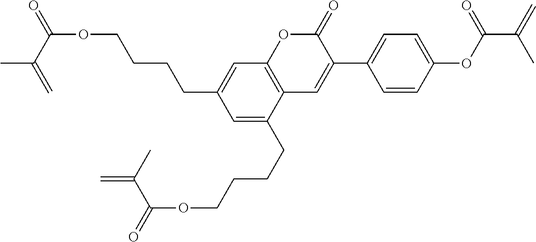 | RM-93 |
| 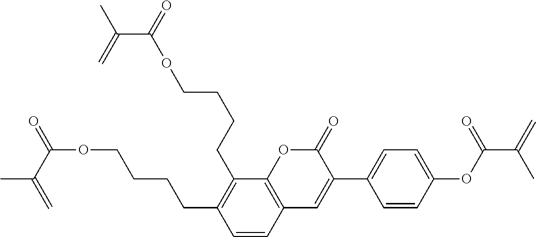 | RM-94 |
| 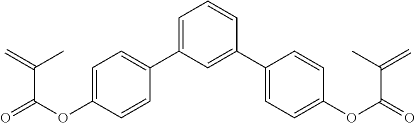 | RM-95 |
| 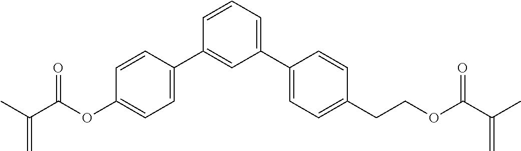 | RM-96 |
| 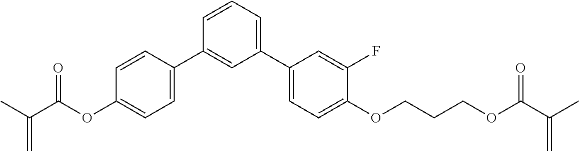 | RM-97 |
| 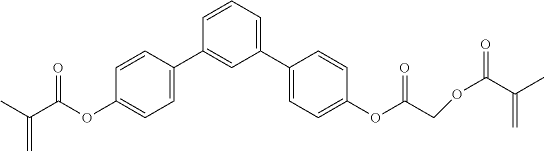 | RM-98 |
| 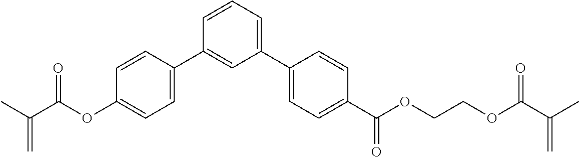 | RM-99 |
| 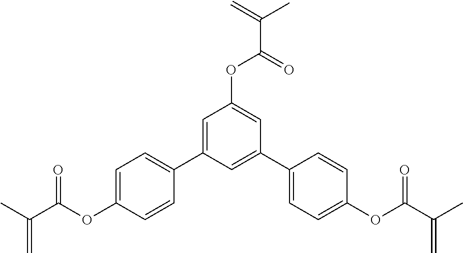 | RM-100 |
| 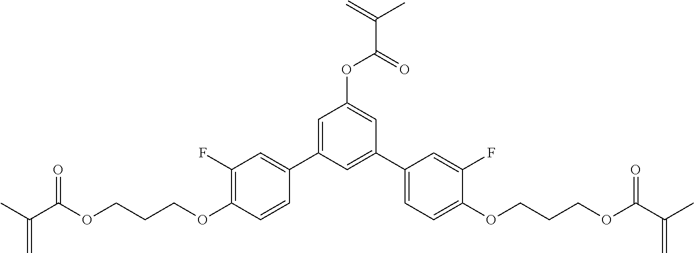 | RM-101 |
| 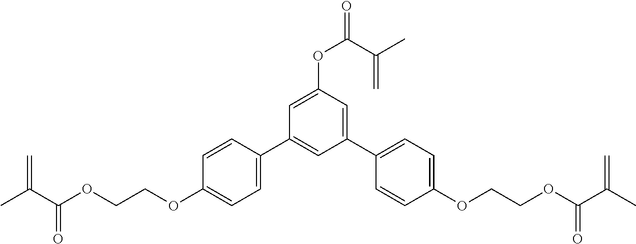 | RM-102 |
| 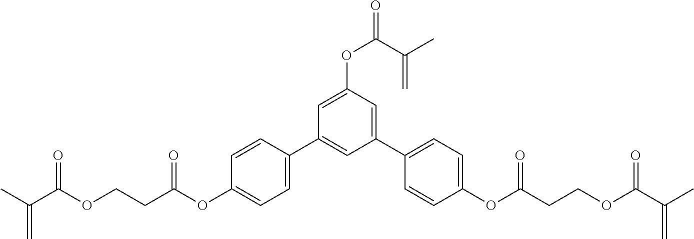 | RM-103 |
| 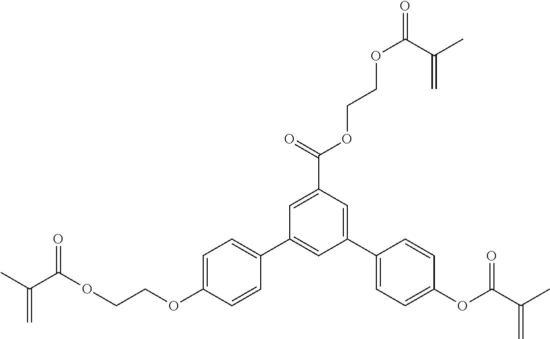 | RM-104 |
| 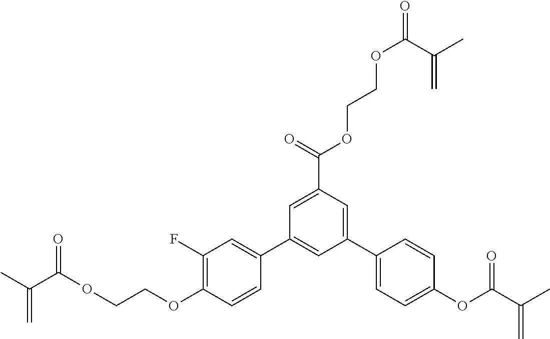 | RM-105 |
| 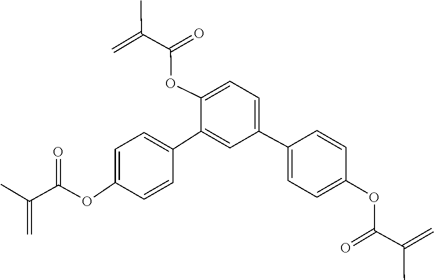 | RM-106 |
| 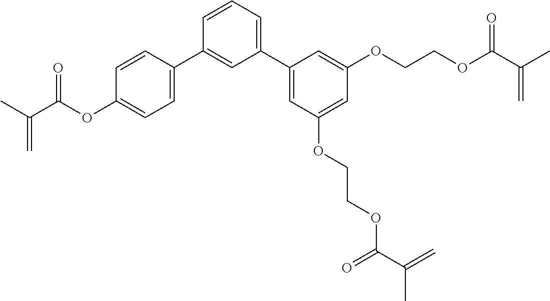 | RM-107 |
| 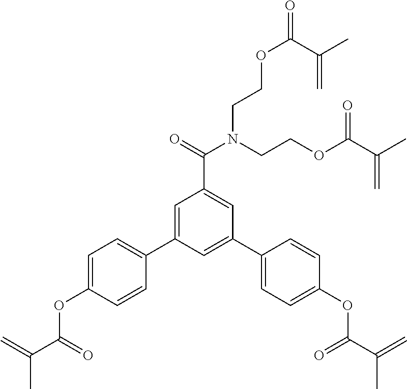 | RM-108 |
| 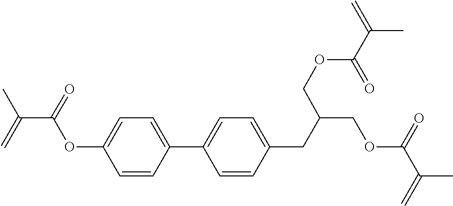 | RM-109 |
| 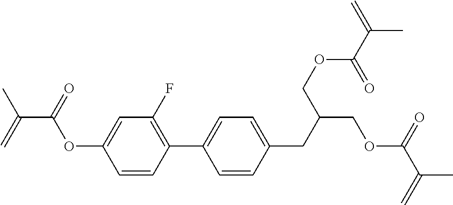 | RM-110 |
| 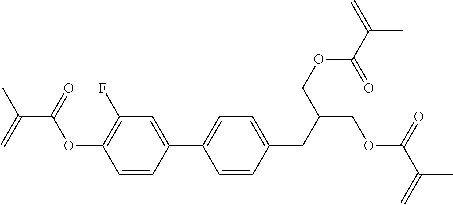 | RM-111 |
| 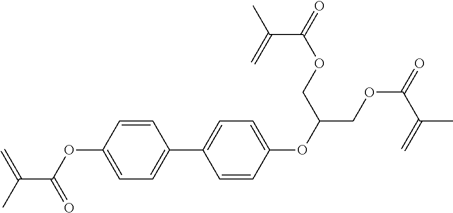 | RM-112 |
| 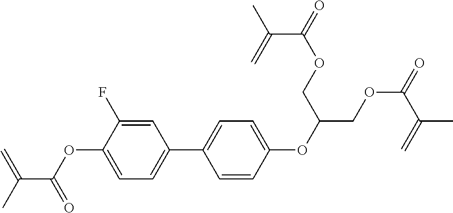 | RM-113 |
| 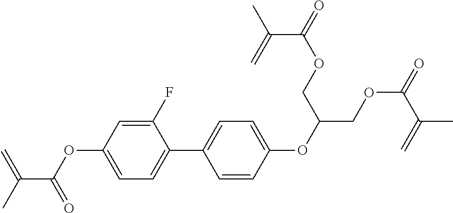 | RM-114 |
| 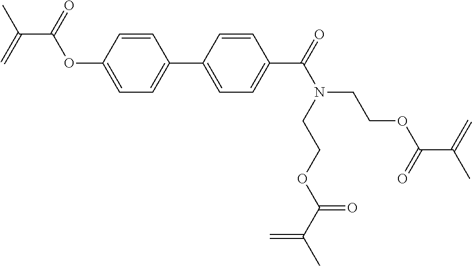 | RM-115 |
| 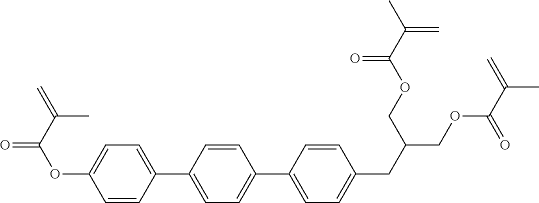 | RM-116 |
| 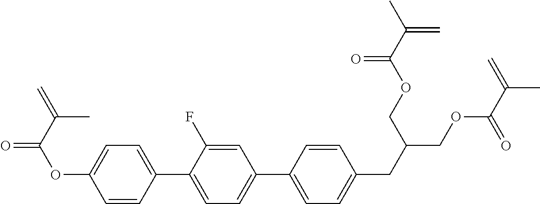 | RM-117 |
| 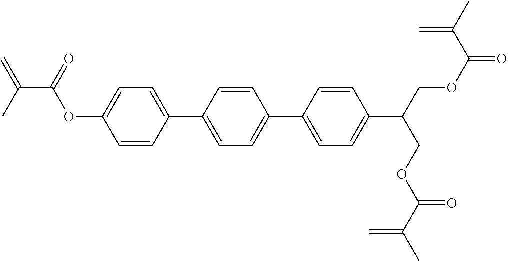 | RM-118 |
| 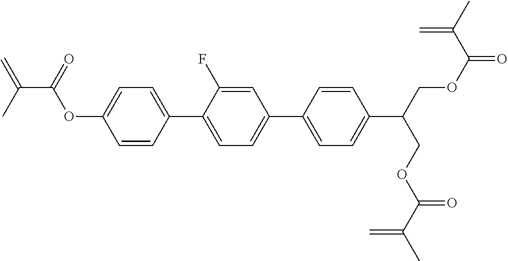 | RM-119 |
| 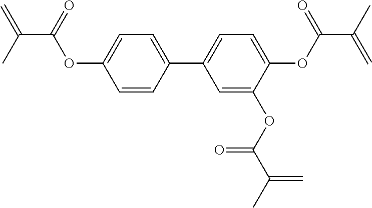 | RM-120 |
| 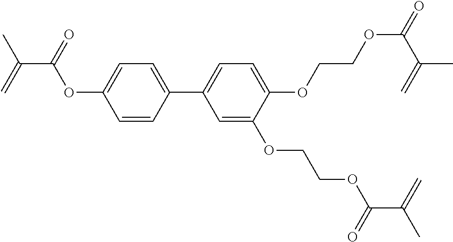 | RM-121 |
| 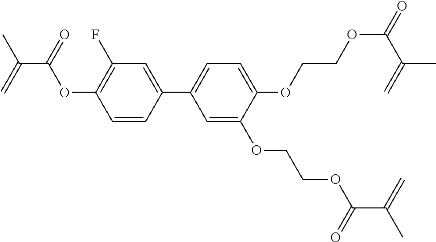 | RM-122 |
| 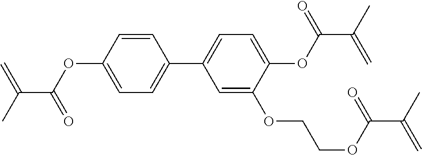 | RM-123 |
| 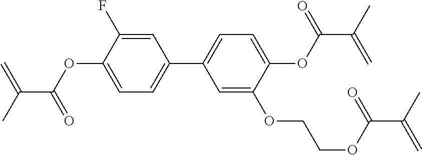 | RM-124 |
| 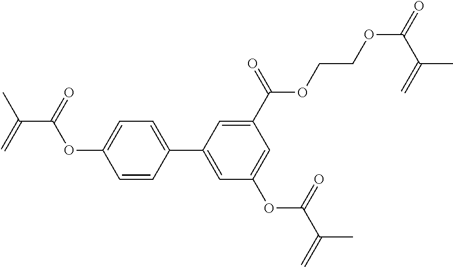 | RM-125 |
| 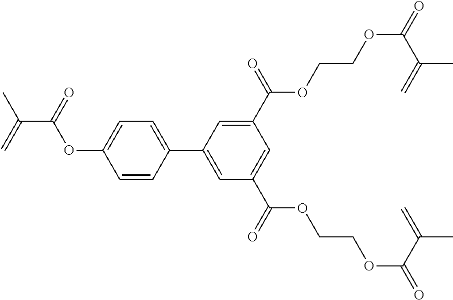 | RM-126 |
| 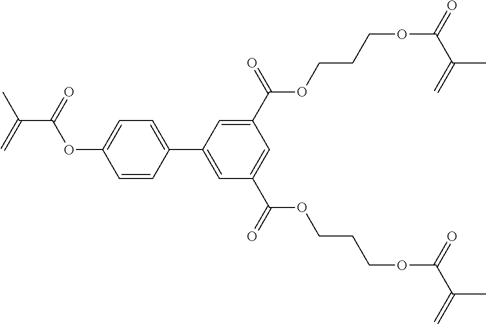 | RM-127 |
| 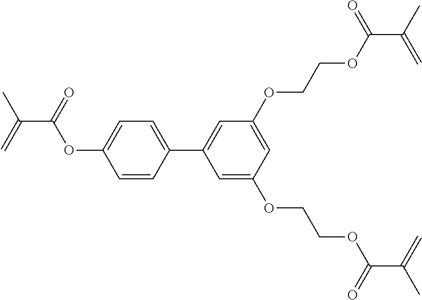 | RM-128 |
| 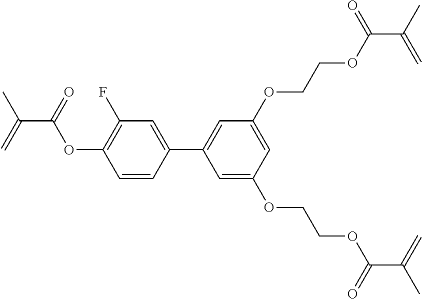 | RM-129 |
| 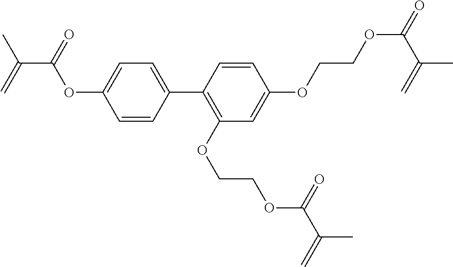 | RM-130 |
| 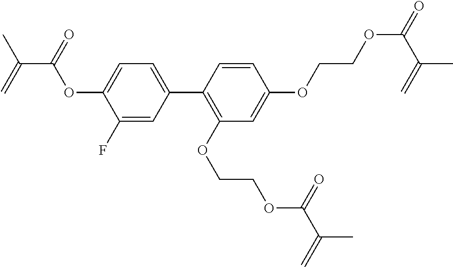 | RM-131 |
| 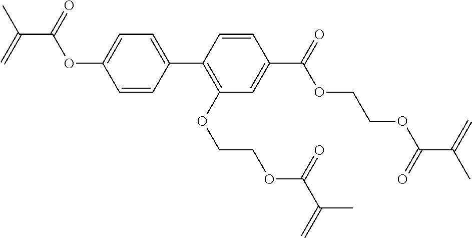 | RM-132 |
| 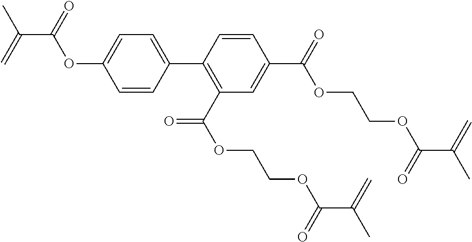 | RM-133 |
| 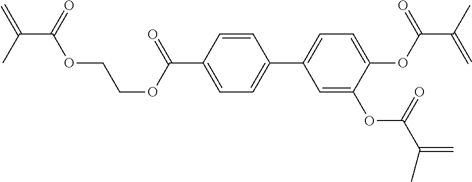 | RM-134 |
| 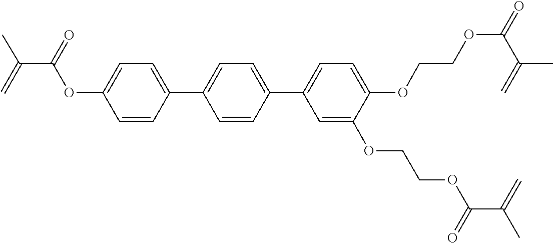 | RM-135 |
| 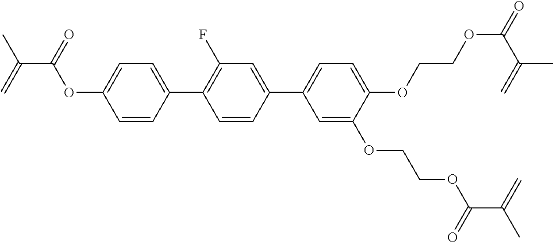 | RM-136 |
| 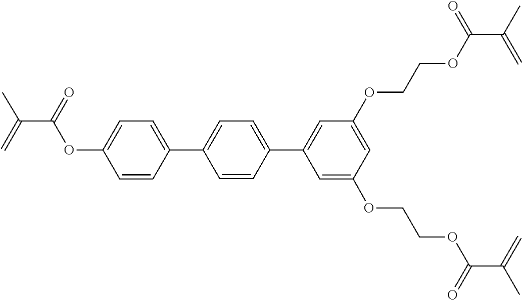 | RM-137 |
| 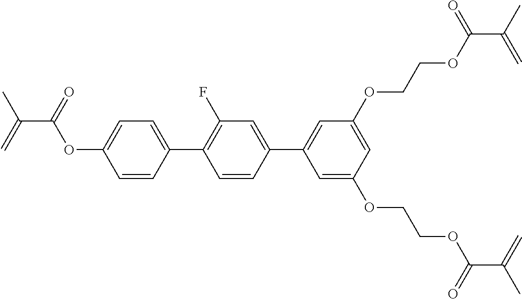 | RM-138 |
| 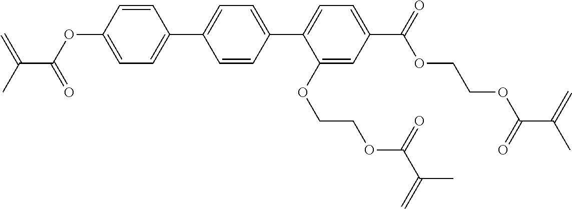 | RM-139 |
| 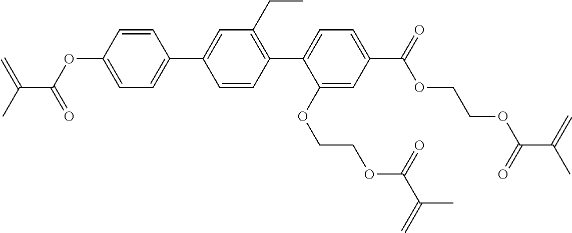 | RM-140 |
| 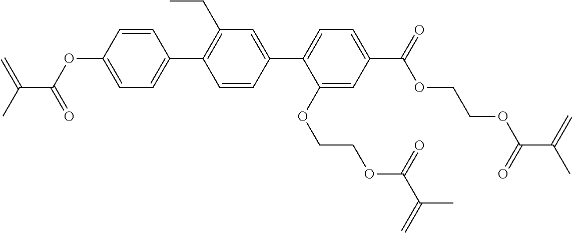 | RM-141 |
| 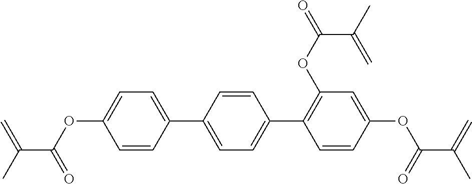 | RM-142 |
| 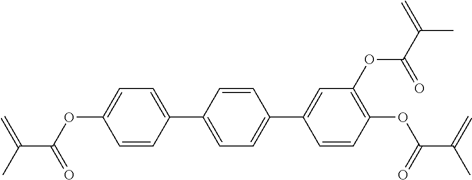 | RM-143 |
| 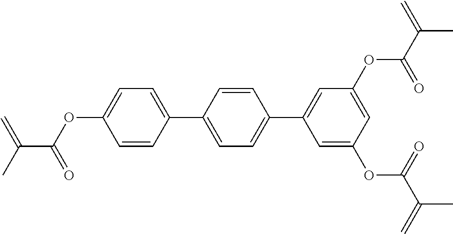 | RM-144 |
| 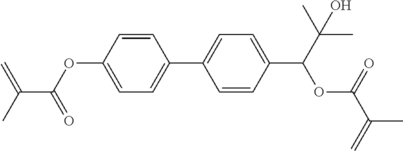 | RM-145 |
| 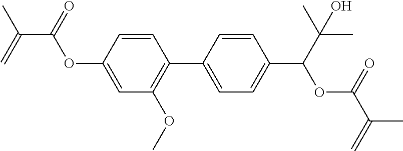 | RM-146 |
| 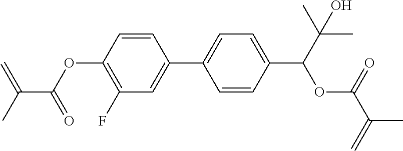 | RM-147 |
| 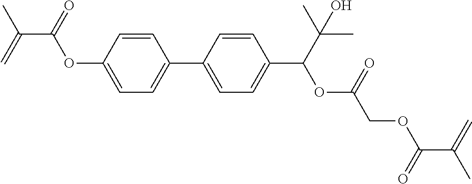 | RM-148 |
| 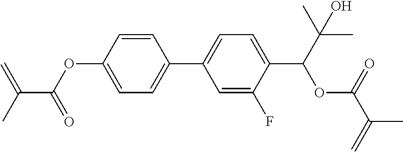 | RM-149 |
| 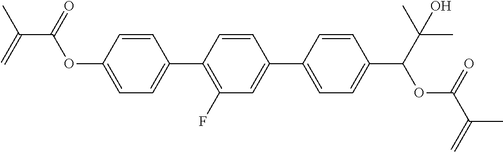 | RM-150 |
| 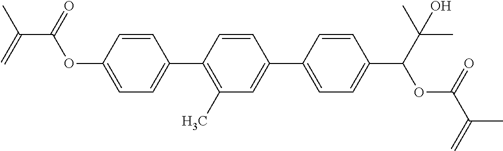 | RM-151 |
| 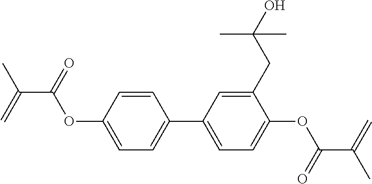 | RM-152 |
| 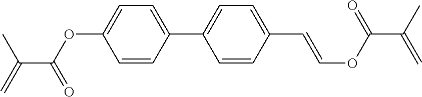 | RM-153 |
| 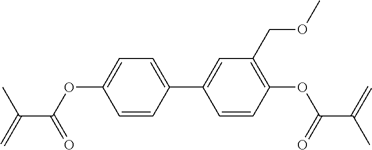 | RM-154 |
| 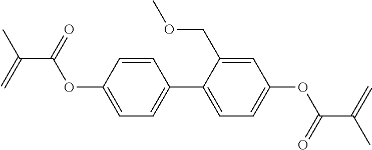 | RM-155 |
| 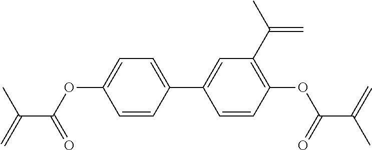 | RM-156 |
| 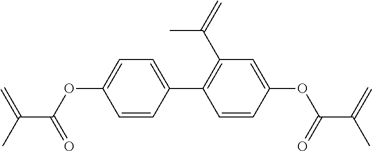 | RM-157 |
| 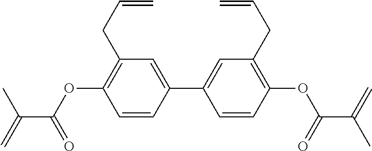 | RM-158 |
| 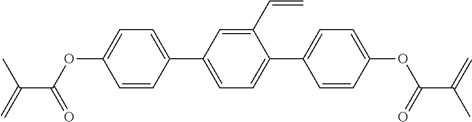 | RM-159 |
| 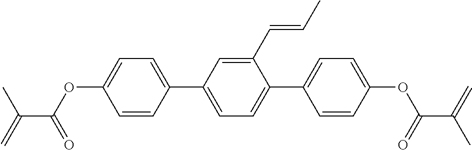 | RM-160 |
| 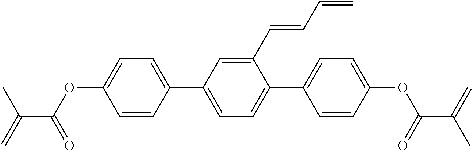 | RM-161 |
| 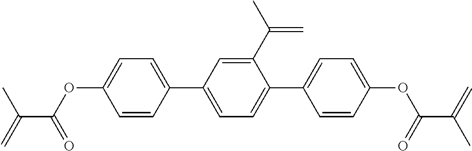 | RM-162 |
| 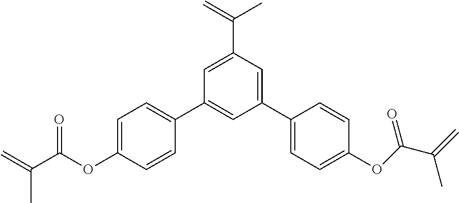 | RM-163 |
| 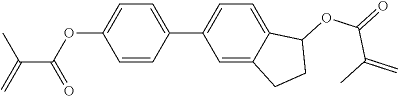 | RM-164 |
| 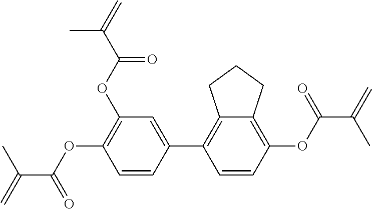 | RM-165 |
| 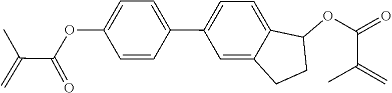 | RM-166 |
| 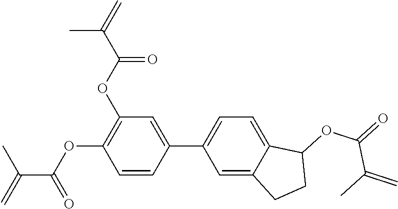 | RM-167 |
| 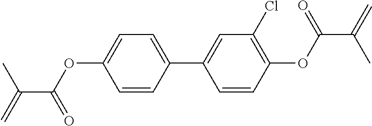 | RM-168 |
| 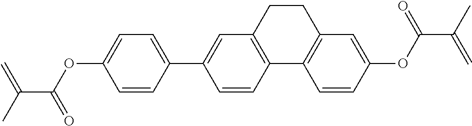 | RM-169 |
| 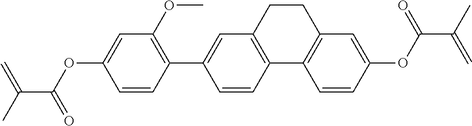 | RM-170 |
| 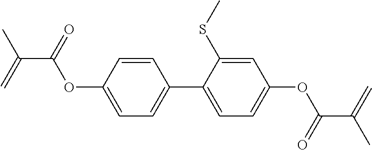 | RM-171 |
| 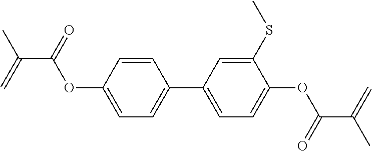 | RM-172 |
| 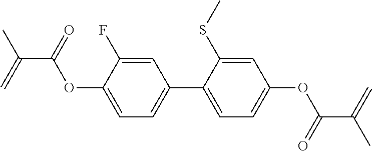 | RM-173 |
| 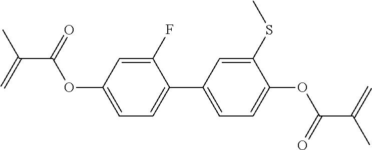 | RM-174 |
| 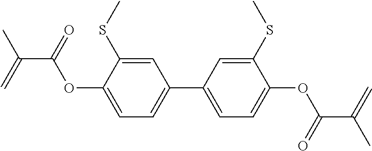 | RM-175 |
| 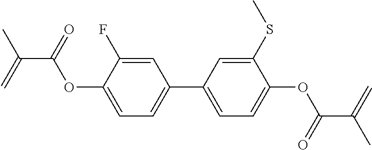 | RM-176 |
| 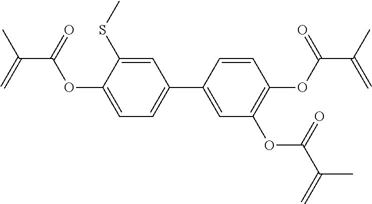 | RM-177 |
| 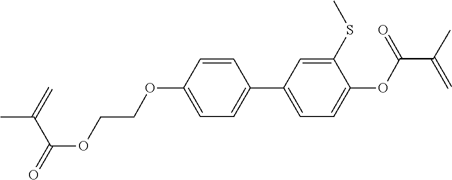 | RM-178 |
| 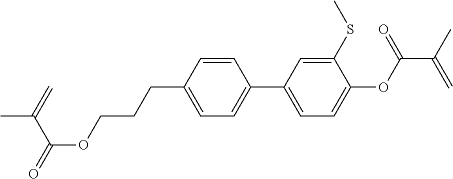 | RM-179 |
| 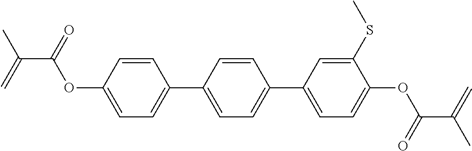 | RM-180 |
| 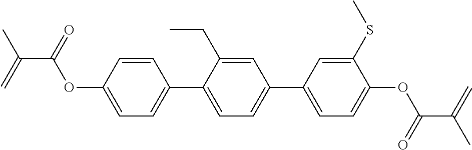 | RM-181 |
| 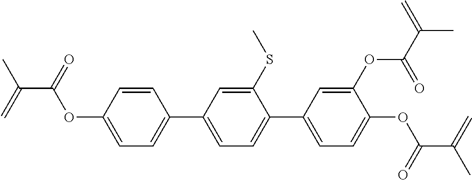 | RM-182 |
| 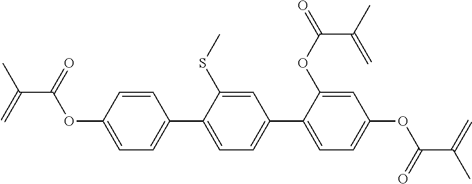 | RM-183 |

In a preferred embodiment, the LC media according to the invention comprise one or more polymerizable compounds, preferably selected from the polymerizable compounds of the Formulae RM-1 to RM-182. Of these compounds, compounds RM-1, RM-4, RM-8, RM-17, RM-19, RM-35, RM-37, RM-39, RM-40, RM-41, RM-48, RM-52, RM-54, RM-57, RM-58, RM-64, RM-74, RM-76, RM-88, RM-91, RM-102, RM-103, RM-109, RM-116, RM-117, RM-120, RM-121, RM-122, RM-139, RM-140, RM-142, RM-143, RM-145, RM-146, RM-147, RM-149, RM-156 to RM-163, RM-169, RM-170, and RM-171 to RM-183 are particularly preferred.

### Table I

Table I shows self-alignment additives for vertical alignment which can be used in LC media for SA-FFS, SA-HB-FFS, and SA-XB-FFS displays according to the present invention, optionally together with the polymerizable compounds of Formula I:

| | |
|---|---|
| 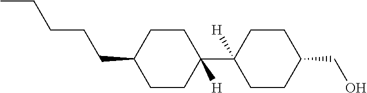 | SA-1 |
| 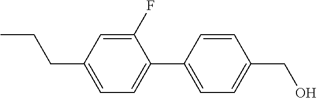 | SA-2 |
| 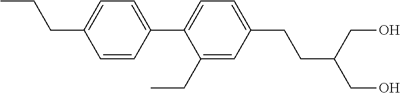 | SA-3 |
| 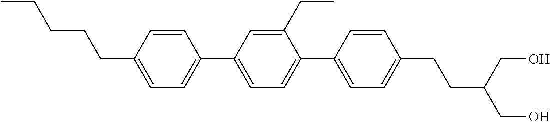 | SA-4 |
| 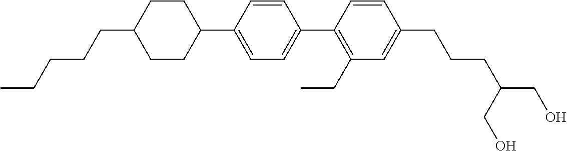 | SA-5 |
| 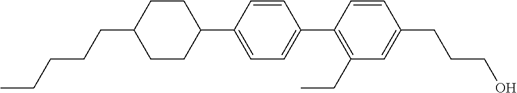 | SA-6 |
| 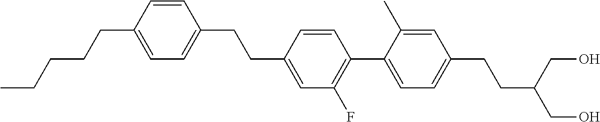 | SA-7 |
| 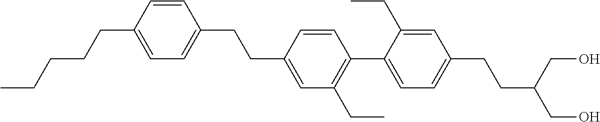 | SA-8 |
| 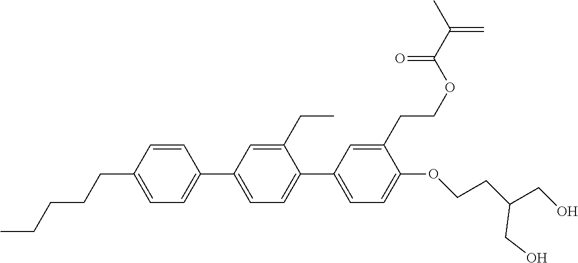 | SA-9 |
| 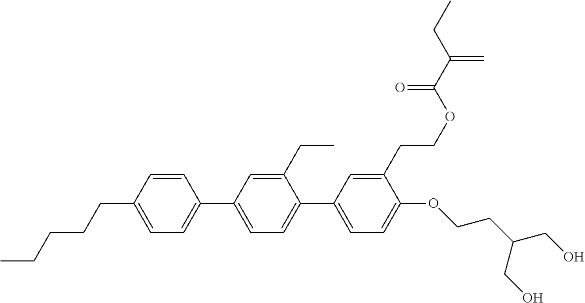 | SA-10 |
| 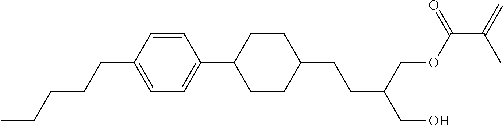 | SA-11 |
| 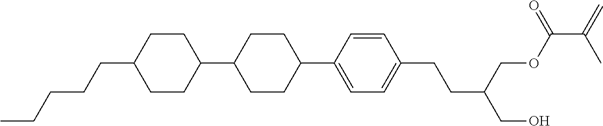 | SA-12 |
| 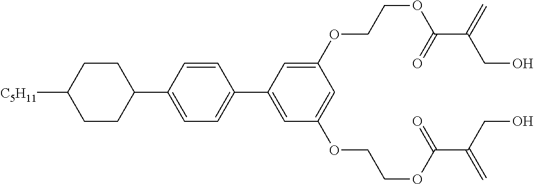 | SA-13 |
| 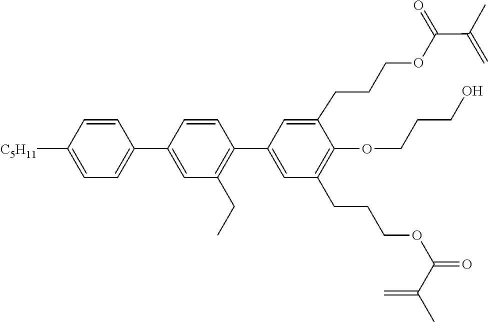 | SA-14 |
| 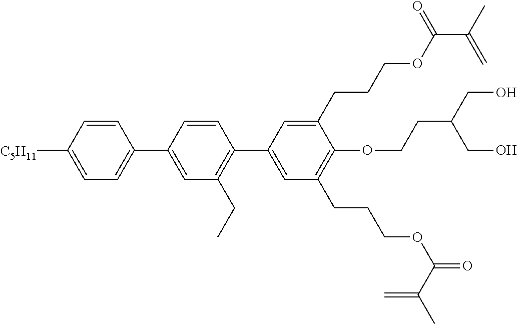 | SA-15 |
| 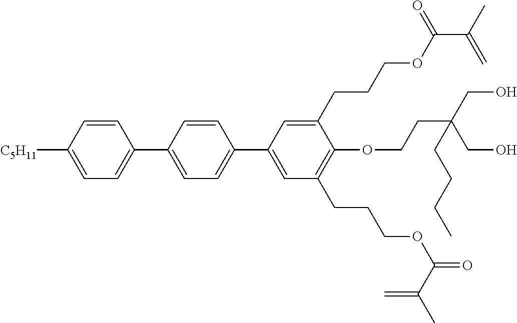 | SA-16 |
| 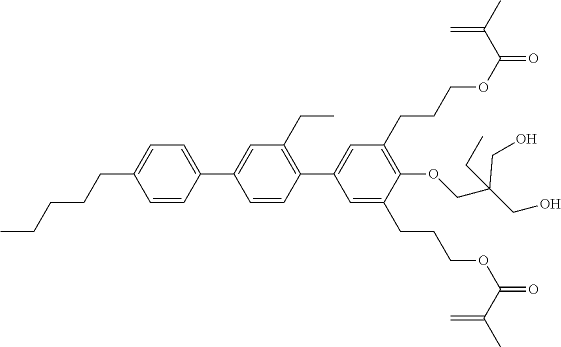 | SA-17 |
| 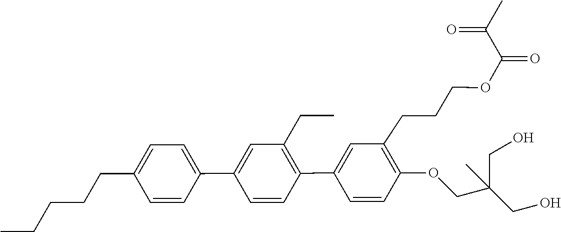 | SA-18 |
| 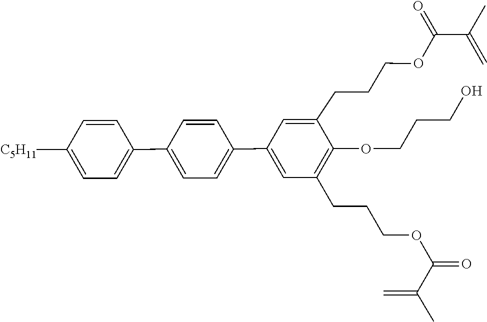 | SA-19 |
| 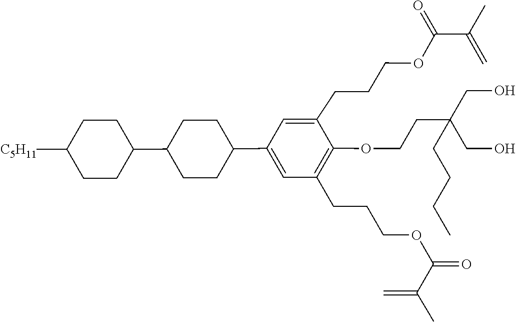 | SA-20 |
| 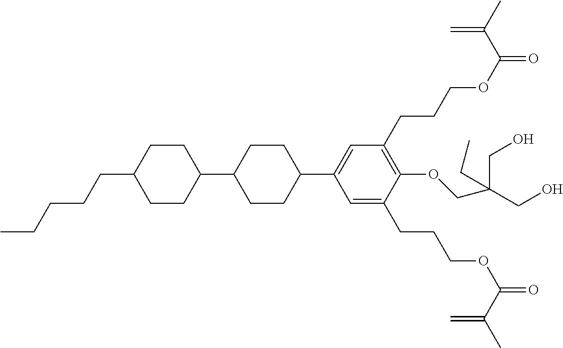 | SA-21 |
| 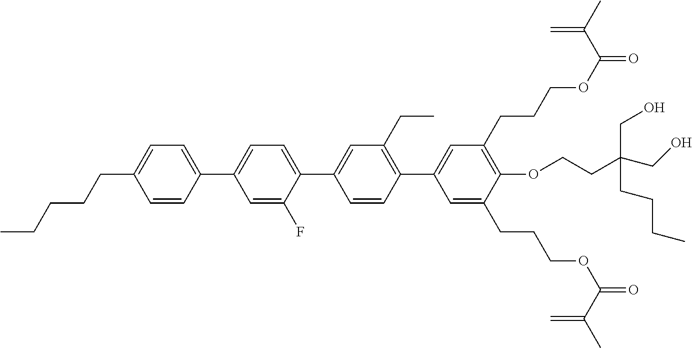 | SA-22 |
| 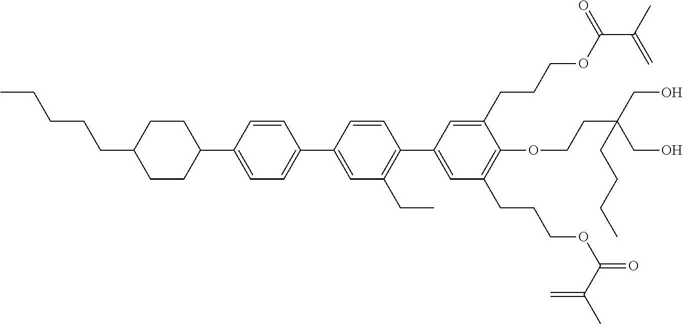 | SA-23 |
| 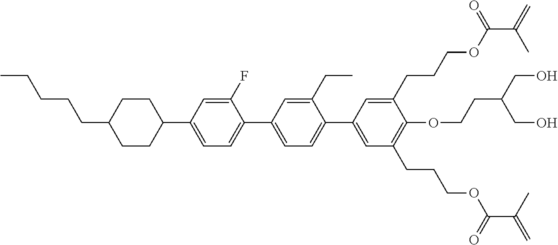 | SA-24 |
| 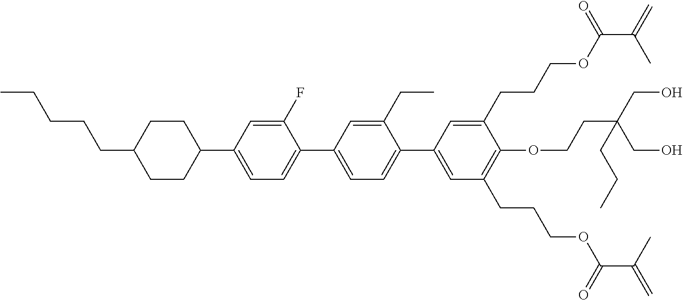 | SA-25 |
| 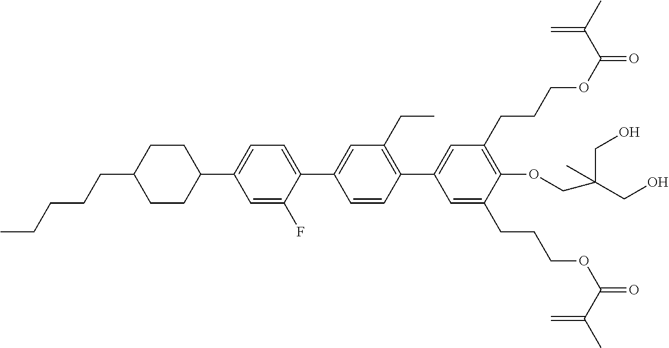 | SA-26 |
| 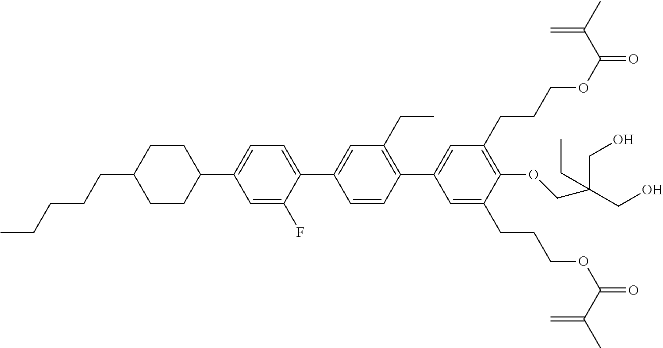 | SA-27 |
| 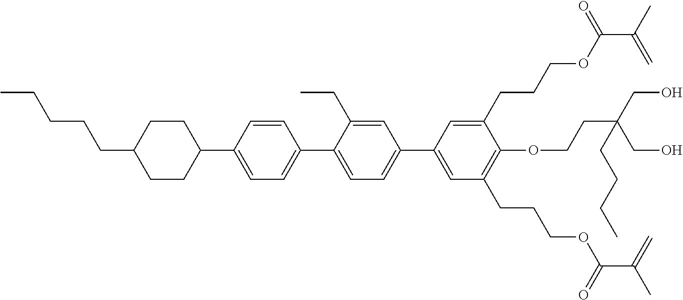 | SA-28 |
| 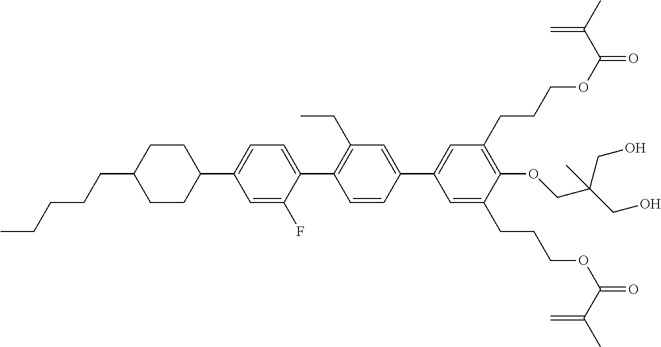 | SA-29 |
| 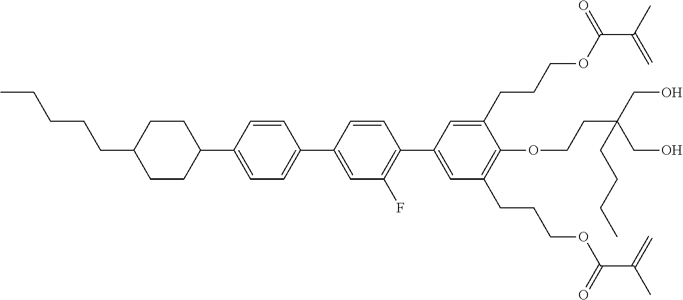 | SA-30 |
| 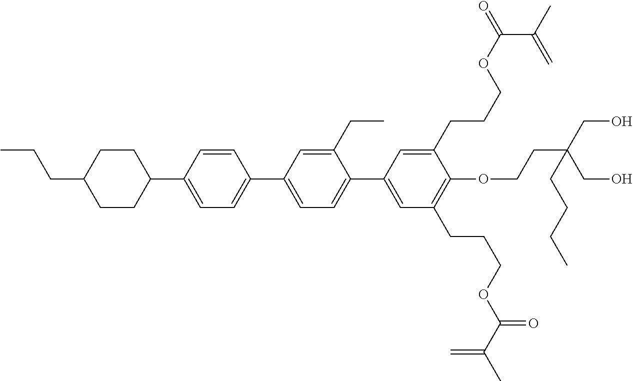 | SA-31 |
| 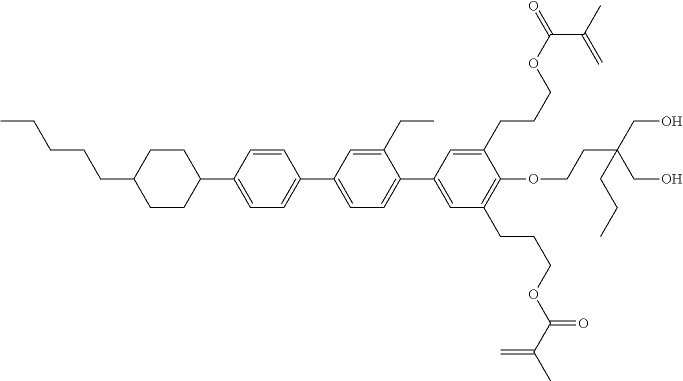 | SA-32 |
| 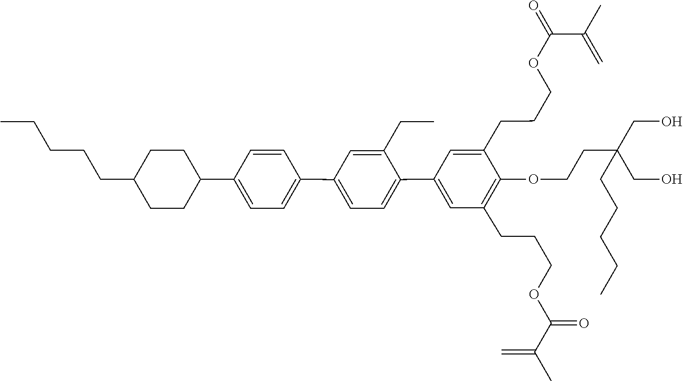 | SA-33 |
| 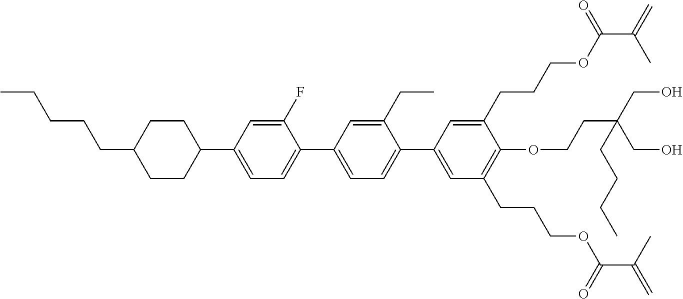 | SA-34 |
| 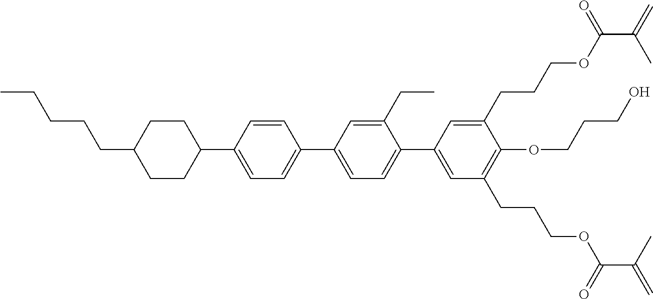 | SA-35 |
| 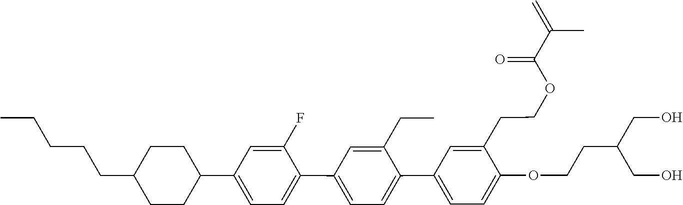 | SA-36 |
| 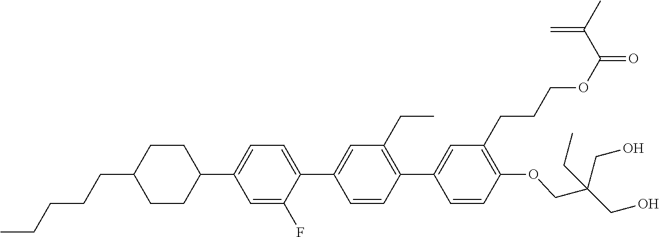 | SA-37 |
| 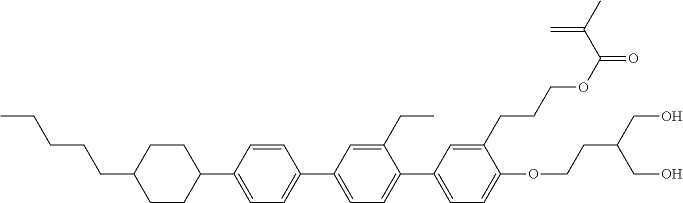 | SA-38 |
| 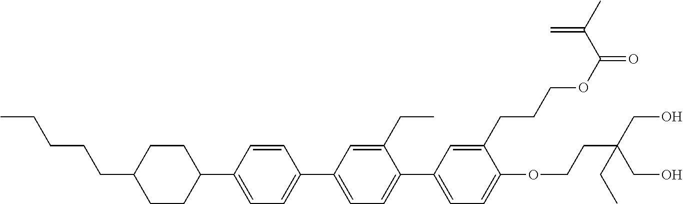 | SA-39 |
| 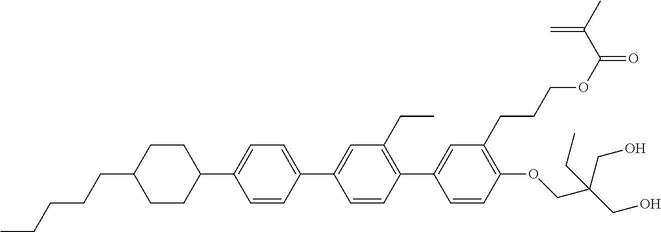 | SA-40 |
| 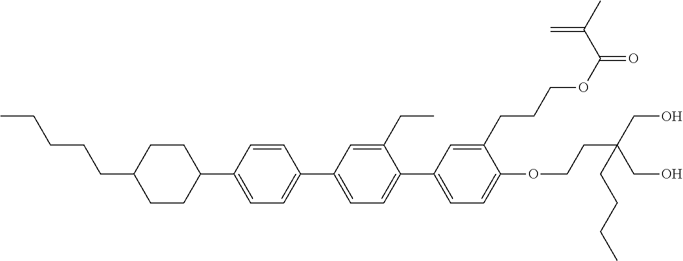 | SA-41 |
| 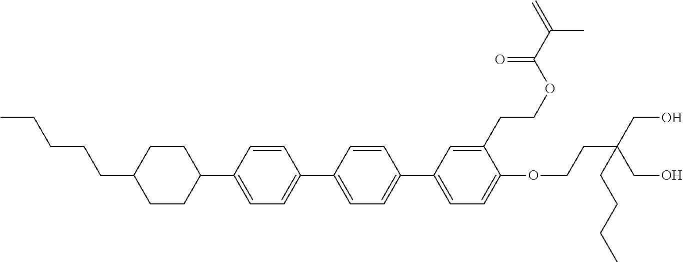 | SA-42 |
| 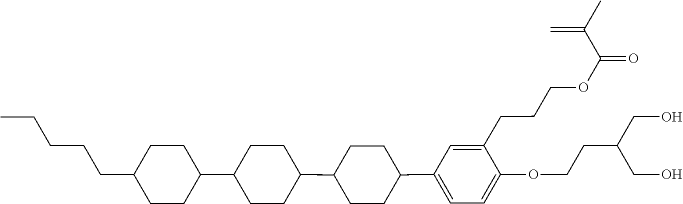 | SA-43 |
| 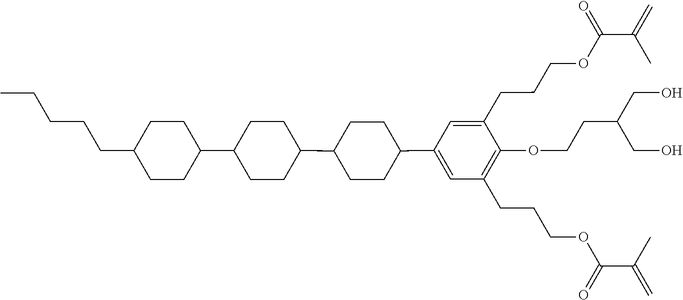 | SA-44 |
| 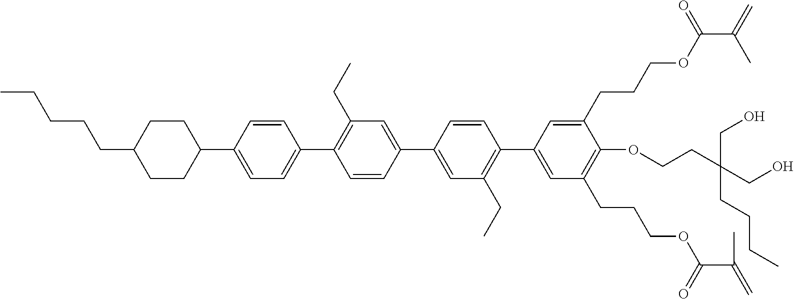 | SA-45 |
| 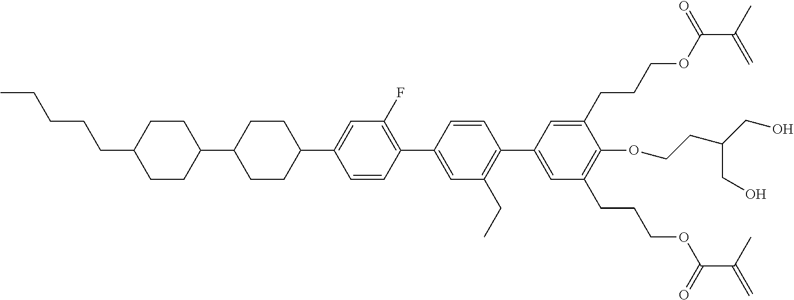 | SA-46 |
| 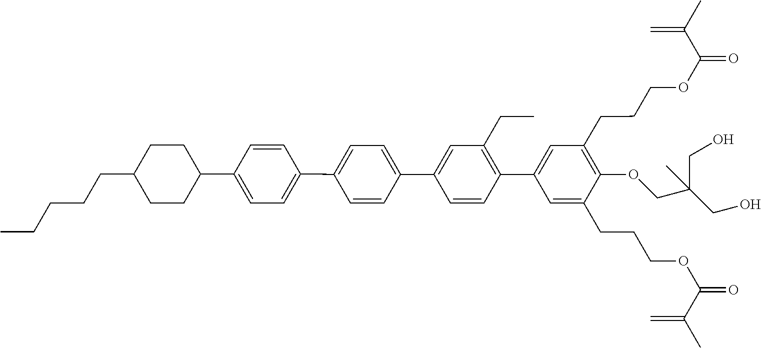 | SA-47 |
| 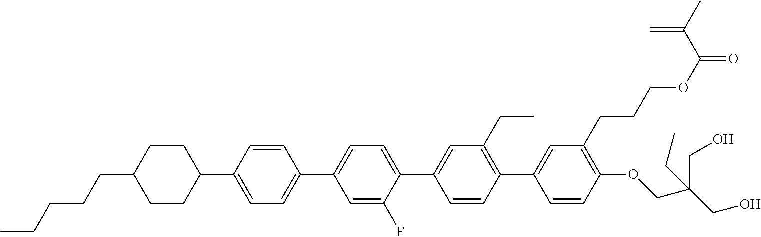 | SA-48 |

In a preferred embodiment, the LC media, SA-VA and SA-FFS displays according to the present invention comprise one or more SA additives selected from Formulae SA-1 to SA-48, preferably from Formulae SA-14 to SA-48, very preferably from Formulae SA-20 to SA-34 and SA-44, in combination with one or more RMs.

The following examples are intended to explain the invention without limiting it.

Above and below, percentage data denote percent by weight. All temperatures are indicated in degrees Celsius. m.p. denotes melting point, cl.p.=clearing point. Furthermore, C=crystalline state, N=nematic phase, S=smectic phase and I=isotropic phase. The data between these symbols represent the transition temperatures. Furthermore, the following symbols are used:
V₀ Freedericks threshold voltage, capacitive [V] at 25° C.,
V₁₀ voltage [V] for 10% transmission,
nₑ extraordinary refractive index measured at 25° C. and 589 nm,
nₒ ordinary refractive index measured at 25° C. and 589 nm,
Δn optical anisotropy measured at 25° C. and 589 nm,
ε_{⊥} dielectric susceptibility (or “dielectric constant”) perpendicular to the to the longitudinal axes of the molecules at 25° C. and 1 kHz,
ε_{∥} dielectric susceptibility (or “dielectric constant”) parallel to the to the longitudinal axes of the molecules at 25° C. and 1 kHz,
Δε dielectric anisotropy at 25° C. and 1 kHz,
cl.p. or
T(N,I) clearing point [C],
ν flow viscosity measured at 25° C. [mm²·s⁻¹],
γ₁ rotational viscosity measured at 25° C. [mPa·s],
K₁ elastic constant, “splay” deformation at 25° C. [pN],
K₂ elastic constant, “twist” deformation at 25° C. [pN],
K₃ elastic constant, “bend” deformation at 25° C. [pN], and
LTS low-temperature stability of the phase [h] in bulk
VHR voltage holding ratio.

All physical properties are determined in accordance with “Merck Liquid Crystals, Physical Properties of Liquid Crystals”, status November 1997, Merck KGaA, Germany, under a temperature of 25° C., unless explicitly indicated otherwise.

### Comparative Base Mixture M1

A nematic LC medium is formulated as follows:

| Composition | | | | | |
|---|---|---|---|---|---|
| | | Concentration, | | | |
| Nr. | Compound | wt. % | Properties | | |
| 1 | PGU-2-F | 6.50 | T(N, I) | = | 75° C. |
| 2 | DGUQU-4-F | 5.50 | n_{\|\|} (25° C., 1 kHz) | = | 1.6341 |
| 3 | PGUQU-3-F | 5.00 | n_{⊥} (25° C., 1 kHz) | = | 1.4955 |
| 4 | CC-3-V | 44.00 | Δn (25° C., 589 nm) | = | 0.1386 |
| 5 | CC-3-V1 | 4.00 | ε_{\|\|} (25° C., 1 kHz) | = | 7.5 |
| 6 | CCP-V-1 | 5.50 | ε_{⊥} (25° C., 1 kHz) | = | 2.9 |
| 7 | PGP-2-2V | 4.00 | Δε (25° C., 1 kHz) | = | 4.6 |
| 8 | PUS-3-2 | 25.00 | K₁ (25° C.) | = | 12.9 pN |
| 9 | PPGU-3-F | 0.50 | K₃ (25° C.) | = | 11.5 pN |
| | | | V₀ (25° C.) | = | 1.76 V |
| | | | γ₁ (25° C.) | = | 43 mPa · s |
| | | | γ₁/K₁ | = | 3.33 |

The LC medium shows a nematic phase at −14° C. but formation of a smectic phase takes place at lower temperatures.

### Comparative Mixture Example S1

A nematic LC medium according to the invention is formulated as follows:

| | |
|---|---|
| Comparative Mixture M1 | 99.99 wt.% |
| Compound of Formula ST-1-3 | 100 ppm |

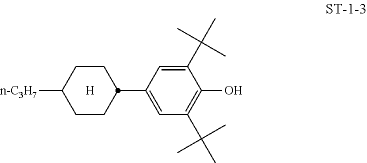

Addition of ST-1-3 significantly improves the VHR100 after UV exposure compared to the non-stabilized mixture M1 without affecting the remaining physical properties of the mixture M1.

### Comparative Base Mixture M2

A nematic LC medium is formulated as follows:

| Composition | | | | | |
|---|---|---|---|---|---|
| | | Concentration, | | | |
| Nr. | Compound | wt. % | Properties | | |
| 1 | PGU-3-F | 6.50 | T(N, I) | = | 75.1° C. |
| 2 | DGUQU-4-F | 5.50 | n_{\|\|} (25° C., 1 kHz) | = | 1.6348 |
| 3 | PGUQU-3-F | 5.00 | n_{⊥} (25° C., 1 kHz) | = | 1.4947 |
| 4 | CC-3-V | 44.00 | Δn (25° C., 589 nm) | = | 0.1401 |
| 5 | CC-3-V1 | 4.50 | ε_{\|\|} (25° C., 1 kHz) | = | 7.5 |
| 6 | CCP-V-1 | 4.00 | ε_{⊥} (25° C., 1 kHz) | = | 2.9 |
| 7 | PGP-2-2V | 5.00 | Δε (25° C., 1 kHz) | = | 4.6 |
| 8 | PUS-3-2 | 25.00 | K₁ (25° C.) | = | 13.2 pN |
| 9 | PPGU-3-F | 0.50 | K₃ (25° C.) | = | 11.6 pN |
| | | | V₀ (25° C.) | = | 1.79 V |
| | | | γ₁ (25° C.) | = | 44 mPa · s |
| | | | γ₁/K₁ | = | 3.33 |

The LC medium shows a nematic phase at −15° C. but formation of a smectic phase takes place at lower temperatures.

### Comparative Mixture Example S2

A nematic LC medium according to the invention is formulated as follows:

| | |
|---|---|
| Comparative Mixture M2 | 99.98 wt. % |
| Compound of Formula ST-2-3 | 200 ppm |

Addition of ST-2-3 significantly improves the VHR100 after UV exposure compared to the non-stabilized mixture M2 without affecting the remaining physical properties of the mixture M2.

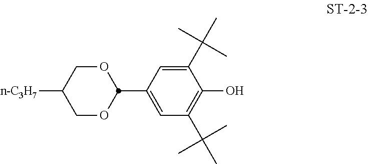

### Inventive Base Mixture M3

A nematic LC medium is formulated as follows:

| Composition | | | | | |
|---|---|---|---|---|---|
| | | Concentration, | | | |
| Nr. | Compound | wt. % | Properties | | |
| 1 | PGU-2-F | 7.50 | T(N, I) | = | 74.1° C. |
| 2 | DGUQU-4-F | 5.00 | n_{\|\|} (25° C., 1 kHz) | = | 1.6326 |
| 3 | PGUQU-3-F | 5.00 | n_{⊥} (25° C., 1 kHz) | = | 1.4941 |
| 4 | CC-3-V | 44.00 | Δn (25° C., 589 nm) | = | 0.1385 |
| 5 | CC-3-V1 | 8.00 | ε_{\|\|} (25° C., 1 kHz) | = | 7.4 |
| 6 | CPTP-3-2 | 5.00 | ε_{⊥} (25° C., 1 kHz) | = | 2.8 |
| 7 | PUS-3-2 | 25.00 | Δε (25° C., 1 kHz) | = | 4.6 |
| 8 | PPGU-3-F | 0.50 | K₁ (25° C.) | = | 12.6 pN |
| | | | K₃ (25° C.) | = | 11.2 pN |
| | | | V₀ (25° C.) | = | 1.77 V |
| | | | γ₁ (25° C.) | = | 43 mPa · s |
| | | | γ₁/K₁ | = | 3.41 |
| | | | LTS bulk [h, −20° C.]: | = | 1000 h |

Although the LC medium has a high overall content of CC-3-V and CC-3-V1, due to the presence of CPTP-3-2 it retains a nematic phase even at −23° C. and shows an excellent low temperature stability (LTS) at −20° C.

### Inventive Mixture Example S3

A nematic LC medium according to the invention is formulated as follows:

| | |
|---|---|
| Inventive Mixture M3 | 99.9 wt. % |
| Compound of Formula H-3-1 | 1000 ppm |

Addition of H-3-1 significantly improves the VHR100 after UV exposure compared to the non-stabilized mixture M3 without affecting the remaining physical properties of the mixture M3.

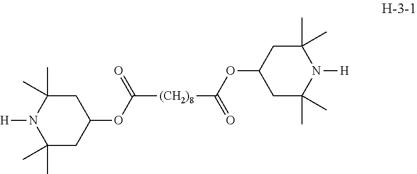

### Inventive Base Mixture M4

A nematic LC medium is formulated as follows:

| Composition | | | | | |
|---|---|---|---|---|---|
| | | Concentration, | | | |
| Nr. | Compound | wt. % | Properties | | |
| 1 | PGU-2-F | 7.50 | T(N, I) | = | 75.2° C. |
| 2 | DGUQU-4-F | 5.00 | n_{∥} (25° C., 1 kHz) | = | 1.6322 |
| 3 | PGUQU-3-F | 5.00 | n_{⊥} (25° C., 1 kHz) | = | 1.4931 |
| 4 | CC-3-V | 44.00 | Δn (25° C., 589 nm) | = | 0.1391 |
| 5 | CC-3-V1 | 8.50 | ε_{∥} (25° C., 1 kHz) | = | 7.5 |
| 6 | CPTP-3-01 | 4.50 | ε_{⊥} (25° C., 1 kHz) | = | 2.8 |
| 7 | PUS-3-2 | 25.00 | Δε (25° C., 1 kHz) | = | 4.7 |
| 8 | PPGU-3-F | 0.50 | K₁ (25° C.) | = | 12.8 pN |
| | | | K₃ (25° C.) | = | 11.7 pN |
| | | | V₀ (25° C.) | = | 1.77 V |
| | | | γ₁ (25° C.) | = | 45 mPa·s |
| | | | γ₁/K₁ | = | 3.52 |

Although the LC medium has a high overall content of CC-3-V and CC-3-V1, due to the presence of CPTP-3-01 it retains a nematic phase even at −26° C. and shows an excellent low temperature stability (LTS) at −20° C.

Hence, presence of compounds of Formula T1 such as CPTP-3-2 or CPTP-3-01 allows a significant lowering of the phase transition temperature (nematic to smectic). Additionally, CPTP-3-2 has even a better compatibility with the LC medium than CPTP-3-01 at lower temperatures.

### Inventive Mixture Example S4

A nematic LC medium according to the invention is formulated as follows:

| | |
|---|---|
| Inventive Mixture M4 | 99.9 wt. % |
| Compound of Formula H-3-3 | 1 000 ppm |

Addition of H-3-3 significantly improves the VHR100 after UV exposure compared to the non-stabilized mixture M4 without affecting the remaining physical properties of the mixture M4.

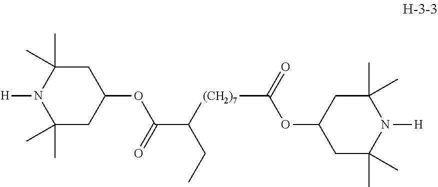

### Inventive Base Mixture M5

A nematic LC medium is formulated as follows:

| Composition | | | | | |
|---|---|---|---|---|---|
| | | Concentration, | | | |
| Nr. | Compound | wt. % | Properties | | |
| 1 | PGU-2-F | 7.50 | T(N, I) | = | 73.9° C. |
| 2 | DGUQU-4-F | 5.00 | nₑ (25° C., 1 kHz) | = | 1.6323 |
| 3 | PGUQU | 5.00 | nₒ (25° C., 1 kHz) | = | 1.4944 |
| | (1)-3-F | | | | |
| 4 | CC-3-V | 44.00 | Δn (25° C., 589 nm) | = | 0.1379 |
| 5 | CC-3-V1 | 8.00 | ε_{∥} (25° C., 1 kHz) | = | 7.4 |
| 6 | CPTP-3-2 | 5.00 | ε_{⊥} (25° C., 1 kHz) | = | 2.9 |
| 7 | PUS-3-2 | 25.00 | Δε (25° C., 1 kHz) | = | 4.5 |
| 8 | PPGU-3-F | 0.50 | γ₁ (25° C.) | = | 44 mPa·s |

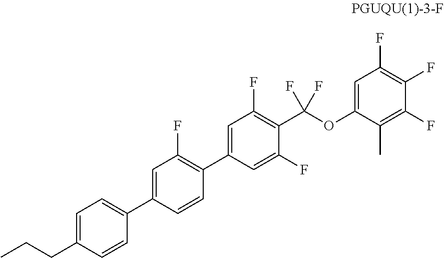 [SMILES: CCCc1ccc(-c2ccc(-c3cc(F)c(C(F)(F)Oc4cc(F)c(F)c(F)c4C)c(F)c3)c(F)c2)cc1]

### Inventive Mixture Example S5

A nematic LC medium according to the invention is formulated as follows:

| | |
|---|---|
| Inventive Mixture M5 | 99.995 wt. % |
| Compound of Formula H-3-5 | 50 ppm |

Addition of H-3-5 significantly improves the VHR100 after UV exposure compared to the non-stabilized mixture M5 without affecting the remaining physical properties of the mixture M5.

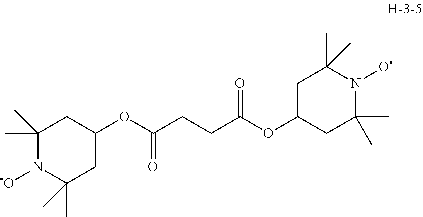

### Inventive Base Mixture M6

A nematic LC medium is formulated as follows:

| Composition | | | | | |
|---|---|---|---|---|---|
| Nr. | | | Properties | | |
| 1 | PGU-2-F | 7.50 | T(N, I) | = | 76° C. |
| 2 | DGUQU-4-F | 5.00 | nₑ (25° C., 1 kHz) | = | 1.6334 |
| 3 | PGUQU-3-F | 5.00 | nₒ (25° C., 1 kHz) | = | 1.4950 |
| 4 | CC-3-V | 44.00 | Δn (25° C., 589 nm) | = | 0.1384 |
| 5 | CC-3-V1 | 8.00 | ε_{∥} (25° C., 1 kHz) | = | 7.5 |
| 6 | CPTP-3-2 | 5.00 | ε_{⊥} (25° C., 1 kHz) | = | 2.8 |
| 7 | PUS-3-2 | 25.00 | Δε (25° C., 1 kHz) | = | 4.7 |
| 8 | PUS-(c5)-2 | 5.00 | γ₁ (25° C.) | = | 44 mPa·s |
| 9 | PPGU-3-F | 0.50 | | | |

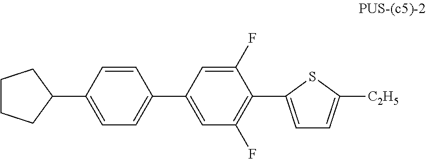 [SMILES: CCc1ccc(-c2c(F)cc(-c3ccc(C4CCCC4)cc3)cc2F)s1]

### Inventive Mixture Example S6

A nematic LC medium according to the invention is formulated as follows:

| | |
|---|---|
| Inventive Mixture M6 | 99.99 wt. % |
| Compound of Formula ST-1-3 | 100 ppm |

Addition of ST-1-3 significantly improves the VHR100 after UV exposure compared to the non-stabilized mixture M6 without affecting the remaining physical properties of the mixture M6.

### Inventive Base Mixture M7

A nematic LC medium is formulated as follows:

| Composition | | | | | |
|---|---|---|---|---|---|
| Nr. | | | Properties | | |
| 1 | PGU-2-F | 7.50 | T(N, I) | = | 73.3° C. |
| 2 | DGUQU-4-F | 6.00 | nₑ (25° C., 1 kHz) | = | 1.6314 |
| 3 | PGUQU- | 4.00 | nₒ (25° C., 1 kHz) | = | 1.4942 |
| | (c3)1-F | | | | |
| 4 | CC-3-V | 4.00 | Δn (25° C., 589 nm) | = | 0.1373 |
| 5 | CC-3-V1 | 8.00 | ε_{∥} (25° C., 1 kHz) | = | 7.5 |
| 6 | CPTP-3-2 | 5.00 | ε_{⊥} (25° C., 1 kHz) | = | 2.9 |
| 7 | PUS-3-2 | 25.00 | Δε (25° C., 1 kHz) | = | 4.6 |
| 8 | PPGU-3-F | 0.50 | γ₁ (25° C.) | = | 43 mPa·s |

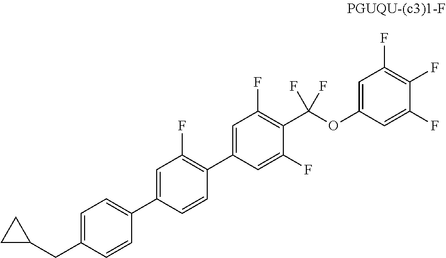 [SMILES: Fc1cc(-c2ccc(CC3CC3)cc2)ccc1-c1cc(F)c(C(F)(F)Oc2cc(F)c(F)c(F)c2)c(F)c1]

### Inventive Mixture Example S7

A nematic LC medium according to the invention is formulated as follows:

| | |
|---|---|
| Inventive Mixture M7 | 99.99 wt. % |
| Compound of Formula BHT-1 | 100 ppm |

Addition of BHT-1 improves the VHR100 after UV exposure compared to the non-stabilized mixture M7 without affecting the remaining physical properties of the mixture M7.

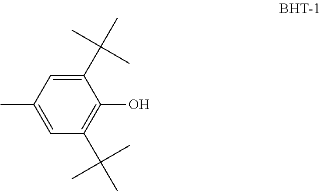 [SMILES: Cc1cc(C(C)(C)C)c(O)c(C(C)(C)C)c1]

### Inventive Base Mixture M8

A nematic LC medium is formulated as follows:

| Composition | | | | | |
|---|---|---|---|---|---|
| Nr. | | | Properties | | |
| 1 | PGU-2-F | 7.50 | T(N, I) | = | 74.9° C. |
| 2 | DGUQU-4-F | 5.00 | n_{∥} (25° C., 1 kHz) | = | 1.6307 |
| 3 | PGUQU-3-F | 5.00 | n_{⊥} (25° C., 1 kHz) | = | 1.4931 |
| 4 | CC-3-V | 32.00 | Δn (25° C., 589 nm) | = | 0.1370 |
| 5 | CC-3-V1 | 8.50 | ε_{∥} (25° C., 1 kHz) | = | 7.5 |
| 6 | CCH-23 | 12.00 | ε_{⊥} (25° C., 1 kHz) | = | 2.8 |
| 7 | CPTP-3-01 | 4.50 | Δε (25° C., 1 kHz) | = | 4.7 |
| 8 | PUS-3-2 | 25.00 | V₀ (25° C.) | = | 1.64 V |
| 9 | PPGU-3-F | 0.50 | γ₁ (25° C.) | = | 44 mPa·s |

### Inventive Mixture Example S8

A nematic LC medium according to the invention is formulated as follows:

| | |
|---|---|
| Inventive Mixture M8 | 99.99 wt. % |
| Compound of Formula BHT-6 | 100 ppm |

Addition of BHT-6 improves the VHR100 after UV exposure compared to the non-stabilized mixture M8 without affecting the remaining physical properties of the mixture M8.

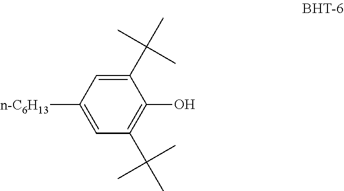

### Inventive Base Mixture M9

A nematic LC medium is formulated as follows:

| Composition | | | | | |
|---|---|---|---|---|---|
| Nr. | | | Properties | | |
| 1 | PGU-2-F | 7.50 | T(N, I) | = | 74.0° C. |
| 2 | DGUQU-4-F | 5.00 | nₑ (25° C., 1 kHz) | = | 1.6323 |
| 3 | PGUQU-3-F | 5.00 | nₒ (25° C., 1 kHz) | = | 1.4942 |
| 4 | CC-3-V | 44.00 | Δn (25° C., 589 nm) | = | 0.1381 |
| 5 | CC-3-V1 | 4.00 | ε_{∥} (25° C., 1 kHz) | = | 7.4 |
| 6 | CC-4-V1 | 4.00 | ε_{⊥} (25° C., 1 kHz) | = | 2.9 |
| 7 | CPTP-3-2 | 5.00 | Δε (25° C., 1 kHz) | = | 4.5 |
| 8 | PUS-3-2 | 25.00 | γ₁ (25° C.) | = | 43 mPa·s |
| 9 | PPGU-3-F | 0.50 | V₀ (25° C.) | = | 1.76 V |
| | | | K₁ (25° C.) | = | 12.5 pN |
| | | | K₃ (25° C.) | = | 11.1 pN |

### Inventive Mixture Example S9

A nematic LC medium according to the invention is formulated as follows:

| | |
|---|---|
| Inventive Mixture M9 | 99.99 wt. % |
| Compound of Formula BHT-7 | 100 ppm |

Addition of BHT-6 improves the VHR100 after UV exposure compared to the non-stabilized mixture M9 without affecting the remaining physical properties of the mixture M9

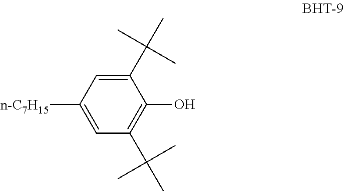

### Inventive Base Mixture M10

A nematic LC medium is formulated as follows:

| Composition | | | | | |
|---|---|---|---|---|---|
| Nr. | | | Properties | | |
| 1 | PGU-2-F | 7.50 | T(N, I) | = | 73.8° C. |
| 2 | DGUQU-4-F | 5.00 | nₑ (25° C., 1 kHz) | = | 1.6321 |
| 3 | PGUQU-3-F | 5.00 | nₒ (25° C., 1 kHz) | = | 1.4940 |
| 4 | CC-3-V | 44.00 | Δn (25° C., 589 nm) | = | 0.1381 |
| 5 | CC-3-V1 | 4.00 | ε_{∥} (25° C., 1 kHz) | = | 7.4 |
| 6 | CC-4-V1 | 4.00 | ε_{⊥} (25° C., 1 kHz) | = | 2.9 |
| 7 | CPTP-3-2 | 5.00 | Δε (25° C., 1 kHz) | = | 4.5 |
| 8 | PUS-3-2 | 20.00 | γ₁ (25° C.) | = | 44 mPa·s |
| 9 | PUS-(c3) 1-2 | 5.00 | V₀ (25° C.) | = | 1.74 V |
| 10 | PPGU-3-F | 0.50 | K₁ (25° C.) | = | 12.1 pN |
| | | | K₃ (25° C.) | = | 10.9 pN |

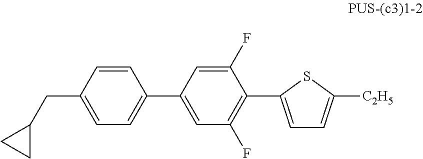 [SMILES: CCc1ccc(-c2c(F)cc(-c3ccc(CC4CC4)cc3)cc2F)s1]

### Inventive Mixture Example S10

A nematic LC medium according to the invention is formulated as follows:

| | |
|---|---|
| Inventive Mixture M10 | 99.99 wt. % |
| Compound of Formula ST-1-3 | 100 ppm |

Addition of ST-1-3 significantly improves the VHR100 after UV exposure compared to the non-stabilized mixture M10 without affecting the remaining physical properties of the mixture M10.

### Inventive Base Mixture M11

A nematic LC medium is formulated as follows:

| Composition | | | | | |
|---|---|---|---|---|---|
| Nr. | | | Properties | | |
| 1 | CC-3-V | 3.0 | T(N, I) | = | 119.6° C. |
| 2 | CCH-301 | 8.0 | Δn (25° C., 589 nm) | = | 0.2791 |
| 3 | CPGP-5-2 | 3.0 | Δε (25° C., 1 kHz) | = | 10.9 |
| 4 | PGUQU-3-F | 3.0 | γ₁ (25° C.) | = | 240 mPa·s |
| 5 | PGUQU-5-F | 3.0 | K₁ (25° C.) | = | 13.4 pN |
| 6 | PPTUI-3-2 | 25.0 | K₃ (25° C.) | = | 15.6 pN |
| 7 | PPTUI-3-4 | 26.0 | V₀ (25° C.) | = | 1.15 V |
| 8 | PUS-3-2 | 11.0 | Δn (20° C., 589 nm) | = | 0.2820 |
| 9 | ME4N.F | 9.0 | ε_{∥} (20° C.): | = | 15.3 |
| 10 | ME2N.F | 4.0 | ε_{⊥} (20° C.): | = | 4.0 |
| 11 | CPTP-301 | 3.0 | Δε (20° C.): | = | 11.4 |
| 12 | PTP-102 | 2.0 | γ₁ (20° C.) | = | 307 mPa·s |
| | | | K₁ (20° C.) | = | 13.9 pN |
| | | | K₃ (20° C.) | = | 17.1 pN |
| | | | V₀ (20° C.) | = | 1.17 V |

### Inventive Mixture Example S11

A nematic LC medium according to the invention is formulated as follows:

| | |
|---|---|
| Inventive Mixture M11 | 99.4 wt.% |
| Compound of Formula ST-1-3 | 2000 ppm |
| Compound of Formula SU-1 | 4000 ppm |

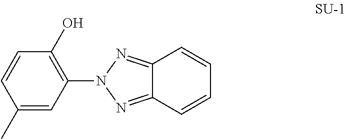 [SMILES: Cc1ccc(O)c(-n2nc3ccccc3n2)c1]

Addition of ST-1-3 in combination with SU-1 significantly improves the VHR100 after UV exposure compared to the non-stabilized mixture M11 without affecting the remaining physical properties of the mixture M11.

### Inventive Base Mixture M12

A nematic LC medium is formulated as follows:

| Nr. | Composition | | Properties | | |
|---|---|---|---|---|---|
| 1 | APUQU-3-F | 3.0 | T(N, I) | = | 132.6° C. |
| 2 | CC-3-V | 3.0 | Δn (25° C., 589 nm) | = | 0.2791 |
| 3 | CCH-301 | 8.0 | Δε (25° C., 1 kHz) | = | 7.1 |
| 4 | CPGP-5-2 | 4.0 | γ₁ (25° C.) | = | 254 mPa · s |
| 5 | CPGP-5-3 | 4.0 | K₁ (25° C.) | = | 15.9 pN |
| 6 | PGUQU-3-F | 3.5 | K₃ (25° C.) | = | 20.7 pN |
| 7 | PGUQU-5-F | 3.5 | V₀ (25° C.) | = | 1.56 V |
| 8 | PPTUI-3-2 | 20.0 | | | |
| 9 | PPTUI-3-4 | 31.0 | | | |
| 10 | PUQU-3-F | 10.0 | | | |
| 11 | PUS-3-2 | 10.0 | | | |

### Inventive Mixture Example S12

A nematic LC medium according to the invention is formulated as follows:

| | |
|---|---|
| Inventive Mixture M12 | 99.4 wt.% |
| Compound of Formula ST-1-3 | 2000 ppm |
| Compound of Formula SU-1 | 4000 ppm |

Addition of ST-1-3 in combination with SU-1 significantly improves the VHR100 after UV exposure compared to the non-stabilized mixture M12 without affecting the remaining physical properties of the mixture M12.

### Inventive Base Mixture M13

A nematic LC medium is formulated as follows:

| Nr. | Composition | | Properties | | |
|---|---|---|---|---|---|
| 1 | CC-3-V | 3.0 | T(N, I) | = | 108.1 ° C. |
| 2 | ME4N.F | 11.0 | Δn (25° C., 589 nm) | = | 0.2757 |
| 3 | PPTUI-3-2 | 25.0 | Δε (25° C., 1 kHz) | = | 11.5 |
| 4 | PPTUI-3-4 | 28.0 | γ₁ (25° C.) | = | 216 mPa · s |
| 5 | PUS-3-2 | 10.0 | K₁ (25° C.) | = | 11.8 pN |
| 6 | CPTP-301 | 4.0 | K₃ (25° C.) | = | 15.9 pN |
| 7 | PTP-102 | 4.0 | V₀ (25° C.) | = | 1.04 V |
| 8 | ME2N.F | 7.0 | Δn (20° C., 589 nm): | = | 0.2789 |
| 9 | CCH-301 | 8.0 | ε_{\|\|} (20° C.): | = | 16.3 |
| | | | ε_{⊥} (20° C.): | = | 4.3 |
| | | | Δε (20° C.): | = | 12.0 |
| | | | γ₁ (20° C.) | = | 277 mPa · s |
| | | | K₁ (20° C.) | = | 12.3 pN |
| | | | K₃ (20° C.) | = | 17.3 pN |
| | | | V₀ (20° C.) | = | 1.07 V |

### Inventive Mixture Example S13

A nematic LC medium according to the invention is formulated as follows:

| | |
|---|---|
| Inventive Mixture M13 | 99.4 wt.% |
| Compound of Formula ST-1-3 | 2000 ppm |
| Compound of Formula SU-1 | 4000 ppm |

Addition of ST-1-3 in combination with SU-1 significantly improves the VHR100 after UV exposure compared to the non-stabilized mixture M13 without affecting the remaining physical properties of the mixture M13.

### Inventive Base Mixture M14

A nematic LC medium is formulated as follows:

| Nr. | Composition | | Properties | | |
|---|---|---|---|---|---|
| 1 | CC-3-V | 3.0 | T(N, I) | = | 126.3° C. |
| 2 | CCH-301 | 8.0 | Δn (25° C., 589 nm) | = | 0.2761 |
| 3 | CPGP-5-2 | 4.0 | Δε (25° C., 1 kHz) | = | 11.1 |
| 4 | CPGP-5-3 | 4.0 | γ₁ (25° C.) | = | 270 mPa · s |
| 5 | PGUQU-3-F | 3.0 | K₁ (25° C.) | = | 15.0 pN |
| 6 | PGUQU-5-F | 3.0 | K₃ (25° C.) | = | 17.7 pN |
| 7 | PPTUI-3-2 | 20.0 | V₀ (25° C.) | = | 1.20 V |
| 8 | PPTUI-3-4 | 31.0 | Δn (20° C., 589 nm): | = | 0.2785 |
| 9 | PUS-3-2 | 11.0 | ε_{\|\|} (20° C.): | = | 15.4 |
| 10 | ME4N.F | 9.0 | ε_{⊥} (20° C.): | = | 3.9 |
| 11 | ME2N.F | 4.0 | Δε (20° C.): | = | 11.5 |
| | | | γ₁ (20° C.) | = | 331 mPa · s |
| | | | K₁ (20° C.) | = | 15.3 pN |
| | | | K₃ (20° C.) | = | 18.9 pN |
| | | | V₀ (20° C.) | = | 1.22 V |

### Inventive Mixture Example S14

A nematic LC medium according to the invention is formulated as follows:

| | |
|---|---|
| Inventive Mixture M14 | 99.4 wt.% |
| Compound of Formula ST-1-3 | 2000 ppm |
| Compound of Formula SU-1 | 4000 ppm |

Addition of ST-1-3 in combination with SU-1 significantly improves the VHR100 after UV exposure compared to the non-stabilized mixture M14 without affecting the remaining physical properties of the mixture M14.

### Inventive Base Mixture M15

A nematic LC medium is formulated as follows:

| Nr. | Composition | | Properties | | |
|---|---|---|---|---|---|
| 1 | PUQU-3-F | 17 | T(N, I) | = | 104.5° C. |
| 2 | APUQU-3-F | 7 | Δn (25° C., 589 nm) | = | 0.244 |
| 3 | PGUQU-3-F | 8 | Δε (25° C., 1 kHz) | = | 11.9 |
| 4 | CC-3-V | 17 | γ₁ (25° C.) | = | 146 mPa · s |
| 5 | PPTUI-3-2 | 18 | K₁ (25° C.) | = | 16.9 pN |
| 6 | PPTUI-3-4 | 18 | K₃ (25° C.) | = | 15.9 pN |
| 7 | PUS-3-2 | 5 | V₀ (25° C.) | = | 1.22 V |
| 8 | PGS-2-1 | 10 | Δn (20° C., 589 nm): | = | 0.2470 |
| | | | ε_{\|\|} (20° C.): | = | 15.9 |
| | | | ε_{⊥} (20° C.): | = | 3.6 |
| | | | Δε (20° C.): | = | 12.4 |
| | | | γ₁ (20° C.) | = | 187 mPa · s |
| | | | K₁ (20° C.) | = | 17.4 pN |
| | | | K₃ (20° C.) | = | 17.4 pN |
| | | | V₀ (20° C.) | = | 1.25 V |

### Inventive Mixture Example S15

A nematic LC medium according to the invention is formulated as follows:

| | |
|---|---|
| Inventive Mixture M15 | 99.6 wt. % |
| Compound of Formula SU-1 | 4000 ppm |

Addition of SU-1 significantly improves the VHR100 after UV exposure compared to the non-stabilized mixture M15 without affecting the remaining physical properties of the mixture M15.

### Inventive Base Mixture M16

A nematic LC medium is formulated as follows:

| Nr. | Composition | | Properties | | |
|---|---|---|---|---|---|
| 1 | APUQU-3-F | 3.0 | T(N, I) | = | ° C. |
| 2 | CC-3-V | 9.0 | Δn (25° C., 589 nm) | = | |
| 3 | CCH-301 | 2.0 | Δε (25° C., 1 kHz) | = | |
| 4 | CCP-V-1 | 7.0 | γ₁ (25° C.) | = | mPa · s |
| 5 | CPGP-5-2 | 4.0 | K₁ (25° C.) | = | pN |
| 6 | CPGP-5-3 | 4.0 | K₃ (25° C.) | = | pN |
| 7 | PGUQU-3-F | 3.5 | V₀ (25° C.) | = | V |
| 8 | PGUQU-5-F | 3.5 | | | |
| 9 | PPTUI-3-2 | 20.0 | | | |
| 10 | PPTUI-3-4 | 31.0 | | | |
| 11 | PUQU-3-F | 3.0 | | | |
| 12 | PUS-3-2 | 10.0 | | | |

### Inventive Base Mixture M17

A nematic LC medium is formulated as follows:

| Nr. | Composition | | Properties | | |
|---|---|---|---|---|---|
| 1 | CC-3-V | 7.0 | T(N, I) | = | ° C. |
| 2 | CPGP-5-2 | 4.0 | Δn (25° C., 589 nm) | = | |
| 3 | CPTP-301 | 4.0 | Δε (25° C., 1 kHz) | = | |
| 4 | ME2N.F | 9.0 | γ₁ (25° C.) | = | mPa · s |
| 5 | ME4N.F | 10.0 | K₁ (25° C.) | = | pN |
| 6 | PCH-302 | 7.0 | K₃ (25° C.) | = | pN |
| 7 | PPTUI-3-2 | 22.0 | V₀ (25° C.) | = | V |
| 8 | PPTUI-3-4 | 22.0 | | | |
| 9 | PTP-102 | 4.0 | | | |
| 10 | PYP-2-3 | 5.0 | | | |
| 11 | PP-1-2V1 | 4.0 | | | |
| 12 | PUS-3-2 | 2.0 | | | |

### Inventive Mixture Example S17

A nematic LC medium according to the invention is formulated as follows:

| | |
|---|---|
| Inventive Mixture M17 | 99.56 wt.% |
| Compound of Formula SU-1 | 4400 ppm |

Addition of SU-1 significantly improves the VHR100 after UV exposure compared to the non-stabilized mixture M17 without affecting the remaining physical properties of the mixture M17.

### Inventive Base Mixture M18

A nematic LC medium is formulated as follows:

| Nr. | Composition | | Properties | | |
|---|---|---|---|---|---|
| 1 | CC-3-V | 8.0 | T(N, I) | = | ° C. |
| 2 | CPGP-5-2 | 4.0 | Δn (25° C., 589 nm) | = | |
| 3 | CPTP-301 | 4.0 | Δε (25° C., 1 kHz) | = | |
| 4 | ME2N.F | 9.0 | γ₁ (25° C.) | = | mPa · s |
| 5 | ME4N.F | 10.0 | K₁ (25° C.) | = | pN |
| 6 | PCH-302 | 8.0 | K₃ (25° C.) | = | pN |
| 7 | PPTUI-3-2 | 22.0 | V₀ (25° C.) | = | V |
| 8 | PPTUI-3-4 | 22.0 | | | |
| 9 | PTP-102 | 4.0 | | | |
| 10 | PYP-2-3 | 5.0 | | | |
| 11 | PUS-3-2 | 4.0 | | | |

### Inventive Mixture Example S18

A nematic LC medium according to the invention is formulated as follows:

| | |
|---|---|
| Inventive Mixture M18 | 99.56 wt.% |
| Compound of Formula SU-1 | 4400 ppm |

Addition of SU-1 significantly improves the VHR100 after UV exposure compared to the non-stabilized mixture M18 without affecting the remaining physical properties of the mixture M18.

### Inventive Base Mixture M19

A nematic LC medium is formulated as follows:

| Nr. | Composition | | Properties | | |
|---|---|---|---|---|---|
| 1 | CC-3-V | 8.0 | T(N, I) | = | ° C. |
| 2 | CPTP-301 | 5.0 | Δn (25° C., 589 nm) | = | |
| 3 | ME2N.F | 11.0 | Δε (25° C., 1 kHz) | = | |
| 4 | ME4N.F | 11.0 | γ₁ (25° C.) | = | mPa · s |
| 5 | PCH-302 | 8.0 | K₁ (25° C.) | = | pN |
| 6 | PPTUI-3-2 | 22.0 | K₃ (25° C.) | = | pN |
| 7 | PPTUI-3-4 | 22.0 | V₀ (25° C.) | = | V |
| 8 | PTP-102 | 5.0 | | | |
| 9 | PUS-3-2 | 8.0 | | | |

### Inventive Mixture Example S19

A nematic LC medium according to the invention is formulated as follows:

| | |
|---|---|
| Inventive Mixture M19 | 99.56 wt. % |
| Compound of Formula SU-1 | 4400 ppm |

Addition of SU-1 significantly improves the VHR100 after UV exposure compared to the non-stabilized mixture M19 without affecting the remaining physical properties of the mixture M19.

### Inventive Base Mixture M20

A nematic LC medium is formulated as follows:

| Nr. | Composition | | Properties |
|---|---|---|---|
| 1 | CC-3-V | 7.0 | T(N, I) = ° C. |
| 2 | CPGP-5-2 | 4.0 | Δn (25° C., 589 nm) = |
| 3 | CPTP-301 | 4.0 | Δε (25°C, 1 kHz) = |
| 4 | ME2N.F | 9.0 | γ₁ (25° C.) = mPa · s |
| 5 | ME4N.F | 10.0 | K₁ (25° C.) = pN |
| 6 | PCH-302 | 7.0 | K₃ (25° C.) = pN |
| 7 | PPTUI-3-2 | 22.5 | V₀ (25° C.) = V |
| 8 | PPTUI-3-4 | 22.5 | |
| 9 | PTP-102 | 4.0 | |
| 10 | PYP-2-3 | 5.0 | |
| 11 | PUS-3-2 | 5.0 | |

### Inventive Mixture Example S20

A nematic LC medium according to the invention is formulated as follows:

| | |
|---|---|
| Inventive Mixture M20 | 99.56 wt. % |
| Compound of Formula SU-1 | 4400 ppm |

Addition of SU-1 significantly improves the VHR100 after UV exposure compared to the non-stabilized mixture M20 without affecting the remaining physical properties of the mixture M20.

### Inventive Base Mixture M21

A nematic LC medium is formulated as follows:

| Nr. | Composition | | Properties |
|---|---|---|---|
| 1 | CC-3-V | 9.0 | T(N, I) = ° C. |
| 2 | CPTP-301 | 3.5 | Δn (25° C., 589 nm) = |
| 3 | ME2N.F | 7.5 | Δε (25°C, 1 kHz) = |
| 4 | ME4N.F | 11.0 | γ₁ (25° C.) = mPa · s |
| 5 | PCH-302 | 10.5 | K₁ (25° C.) = pN |
| 6 | PPTUI-3-2 | 22.5 | K₃ (25° C.) = pN |
| 7 | PPTUI-3-4 | 22.5 | V₀ (25° C.) = V |
| 8 | PTP-102 | 3.5 | |
| 9 | PUS-3-2 | 10.0 | |

### Inventive Mixture Example S21

A nematic LC medium according to the invention is formulated as follows:

| | |
|---|---|
| Inventive Mixture M21 | 99.56 wt. % |
| Compound of Formula SU-1 | 4400 ppm |

Addition of SU-1 significantly improves the VHR100 after UV exposure compared to the non-stabilized mixture M21 without affecting the remaining physical properties of the mixture M21.

### Inventive Base Mixture M22

A nematic LC medium is formulated as follows:

| Nr. | Composition | | Properties |
|---|---|---|---|
| 1 | CC-3-V | 8.0 | T(N, I) = ° C. |
| 2 | CPTP-301 | 5.0 | Δn (25° C., 589 nm) = |
| 3 | ME2N.F | 9.0 | Δε (25°C, 1 kHz) = |
| 4 | ME4N.F | 10.0 | γ₁ (25° C.) = mPa · s |
| 5 | PCH-302 | 8.0 | K₁ (25° C.) = pN |
| 6 | PPTUI-3-2 | 24.0 | K₃ (25° C.) = pN |
| 7 | PPTUI-3-4 | 24.0 | V₀ (25° C.) = V |
| 8 | PTP-102 | 5.0 | |
| 9 | PUS-3-2 | 7.0 | |

### Inventive Mixture Example S22

A nematic LC medium according to the invention is formulated as follows.

| | |
|---|---|
| Inventive Mixture M22 | 99.56 wt. % |
| Compound of Formula SU-1 | 4400 ppm |

Addition of SU-1 significantly improves the VHR100 after UV exposure compared to the non-stabilized mixture M22 without affecting the remaining physical properties of the mixture M22.

### Inventive Base Mixture M23

A nematic LC medium is formulated as follows:

| Nr. | Composition | | Properties |
|---|---|---|---|
| 1 | CC-3-V | 5.0 | T(N, I) = ° C. |
| 2 | CPGP-4-3 | 2.0 | Δn (25° C., 589 nm) = |
| 3 | CPGP-5-2 | 2.0 | Δε (25°C, 1 kHz) = |
| 4 | CPTP-301 | 4.0 | γ₁ (25° C.) = mPa · s |
| 5 | ME2N.F | 9.0 | K₁ (25° C.) = pN |
| 6 | ME4N.F | 9.0 | K₃ (25° C.) = pN |
| 7 | PCH-302 | 9.0 | V₀ (25° C.) = V |
| 8 | PGUQU-3-F | 2.0 | |
| 9 | PGUQU-4-F | 2.0 | |
| 10 | PGUQU-5-F | 1.0 | |
| 11 | PPTUI-3-2 | 22.0 | |
| 12 | PPTUI-3-4 | 22.0 | |
| 13 | PTP-102 | 4.0 | |
| 14 | PUS-3-2 | 7.0 | |

### Inventive Mixture Example S23

A nematic LC medium according to the invention is formulated as follows:

| | |
|---|---|
| Inventive Mixture M23 | 99.56 wt. % |
| Compound of Formula SU-1 | 4400 ppm |

Addition of SU-1 significantly improves the VHR100 after UV exposure compared to the non-stabilized mixture M23 without affecting the remaining physical properties of the mixture M23.

### Inventive Base Mixture M24

A nematic LC medium is formulated as follows:

| Nr. | Composition | | Properties |
|---|---|---|---|
| 1 | CC-3-V1 | 8.0 | T(N, I) = ° C. |
| 2 | CC-4-V | 3.0 | Δn (25° C., 589 nm) = |
| 3 | CCP-V-1 | 8.0 | Δε (25°C, 1 kHz) = |
| 4 | CCP-V2-1 | 5.0 | γ₁ (25° C.) = mPa · s |
| 5 | CPTP-301 | 5.0 | K₁ (25° C.) = pN |
| 6 | ME2N.F | 8.0 | K₃ (25° C.) = pN |
| 7 | ME4N.F | 10.0 | V₀ (25° C.) = V |
| 8 | PPTUI-3-2 | 22.0 | |
| 9 | PPTUI-3-4 | 22.0 | |
| 10 | PTP-102 | 5.0 | |
| 11 | PUS-3-2 | 4.0 | |

### Inventive Mixture Example S24

A nematic LC medium according to the invention is formulated as follows:

| | |
|---|---|
| Inventive Mixture M24 | 99.56 wt. % |
| Compound of Formula SU-1 | 4400 ppm |

Addition of SU-1 significantly improves the VHR100 after UV exposure compared to the non-stabilized mixture M24 without affecting the remaining physical properties of the mixture M24.

### Inventive Base Mixture M25

A nematic. I C medium is formulated as follows:

| Nr. | Composition | | Properties |
|---|---|---|---|
| 1 | APUQU-3-F | 8.0 | T(N, I) = ° C. |
| 2 | CCH-301 | 8.0 | Δn (25° C., 589 nm) = |
| 3 | CCP-V-1 | 3.0 | Δε (25°C, 1 kHz) = |
| 4 | CPGP-5-2 | 4.0 | γ₁ (25° C.) = mPa · s |
| 5 | CPGP-5-3 | 4.0 | K₁ (25° C.) = pN |
| 6 | PGUQU-3-F | 6.0 | K₃ (25° C.) = pN |
| 7 | PGUQU-5-F | 6.0 | V₀ (25° C.) = V |
| 8 | PPTUI-3-2 | 30.0 | |
| 9 | PUQU-3-F | 10.0 | |
| 10 | PUS-3-2 | 10.0 | |
| 11 | CC-3-V | 7.0 | |
| 12 | CPGP-4-3 | 4.0 | |

### Inventive Mixture Example S25

A nematic LC medium according to the invention is formulated as follows:

| | |
|---|---|
| Inventive Mixture M25 | 99.4 wt. % |
| Compound of Formula ST-1-3 | 2000 ppm |
| Compound of Formula SU-1 | 4000 ppm |

Addition of ST-1-3 in combination with SU-1 significantly improves the VHR100 after UV exposure compared to the non-stabilized mixture M25 without affecting the remaining physical properties of the mixture M25.

### Inventive Base Mixture M26

A nematic LC medium is formulated as follows:

| Nr. | Composition | | Properties |
|---|---|---|---|
| 1 | CC-3-V | 6.0 | T(N, I) = ° C. |
| 2 | CPGP-5-2 | 4.0 | Δn (25° C., 589 nm) = |
| 3 | CPTP-301 | 4.0 | Δε (25°C, 1 kHz) = |
| 4 | ME2N.F | 9.0 | γ₁ (25° C.) = mPa · s |
| 5 | ME4N.F | 10.0 | K₁ (25° C.) = pN |
| 6 | PCH-302 | 6.0 | K₃ (25° C.) = pN |
| 7 | PPTUI-3-2 | 22.5 | V₀ (25° C.) = V |
| 8 | PPTUI-3-4 | 22.5 | |
| 9 | PTP-102 | 4.0 | |
| 10 | PYP-2-3 | 5.0 | |
| 11 | PUS-3-2 | 7.0 | |

### Inventive Base Mixture M27

A nematic LC medium is formulated as follows:

| Nr. | Composition | | Properties |
|---|---|---|---|
| 1 | CC-3-V | 6.0 | T(N, I) = ° C. |
| 2 | CPGP-5-2 | 4.0 | Δn (25° C., 589 nm) = |
| 3 | CPTP-301 | 4.0 | Δε (25°C, 1 kHz) = |
| 4 | ME2N.F | 9.0 | γ₁ (25° C.) = mPa · s |
| 5 | ME4N.F | 10.0 | K₁ (25° C.) = pN |
| 6 | PCH-302 | 6.0 | K₃ (25° C.) = pN |
| 7 | PPTUI-3-2 | 22.5 | V₀ (25° C.) = V |
| 8 | PPTUI-3-4 | 22.5 | |
| 9 | PTP-102 | 4.0 | |
| 10 | PYP-2-3 | 5.0 | |
| 11 | PUS-3-2 | 7.0 | |

### Inventive Mixture Example S27

A nematic LC medium according to the invention is formulated as follows:

| | |
|---|---|
| Inventive Mixture M27 | 99.56 wt. % |
| Compound of Formula SU-1 | 4400 ppm |

Addition of SU-1 significantly improves the VHR100 after UV exposure compared to the non-stabilized mixture M27 without affecting the remaining physical properties of the mixture M27.

### Inventive Base Mixture M28

A nematic LC medium is formulated as follows:

| Nr. | Composition | | Properties | | |
|---|---|---|---|---|---|
| 1 | CC-3-V | 7.0 | T(N, I) | = | ° C. |
| 2 | CPTP-301 | 4.0 | Δn (25° C., 589 nm) | = | |
| 3 | ME2N.F | 9.0 | Δε (25° C., 1 kHz) | = | |
| 4 | ME4N.F | 10.0 | γ₁ (25° C.) | = | mPa · s |
| 5 | PCH-302 | 7.0 | K₁ (25° C.) | = | pN |
| 6 | PPTUI-3-2 | 22.5 | K₃ (25° C.) | = | pN |
| 7 | PPTUI-3-4 | 22.5 | V₀ (25° C.) | = | V |
| 8 | PTP-102 | 4.0 | | | |
| 9 | PYP-2-3 | 5.0 | | | |
| 10 | PUS-3-2 | 9.0 | | | |

### Inventive Mixture Example S28

A nematic LC medium according to the invention is formulated as follows:

| | |
|---|---|
| Inventive Mixture M28 | 99.56 wt. % |
| Compound of Formula SU-1 | 4400 ppm |

Addition of SU-1 significantly improves the VHR100 after UV exposure compared to the non-stabilized mixture M28 without affecting the remaining physical properties of the mixture M28.

### Inventive Base Mixture M29

A nematic LC medium is formulated as follows:

| Nr. | Composition | | Properties | | |
|---|---|---|---|---|---|
| 1 | CC-3-V | 6.0 | T(N, I) | = | ° C. |
| 2 | CPGP-5-2 | 4.0 | Δn (25° C., 589 nm) | = | |
| 3 | CPTP-301 | 4.0 | Δε (25° C., 1 kHz) | = | |
| 4 | ME2N.F | 4.0 | γ₁ (25° C.) | = | mPa · s |
| 5 | ME4N.F | 10.0 | K₁ (25° C.) | = | pN |
| 6 | PCH-302 | 6.0 | K₃ (25° C.) | = | pN |
| 7 | PGUQU-3-F | 5.0 | V₀ (25° C.) | = | V |
| 8 | PPTUI-3-2 | 22.5 | | | |
| 9 | PPTUI-3-4 | 22.5 | | | |
| 10 | PTP-102 | 4.0 | | | |
| 11 | PUS-3-2 | 7.0 | | | |
| 12 | PYP-2-3 | 5.0 | | | |

### Inventive Mixture Example S29

A nematic LC medium according to the invention is formulated as follows:

| | |
|---|---|
| Inventive Mixture M29 | 99.56 wt. % |
| Compound of Formula SU-1 | 4400 ppm |

Addition of SU-1 significantly improves the VHR100 after UV exposure compared to the non-stabilized mixture M29 without affecting the remaining physical properties of the mixture M29.

### Inventive Base Mixture M30

A nematic LC medium is formulated as follows:

| Nr. | Composition | | Properties | | |
|---|---|---|---|---|---|
| 1 | CC-3-V | 7.0 | T(N, I) | = | ° C. |
| 2 | CPGP-5-2 | 3.0 | Δn (25° C., 589 nm) | = | |
| 3 | CPTP-301 | 4.0 | Δε (25° C., 1 kHz) | = | |
| 4 | ME2N.F | 8.0 | γ₁ (25° C.) | = | mPa · s |
| 5 | ME4N.F | 10.0 | K₁ (25° C.) | = | pN |
| 6 | PCH-302 | 7.0 | K₃ (25° C.) | = | pN |
| 7 | PPTUI-3-2 | 22.0 | V₀ (25° C.) | = | V |
| 8 | PPTUI-3-4 | 22.0 | | | |
| 9 | PTP-102 | 4.0 | | | |
| 10 | PYP-2-3 | 5.0 | | | |
| 11 | PUS-3-2 | 3.0 | | | |
| 12 | PGUQU-3-F | 5.0 | | | |

### Inventive Mixture Example S30

A nematic LC medium according to the invention is formulated as follows:

| | |
|---|---|
| Inventive Mixture M30 | 99.56 wt. % |
| Compound of Formula SU-1 | 4400 ppm |

Addition of SU-1 significantly improves the VHR100 after UV exposure compared to the non-stabilized mixture M30 without affecting the remaining physical properties of the mixture M30.

### Inventive Base Mixture M31

A nematic LC medium is formulated as follows:

| Nr. | Composition | | Properties | | |
|---|---|---|---|---|---|
| 1 | CC-3-V | 7.0 | T(N, I) | = | ° C. |
| 2 | CPTP-301 | 5.0 | Δn (25° C., 589 nm) | = | |
| 3 | ME2N.F | 9.0 | Δε (25° C., 1 kHz) | = | |
| 4 | ME4N.F | 10.0 | γ₁ (25° C.) | = | mPa · s |
| 5 | PCH-302 | 7.0 | K₁ (25° C.) | = | pN |
| 6 | PPTUI-3-2 | 24.0 | K₃ (25° C.) | = | pN |
| 7 | PPTUI-3-4 | 22.0 | V₀ (25° C.) | = | V |
| 8 | PTP-102 | 4.0 | | | |
| 9 | PYP-2-3 | 5.0 | | | |
| 10 | PUS-3-2 | 7.0 | | | |

### Inventive Mixture Example S31

A nematic LC medium according to the invention is formulated as follows:

| | |
|---|---|
| Inventive Mixture M31 | 99.56 wt. % |
| Compound of Formula SU-1 | 4400 ppm |

Addition of SU-1 significantly improves the VHR100 after UV exposure compared to the non-stabilized mixture M31 without affecting the remaining physical properties of the mixture M31.

### Inventive Base Mixture M32

A nematic LC medium is formulated as follows:

| Nr. | Composition | | Properties | | |
|---|---|---|---|---|---|
| 1 | CCH-301 | 8.0 | T(N, I) | = | ° C. |
| 2 | CPGP-5-2 | 4.0 | Δn (25° C., 589 nm) | = | |
| 3 | CPGP-5-3 | 4.0 | Δε (25° C., 1 kHz) | = | |
| 4 | PGUQU-3-F | 3.0 | γ₁ (25° C.) | = | mPa · s |
| 5 | PGUQU-5-F | 3.0 | K₁ (25° C.) | = | pN |
| 6 | PPTUI-3-2 | 20.0 | K₃ (25° C.) | = | PN |
| 7 | PPTUI-3-4 | 31.0 | V₀ (25° C.) | = | V |
| 8 | PUS-3-2 | 11.0 | | | |
| 9 | ME4N.F | 9.0 | | | |
| 10 | ME2N.F | 4.0 | | | |
| 11 | PCH-302 | 3.0 | | | |

### Inventive Mixture Example S32

A nematic LC medium according to the invention is formulated as follows:

| | |
|---|---|
| Inventive Mixture M32 | 99.4 wt. % |
| Compound of Formula ST-1-3 | 2000 ppm |
| Compound of Formula SU-1 | 4000 ppm |

Addition of ST-1-3 in combination with SU-1 significantly improves the VHR100 after UV exposure compared to the non-stabilized mixture M32 without affecting the remaining physical properties of the mixture M32.

### Inventive Base Mixture M33

A nematic LC medium is formulated as follows:

| Nr. | Composition | | Properties | | |
|---|---|---|---|---|---|
| 1 | CC-3-V | 8.0 | T(N, I) | = | ° C. |
| 2 | CPGP-5-2 | 4.0 | Δn (25° C., 589 nm) | = | |
| 3 | CPTP-301 | 4.0 | Δε (25° C., 1 kHz) | = | |
| 4 | ME2N.F | 9.0 | γ₁ (25° C.) | = | mPa · s |
| 5 | ME4N.F | 9.0 | K₁ (25° C.) | = | pN |
| 6 | PCH-302 | 8.0 | K₃ (25° C.) | = | pN |
| 7 | PPTUI-3-2 | 23.0 | V₀ (25° C.) | = | V |
| 8 | PPTUI-3-4 | 23.0 | | | |
| 9 | PTP-102 | 4.0 | | | |
| 10 | PYP-2-3 | 5.0 | | | |
| 11 | PUS-3-2 | 3.0 | | | |

### Inventive Mixture Example S33

A nematic LC medium according to the invention is formulated as follows:

| | |
|---|---|
| Inventive Mixture M33 | 99.56 wt. % |
| Compound of Formula SU-1 | 4400 ppm |

Addition of SU-1 significantly improves the VHR100 after UV exposure compared to the non-stabilized mixture M33 without affecting the remaining physical properties of the mixture M33.

### Inventive Base Mixture M34

A nematic LC medium is formulated as follows:

| Nr. | Composition | | Properties | | |
|---|---|---|---|---|---|
| 1 | CC-3-V | 6.5 | T(N, I) | = | ° C. |
| 2 | CPTP-301 | 5.0 | Δn (25° C., 589 nm) | = | |
| 3 | ME2N.F | 9.0 | Δε (25° C., 1 kHz) | = | |
| 4 | ME4N.F | 10.0 | γ₁ (25° C.) | = | mPa · s |
| 5 | PCH-302 | 6.5 | K₁ (25° C.) | = | pN |
| 6 | PPTUI-3-2 | 24.0 | K₃ (25° C.) | = | pN |
| 7 | PPTUI-3-4 | 23.0 | V₀ (25° C.) | = | V |
| 8 | PTP-102 | 4.0 | | | |
| 9 | PYP-2-3 | 5.0 | | | |
| 11 | PUS-3-2 | 7.0 | | | |

### Inventive Mixture Example S34

A nematic LC medium according to the invention is formulated as follows:

| | |
|---|---|
| Inventive Mixture M34 | 99.56 wt. % |
| Compound of Formula SU-1 | 4400 ppm |

Addition of SU-1 significantly improves the VHR100 after UV exposure compared to the non-stabilized mixture M34 without affecting the remaining physical properties of the mixture M34.

### Inventive Base Mixture M35

A nematic LC medium is formulated as follows:

| Nr. | Composition | | Properties | | |
|---|---|---|---|---|---|
| 1 | CC-3-V | 3.0 | T(N, I) | = | ° C. |
| 2 | CPTP-301 | 5.0 | Δn (25° C., 589 nm) | = | |
| 3 | ME2N.F | 9.0 | Δε (25° C., 1 kHz) | = | |
| 4 | ME4N.F | 10.0 | γ₁ (25° C.) | = | mPa · s |
| 5 | PCH-302 | 6.0 | K₁ (25° C.) | = | pN |
| 6 | PPTUI-3-2 | 24.0 | K₃ (25° C.) | = | pN |
| 7 | PPTUI-3-4 | 24.0 | V₀ (25° C.) | = | V |
| 8 | PTP-102 | 4.0 | | | |
| 9 | PYP-2-3 | 4.0 | | | |
| 10 | PUS-3-2 | 7.0 | | | |
| 11 | PYP-2-4 | 4.0 | | | |

### Inventive Mixture Example S35

A nematic LC medium according to the invention is formulated as follows:

| | |
|---|---|
| Inventive Mixture M35 | 99.56 wt. % |
| Compound of Formula SU-1 | 4400 ppm |

Addition of SU-1 significantly improves the VHR100 after UV exposure compared to the non-stabilized mixture M35 without affecting the remaining physical properties of the mixture M35.

### Inventive Base Mixture M36

A nematic LC medium is formulated as follows:

| Nr. | Composition | | Properties | | |
|---|---|---|---|---|---|
| 1 | CC-3-V | 6.0 | T(N, I) | = | ° C. |
| 2 | CPTP-301 | 5.0 | Δn (25° C., 589 nm) | = | |
| 3 | ME2N.F | 9.0 | Δε (25° C., 1 kHz) | = | |
| 4 | ME4N.F | 10.0 | γ₁ (25° C.) | = | mPa · s |
| 5 | PCH-302 | 6.0 | K₁ (25° C.) | = | pN |
| 6 | PPTUI-3-2 | 24.0 | K₃ (25° C.) | = | pN |
| 7 | PPTUI-3-4 | 24.0 | V₀ (25° C.) | = | V |
| 8 | PTP-102 | 4.0 | | | |
| 9 | PYP-2-3 | 5.0 | | | |
| 10 | PUS-3-2 | 7.0 | | | |

### Inventive Mixture Example S36

A nematic LC medium according to the invention is formulated as follows:

| | |
|---|---|
| Inventive Mixture M36 | 99.56 wt. % |
| Compound of Formula SU-1 | 4400 ppm |

Addition of SU-1 significantly improves the VHR100 after UV exposure compared to the non-stabilized mixture M36 without affecting the remaining physical properties of the mixture M36.

### Inventive Base Mixture M37

A nematic LC medium is formulated as follows:

| Nr. | Composition | | Properties | | |
|---|---|---|---|---|---|
| 1 | CC-3-V | 5.0 | T(N, I) | = | ° C. |
| 2 | CPGP-4-3 | 2.0 | Δn (25° C., 589 nm) | = | |
| 3 | CPGP-5-2 | 3.0 | Δε (25° C., 1 kHz) | = | |
| 4 | CPTP-301 | 4.0 | γ₁ (25° C.) | = | mPa · s |
| 5 | ME2N.F | 10.0 | K₁ (25° C.) | = | pN |
| 6 | ME4N.F | 10.0 | K₃ (25° C.) | = | pN |
| 7 | PCH-302 | 10.0 | V₀ (25° C.) | = | V |
| 8 | PGUQU-3-F | 5.0 | | | |
| 9 | PPTUI-3-2 | 20.0 | | | |
| 10 | PPTUI-3-4 | 20.0 | | | |
| 11 | PTP-102 | 4.0 | | | |
| 12 | PUS-3-2 | 7.0 | | | |

### Inventive Mixture Example S37

A nematic LC medium according to the invention is formulated as follows:

| | |
|---|---|
| Inventive Mixture M37 | 99.56 wt. % |
| Compound of Formula SU-1 | 4400 ppm |

Addition of SU-1 significantly improves the VHR100 after UV exposure compared to the non-stabilized mixture M37 without affecting the remaining physical properties of the mixture M37.

### Inventive Base Mixture M38

A nematic LC medium is formulated as follows:

| Nr. | Composition | | Properties | | |
|---|---|---|---|---|---|
| 1 | CC-3-V | 10.0 | T(N, I) | = | ° C. |
| 2 | CPTP-301 | 5.0 | Δn (25° C., 589 nm) | = | |
| 3 | ME4N.F | 11.0 | Δε (25° C., 1 kHz) | = | |
| 4 | PGU-3-F | 8.0 | γ₁ (25° C.) | = | mPa · s |
| 5 | PPTUI-3-2 | 24.0 | K₁ (25° C.) | = | pN |
| 6 | PPTUI-3-4 | 24.0 | K₃ (25° C.) | = | pN |
| 7 | PTP-102 | 5.0 | V₀ (25° C.) | = | V |
| 8 | PUS-3-2 | 8.0 | | | |
| 9 | PYP-2-3 | 5.0 | | | |

### Inventive Base Mixture M39

A nematic LC medium is formulated as follows:

| Nr. | Composition | | Properties | | |
|---|---|---|---|---|---|
| 1 | CC-3-V | 10.0 | T(N, I) | = | ° C. |
| 2 | CPGU-3-OT | 5.0 | Δn (25° C., 589 nm) | = | |
| 3 | CPTP-301 | 5.0 | Δε (25° C., 1 kHz) | = | |
| 4 | ME4N.F | 10.0 | γ₁ (25° C.) | = | mPa · s |
| 5 | PGU-3-F | 5.0 | K₁ (25° C.) | = | pN |
| 6 | PPTUI-3-2 | 24.0 | K₃ (25° C.) | = | pN |
| 7 | PPTUI-3-4 | 24.0 | V₀ (25° C.) | = | V |
| 8 | PTP-102 | 5.0 | | | |
| 9 | PUS-3-2 | 7.0 | | | |
| 10 | PYP-2-3 | 5.0 | | | |

### Inventive Base Mixture M40

A nematic LC medium is formulated as follows:

| Nr. | Composition | | Properties | | |
|---|---|---|---|---|---|
| 1 | CC-3-V | 6.5 | T(N, I) | = | ° C. |
| 2 | CPTP-301 | 5.0 | Δn (25° C., 589 nm) | = | |
| 3 | ME2N.F | 9.0 | Δε (25° C., 1 kHz) | = | |
| 4 | ME4N.F | 10.0 | γ₁ (25° C.) | = | mPa · s |
| 5 | PCH-302 | 6.5 | K₁ (25° C.) | = | pN |
| 6 | PPTUI-3-2 | 24.0 | K₃ (25° C.) | = | pN |
| 7 | PPTUI-3-4 | 22.0 | V₀ (25° C.) | = | V |
| 8 | PTP-102 | 4.0 | | | |
| 9 | PYP-2-3 | 5.0 | | | |
| 10 | PUS-3-2 | 7.0 | | | |
| 11 | PYP-2-4 | 1.0 | | | |

### Inventive Mixture Example S40

A nematic LC medium according to the invention is formulated as follows:

| | |
|---|---|
| Inventive Mixture M40 | 99.56 wt. % |
| Compound of Formula SU-1 | 4400 ppm |

Addition of SU-1 significantly improves the VHR100 after UV exposure compared to the non-stabilized mixture M40 without affecting the remaining physical properties of the mixture M40.

### Inventive Base Mixture M41

A nematic LC medium is formulated as follows:

| Nr. | Composition | | Properties | | |
|---|---|---|---|---|---|
| 1 | CC-3-V | 6.5 | T(N, I) | = | ° C. |
| 2 | CPTP-301 | 5.0 | Δn (25° C., 589 nm) | = | |
| 3 | ME2N.F | 9.0 | Δε (25° C., 1 kHz) | = | |
| 4 | ME4N.F | 10.0 | γ₁ (25° C.) | = | mPa · s |
| 5 | PCH-302 | 6.5 | K₁ (25° C.) | = | pN |
| 6 | PPTUI-3-2 | 23.0 | K₃ (25° C.) | = | pN |
| 7 | PPTUI-3-4 | 23.0 | V₀ (25° C.) | = | V |
| 8 | PTP-102 | 4.0 | | | |
| 9 | PYP-2-3 | 5.0 | | | |
| 10 | PUS-3-2 | 8.0 | | | |

### Inventive Mixture Example S41

A nematic LC medium according to the invention is formulated as follows:

| | |
|---|---|
| Inventive Mixture M41 | 99.56 wt. % |
| Compound of Formula SU-1 | 4400 ppm |

Addition of SU-1 significantly improves the VHR100 after UV exposure compared to the non-stabilized mixture M41 without affecting the remaining physical properties of the mixture M41.

### Inventive Base Mixture M42

A nematic LC medium is formulated as follows:

| Nr. | Composition | | Properties | | |
|---|---|---|---|---|---|
| 1 | APUQU-3-F | 3.0 | T(N, I) | = | ° C. |
| 2 | CC-3-V | 9.0 | Δn (25° C., 589 nm) | = | |
| 3 | CCH-301 | 2.0 | Δε (25° C., 1 kHz) | = | |
| 4 | CCP-V-1 | 7.0 | γ₁ (25° C.) | = | mPa · s |
| 5 | CPGP-5-2 | 4.0 | K₁ (25° C.) | = | pN |
| 6 | CPGP-5-3 | 4.0 | K₃ (25° C.) | = | pN |
| 7 | PGUQU-3-F | 3.5 | V₀ (25° C.) | = | V |
| 8 | PGUQU-5-F | 3.5 | | | |
| 9 | PPTUI-3-2 | 20.0 | | | |
| 10 | PPTUI-3-4 | 31.0 | | | |
| 11 | PUQU-3-F | 3.0 | | | |
| 12 | PUS-3-2 | 10.0 | | | |

### Inventive Base Mixture M43

A nematic LC medium is formulated as follows:

| Nr. | Composition | | Properties | | |
|---|---|---|---|---|---|
| 1 | CC-3-V | 3.00 | T(N, I) | = | 138.6 ° C. |
| 2 | CPGP-4-3 | 3.00 | n_{\|\|} (20° C., 1 kHz) | = | 1.8234 |
| 3 | CPGP-5-3 | 3.00 | n_{⊥} (20° C., 1 kHz) | = | 1.5175 |
| 4 | CPTP-301 | 4.00 | Δn (20° C., 589 nm) | = | 0.3059 |
| 5 | ME2N.F | 6.00 | ε_{\|\|} (20° C., 1 kHz) | = | 19.6 |
| 6 | ME4N.F | 11.00 | ε_{⊥} (20° C., 1 kHz) | = | 4.2 |
| 7 | PGUQU-3-F | 5.00 | Δε (20° C., 1 kHz) | = | 15.4 |
| 8 | PPTUI-3-2 | 22.00 | K₁ (20° C.) | = | 15.1 pN |
| 9 | PPTUI-3-4 | 34.00 | K₃ (20° C.) | = | 23.1 pN |
| 10 | PTP-102 | 2.00 | V₀ (20° C.) | = | 1.05 V |
| 11 | PUS-3-2 | 7.00 | γ₁ (20° C.) | = | 425 mPa · s |

### Inventive Mixture Example S43

A nematic LC medium according to the invention is formulated as follows:

| | |
|---|---|
| Inventive Mixture M43 | 99.56 wt. % |
| Compound of Formula SU-1 | 4400 ppm |

Addition of SU-1 significantly improves the VHR100 after UV exposure compared to the non-stabilized mixture M43 without affecting the remaining physical properties of the mixture M43.

1. A liquid-crystalline (LC) medium comprising:
one or more compounds of Formula I 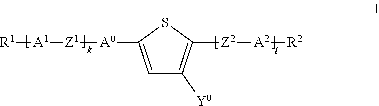
in which the individual substituents have the following meanings:
R¹ and R² each, independently of one another, denote a H atom, an alkyl or alkoxy group having 1 to 12 C atoms, or an alkenyl or alkenyloxy group having 2 to 12 C atoms, in which one or more non-adjacent CH₂ groups are optionally substituted by —C≡C—, —CF₂O—, —OCF₂—, —CH═CH—, 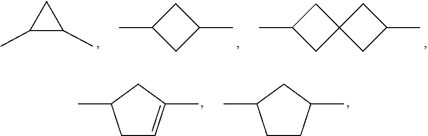
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom;
Y⁰ denotes a H atom, an alkyl group having 1 to 3 C atoms, or an alkenyl group having 2 to 3 C atoms, in which one or more non-adjacent CH₂ groups are optionally substituted by —C═C—, —CF₂O—, —OCF₂—, —CH═CH—, —O—, —CO—O—, or —O—CO— in such a way that O atoms are not linked directly to one another;
A⁰, A¹, A² each, independently of one another, denote i) phenylene-1,4-diyl, in which, in addition, one or two CH groups are optionally replaced by N and one or more H atoms are optionally replaced by halogen, CN, CH₃, CHF₂, CH₂F, CF₃, OCH₃, OCHF₂, or OCF₃, ii) cyclohexane-1,4-diyl, in which, in addition, one or two non-adjacent CH₂ groups are optionally replaced, independently of one another, by O or S and one or more H atoms are optionally replaced by F, iii) cyclohexene-1,4-diyl, iv) bicyclo[1.1.1]pentane-1,3-diyl, v) bicyclo[2.2.2]octane-1,4-diyl, vi) spiro[3.3]heptane-2,6-diyl, vii) tetrahydropyran-2,5-diyl, or viii) 1,3-dioxane-2,5-diyl;
Z¹ and Z² each, independently of one another, denote-CF₂O—, —OCF₂—, —CH₂O—, —OCH₂—, —CO—O—, —O—CO—, —C₂H₄—, —C₂F₄—, —CF₂CH₂—, —CH₂CF₂—, —CFHCFH—, —CFHCH₂—, —CH₂CFH—, —CF₂CFH—, —CFHCF₂—, —CH═CH—, —CF═CH—, —CH═CF—, —CF═CF—, —C═C—, or a single bond;
k and l each, independently of one another, denote 0, 1, 2, or 3; and
one or more compounds selected from Formulae T1 and T2: 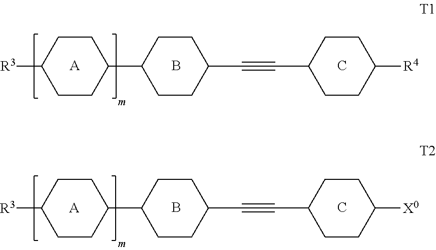
in which 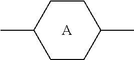
denotes 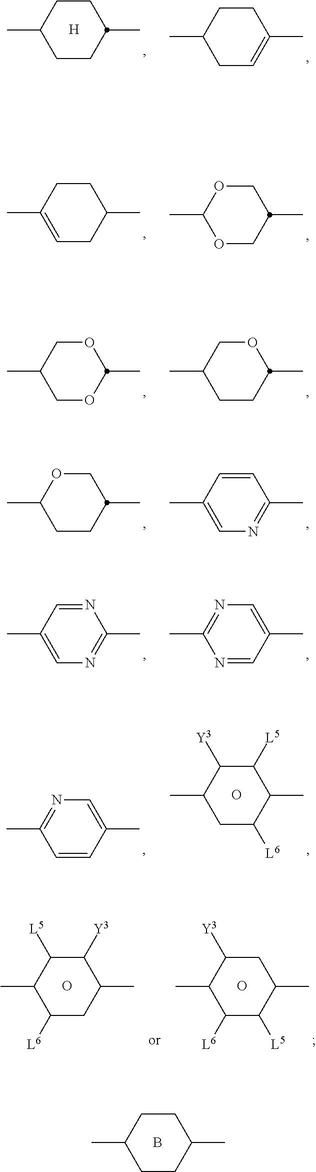
denotes 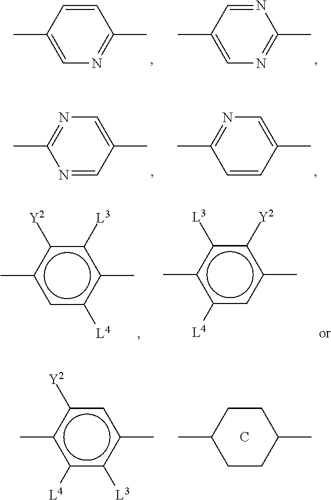
denotes 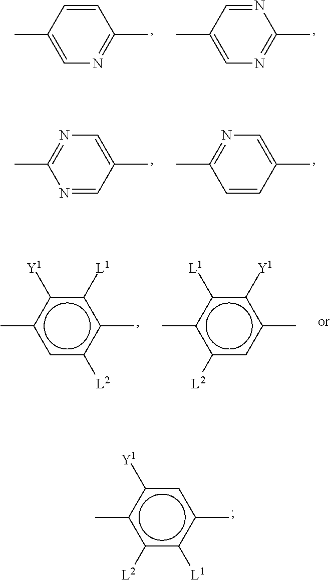
R³ and R⁴ each, independently from one another, denote an alkyl or an alkoxy group having 1 to 12 C atoms or an alkenyl group having 2 to 12 C atoms, in which one or more CH₂ groups are optionally substituted by —C═C—, —CF₂O—, —OCF₂—, —CH═CH—, 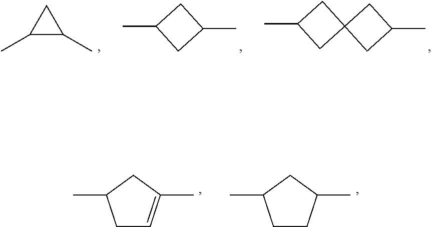
—O—, —CO—O—, or —O—CO— in such a way that O atoms are not linked directly to one another, and in which one or more H atoms replaced by a halogen atom;
L¹⁻⁶ each, independently from one another, denote H or F;
X⁰ denotes F, Cl, CN, SF₅, SCN, NCS, a halogenated alkyl group or alkoxy group having 1 to 6 C atoms, or a halogenated alkenyl or alkenyloxy group having 2 to 6 C atoms;
Y¹⁻³ each, independently from one another, denote H, a straight-chain alkyl or alkoxy group having 1 to 6 C atoms, a branched alkyl or alkoxy group having $3 to 6 C atoms, or a cycloalkyl or cycloalkoxy group having 3 to 6 C atoms; and
m and n each, independently of one another, denote 0 or 1.

2. The LC medium according to claim 1, wherein the one or more compounds of Formula I comprise one or more compounds of Formulae I-1-1 to I-1-6: 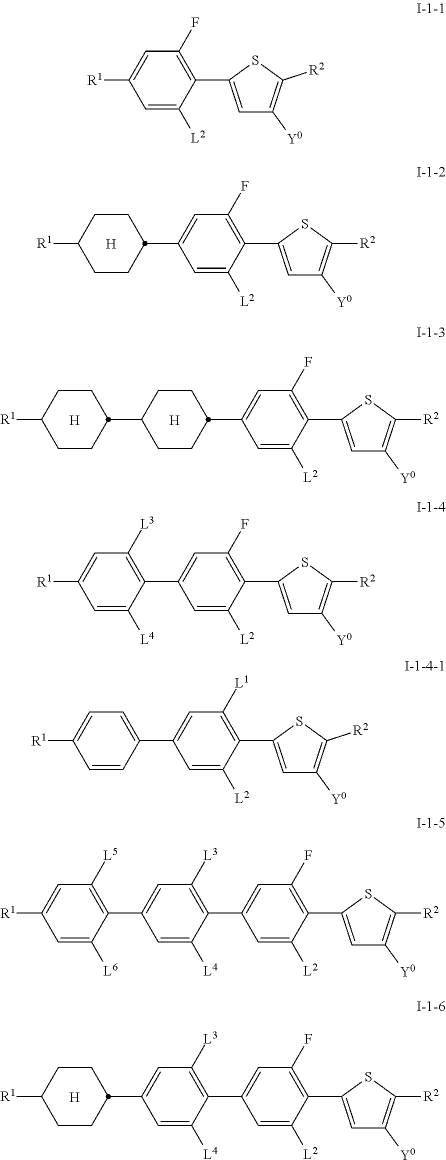
in which
R¹ and R² each, independently of one another, denote a H atom, an alkyl or alkoxy group having 1 to 12 C atoms, or and alkenyl or alkenyloxy group having 2 to 12 C atoms, in which one or more non-adjacent CH₂ groups are optionally substituted by —C═C—, —CF₂O—, —OCF₂—, —CH═CH—, 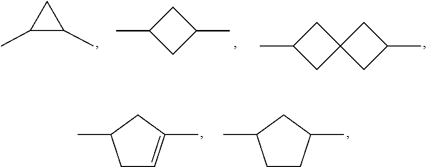
—O—, —CO—O—, or —O—CO— in such a way that O atoms are not linked directly to one another, and in which one ore more H atoms are optionally replaced by a halogen atom or a cycloalkyl or cycloalkoxy group having 3 to 12 C atoms, in which one or more H atoms are optionally replaced by a halogen atom;
Y⁰ denotes a H atom or a methyl group; and
L¹ to L⁶ each, independently from one another, denote a H atom, F, Cl, or an alkyl group having 1 to 4 C atoms.

3. The LC medium according to claim 1, wherein the one or more compounds selected from the Formulae T1 and T2 comprise one or more compounds of Formulae T1-1 to T2-4: 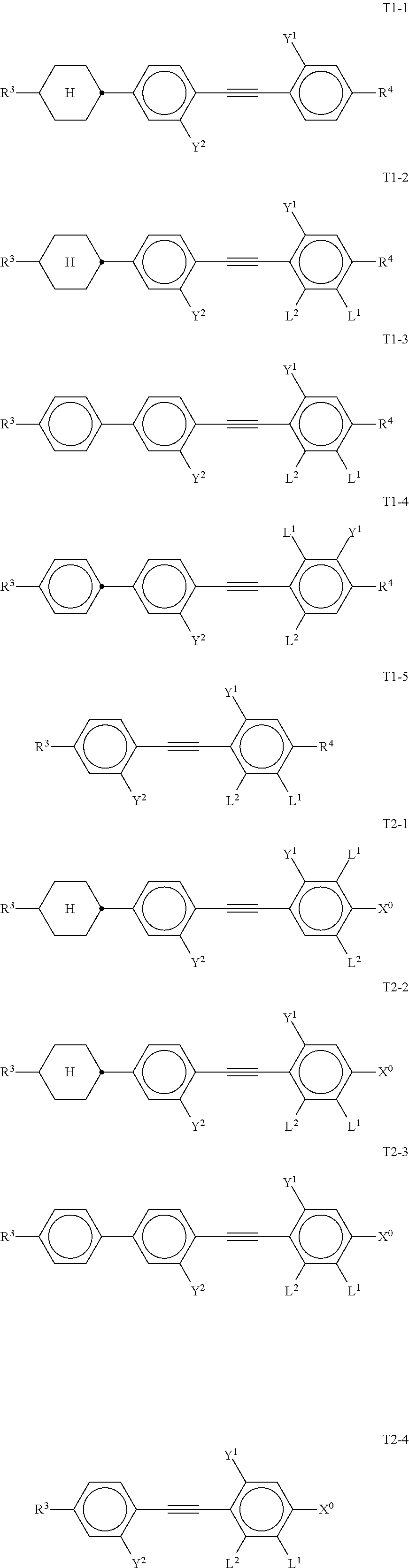
in which
R³ and R⁴ each, independently from one another, denote an alkyl or alkoxy group having 1 to 6 C atoms or an alkenyl group having 2 to 6 C atoms, in which one or more CH₂ groups are optionally substituted by —C═C—, —CF₂O—, —OCF₂—, —CH═CH—, 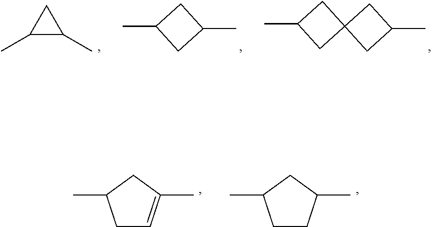
—O—, —CO—O—, or —O—CO— in such a way that O atoms are not linked directly to one another, and in which one or more H atoms are optionally replaced by a halogen atom;
L¹ and L² each, independently from one another, denote H or F;
X⁰ denotes CN, SCN, NCS, or a halogenated alkyl group, having 1 to 6 C atoms; and
Y¹ and Y² each, independently from one another, denote H a straight-chain alkyl or alkoxy group having 1 to 6 C atoms, a branched alkyl or alkoxy group having 3 to 6 C atoms, or a cycloalkyl or cycloalkoxy group having 3 to 6 C atoms.

4. The LC medium according to claim 1, further comprising one or more compounds of F formulae Z¹-Z¹¹: 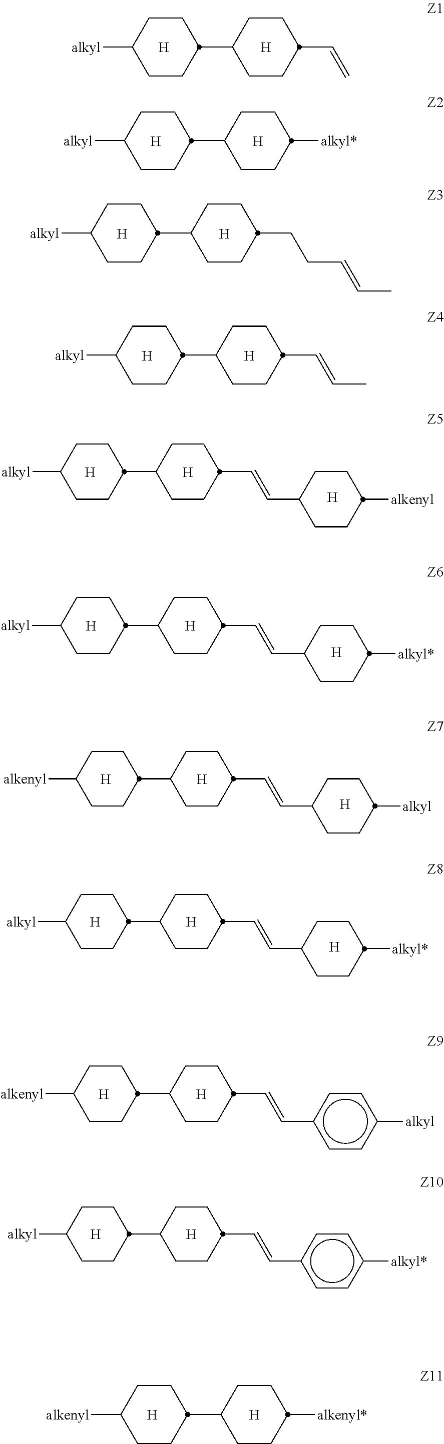
in which
“alkyl” and “alkyl*” denotes an C₁₋₆-alkyl group; and
“alkenyl” and “alkenyl*” each, independently of one another, denote a C₂₋₆-alkenyl group.

5. The LC medium according to claim 1, further comprising one or more compounds selected from the group consisting of Formulae II and III: 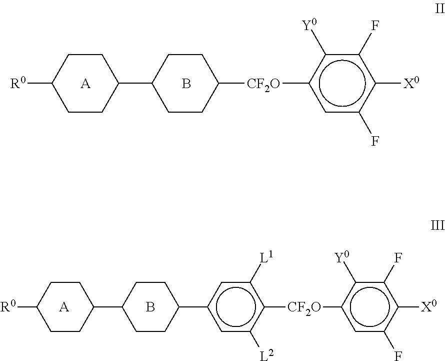
wherein the individual groups, independently of each other and on each occurrence, identically or differently, have the following meanings: 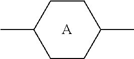
denotes 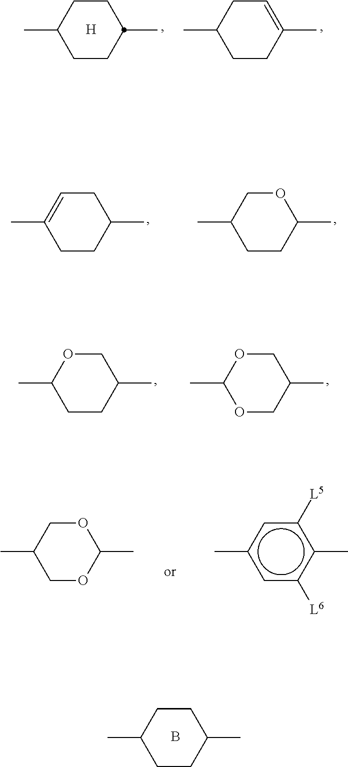
denotes 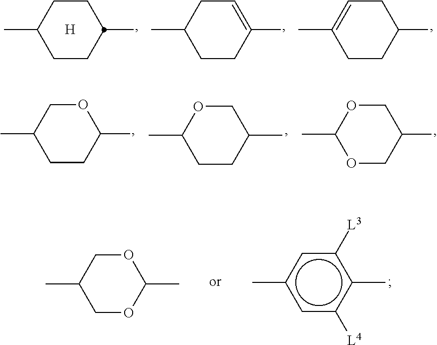
R⁰ denotes a H atom, an alkyl or alkoxy group having 1 to 12 C atoms, or an alkenyl or alkenyloxy group having 2 to 12 C atoms, in which one or more non-adjacent CH₂ groups are optionally substituted by —C═C—, —CF₂O—, —OCF₂—, —CH═CH—, 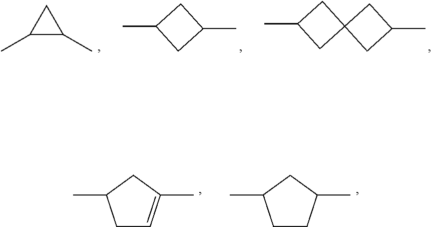
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom;
X⁰ denotes F, Cl, a halogenated alkyl alkenyl, alkoxy, or alkenyloxy group having up to 6 C atoms;
L¹⁻⁶ the H or F; and
Y⁰ denotes H or CH₃.

6. The LC medium according to claim 5, wherein the one or more compounds of Formula II comprise one or more compounds of sub-formulae II-1 to II-7: 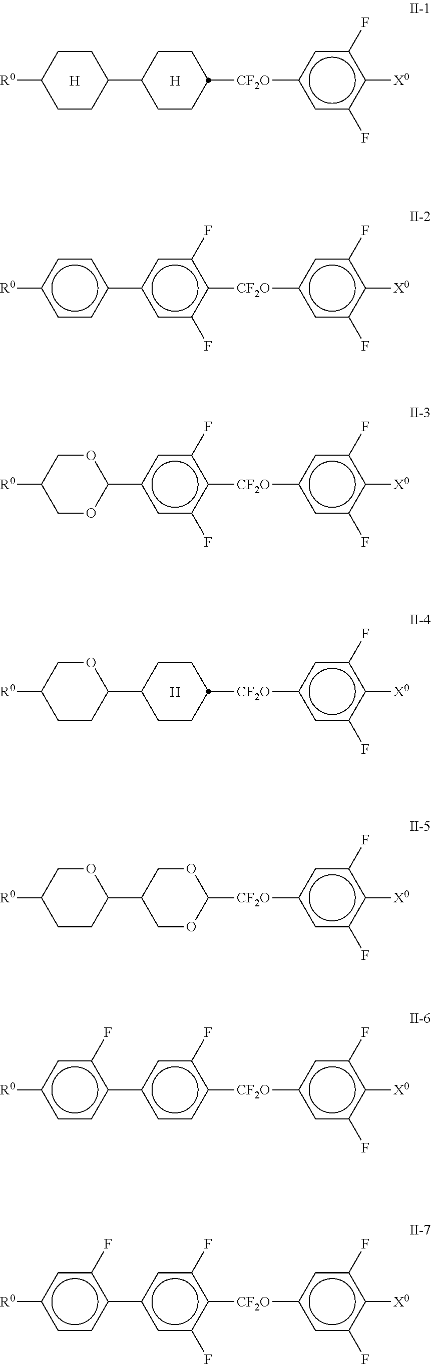
in which
R⁰ denotes a H atom, an alkyl or alkoxy group having 1 to 12 C atoms, or an alkenyl or alkenyloxy group having 2 to 12 C atoms, in which one or more non-adjacent CH₂ groups are optionally substituted by —C═C—, —CF₂O—, —OCF₂—, —CH═CH—, 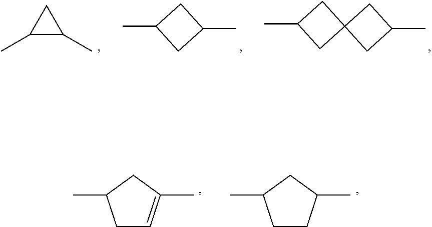
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom;
X⁰ denotes F, Cl, a halogenated alkyl alkenyl, alkoxy, or alkenyloxy group having up to 6 C atoms.

7. The LC medium according to claim 5, wherein the one or more compounds of Formula III comprises one or more compounds of subformulae III-1 to III-22: 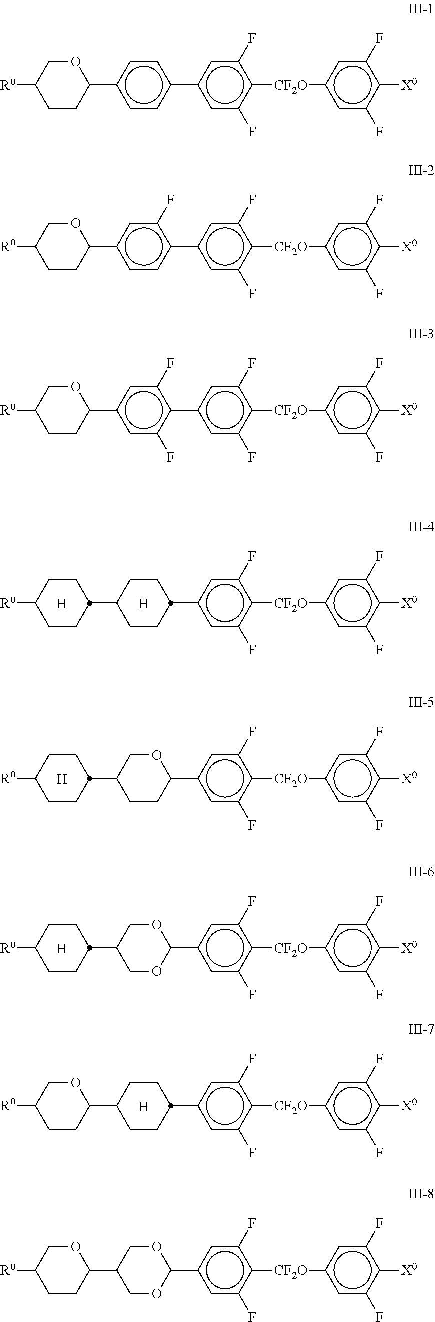 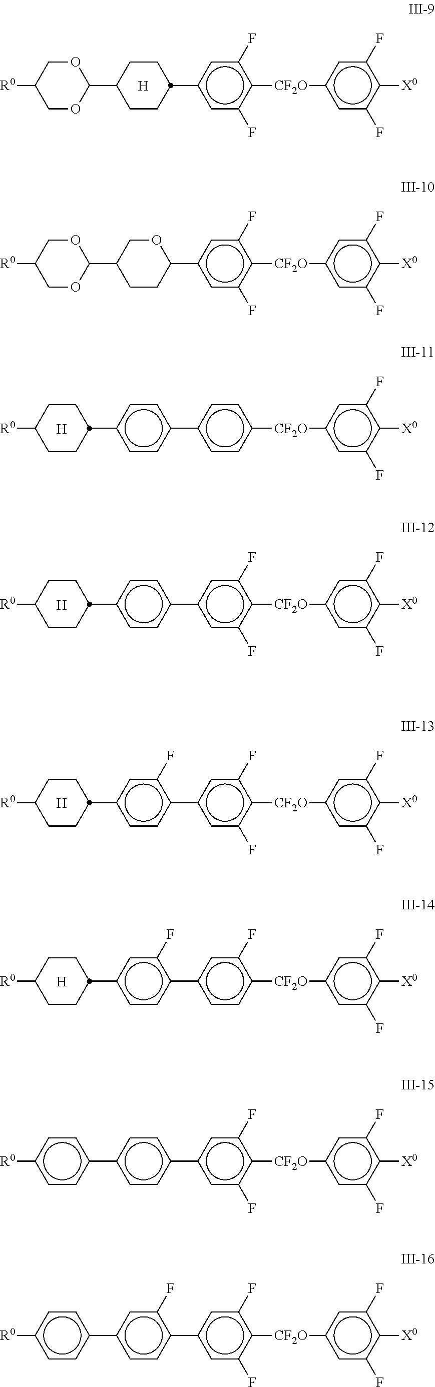 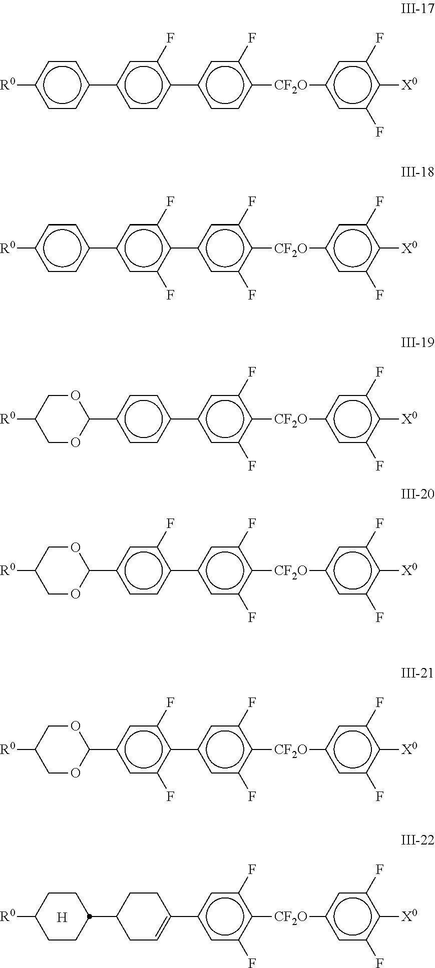
in which
R⁰ denotes a H atom, an alkyl or alkoxy group having 1 to 12 C atoms, or an alkenyl or alkenyloxy group having 2 to 12 C atoms, in which one or more non-adjacent CH₂ groups are optionally substituted by —C═C—, —CF₂O—, —OCF₂—, —CH═CH—, 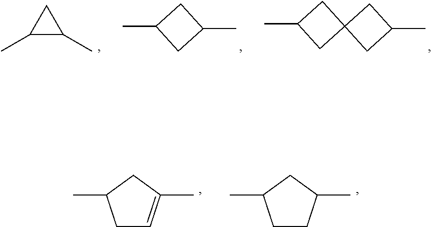
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom;
X⁰ denotes F, Cl, a halogenated alkyl alkenyl, alkoxy, or alkenyloxy group having up to 6 C atoms.

8. The LC medium according to claim 1, further comprising one or more compounds of Formulae IV, V, VI, VII or VIII: 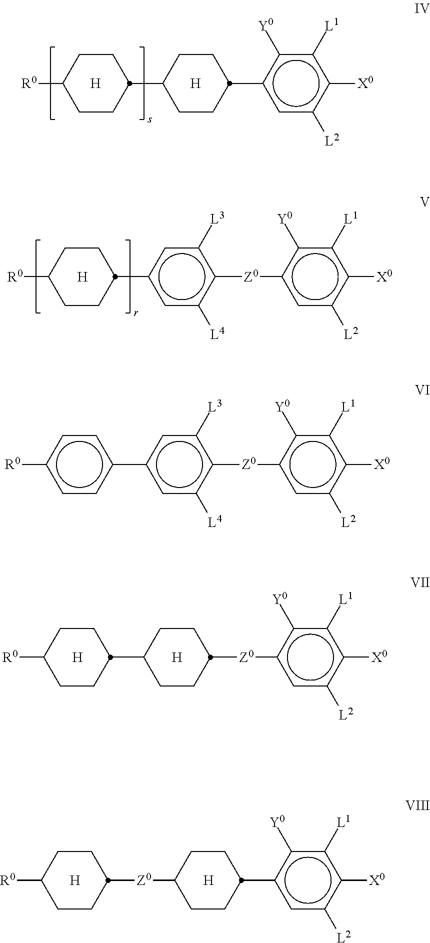
in which
R⁰ denotes a H atom, an alkyl or alkoxy group having 1 to 12 C atoms, or an alkenyl or alkenyloxy group having 2 to 12 C atoms, in which one or more non-adjacent CH₂ groups are optionally substituted by —C═C—, —CF₂O—, —OCF₂—, —CH═CH—, 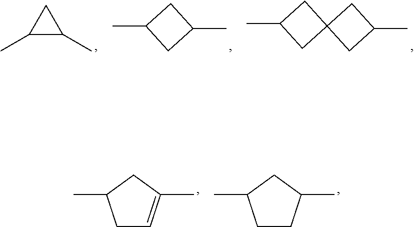
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom;
X⁰ denotes F, Cl, a halogenated alkyl alkenyl, alkoxy, or alkenyloxy group having up to 6 C atoms;
L¹⁻⁴ the H or F; and
Y⁰ denotes H or CH₃;
Z⁰ denotes —C₂H₄—, —(CH₂)₄—, —CH═CH—, —CF═CF—, —C₂F₄—, —CH₂CF₂—, —CF₂CH₂—, —CH₂O—, —OCH₂—, —COO—, —CF₂O—, of —OCF₂—, or, in Formulae V and VI, a single bond;
r denotes 0 or 1, and
S denotes 0 or 1.

9. The LC medium according to claim 1, further comprising one or more compounds of Formulae XXVII, XXVIII, XXIX, or XXX: 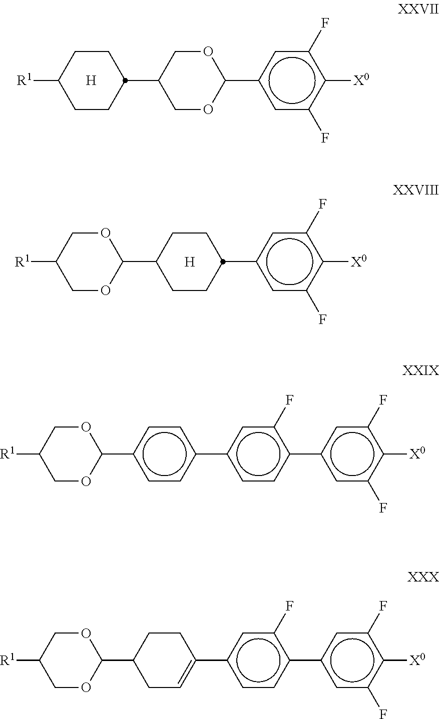
in which
R¹ denotes a H atom, an alkyl or alkoxy group having 1 to 12 C atoms, or an alkenyl or alkenyloxy group having 2 to 12 C atoms, in which one or more non-adjacent CH₂ groups are optionally substituted by —C═C—, —CF₂O—, —OCF₂—, —CH═CH—, 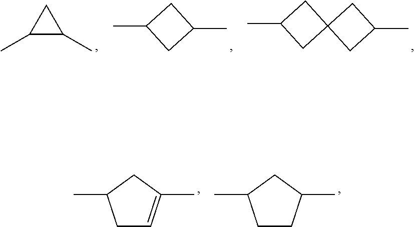
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom;
X⁰ denotes F, Cl, a halogenated alkyl, alkenyl, alkoxy, or alkenyloxy group having up to 6 C atoms.

10. The LC medium according to claim 1, further comprising one or more compounds of the Formula XIV: 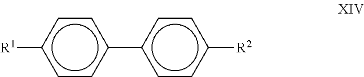
in which R¹ and R² each, independently of one another, denote n-alkyl, alkoxy, oxaalkyl, fluoroalkyl, or alkenyl, each having up to 6 C atoms.

11. The LC medium according to claim 1, further comprising one or more compounds of Formula XVI: 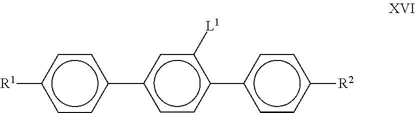
in which
L¹ the H or F; and
R¹ and R² each, independently of one another, denote a H atom, an alkyl or alkoxy group having 1 to 12 C atoms, or an alkenyl or alkenyloxy group having 2 to 12 C atoms, in which one or more non-adjacent CH₂ groups are optionally substituted by —C≡C—, —CF₂O—, —OCF₂—, —CH═CH—, 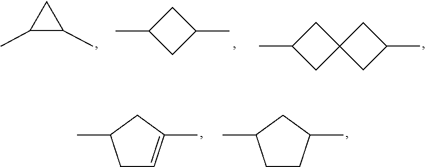
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom.

12. The LC medium according to claim 1, further comprising one or more compounds of Formulae XXXI, XXXII, and XXXII: 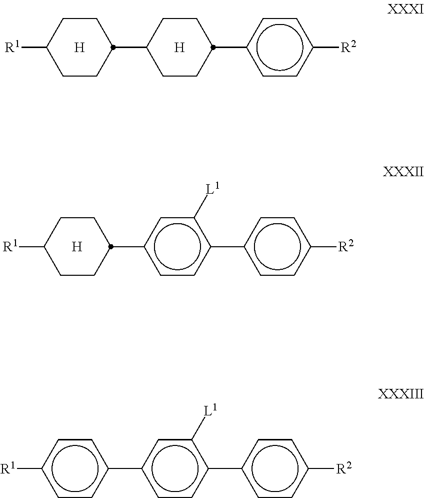
in which
L¹ the H or F; and
R¹ and R² each, independently of one another, denote a H atom, an alkyl or alkoxy group having 1 to 12 C atoms, or an alkenyl or alkenyloxy group having 2 to 12 C atoms, in which one or more non-adjacent CH₂ groups are optionally substituted by —C≡C—, —CF₂O—, —OCF₂—, —CH═CH—, 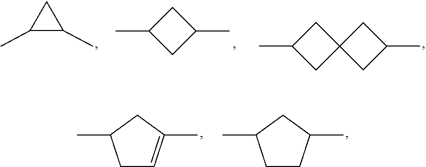
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom.

13. The LC medium according to claim 1, further comprising one or more compounds of Formulae Z¹, Z², Z³, Z⁴, Z⁵, II, III, IV, V, VI, VII, VIII, XXVII, XXVIII, XXIX, XXX, XIV, XVI, XXXI, XXXII, and XXXIII, 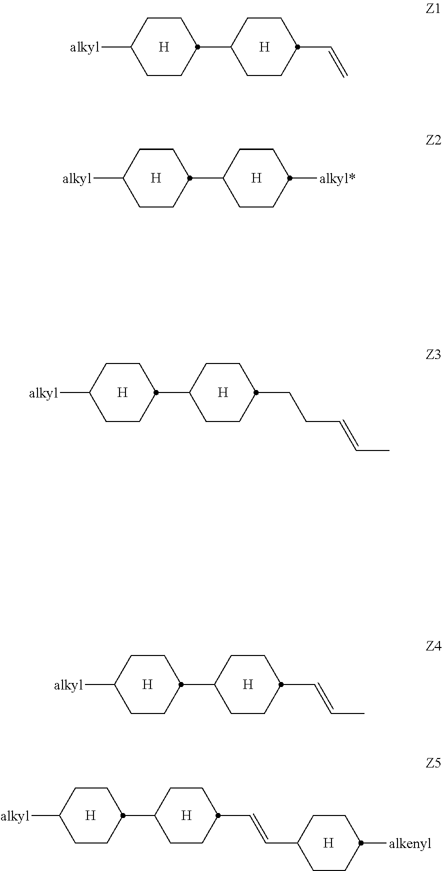
in which
“alkyl” and “alkyl*” denotes an C₁₋₄-alkyl group; and
“alkenyl” and “alkenyl*” each, independently of one another, denote a C₂₋₆-alkenyl group; 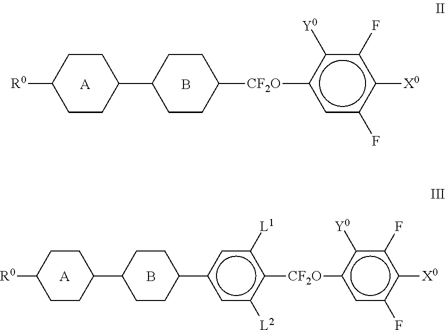
wherein the individual groups, independently of each other and on each occurrence, identically or differently, have the following meanings: 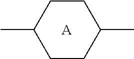
denotes 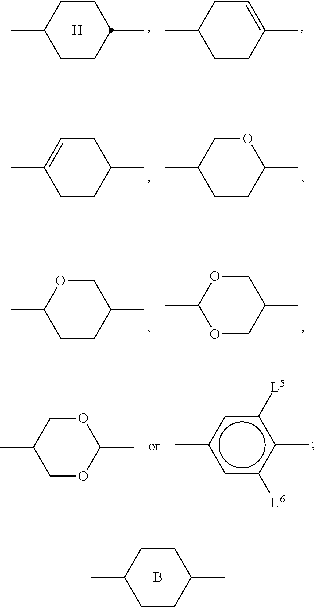
denotes 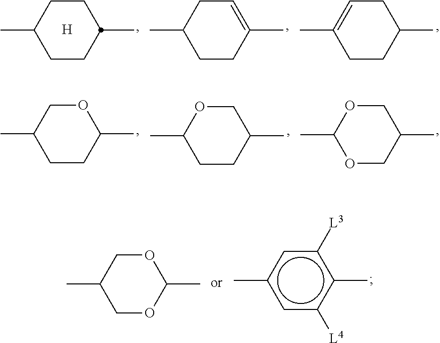
R⁰ denotes a H atom, an alkyl or alkoxy group having 1 to 12 C atoms, or an alkenyl or alkenyloxy group having 2 to 12 C atoms, in which one or more non-adjacent CH₂ groups are optionally substituted by —C═C—, —CF₂O—, —OCF₂—, —CH═CH—, 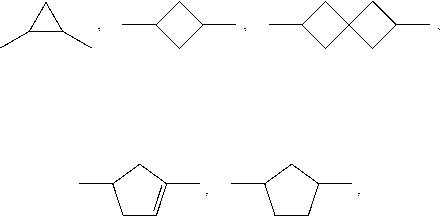
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom;
X⁰ denotes F, Cl, a halogenated alkyl alkenyl, alkoxy, or alkenyloxy group having up to 6 C atoms;
L¹⁻⁶ the H or F; and
Y⁰ denotes H or CH₃: 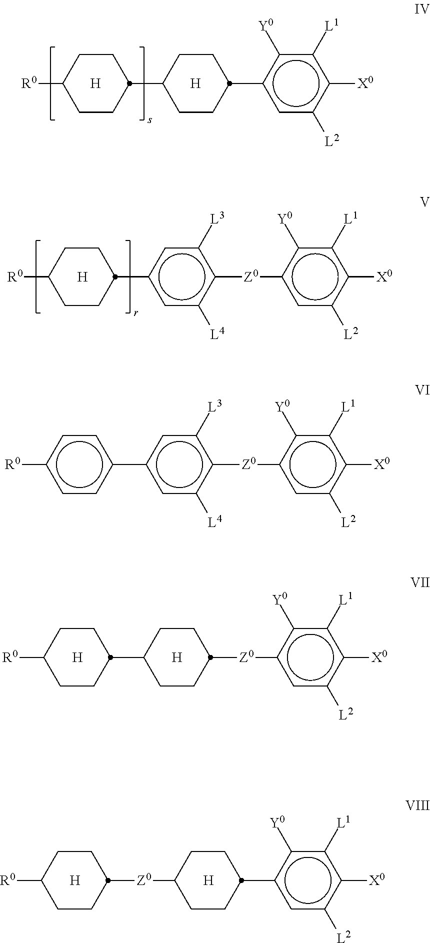
in which
R⁰ denotes a H atom, an alkyl or alkoxy group having 1 to 12 C atoms, or an alkenyl or alkenyloxy group having 2 to 12 C atoms, in which one or more non-adjacent CH₂ groups are optionally substituted by —C═C—, —CF₂O—, —OCF₂—, —CH═CH—, 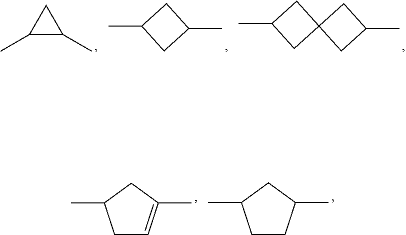
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom; 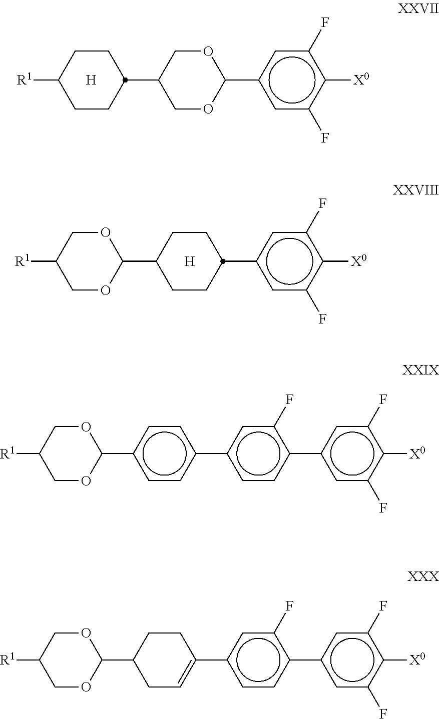
in which
R¹ denotes a H atom, an alkyl or alkoxy group having 1 to 12 C atoms, or an alkenyl or alkenyloxy group having 2 to 12 C atoms, in which one or more non-adjacent CH₂ groups are optionally substituted by —C═C—, —CF₂O—, —OCF₂—, —CH═CH—, 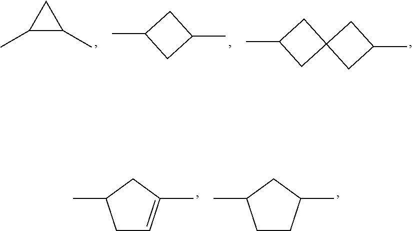
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom; and
X⁰ denotes F, Cl, a halogenated alkyl, alkenyl, alkoxy, or alkenyloxy group having up to 6 C atoms; 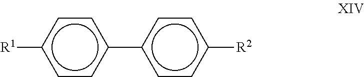
in which R¹ and R² each, independently of one another, denote n-alkyl, alkoxy, oxaalkyl, fluoroalkyl, or alkenyl, each having up to 6 C atoms; 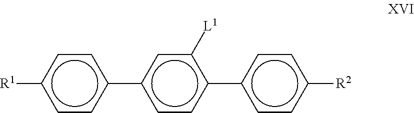
in which
L¹ the H or F; and
R¹ and R² each, independently of one another, denote a H atom, an alkyl or alkoxy group having 1 to 12 C atoms, or an alkenyl or alkenyloxy group having 2 to 12 C atoms, in which one or more non-adjacent CH₂ groups are optionally substituted by —C≡C—, —CF₂O—, —OCF₂—, —CH═CH—, 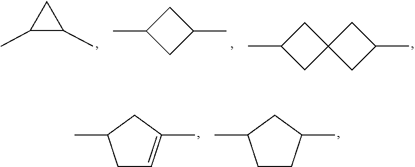
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom; and 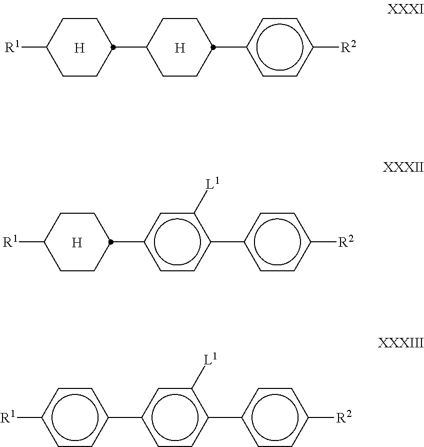
in which
L¹ the H or F; and
R¹ and R² each, independently of one another, denote a H atom, an alkyl or alkoxy group having 1 to 12 C atoms, or an alkenyl or alkenyloxy group having 2 to 12 C atoms, in which one or more non-adjacent CH₂ groups are optionally substituted by —C≡C—, —CF₂O—, —OCF₂—, —CH═CH—, 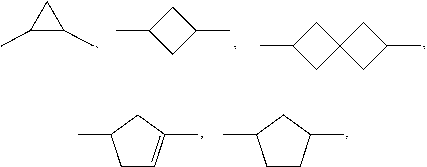
—O—, —CO—O—, or —O—CO— in such a way that O atoms are not linked directly to one another, and in which one or more H atoms are optionally replaced by a halogen atom or a cycloalkyl or cycloalkoxy group having 3 to 12 C atoms, in which one or more H atoms are optionally replaced by a halogen atom.

14. A process for preparation of the LC medium according to claim 1, comprising mixing the one or more compounds of Formula I and the one or more compounds of Formula T1 and T2 with one or more mesogenic compounds, optionally with one or more polymerizable compounds, and optionally with one or more additives.

15. (canceled)

16. An electro-optical LC display comprising the LC medium according to claim 1.

17. The electro-optical LC display according to claim 16, wherein the electro-optical LC display is a TN, PS-TN, STN, TN-TFT, OCB, IPS, PS-IPS, FFS, HB-FFS, XB-FFS, PS-HB-FFS, PS-XB-FFS, SA-HB-FFS, SA-XB-FS, polymer-stabilized SA-HB-FFS, polymer-stabilized SA-XB-FFS, positive VA, or positive PS-VA display.

18. The electro-optical LC display according to claim 16, wherein the electro-optical LC display is an FFS, HB-FFS, XB-FFS, PS-HB-FFS, PS-XB-FFS, IPS, or PS-IPS display.
